(19) United States
(12) Patent Application Publication
(10) Pub. No.: US 2007/0083333 A1
(43) Pub. Date: Apr. 12, 2007

(54) Modeling of systemic inflammatory response to infection

(76) Inventors: Maria Antonia Vitiello, San Diego, CA (US); Yi Zhang, San Diego, CA (US); Dhammika Jayanath Amaratunga, Bridgewater, NJ (US); Tao Shi, San Diego, CA (US); Christine K. Ward, Malvern, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/579,458

(22) PCT Filed: Nov. 17, 2004
(86) PCT No.: PCT/US04/38648

§ 371 Date: May 16, 2006

Related U.S. Application Data
(60) Provisional application No. 60/523,296, filed on Nov. 17, 2003.

(51) Int. Cl. G06F 19/00

(52) U.S. Cl. 702/19

(57) ABSTRACT

Models for the systemic inflammatory response to infection, which involve the use of immunocompromised animals, and methods of using the models are described. These models can be used in identifying analytes or biomarker panels that can be used in staging or monitoring sepsis. The models can also be used for predicting an animal's disease outcome or in providing a prognosis for sepsis patients. Further, the invention relates to methods for evaluating potential treatments for sepsis.

### CROSS-REFERENCE TO RELATED APPLICATION

This application claims priority to U.S. Provisional Application No. 60/523,296, the disclosure of which is incorporated by reference herein.

### FIELD OF THE INVENTION

This invention relates to models for the systemic inflammatory response to infection comprising immunocompromised mice. The invention also relates to methods of using the models to identify biomarkers correlated with the systemic inflammatory response to infection, to identify biomarker panels useful in staging the disease, and to predict disease outcome. Further, the invention relates to methods for evaluating potential treatments for sepsis.

### BACKGROUND OF THE INVENTION

Septic shock is among the leading causes of death of hospitalized patients and is a condition for which insufficient treatment options are available. The search for new effective treatments for sepsis has been limited. The incidence of sepsis is expected to increase sharply in the near future due to aging of the population, advances in technology, widespread use of new medical devices, and the advent of procedures that extend survival of critically ill patients. The incidence of sepsis has been increasing in the last 20 years and current figures indicate the presence of 750,000 cases per year of severe sepsis in the United States alone (Angus, D. C. et al. Crit. Care Med. 29:1303-1310, 2001). The estimated crude mortality is 35%, all comorbidities being considered (Rangel-Frausto, M S. Infectious Disease Clinics of North America 13(2):299-312, 1999). Sepsis is the 10th leading cause of death in the United States, and among hospitalized patients in noncoronary intensive care units, has been reported to be the most common cause of death. The disease accounts for an estimated $16 billion in annual health care expenditures in the United States alone.

During bacterial infections, bacteria and its products can cause septic shock that can result in death. For example, endotoxins are usually heat-stable lipopolysaccharide-protein complexes of high toxicity, typically formed by gram-negative bacteria, e.g., of the genera Brucella, Haemophilus, Escherichia, Klebsiella, Proteus, Salmonella, Pseudomonas, Shigella, Vibrio, Yersinia. Septic shock is often associated with bacteremia due to gram-negative bacteria or meningococci. Pathogen species which cause sepsis include bacterium species, e.g., a bacterium species selected from the group consisting of Enterococcus spp., Staphylococcus spp., Streptococcus spp., Enterobacteriacae family, Providencia spp., Pseudomonas spp. and others. Sepsis and its consequences, severe sepsis and septic shock can result from Gram negative, Gram positive bacteria, fungi and viruses.

The terms sepsis, bacteremia and septicemia have been used interchangeably in the past; however, approximately one of every three patients presenting with sepsis have sterile cultures, indeterminate microbiological studies or lack a definite site of infection. Therefore, sepsis is now considered to be the clinical presentation of patients with a serious infection, who demonstrate a systemic inflammatory response to infection that may or may not be accompanied by a positive blood culture. Severe sepsis, the most common type found in the intensive care unit (ICU), is the systemic inflammatory response induced by infection and accompanied by evidence of altered organ function or perfusion. Sepsis, including all stages through septic shock, results from the inability of the immune system to properly control a bacterial infection. Upon interaction with microbial components, cells of the immune system initiate an inflammatory response aimed at avoiding a systemic infection and promoting clearance of the bacteria. In some instances, however, bacteria gain access to the circulation, resulting in mis-regulated production of inflammatory cytokines, sepsis syndrome, septic shock, and eventually death. Descriptions for the stages of sepsis are set forth in Levy M M, Fink M P, Marshall J C, Abraham E, Angus D, Cook D, Cohen J, Opal S M, Vincent J L, Ramsay G. 2001 SCCM/ESICM/ACCP/ATS/SIS International Sepsis Definitions Conference, Crit. Care Med 2003; 31:1250-6, and in the preceding conference held in 1991 and described in the 1992 report, Bone R C et al., American College of Chest Physicians/Society of Critical Care Medicine Consensus Conference, Definitions for sepsis and organ failure and guidelines for the use of innovative therapies in sepsis, Chest 101: 1644-1655, which describe sepsis as a clinical syndrome defined by the presence of both infection and a systemic inflammatory response.

Sepsis is a systemic inflammatory response to infection. Three major stages have been put forth by the Consensus Conference of the American College of Chest Physicians and by the Society of Critical Care Medicine. The first stage, Systemic Inflammatory Response Syndrome (SIRS), requires two or more of the following conditions: fever or hypothermia, tachypnea, tachycardia, leukocytosis, and leukopenia. In the second stage, sepsis proceeds to a more severe complication called “severe sepsis” or “sepsis syndrome,” which is sepsis with one or more signs of organ dysfunction (for example, metabolic acidosis, acute encephalopathy, oliguria, hypoxemia, or disseminated intravascular coagulation) or hypotension. Finally, in the third stage, septic shock, in which hypotension that is unresponsive to fluid resuscitation along with organ dysfunction occurs, is observed.

Staging sepsis to identify points at which the clinician can intervene with preventive measures has been and continues to be a very challenging task. Broad disease definitions have limited the ability of clinicians to identify appropriate therapies for patients who have sepsis and who are at high risk for developing sepsis. In addition, these definitions do not permit the clinician to differentiate between an at-risk patient who may derive a net benefit from a new therapy and a patient who will either not benefit, given his/her underlying disease co-morbidities, or who may be placed at higher risk from the therapy's inherent safety profile. Additionally, the variability of disease progression and sequelae have made staging sepsis very difficult. Furthermore, certain treatments have been found to have opposite effects on sepsis patients depending on when they are administered. For example, therapies directed against TNF-α have been shown to both worsen and improve survival in patients with sepsis. Such results are speculated to be due to a change in the syndrome over time, with initial sepsis characterized by increases in inflammatory mediators, but with a later shift toward an antiinflammatory immunosuppressive state (Hotchkiss et al., “The Pathophysiology and Treatment of Sepsis,” The New England Journal of Medicine 348:2, Jan. 9, 2003). The difficulty in staging sepsis, combined with the contrasting results obtained with treatments tested, have made it very difficult to identify candidate drugs for treating sepsis and sepsis syndrome.

There are scoring systems and predictive models for sepsis, and general disease scoring systems that have been applied to sepsis. These scoring systems include the Injury Severity Score (ISS, 1974) which is a measure of the severity of blunt trauma injury to five major body systems; the Glasgow Coma Scale (SCS, 1974) which measures mental status changes; the Trauma Score (1980), which extends the Glasgow score to include respiratory and hemodynamic parameters; the TRISS method, which combines physiologic and anatomic measurements to assess probability of surviving an injury; the Sepsis Severity Score (1983), which grades the functioning of seven body organs; the Polytrauma Score (1985), which adds an age parameter to the Injury Severity Score; the Multiple Organ Failure (MOF) Score (1985), which assesses the function of seven major organ systems; and the APACHE II (1985). The APACHE II is a scoring system that utilizes data from routinely measured physiological assessments in addition to a general health status score and an age score (reviewed by Roumen, R L et al., J. Trauma 35: 349-355, 1993). APACHE II, and its more recent version APACHE III, are used to evaluate how sick an individual is, rather than to diagnose sepsis.

Various pro-inflammatory cytokines are associated with sepsis. Use of measurements of one or more pro-inflammatory cytokine to evaluate the severity of inflammation in patients with SIRS has been reported. Takala, A. et al. (Clin. Sci. 96, 287-295 [1999]) described measuring levels of a small group of analytes—CD11b, IL-6, IL-1β, TNF-α, and C-reactive protein groups—in SIRS patients meeting two, three, or four SIRS criteria. Based on their measurement of the markers, the authors used a whole number subscore, known as the Systemic Inflammation Composite Score (SICS), to compare the severity of inflammation in the patients. They concluded that their results suggest that if the SICS is low, an acutely ill patient who meets the SIRS criteria most probably does not have sepsis, whereas if the SICS is high, the patient should be carefully examined for the presence of infection, among other disorders able to elicit the systemic inflammatory reaction.

U.S. Pat. No. 6,190,872 describes measurement of acute inflammatory response mediators known or suspected to be involved in the inflammatory response to identify patients at risk for developing a selected systemic inflammatory condition prior to development of signs and symptoms which are diagnostic of the selected systemic inflammatory condition.

U.S. Pat. No. 5,804,370 describes a method for determining the presence or extent of sepsis in a human or animal patient using an antibody assay to determine the amount of an analyte, including TNF, IL-1, IL-6, IL-8, Interferon and TGF-β. These analytes have been shown not to be necessarily predictive of survival vs. death.

Published Application No. US2003/0194752 describes a method for detecting early sepsis using a statistical measure of the extreme values of analyte measurements obtained over time, rather than a statistical analysis of values of analytes obtained from samples at a selected timepoint.

Billions of dollars have been spent to generate treatments to prevent a fatal outcome for sepsis/septic shock. Such efforts have been largely unsuccessful—an alarming result for a disease syndrome with a current mortality rate of 30 to 50%. Moreover, the incidence of sepsis/septic shock is expected to steadily increase, reflecting an aging population and advancing technologies that prolong survival of immunocompromised and critically ill patients. Despite the efforts made to develop treatments, there is just one approved drug, which is indicated for only the most severe cases of septic shock. Furthermore, even with respect to that drug, Xigris® (Lilly), there is not a straightforward way to determine when the drug should be administered to a sepsis patient.

Animal models for use in research have also been described. U.S. Pat. No. 6,368,572 describes a chimeric hematopoietic-deficient mouse as a model for toxin shock. U.S. Pat. No. 6,610,503 describes a method for predicting an expected time of death of an experimental animal in a model system of sepsis using data generated in the initial part of the experiment.

Obstacles for developing sepsis therapies include incomplete understanding of the syndrome, inadequacies in staging the syndrome, and lack of adequate animal models. Currently, animal models for sepsis syndrome do not mimic the human disease and have been considered an important cause behind the failure of proposed therapies. Murine models have been used extensively with limited success to evaluate the efficacy of therapeutics in development for septic shock. Analysis of these models has revealed that two major important differences exist in the progression of the disease in humans compared to the disease in mice that may explain the unreliability of prior murine models to predict future clinical success. The first major difference is that generally young, healthy animals are used in the murine models, whereas sepsis syndrome typically occurs in critically ill patients, or patients whose immune defenses are impaired (either by trauma, surgery or severe burns, or by immunocompromising disorders, such as cancer and chemotherapy). The second major difference concerns the establishment of the septic state in murine models (e.g., the agent, the route, and the mode of challenge). In the majority of murine models, healthy animals typically receive a bolus dose of either LPS or live microorganisms intravenously or intraperitoneally and will develop septic shock and achieve a moribund state within 24 hours. In septic human patients, the source and identity of the triggering infection is not always apparent and patients develop septic shock and die after a period of several days. Moreover, the SICS scoring system and other scoring systems have not provided effective modeling to predict outcome or to detect when and if a given patient has become septic.

Thus, there is a need for more predictive or accurate models of sepsis. An animal model that more closely resembles the human disease would more closely predict the efficacy of potential drug targets and the outcome of potential therapies.

### SUMMARY OF THE INVENTION

General aspects of the invention are defined in the appended independent claims, which for the sake of brevity are incorporated by reference herein. Preferred embodiments of the invention are defined in the dependent claims following the detailed description, which are likewise incorporated by reference herein. Other preferred embodiments as well as exemplary features and advantages of the invention will become apparent from the detailed description taken in conjunction with the drawing figures.

### BRIEF DESCRIPTION OF THE DRAWINGS

FIGS. 1A-1C show the time-profiles of the measured concentrations of the 57 analytes assayed in INFECTED mice (solid lines) vs. XR.INFECTED mice (dotted lines). The analyte names are listed on the Y-axis. Concentration values are in picograms per milliliter (pg/ml). The two-way ANOVA interaction p value for each analyte is listed above each graph. Error bars represent one standard deviation above or below the mean at a given time point.

FIGS. 2A-2D show plots of the log2-transformed data depicted in FIGS. 1A-1C. All the measurements are plotted as points and the mean time-profiles are represented in lowess-fitted lines (Cleveland, W. S. (1979), “Robust locally weighted regression and smoothing scatterplots,” J. Amer. Statist. Assoc. Vol. 74, pp. 829-836). The dotted curves represent data derived from XR.INFECTED mice.

FIGS. 3A-3E show the time-profiles of the 28 analytes depicted in FIGS. 1A-1C that displayed a two-way ANOVA interaction p value <0.1. Error bars represent 1 standard deviation above or below the mean at a given time point. The analyte names are listed on the Y-axis. Concentration values are presented in picograms per milliliter (pg/ml). The two-way ANOVA interaction p value for each analyte is listed above each graph. The dotted curves represent data derived from XR.INFECTED mice.

FIG. 4 shows box-and-whisker plots of analyte measurements taken at 4 hours and zero hour that showed an interaction p value <0.05. The boxes are drawn with widths proportional to the square-roots of the number of observations in the groups, and a notch is drawn in each side of the boxes. Notches of two plots that do not overlap reflect a substantial difference between the medians of such plots (Chambers, et al., Graphical Methods for Data Analysis, Wadsworth & Brooks/Cole (1983)).

FIG. 5 shows box-and-whisker plots of analyte measurements taken at 4 hours and zero hour that showed an interaction p value <0.05. Boxes are rendered as described for FIG. 4.

FIG. 6 shows box-and-whisker plots of analyte measurements taken at 4 hours and zero hour that showed an interaction p value <0.05. Boxes are rendered as described for FIG. 4.

FIG. 7 shows box-and-whisker plots of analyte measurements taken at 4 hours and zero hour that showed an interaction p value <0.05. Boxes are rendered as described for FIG. 4.

FIG. 8 shows box-and-whisker plots of analyte measurements taken at 4 hours and zero hour that showed an interaction p value <0.05. Boxes are rendered as described for FIG. 4.

FIG. 9 shows box-and-whisker plots of analyte measurements taken at 4 hours and zero hour that showed an interaction p value <0.05. Boxes are rendered as described for FIG. 4.

FIG. 10 shows a Kaplan-Meier curves comparing survival rates derived from irradiated mice treated with one dose every 24 hours post-infection for four days of ethyl pyruvate (“EP”) at 35 mg/ml, eight doses of ethyl pyruvate (“EP2x”) at 35 mg/ml at 24, 30, 48, and 54 hours post-infection and every 24 hours thereafter for four days, four doses of ceftriaxone (CEF) at 0.1 mg/ml every 24 hours post-infection for days, and untreated animals (“Control”). Arrows denote 24, 48, 72, and 96 hour dosage times.

FIG. 11 shows median VEGF concentration from INFECTED (solid line and x's) and XR.INFECTED (dotted line and circles) mice measured at the indicated time points. VEGF concentration units are pictogram per milliliter (pg/ml).

FIGS. 12A-12D show Kaplan-Meier curves (FIGS. 12A and 12C) and box-and-whisker plots (FIGS. 12B and 12D) comparing survival rates derived from irradiated mice treated with anti-VEGF antibody (“anti-VEGF”) and anti-VEGF antibody isotype control (“control”). FIGS. 12A and 12B compare data derived from all animals in the experiment. FIGS. 12C and 12D exclude data derived from animals with bacterial counts >10⁴.

FIGS. 13A-13D show Kaplan-Meier curves (FIGS. 13A and 13C) and box-and-whisker plots (FIGS. 13B and 13D) comparing survival rates derived from irradiated mice treated with anti-VEGF antibody (“anti-VEGF”) and anti-VEGF antibody isotype control (“control”). FIGS. 13A and 13B compare data derived from all animals in the experiment. FIGS. 13C and 13D exclude data derived from animals with bacterial counts >10⁴.

FIGS. 14A-14D show plots of the combined data derived from ceftriaxone-treated animals used in the experiments performed to generate the data depicted in FIGS. 12A-13D. The survival difference between the combined “control” and “treatment” groups is depicted in FIG. 14A. There is no difference in terms of bacterial count (FIG. 14B) and health between the two groups. FIGS. 14C and 14D show similar plots, but which exclude animals with bacterial counts >10⁴.

FIGS. 15A-15D shows plots of the combined data from all animals used in the experiments performed to generate the data depicted in FIGS. 12A-13D. The survival difference between the combined “control” and “treatment” groups is depicted in FIG. 15A. There is no difference in terms of bacterial count (FIG. 15B) and health between the two groups. FIGS. 15C and 15D show similar plots, but which exclude animals with bacterial counts >10⁴.

FIGS. 16A-16D show Kaplan-Meier curves (FIGS. 16A and 16C) and box-and-whisker plots (FIGS. 16B and 16D) comparing survival rates derived from irradiated mice treated with anti-VEGF antibody (“anti-VEGF”) and anti-VEGF isotype control (“control”). FIGS. 16A and 16B compare data derived from all animals in the experiment. FIGS. 16C and 16D exclude data derived from animals with bacterial counts >10⁴.

FIGS. 17A-17D show Kaplan-Meier curves (FIGS. 17A and 17C) and box-and-whisker plots (FIGS. 17B and 17D) comparing survival rates derived from irradiated mice treated with anti-VEGF antibody (“anti-VEGF”) and anti-VEGF isotype control (“control”). FIGS. 17A and 17B compare data derived from all animals in the experiment. FIGS. 17C and 17D exclude data derived from animals with bacterial counts >10⁴.

FIGS. 18A-18D show plots of the combined data from animals that received anti-VEGF antibody or anti-VEGF isotype control used in the experiments performed to generate the data depicted in FIGS. 16A-17D. The survival difference between the combined “control” and “treatment” groups is depicted in FIG. 18A. There is no difference in terms of bacterial count (FIG. 18B) and health between the two groups. FIGS. 18C and 18D show similar plots, but which exclude animals with bacterial counts >10⁴.

FIGS. 19A-19B shows plots of the combined data for all animals used in the experiments performed to generate the data depicted in FIGS. 16A-17D. The survival difference between the combined “control” and “treatment” groups is depicted in FIG. 18A. There is no difference in terms of bacterial count (FIG. 18B) and health between the two groups. FIGS. 18C and 18D show similar plots, but which exclude animals with bacterial counts >10⁴.

FIG. 20 shows the median JE/MCP-1 concentration from INFECTED (solid line and x's) and XR.INFECTED (dotted line and circles) mice measured at the indicated time points. VEGF concentration units are pictogram per milliliter (pg/ml).

FIGS. 21A-21X show Kaplan-Meier curves (FIGS. 21A-21D, 21I-21L, and 21Q-21T) and box-and-whisker plots (FIGS. 21E-21H, 21M-21P, and 21U-21X) comparing survival rates derived from irradiated mice treated with anti-JE/MCP-1 antibody (“antiJE”) and anti-JE/MCP-1 isotype control (“ISO”). The survival difference between groups A, B, and C (described in Example 8) is depicted in FIG. 21A. The survival difference between groups A and C is depicted in FIG. 21B. The survival difference between groups A and B is depicted in FIG. 21C. The survival difference between groups B and C is depicted in FIG. 21D. There is no difference in terms of bacterial count and health between the three groups, as seen in FIGS. 21E-21H. FIGS. 21I-21L show similar plots, but which exclude animals with bacterial counts >10⁴. The survival difference between groups A, B, and C is depicted in FIG. 21I. The survival difference between groups A and C is depicted in FIG. 21J. The survival difference between groups A and B is depicted in FIG. 21K. The survival difference between groups B and C is depicted in FIG. 21L. There is no difference in terms of bacterial count and health between the three groups, as seen in FIGS. 21M-21P. FIGS. 21Q-21X show plots of data from animals used in the experiment that did not die and were not euthanized before the second treatment. The survival difference between groups A, B, and C is depicted in FIG. 21Q. The survival difference between groups A and C is depicted in FIG. 21R. The survival difference between groups A and B is depicted in FIG. 21S. The survival difference between groups B and C is depicted in FIG. 21T. There is no difference in terms of bacterial count and health between the three groups, as seen in FIGS. 21U-21X.

FIGS. 22A-22F show Kaplan-Meier curves (FIGS. 22A, 22C, and 22E) and box-and-whisker plots (FIGS. 22B, 22D, and 22F) comparing survival rates derived from irradiated mice treated with anti-JE/MCP-1 antibody (“antiJE”) and anti-JE/MCP-1 isotype control (“ISO”). The survival difference between groups A and B (described in Example 8) is depicted in FIG. 22A. There is no difference in terms of bacterial count and health between the two groups, as seen in FIG. 22B. FIG. 22C shows a similar plot, but which excludes animals with bacterial counts >10⁴. There is no difference in terms of bacterial count and health between the two groups, as seen in FIG. 22D. The survival difference between groups A and B, excluding animals that were euthanized before ceftriaxone treatment, is depicted in FIG. 22E. There is no difference in terms of bacterial count and health between the three groups, as seen in FIG. 22F.

FIGS. 23A-23F show Kaplan-Meier curves (FIGS. 23A, 23C, and 23E) and box-and-whisker plots (FIGS. 23B, 23D, and 23F) comparing survival rates derived from the combined data from animals used in the experiments performed to generate the data depicted in FIGS. 21A-22F. FIG. 23A shows the survival difference between “ISO” and “antiJE” groups. There is no difference in terms of bacterial count (FIG. 23B) and health between the two groups. FIGS. 23C and 23D show similar plots, but which exclude animals with bacterial counts >10⁴. FIGS. 23E-23F show plots of the combined data for all animals used in the experiment that did not die and were not euthanized before the second treatment.

FIGS. 24A-24F show Galaxy maps for five different groups of analytes analyzed by PCA as indicated above each Figure. The solid line in each Figure denotes a plane that is discerned, which separates data points derived from Survived animals, which fall generally on the left side of each line in each map, and Doomed animals, which fall generally on the right side of each line in each map. Numbers in each map represent the number of animals that were misclassified by the PCA of each respective group of analytes.

FIGS. 25A-25B show Kaplan-Meier curves comparing survival rates derived from irradiated and untreated mice to the survival rates of irradiated mice that were subsequently treated with either one of the VEGF antagonists, Compounds I and II.

FIG. 26 shows Kaplan-Meier curves comparing survival rates derived from irradiated and untreated mice to the survival rates of irradiated mice that were subsequently treated with either 50 μg/ml rosiglitazone or 200 μg/ml rosiglitazone.

### DETAILED DESCRIPTION OF THE INVENTION AND ITS PREFERRED EMBODIMENTS

The present invention provides methods for using an immunocompromised animal model to study the systemic inflammatory response to infection, including selecting panels of biomarkers used for staging sepsis syndrome in animal subjects, including humans, and for predicting disease outcomes in these subjects. The invention further provides methods for using the biomarker panels to identify candidate drugs for treatment of sepsis and sepsis syndrome. The invention can also be used to identify new biomarkers correlated with sepsis from analytes identified in proteomic and genomic studies. The invention provides methods for determining reference scores for a group of immunocompromised infected animals in a model system, and methods for using the animal models to validate drug targets and to test therapeutic compounds.

The invention also relates to methods for selecting a panel of biomarkers useful for determining the stage of sepsis syndrome in an animal species comprising: providing a plurality of biological samples taken at a selected timepoint or timepoints, the samples selected from at least two groups of animals where the first group comprises survived immunocompromised individuals infected by a sepsis-causing pathogen and the second group comprises doomed immunocompromised individuals infected by a sepsis-causing pathogen; measuring the amount of each of a plurality of analytes in the biological samples from each group and generating a dataset for each group; and performing an analysis, for example, a statistical analysis, on the data. The statistical analysis can comprise conducting a univariate statistical test on the dataset, for each analyte, to compare the dataset for biological samples from the first group to the dataset for biological samples from the second group of animals. Further, analytes can be selected according to their significance level as determined by the univariate statistical test.

The invention provides using the univariate statistical analysis to identify those analytes that are associated with a given outcome at a desired significance level, e.g., 0.05 or better (e.g., 0.04, 0.03, 0.02, or 0.01). A significance level of 0.05 is a standard typically used in statistical research. Depending on the purpose of the research, the statistical stringency can be lowered to 0.02, 0.01 or even smaller.

Univariate statistical analyses include the T-test. The T-test is a statistical method to test the equality of means of the two groups of biological samples that are being compared. There are many univariate statistical tests available for use in different situations and for different purposes, including the nonparametric Wilcoxon two sample test, analysis of variance (ANOVA), and other univariate statistical tests known to statisticians and biostaticians.

The invention further provides transforming the data obtained for each group of animals or individuals to log scale. Generally, transforming the data to log scale renders the distribution of the data close to normal distribution, thus making the statistical tests used advantageous because most statistical tests either require normal distribution or would be optimal under normal distribution.

The present invention additionally provides methods of selecting a panel of biomarkers as described above, further comprising the step of deriving a discrimination function for the selected biomarkers, where the deriving comprises performing a principle component analysis and a linear discriminant analysis, and where the discrimination function can be used to generate a score for each animal.

In one embodiment of the invention, the analytes tested include (but are not limited to): Apolipoprotein A1, β2 Microglobulin, C Reactive Protein, D-dimer, EGF, Endothelin-1, Eotaxin, Factor VII, FGF-9, FGF-Basic, Fibrinogen, GCP-2, LIX, GM-CSF, Growth Hormone, GST, Haptoglobin, IFN-γ, IgA, IL-10, IL-11, IL-12p70, IL-17, IL-18, IL-1α, IL-1β, IL-2, IL-3, IL-4, IL-5, IL-6, IL-7, Insulin, IP-10, KC-GRO, Leptin, LIF, Lymphotactin, monocyte chemoattractant protein 1 (MCP-1 or JE), MCP-3, MCP-5, M-CSF, MDC, MIP-1α, MIP-1β, MIP-1α, MIP-2, MIP-3β, Myoglobin, OSM, RANTES, SCF, SGOT, TIMP-1, Tissue Factor, TNF-α, TPO, VCAM-1, VEGF, and VWF. In other embodiments of the invention, the selected panel of biomarkers includes MCP-1-JE, IL-6, MCP-3, IL-3, MIP-1β, and KC-GRO, and the discrimination function is represented as 19(MCP-1-JE)+27(IL-6)+18(MCP-3)+21(IL-3)+18(MIP-1β)+25(KC-GRO).

Preferred panels of biomarkers therefore include: (i) Apolipoprotein A1, β2 Microglobulin, C Reactive Protein, D-dimer, EGF, Endothelin-1, Eotaxin, Factor VII, FGF-9, FGF-Basic, Fibrinogen, GCP-2, LIX, GM-CSF, Growth Hormone, GST, Haptoglobin, IFN-γ, IgA, IL-10, IL-11, IL-12p70, IL-17, IL-18, IL-1α, IL-1β, IL-2, IL-3, IL-4, IL-5, IL-6, IL-7, Insulin, IP-10, KC-GRO, Leptin, LIF, Lymphotactin, MCP-1-JE, MCP-3, MCP-5, M-CSF, MDC, MIP-1α, MIP-1β, MIP-1α, MIP-2, MIP-3β, Myoglobin, OSM, RANTES, SCF, SGOT, TIMP-1, Tissue Factor, TNF-α, TPO, VCAM-1, VEGF, and VWF; or (ii) MCP-1-JE, IL-6, MCP-3, IL-3, MIP-1β, and KC-GRO. Other preferred biomarker panels comprise at least MCP-1, more preferably MCP-1 and VEGF. Such biomarkers may be used to provide a sepsis diagnosis or survival prognosis or to monitor the efficacy of a treatment, e.g., in a clinical setting.

In the methods of the invention, exemplary animal species include humans and other mammals, including mice, rabbits, monkeys, dogs and birds. In one embodiment, the invention provides for analyzing a biological sample at a timepoint of 22 hours following infection with a pathogen species, but the invention also provides for analysis of biological samples at timepoints taken throughout the course of disease, at death, and following recovery from the disease. The invention provides for the use of blood, serum or other body fluids, including blood plasma, cerebrospinal fluid, lymph aspirate, bronco-alveolar lavage, ascitis and essudates obtained from the infection site, and tissues, including homogenized organs.

The invention also provides for the selection of a panel consisting of biomarkers determined to be characteristic of a disease stage. This determination can be based on the statistical analysis of the analyte levels measured in diseased and control animals. In certain embodiments, the panel consists of fifteen or fewer biomarkers, or ten or fewer biomarkers, or five or fewer biomarkers, e.g., nine, eight, seven, six, four, three, two or one biomarker, but is not limited to those number of biomarkers.

The invention additionally permits for using OmniViz Analysis® software (OmniViz, Inc., Maynard, Mass.), or an equivalent or similar data-visualization application, to evaluate the ability of a biomarker panel to discriminate different groups, i.e., to predict disease outcome. The OmniViz software employs a “Galaxy” visualization approach to pattern and relationship determination among data. In a Galaxy visualization, each data point is represented, and the data are logically grouped into sets or clusters of similar data, with an open circle associated with each cluster reflecting the mathematical centroid for the data in the cluster. Proximity of points represents relatedness, and therefore facilitates analysis and interpretation of data.

The present invention also provides methods for staging sepsis and sepsis syndrome and predicting survival using an immunocompromised animal model system. More particularly, the invention provides a method for predicting whether an animal with sepsis syndrome will survive or die, comprising: providing a biological sample from an animal suspected of being infected by a sepsis-causing pathogen; providing a panel of biomarkers useful for determining the stage of sepsis syndrome in the animal species, the panel selected according to methods of the invention as described herein; measuring, in the biological sample, the amount of the biomarkers; generating a score for the biological sample using the discrimination function determined; and comparing the score with at least one score determined using a biological sample from a survived immunocompromised animal and at least one score determined using a biological sample from a doomed immunocompromised animal.

Patients in different stages of sepsis may not be responsive to a given treatment, if that treatment is not effective when administered during some stages of sepsis. Methods according to the invention are useful for characterizing stages of the disease useful for studying the effectiveness of drugs for treating sepsis, severe sepsis and septic shock as well as for investigating the cellular and molecular mechanisms important in sepsis. This can be accomplished through comparing data obtained for a panel in a diseased biological sample with data obtained using the same panel in an uninfected control biological sample. The information obtained can be used to stage disease in a test biological sample. The invention further permits screening a compound or molecular entity for its efficacy as a potential drug or treatment for sepsis using the methods of the invention.

Methods of the invention employ an immunocompromised animal model for staging sepsis syndrome in the animal. Certain embodiments of the method comprise: providing a biological sample from an animal suspected of being infected by a sepsis-causing pathogen; and providing a panel of biomarkers useful for determining the stage of sepsis syndrome in the animal species, where the biomarkers are selected, for example, according to methods described herein. The amounts of the biomarkers can be measured in the biological sample—a score for the biological sample generated using a discrimination function determined for the stage of sepsis syndrome; and the score for the biological sample compared with a reference score. The reference score used for comparison may be, for example, a reference score determined using a biological sample from at least one animal at a given stage of sepsis syndrome. In some embodiments of these inventions, the immunocompromised animal is known or confirmed to be infected by a sepsis-causing pathogen.

The invention also provides for methods of selecting a candidate drug for treating sepsis syndrome comprising: selecting a model system of sepsis syndrome, the model system comprising immunocompromised individuals from an animal species and a pathogen species capable of causing sepsis in the animal species, wherein the survival rate of immunocompromised infected animals in the model system is within a desired range (for example, 30-70% may be used to establish differences between survived and doomed animals; when treating, the survival rate will preferably approach 100% in comparison with the mortality rate without treatment); infecting experimental immunocompromised and control animals of the animal species with the pathogen species; administering a test drug to the experimental animals; obtaining biological samples from the experimental and control animals at one or more selected times following infection; and measuring the amounts of a plurality of analytes in the biological samples. Further, scores can be determined for the experimental and control animals using the discrimination function for the animal species at the appropriate time point. The test compound is a candidate drug for treating sepsis syndrome if it is found effective in the model. Effectiveness can be evaluated based upon a change in disease outcome, or a change in the amounts of a panel of biomarkers, or in the scores determined using the discrimination function. The difference in score between the biological sample from the test animal and the control animal can further be evaluated based on its statistical significance.

In one preferred embodiment of the invention, the test compound for treating sepsis is a compound suspected as having or determined as having (e.g., from high-throughput screening, a cell-based assay, or the like) VEGF-modulating activity, such as a vascular endothelial growth factor (VEGF) inhibitor, an anti-vascular endothelial growth factor (VEGF) antibody, or a peptide or small molecule VEGF agonist or antagonist. In another embodiment, the potential compound for treating sepsis is a compound suspected or determined as having activity in modulating a toll-like receptor (TLR), e.g., a TLR inhibitor. In yet another embodiment, the test compound is an anti-MCP-1 (or anti-JE) antibody. In yet another embodiment, the potential treatment comprises a PPARγ agonist, such as rosiglitazone. In a still further embodiment, the test compound is a reactive oxygen species or an antioxidant, such as ethyl pyruvate. In an additional embodiment, the test compound is a CCR2 modulator, more preferably a CCR2 inhibitor.

The invention also provides methods of determining a reference score for a group of immunocompromised infected animals in a model system, comprising: providing a model system of sepsis syndrome, the model system comprising immunocompromised survived animals and immunocompromised doomed animals from an animal species and a sepsis-causing pathogen species; infecting the animals in the model system; obtaining biological samples from the animals at one or more selected times after infecting; measuring the levels of a panel of biomarkers selected using the methods described herein in each biological sample; and determining a first reference score for immunocompromised survived animals using a discrimination function, and determining a second reference score for immunocompromised doomed animals using a discrimination function.

To further understand the invention, a glossary of various terms is provided below. The invention is also described in reference to various publications, the disclosures of which are incorporated by reference herein for the sake of brevity. Unless defined herein or indicated otherwise by context, the technical or scientific terms used herein have the same meaning as they would to one of ordinary skill in the art.

The terms “comprising”, “including”, and “containing” are used in their open, non-limiting sense.

An “analyte” is a specific substance of interest present in a biological sample and being analyzed, e.g., by the methods of the present invention. In the case of analytes related to infection and sepsis, these may include, for example, the inflammatory mediators that appear in circulation as a result of the presence of microorganisms and their components, including gram positive cell wall constituents and gram negative endotoxin, lipopolysaccharide, lipoteichoic acid. These inflammatory mediators include tumor necrosis factor (TNF), interleukin-1 (IL-1) and other interleukins and cytokines. Analytes may also refer to biochemicals, e.g., proteins, nucleotides, peptides, or siRNA's produced by cells in response to inflammatory mediators. Other analytes may include drugs of abuse, hormones, toxins, therapeutic drugs, markers of cardiac muscle damage.

An “animal” refers to a human or non-human mammal, including laboratory animals such as rodents (e.g., mice, rats, hamsters, gerbils and guinea pigs); farm animals such as cattle, sheep, pigs, goats and horses; and domestic mammals such as dogs and cats, and; birds, including domestic, wild and game birds such as chickens, turkeys and other gallinaceous birds, ducks, geese, and the like. The term does not denote a particular age. Thus, both adult and newborn or immature individuals are intended to be covered.

“Bacteremia” is the presence of bacteria in the blood.

A “biological sample” is an aliquot of body fluid or tissue withdrawn from an animal, for example, a human. In one embodiment, the biological fluid is whole blood. Examples of other biological samples include cell-containing compositions such as red blood cell concentrates, platelet concentrates, leukocyte concentrates, plasma, serum, urine, bone marrow aspirates, cerebrospinal fluid, tissue, cells, and other body fluids, including lymph aspirate, bronco-alveolar lavage, ascitis and essudates obtained from an infection site, as well as tissues, including homogenized organs.

A “biomarker” is any physiological substance measurable in a biological sample that is informative of the state of the animal from which the sample was taken, for example, the state of its immune system. A biomarker is considered to be informative if a measurable aspect of the marker is associated with the state of the animal. For a particular molecule identified as a marker, the measurable aspect of the marker that is associated with the state of the animal may include, for example, the concentration, amount, expression, or level of expression of the particular molecule.

A “candidate drug” or “test drug” refers to any compound or molecular entity or substance whose efficacy can be evaluated using the test animals and methods of the present invention. Such compounds or drugs include, e.g., chemical compounds, pharmaceuticals, antibodies, polypeptides, peptides, including soluble receptors, polynucleotides, and polynucleotide analogs, DNA, RNA, siRNA, or mixtures or chimeric molecules comprising one or more of these compounds or drugs. Many organizations (e.g., the National Institutes of Health, pharmaceutical and chemical corporations) have large libraries of chemical or biological compounds from natural or synthetic processes, or fermentation broths or extracts. Such compounds can be employed in the practice of the present invention.

A “control animal” refers to an animal that has not been subject to a treatment (e.g., exposure to a test drug) which might affect the progress of bacterial sepsis in the animal.

A “control sample” is a biological sample used for comparison with a test biological sample. A control sample may be taken from either a healthy mammal/individual or from a mammal/individual known to be infected with a sepsis-causing pathogen at any particular stage of interest.

A “control amount” of an analyte is the amount of an analyte determined to be present in a control sample.

A “diseased animal” refers to an animal afflicted with sepsis, severe sepsis, or septic shock.

A “discrimination function” is a linear function of measured variables. The discrimination function can be used to compute a score for each individual based on the measured variable. For example, a score below a given threshold can be used to classify an individual as belonging to one group, and a score above that threshold can be used to classify an individual as belonging to another group.

A “doomed” individual is defined as an animal with sepsis that is observed to die, or is predicted (or has a prognosis) to die, as a result of the disease based on exhibition of symptoms correlated with death due to sepsis. Similarly, a “doomed immunocompromised” individual is one observed to die from sepsis or reach a state of predicted nonrecovery from the disease.

“Immunocompromised” is used to describe an animal that has an impaired immune response to infection relative to another animal for any reason, including, e.g., exposure to irradiation, treatment with cytostatic drugs or other treatments, genetic alteration, age, or disease status.

“Linear discriminant analysis” (or LDA) is a technique for data classification in which a score is computed for each test subject. The score is a linear function of the measured variables. Scores below a threshold are predicted to belong to one group, and scores above the threshold are predicted to belong to another group.

“Multiple organ dysfunction syndrome” (or MODS) is the presence of altered organ function in an acutely ill patient such that homeostasis cannot be maintained without intervention.

A “principle component analysis” (or PCA) is a statistical technique for data dimensionality reduction.

A “reference score” is used to describe a score corresponding to a particular stage of sepsis obtained by applying a discrimination function to measurements of a panel of biomarkers tested in each of a group of animals in a model system for sepsis syndrome. The score can be used as a reference, or comparison point, to stage sepsis in test animals.

A “score” is a number obtained by applying a discrimination function to values obtained by measuring the concentrations of a panel of biomarkers in an animal. The score is indicative of the disease state of the animal.

A “selected timepoint” is a point in time at which a biological sample is taken from a subject for analysis, for example, measurement of a panel of biomarkers and subsequent score calculation.

“Sepsis,” “severe sepsis,” and “septic shock” are stages of sepsis as described by, e.g., American College of Chest Physicians and the Society of Critical Care Medicine Consensus Definitions, published in 1992. “Sepsis Syndrome” is interchangeable with the term “severe sepsis.” The course by which a sepsis patient may progress either to death or hospital discharge is well known and has been described as a continuum from a state termed systemic inflammatory response syndrome (SIRS) to successive states of sepsis, severe sepsis, septic shock, multiple end-organ failure (MODS) and death (Rangel-Frausto, M S. JAMA 11:117-123 (1995)). In 1991 experts recruited by the American College of Chest Physicians and the Society of Critical Care Medicine met to reach a consensus on the diagnosis of sepsis and its sequelae. Their consensus definitions, published in 1992 (Bone R C et al., American College of Chest Physicians/Society of Critical Care Medicine Consensus Conference, Definitions for sepsis and organ failure and guidelines for the use of innovative therapies in sepsis, Chest 101:1644-1655) have provided a foundation for the common reporting and discussion of various interventions in patients with sepsis. According to the Consensus Definitions set forth in Levy, et al., Crit Care Med 2003; 31:1250-6, Systemic Inflammatory Response Syndrome (SIRS) is defined as a systemic response to inflammatory processes, regardless of its etiology. SIRS is the presence of two or more of the following clinical signs: (i) body temperature >38° C. or <36° C.; (ii) heart rate greater than 90 beats per minute; (iii) respiratory rate >20 breaths/minute and PaCO₂<32 mm Hg; (iv) white blood cell count >12,000/μl or <4,000/μl or >10% immature (band) forms. Sepsis is a clinical syndrome defined by the presence of both infection and a systemic inflammatory response. A list of possible signs of systemic inflammation in response to infection is listed in Table I of the Consensus report, “Diagnostic criteria for sepsis” as follows: infection, documented or suspected, and some of the following: general variables: fever (core temperature >38.3° C.), hypothermia (core temperature <36° C.), heart rate >90 min⁻¹ or >2 SD above the normal value for age, tachypnea, altered mental status, significant edema or positive fluid balance (>20 mL/kg over 24 hrs), hyperglycemia (plasma glucose >120 mg/dL or 7.7 mmol/L) in the absence of diabetes; inflammatory variables: leukocytosis (WBC count >12,000 μL⁻¹), leukopenia (WBC count <4000 μL⁻¹), normal white blood count (WBC) with >10% immature forms, plasma C-reactive protein >2 SD above the normal value, plasma procalcitonin >2 SD above the normal value; Hemodynamic variables: arterial hypotension (SBP <90 mm Hg, MAP <70, or an SBP decrease >40 mm Hg in adults or <2 SD below normal for age), SvO₂>70%, cardiac index >3.5 L·min⁻¹·M⁻²³; organ dysfunction variables: arterial hypoxemia (PA₀_{₂}/F₁₀_{₂}<300), acute oliguria (urine output <0.5 mL·kg⁻¹·hr⁻¹ or 45 mmol/L for at least 2 hrs), creatinine increase >0.5 mg/dL, coagulation abnormalities (INR >1.5 or aPTT >60 secs), ileus (absent bowel sounds), thrombocytopenia (platelet count <100,000 μL⁻¹), hyperbilirubinemia (plasma total bilirubin >4 mg/dL or 70 mmol/L); tissue perfusion variables: hyperlactatemia (>1 mmol/L), decreased capillary refill or mottling. In the report, the authors point out that frequently, infection is strongly suspected without being microbiologically confirmed, and therefore sepsis (infection and the systemic response to it) may only be strongly suspected, without being microbiologically confirmed. Severe sepsis is sepsis complicated by organ dysfunction, hypotension, or hypoperfusion. Hypoperfusion and perfusion abnormalities may include lactic acidosis, oliguria, or an acute alteration in mental status. Organ dysfunction can be defined using the definitions developed by Marshall et al. (Crit Care Med 1995; 23:1638-1652) or the definitions used for the Sequential Organ Failure Assessment (SOFA) score (Ferreira, et al., JAMA 2002; 286:1754-1758). Organ dysfunction in severe sepsis in the pediatric population has been defined by Wilkinson et al., Crit Care Med 1986; 14:271-274, Proulx et al., Chest 1996; 109:1033-1037, and Doughty et al. (Crit Care Med 1996; 109:1033-1037) or using definitions for the PEMOD and PELOD score (Leteutre, et al., Med Decis Making 1997). Septic shock refers to a state of acute circulatory failure characterized by persistent arterial hypotension unexplained by other causes. Septic shock in pediatric patients is a tachycardia (may be absent in the hypothermic patient) with signs of decreased perfusion, including decreased peripheral pulses compared with central pulses, altered alertness, flash capillary refill or capillary refill >2 secs, mottled or cool extremities, or a decreased urine output. Hypotension is a sign of late and decompensated shock in children.

“Significance level” is the probability of a false rejection of the null hypothesis in a statistical test.

“Staging” means determining a reference point reflecting disease status, progression, or disease outcome by measuring concentrations of disease biomarkers.

A “subject” is an individual on which experimentation is performed, such as a human or another animal, healthy or diseased.

“Survived” as used herein refers to an individual with sepsis that is observed to survive after a determined period of time following infection or to recover from infection. Similarly, a “survived immunocompromised” individual is an immunocompromised individual observed to survive or recover from sepsis.

A “test animal” is an animal with sepsis, sepsis syndrome or septic shock that is under evaluation using the methods of the invention.

A “T-test” is a statistical test done to assess whether the difference between the means of two groups is statistically significant.

One general aspect of the invention relates to an immunocompromised mouse model. The invention contemplates the use of any animal susceptible to sepsis syndrome in the model system. Establishing immunosuppression can be accomplished by various means, including, e.g., sublethal irradiation using a gamma irradiator with varying doses, e.g., 50-600 rads or even greater. Irradiation of animals to produce an immunosuppressed state has been described extensively in the art. Immunosuppression can also be achieved by treatment of the animal with cytostatic drugs, including antibodies against T-cell targets, and drugs used to ablate the bone marrow, as well as through the use of animals with defective immune systems due to genetic causes. In general, any treatment or condition that increases the relative susceptibility of a subject to infections is contemplated. For example, individuals that are very young, very old, or debilitated by another disease are immunocompromised or immunoincompetent and, compared to a healthy individual, those individuals are more susceptible to infection. Further, the model can include animals that are not known to be immunocompromised but are being tested for increased susceptibility to infection due, for example, to genetic defects that predispose them to infection and bacteremia. With regard to the study of human subjects, this invention contemplates testing samples taken from humans who have been rendered immunosuppressed by their disease condition, or by drug treatment administered to treat a disease such as cancer.

The animals of the model can be infected by various methods known and used in the art, including, e.g., use of the murine pouch bacterial load assay (Fuursted, et al., “Significance of Low-Level Resistance to Ciprofloxacin in Klebsiella Pneumoniae and the Effect of Increased Dosage of Ciprofloxacin In vivo Using the Rat Granuloma Pouch Model,” Journal of Antimicrobial Chemotherapy 50: 421-424, 2002) and with any of a multitude of pathogen species, including, e.g., a bacterium species selected from the group consisting of Enterococcus spp., Staphylococcus spp., Streptococcus spp., Enterobacteriacae family, Providencia spp., Pseudomonas spp. and others, including Gram negative, Gram positive bacteria, fungi and viruses. Various potential vehicles for inoculation, including mucin or phosphate-buffered saline, are known in the art and may be used as suitable. It is also known in the art that concentrations of bacteria in the inoculum can vary, e.g. 100,000 to 100,000,000 organisms depending on the experimental conditions. LPS or staphylococcal enterotoxin B (SEB) can be injected as a control. Zymosan, for example at a dose of 2.5 mg, can be injected to potentiate bacterial invasion.

It is understood that in practicing the methods according to the present invention, the animals can be monitored as needed, e.g., daily, until sepsis is established as determined by bacterial counts in the blood, white blood cell (wbc) counts, and blood levels of analytes associated with early stages of sepsis such as Tissue Necrosis Factor α, IL-1, IL-6, C reactive protein (CRP), as well as blood oxygen levels. All of these parameters are established as early markers of sepsis in humans. Fibrinogen and fibrinogen degradation products (FDP) are early indicators of Disseminated Intravascular Coagulation (DIC) and early indicators of severe sepsis. Further, the animals of the model can be treated with antibiotics following infection, in order to control bacteremia.

The number of animals included in a study can vary from one to many, as dictated by circumstances and the nature of the questions asked. Physical evaluation of the animals can include observation for diarrhea, lethargy, ruffled fur, lack of appetite and poor body condition. Survival can be evaluated based on a physical evaluation of the animal after a prescribed amount of time, e.g., an animal that remains healthy for one week (or another suitable interval) after the last animal in the study died or was euthanized can be considered survived. Analyte levels and other physiological parameters, including, e.g., blood cell counts, body temperature, and blood pressure, can also be measured to provide information regarding the health status of the animal. In general, the time elapsed between infection and progression of the doomed animals to the moribund state should allow for progression time and/or time to observe different stages of sepsis. The time interval should also allow for measuring differences between groups.

Using the animal model, potential treatments and targets for the systemic inflammatory response to infection can be evaluated. Potential treatments can be evaluated based upon their ability to increase survival rates. For example, the survival rate in immunocompromised, infected animals treated with an experimental drug can be compared with the survival rate in immunocompromised, infected animals not treated with the drug. A statistically significant increase in survival of the treated animals would be one indication that the treatment was effective for sepsis. A substantial increase, e.g. five, six, seven, eight, nine, ten, fifteen, twenty, twenty-five fold or more increase consistently observed from experiment to experiment, could also indicate effectiveness of a treatment. Potential targets can similarly be evaluated based on, for example, a change in survival rate when a model animal having a defective target pathway is used.

One use of the inventive modeling system is to identify panels of sepsis biomarkers that are predictive of disease outcome, including progression to septic shock vs. recovery, and survival vs. death. The panel of biomarkers can be selected by measuring the amounts of a larger number of analytes potentially associated with disease, and narrowing the number using the methods of the invention. The analytes can include any biological molecule suspected of being involved in sepsis, including markers of inflammation and molecules involved in the immune response, including cytokines; chemokines; coagulation factors, biomolecules known to be produced by cells in response to inflammation mediators, and others.

Biological samples can be taken from subjects at any time following infection, depending on the stage of disease under investigation. It is contemplated that timepoints can be taken periodically to follow the scores determined using one biomarker panel over the course of disease through a selected outcome. It is further contemplated that more than one biomarker panel could be identified and followed over the course of disease, as certain biomarker panels might be more predictive of certain outcomes. A panel predictive of one outcome, e.g., survival, might not be the best panel for predicting another outcome, e.g., progression to septic shock.

Determination of sample size depends on the individual situation. Methods for determining appropriate sample sizes are known in the art. In general, sample size can be selected depending on the variation of the data (e.g., how closely the data are clustered), the power required to detect the difference, the difference between the means of the two groups being compared, and significance level used.

Elsewhere in this specification, numerous molecular analytes that can be used in determining a biomarker panel according to the present invention are listed. Testing of these and other analytes in plasma may be performed on a commercial basis from Rules-Based Medicine, Inc. (Austin, Tex.). Concentrations of the analytes can also be measured by methods known in the art. Large numbers of analytes can be measured rapidly using a microchip containing an analyte panel. There is ample literature describing molecular pathways involved in sepsis, which provide guidance for the selection of additional analytes to test. In addition, new analytes may be identified through proteomic and genomic studies by using those techniques to compare proteins expressed or genes transcribed in individuals with sepsis and individuals that do not develop sepsis during a bacterial infection.

Selection of a biomarker panel can be accomplished by performing a statistical analysis of the analyte measurement data, to determine which analytes measured were present at significantly higher levels in the doomed animals than in the survived animals. A statistically significant increase in survival of the treated animals would be one indication that an analyte could serve as a biomarker useful for studying sepsis. Empirical observation could also indicate the usefulness of a given analyte as a biomarker for sepsis. For example, a substantial change in the level of the analyte, e.g., a change of five, six, seven, eight, nine, ten, fifteen, twenty, twenty-five fold or more, consistently observed from experiment to experiment, could indicate its use as a biomarker. Other factors observed by the researcher, e.g., the time course of increasing and decreasing concentrations of analytes, could also influence the decision to include an analyte in the biomarker panel.

Based on the statistical significance of the difference in analyte concentration between doomed and survived animals, a biomarker panel can be selected. For example, the data can be transformed to the log scale (natural base), and T-tests can be performed on the dataset for each analyte. Alternatively the data can be analyzed by other univariate statistical analyses, including using nonparametric Wilcoxon two-sample test for each analyte. Analytes are selected for use as biomarkers at the significance level of 0.05 or better.

A discrimination function using the analytes in the selected biomarker panel can be derived and used to calculate a score for each animal tested. The score is used to discriminate among animals with different disease outcomes, for example, animals that survive vs. animals that die. A discrimination function can be derived by first performing a principle component analysis on the biomarkers. This analysis reveals how much each of the principle components contributes to explaining the variation in the original data. Principle components can be selected to explain at least (95%) of the original data, potentially resulting in a reduction of the dimensionality of the data. Selecting a higher percentage, or a greater number of principle components, results in less information lost, but also less reduction in dimensionality. Determining the minimum percentage can therefore depend on how much information a researcher wishes to retain, and what level of reduction of the dimensionality of the dataset is desired.

In deriving the discrimination function, a linear discriminant analysis is performed on remaining principle components. This is done to provide the best linear combination of the principle components, in terms of maximizing the difference in scores observed between doomed and survived animals.

The number of biomarkers selected for a given panel can vary as preferred by the researcher. In one embodiment of this invention, the panel consists of fifteen or fewer biomarkers; however, use of more than fifteen biomarkers is contemplated depending on the results of the analyte measurements and the needs and preferences of the researcher. In another embodiment of the invention, the panel consists of ten or fewer biomarkers, and in other embodiments, the panel consists of five biomarkers or even as few as one biomarker.

The ability of the biomarkers to predict disease outcome can be evaluated using a visualization-based analytical tool, e.g., OmniViz Analysis® software, to observe patterns in data generated using the biomarker panel. The patterns may be visualized using a plot or galaxy map, in which the level of similarity of the data is represented by the proximity of the datapoints on the map. Patterns which indicate similarity in plot location among biomarker data derived from biological samples taken from animals in the same outcome group indicate that the biomarker panel used is predictive of disease outcome.

In another general aspect of the invention, a method is provided by which an identified biomarker panel is used to predict disease outcome in a test animal. The biomarker panel is measured in a biological sample taken from a test animal, and a score is calculated based on the discrimination function previously derived using the same biomarker panel. The scores may be plotted as described in the examples below, and a threshold value selected to maximize accuracy in predicting one outcome. For example, the threshold value can be set to predict death with 100% accuracy. As described in the examples, when such a threshold was set, this method was found to predict survival with 62.5-100% accuracy. The biomarker levels can also be evaluated empirically, based on substantial differences observed consistently from experiment to experiment.

Disease outcome can also be predicted using the methods of the invention through the use of information obtained by comparing in groups of animals observed to have different disease outcomes factors such as survival vs. death or the ratio of the level of each biomarker found in animals with one outcome to the level in animals with the other outcome. A consistently high or low ratio can be considered indicative of the outcome observed, and therefore a similar ratio observed in a test animal can be used to indicate the outcome in the test animal. Similarly, ratios observed in the model can be applied to the testing of treatments for sepsis. Treated animals that experience a positive outcome, e.g., survival, despite having biomarker ratios indicative of the corresponding negative outcome, e.g., death, prior to or around the time of treatment can be considered to have been treated with a drug candidate warranting further development. Distinctive biomarker ratios can also be indicative of infection stage, if consistently observed at a given timepoint following infection. These ratios, in combination with other information, for example, patient history, can be applied to the staging of sepsis in animals at unknown stages of infection. Diagnostic criteria including those proposed in Crit Care Med 2003, 4:1250-1256 2001, SCCM/ESICM/ACCP/ATS/SIS International Sepsis Definitions Conference can be combined with results obtained using methods according to the invention to help evaluate the staging of sepsis or monitor a patient. For example, biomarker levels or scores could be correlated with a patient's genotype information, as some individuals are likely genetically predisposed to be more or less sensitive to the effects of particular cytokines.

Potential outcomes predicted can include death, progression to various stages of sepsis, including sepsis syndrome and septic shock, and changes in physiological parameters, including white blood cell count, red blood cell count, platelet count, body temperature, body weight, and blood pressure. Other disease outcomes can include the observance of a particular level of an analyte, or death due to different causes. Still other outcomes are contemplated, including response to a drug or treatment, for example, failure to respond to a drug or treatment as expected.

In another general aspect, the invention is directed to methods for staging sepsis syndrome and evaluating potential treatments. Progression of sepsis and sepsis syndrome can be affected by many factors, including pathogen species, inoculum, mode of entry, preexisting disease, the health, age and genetic background of the individual, quality of care, and drugs being taken for other indications. The animal model of the invention can be used to evaluate the ability of potential sepsis treatments to influence disease outcome. Immunocompromised, infected animals treated with a potential sepsis drug or compound can be compared with control animals not given the treatment. The ability of the treatment to alter disease outcome is evaluated by comparing outcome in the two groups. For example, a statistically significant increase in survival rate of the treated animals relative to the control animals would indicate effectiveness of the treatment in preventing death.

Biomarker panels identified according to the invention can also be used in the evaluation of treatments for sepsis, sepsis syndrome and septic shock. A panel of biomarkers, and similar panels identified using the methods of the invention, can be used to predict disease outcome in individuals to be treated with a potential sepsis drug, compound or other treatment. The predicted outcome can then be compared with the outcome observed following administration of the treatment. The efficacy of the treatment can thus be evaluated by a change in the observed outcome of the individuals receiving the treatment in comparison to the outcome predicted for those individuals either prior to treatment or shortly thereafter.

A number of receptors, proteins, and the like implicated in mediating sepsis or sepsis syndrome have been considered and described in the literature (Cohen, J., “The Immunopathogenesis of Sepsis,” Nature 420:885-891, 2002; Netea, et al., “Proinflammatory Cytokines and Sepsis Syndrome: not enough, or too much of a good thing?” Trends in Immunology 24[5]:254-258, 2003). These as well as others that are described herein represent sepsis drug targets—i.e., biological targets that, through modulation of their activity with a drug, may be upregulated, downregulated, inhibited, agonized, antagonized, or the like for therapeutic treatment of the disease or symptoms or medical conditions associated with it.

For example, vascular endothelial growth factor (VEGF), which is expressed in a variety of cell types, including macrophages, is such a target. In macrophages, VEGF has been shown to be upregulated by the inflammatory mediator lipopolysaccharide (LPS) and by engagement of CD40 by CD40 ligand (CD40L). LPS and CD40L activate nuclear factor κB (NF-κB) in monocytes. VEGF production in human macrophages has been shown to be NF-κB-dependent. NF-κB regulates many of the genes involved in immune and inflammatory responses (Kiriakidis et al., Journal of Cell Science 116:665-74, 2003). Increased levels of VEGF may be found in doomed immunocompromised animals using methods according to the invention.

Monocytes have been considered the most important cells in orchestrating the innate immune response against bacteria. Recent studies have shown that mast cell deficient mice are less efficient in surviving experimentally induced infections, indicating that mast cells also play a fundamental role in the defense against bacterial infection.

Mast cells originate from hematopoietic bone marrow precursors, circulate in the peripheral blood as immature progenitors, and complete their differentiation in the mucosal and connective tissues in a microenvironment-characteristic manner. In vitro studies have shown that mast cells, upon contact with bacteria, release a variety of mediators, initiating a cascade of events leading to increased capillary permeability and the egress of antibodies, complement, and inflammatory cells into tissues. This event is likely initiated by the direct interaction of microbial components with pattern recognition receptors, such as toll-like receptors (TLRs) 2, 4, 6 and 8, and the FimH receptor CD48 for E. coli fimbriae.

Importantly, mast cells are the only cells that store preformed pro-inflammatory factors, e.g., tumor necrosis factor α (TNF-α) and IL-8. Since mast cells are distributed along the interface with the external environment at the portals of entry of many infectious agents, and given the immune functions associated with mast cells, we believe that mast cells are key players in preventing systemic spread of bacteria and possibly also in the development of septic shock. Therefore, compounds affecting the activity of the TLRs should be useful in treating sepsis syndrome. Furthermore, involvement of mutations in a TLR, TLR4, has been implicated in death by septic shock.

Other test compounds contemplated by the invention are those that increase vascular permeability, as death due to septic shock may be attributed to hypotension and poor tissue perfusion and oxygenation. Compounds that influence or increase oxygen delivery to the tissues are also contemplated for testing or sepsis modeling.

Numerous compounds are described in the literature as having activity against one or more of the biomarkers described herein, and therefore may be evaluated in a sepsis model according to the invention. Examples of such compounds against various targets include, e.g.: Published Patent Application No. US 2004/0209929 (PPAR agonists); Published Patent Application No. US 2004/0186166 (Peroxisome Proliferator Activated Nuclear Receptor Gamma (PPARγ) activators); Published Patent Application No. US 2004/0162354 (PPARγ agonists); U.S. Pat. No. 6,670,364 (MCP-1 antagonists); Published Patent Application No. US 2004/0186143 (modulators of chemokine receptor or MCP-1 activity); Published Patent Application No. US 2004/0198719 (MCP-1 antagonists); Published Patent Application No. US 2004/0151721 (CCR2 antibodies, etc.); Published Patent Application No. US 2004/0186140 (modulators of MCP-1 function); Published Patent Application No. US 2004/0198719 (MCP-1 antagonists); and Published Patent Application No. US 2004/0171551 (MCP-1 ligands). Additionally, antibodies against such targets may also be tested, such as anti-VEGF antibodies or anti-MCP-1 antibodies (see, e.g., U.S. Provisional Application No. 60/584,365, the disclosure of which is incorporated by reference herein).

The discovery of biomarkers could identify new drug targets for sepsis. One such target discovered using methodology in accordance with the invention is MCP-1. Thus, another general aspect of the invention relates to methods of treating sepsis comprising administering to a subject in need of such treatment an effective amount of compound that modulates MCP-1 activity. Illustrative compounds useful for treating sepsis include those exemplified above.

The term “treating” includes reversing, alleviating, lessening, or inhibiting the progress of sepsis or a stage thereof, or one or more symptoms of such disorder or condition. In therapeutic applications, a composition containing an MCP-1-modulating compound may be administered to a patient already suffering from sepsis in an amount sufficient for treatment, i.e., a therapeutically effective amount or dose. The selection of an amount effective for this use will depend on the severity and course of the proliferative disorder or condition, previous therapy, the patient's health status and response to the drugs, and the judgment of the treating physician. The amount and frequency of administration of the compounds used in the methods described herein and, if applicable, other agents will be selected within suitable ranges, which may be determined by standard techniques such as dose-escalation studies, according to the judgment of the attending clinician (physician) considering such factors as age, condition and size of the patient as well as severity of the disease. However, an illustrative effective dosage is in the range of about 0.001 to about 100 mg per kg body weight per day, or from about 1 to about 35 mg/kg/day, in single or divided doses. For a 70 kg human, this would amount to from about 0.05 to about 7 g/day, of from about 0.2 to about 2.5 g/day. In some instances, dosage levels below the lower limit of the aforesaid range may be more than adequate, while in other cases still larger doses may be employed without causing any harmful side effect, provided that such larger doses are first divided into several small doses for administration throughout the day.

The present invention contemplates the identification or evaluation of compounds for their efficacy in treating sepsis. To be an effective treatment, the administration of which results in a statistically significant change in the levels of one or more panel biomarkers measured at a given time following infection. A change in disease outcome might not be observed if only one or two of the biomarkers were affected; however, the invention also contemplates combining two or more treatments identified in this manner to influence disease outcome.

Other sepsis targets include chemokines, e.g. CXCL5/GCP-2 (chemokine [C-X-C motif] ligand 5; granulocyte chemotactic protein-2), CXCL10/IP-10 (CXCL10: chemokine [C-X-C motif] ligand 10; interferon-inducible cytokine IP-10), IL-8/KC/GROα (interleukin 8), MCP-1/CCL2 (chemokine [C-C motif] ligand 2; monocyte chemoattractant protein-1), MCP-3/CCL7 (chemokine [C-C motif] ligand 7; monocyte chemoattractant protein 3), MCP-5/CCL12 (chemokine [C-C motif] ligand 12), MIG/CXCL9 (chemokine [C-X-C motif] ligand 9; monokine induced by gamma interferon), MIP-1α/CCL3 (chemokine [C-C motif] ligand 3; macrophage inflammatory protein-1 alpha), MIP-1β/CCL4 (chemokine [C-C motif] ligand 4; macrophage inflammatory protein-1 beta), MIP-2/CXCL2 (chemokine [C-X-C motif] ligand 2), RANTES/CCL5 (chemokine [C-C motif] ligand 5); coagulation factors, e.g., Bdk (bradykinin), PAF (platelet activating factor), TF (tissue factor), TFPI (tissue factor pathway inhibitor), and vWF (von Willebrand factor); cytokines, e.g., GM-CSF/CSF2 (colony stimulating factor 2 [granulocyte-macrophage]), HMGB1 (high-mobility group box 1), IFNγ (interferon gamma), IL-10 (interleukin 10), IL-11 (interleukin 11), IL-12p70 (interleukin 12; p70 subunit), IL-17 (interleukin 17), IL-18 (interleukin 18 [interferon-gamma-inducing factor]), IL-1α (interleukin 1a), IL-3 (interleukin 3), IL-6 (interleukin 6), IL-7 (interleukin 7), LIF (leukemia inhibitory factor [cholinergic differentiation factor]), MIF (macrophage migration inhibitory factor), OSM (oncostatin M), and TNFα (tumor necrosis factor alpha); molecules involved in innate immunity, e.g., C5a (complement component 5), CRP (C reactive protein), iNOS (inducible nitric oxide synthase), MBL (mannose binding lectin), TREM1 (triggering receptor expressed on myeloid cells 1), and other molecules, including, SCF/KITLG (stem cell factor; KIT ligand), EDN1 (endothelin 1), PLA2 (phospholipase A2), HIF1A (Hypoxia inducible factor 1), TIMP-1 (tissue inhibitor of metalloproteinase 1 [erythroid potentiating activity, collagenase inhibitor]). The present invention is useful for evaluating test compounds or drugs for use in various stages of sepsis, e.g., sepsis syndrome and septic shock.

Reference scores determined using a biomarker panel identified using the methods of the invention can also be useful for staging disease, and can therefore be used to predict disease outcome and evaluate the effectiveness of a potential sepsis treatment. A reference score can be determined by general techniques known in the art based on scores calculated for individuals in a group of animals. The reference scores can be used to evaluate scores calculated using samples taken from test animals. For example, based on known reference scores for a particular disease outcome, an animal found to have a score indicative of that outcome can be predicted to experience that outcome. Reference scores can also be used to decide when a treatment should be administered to an animal. For example, a treatment determined to be effective when administered to animals having a certain reference score can be given to a test animal when its score is found to be within a reasonable range of the reference score.

Various exemplary embodiments of the invention are described below.

### EXAMPLES

### Example 1

### Infectious Immunocompromised Mouse Model

Initially, C3H/HeJ mice were compared with C3H/HeN normal mice in a pouch model for their ability to survive infection. Mice of strain C3H/HeJ are defective in the TLR4 receptor and do not undergo LPS-induced shock. The mice were anesthetized with isofluorane, shaved in the area caudal to the ears, and a pouch was created by subcutaneous injection of 2-3 ml of air followed by the subcutaneous injection of 0.2 ml of a 0.5% solution of croton oil in olive oil. Either four days (d4) or five days (d5) later, animals were checked for the presence of a pouch. The number of animals observed to have pouches at these times are shown in Table 1 below, under the columns “d4” and “d5.” Animals without pouches were discarded. E. coli bort was injected in the pouches as reported in the first column of Table 1.

All animals of the HeJ strain were euthanized due to terminal health conditions, starting at 18.5 h and lasting until 48 h post-injection. All the HeN mice survived.

TABLE 1

| Bacteria | Mouse | d4 | Bacterial | | d5 | Bacteria | |
|---|---|---|---|---|---|---|---|
| Strain | Strain | pouches | Dose | Euthanized | Pouches | Dose | Euthanized |
| E. coli Bort | HeJ | 2 | 1.2 × 10⁷ | 22 h, 40.5 | 2 | 1.2 × 10⁷ | 18.5 h, 18.5 h |
| | | 3 | 1.2 × 10⁶ | 22 h, 29 h | 2 | 1.2 × 10⁶ | 29 h, 29 h |
| | | 3 | 1.2 × 10⁵ | 22.5 h, 24 h, 29.5 | 1 | 1.2 × 10⁵ | 40.5 h |
| | HeN | 2 | 1.2 × 10⁷ | survived | 2 | 1.2 × 10⁷ | survived |
| | | 3 | 1.2 × 10⁶ | survived | 2 | 1.2 × 10⁶ | survived |
| | | 3 | 1.2 × 10⁵ | survived | 2 | 1.2 × 10⁵ | survived |

Next, survival of sublethally irradiated C3H/HeN was compared with that of C3H/HeJ. Five days after being injected with oil, 11 of the 22 HeN animals were given a 350 rad dose of irradiation. The same day, E. coli bort was injected in the pouches (7 of 14 HeJ; 6/11 irradiated HeN and 6/11 HeN) at the dose of 1×106. The following day, 20 to 24 h after bacterial injection, blood samples were taken to test for the presence of bacteria. There was no bacterial growth from the blood of non irradiated HeN. 5/7 HeJ and 2/6 XR (irradiated) HeN were bacteremic. All HeJ animals became terminally ill and had to be euthanized, and only one of the irradiated HeN animals was euthanized.

TABLE 2

| | | | | | Bacterial |
|---|---|---|---|---|---|
| Bacteria | Mouse | d5 | Bacteria | | Growth at |
| Strain | Strain | Pouches | Dose | Euthanized | 20-24 h |
| E. coli Bort | HeJ | 7 | NONE | NONE | ND |
| | | 7 | 1 × 10⁶ | ALL | 5/7 pos |
| | HeN | 5 | NONE | NONE | ND |
| | | 6 | 1 × 10⁶ | NONE | no growth |
| | HeN XR | 5 | NONE | NONE | ND |
| | 350 rads | 6 | 1 × 10⁶ | 1/6 | 2/6 pos |

As apparent from the data shown above, otherwise healthy animals from the C3H/HeN strain do not succumb to infection in the pouches with infection of up to 1.2×10⁷ bacteria. Animals that have a mutation in the TLR 4 receptor, C3H/HeJ, and therefore cannot interact with E. coli LPS, develop bacteremia and a final disease state requiring euthanasia with as few as 1.2×10⁵ bacteria. One out of six animals of the HeN strain that received an irradiation dose equivalent to 350 rads became susceptible to infection and required euthanasia.

In the next experiment, 37 C3H/HeN mice were pouched according to the procedure described above. One day later, 17 mice received 420 rads irradiation from a gamma irradiator. Five days after irradiation, 1.5×10⁶ bacteria (E. coli bort) in 0.1 ml PBS were injected into the subcutaneous pouches of 7 irradiated mice and 7 non-irradiated mice. The remaining mice were not injected with bacteria (see Table 3). After infection, animals were checked daily for signs of pain and distress, including diarrhea, lethargy, ruffled fur, lack of appetite and poor body condition. Animals were euthanized when very lethargic as defined as being unresponsive (lacking movement) when touched. Under these conditions the animals die within 6-12 hours. At 22 hours after infection, blood samples for analysis were taken from all 37 mice. By 6 days after infection, 3 of the irradiated, infected mice had to be euthanized based on clinical criteria for euthanization, and were euthanized using CO₂. All the other animals survived.

TABLE 3

| | | | E. coli | | | | Time of | | | |
|---|---|---|---|---|---|---|---|---|---|---|
| | | XR | Bort | | | Tag | blood | | | |
| | Pouch | 420 rads | 1.5 × 10⁶ | RBM | Comments | No. | collection | CFU/25 ul blood | WBC | PLT |
| Group 1 | no | no | no | | | 2254 | 22 hours | 0 | 4.7 | 926 |
| | no | no | no | yes | | 2255 | 22 hours | 0 | 5.8 | 1060 |
| | no | no | no | | | 2256 | 22 hours | 0 | 5.7 | 957 |
| | no | no | no | yes | | 2257 | 22 hours | 0 | 6.0 | 1010 |
| | no | no | no | | | 2258 | 22 hours | 0 | 4.8 | 897 |
| | | | | | Average | | | | 5.4 | 970 |
| Group 2 | yes | no | no | | | 2264 | 22 hours | 0 | 6.4 | 988 |
| | yes | no | no | | | 2265 | 22 hours | 0 | 6.6 | 954 |
| | yes | no | no | yes | | 2266 | 22 hours | 0 | 6.9 | 1068 |
| | yes | no | no | | | 2267 | 22 hours | 0 | 7.0 | 963 |
| | yes | no | no | yes | | 2268 | 22 hours | 0 | 5.6 | 1072 |
| | yes | no | no | | | 2274 | 22 hours | 0 | 6.7 | 898 |
| | yes | no | no | | | 2275 | 22 hours | 0 | 5.0 | 998 |
| | yes | no | no | | | 2276 | 22 hours | 0 | 5.9 | 986 |
| | | | | | Average | | | | 6.3 | 991 |
| Group 3 | yes | no | yes | yes | | 2277 | 22 hours | 4 | 4.3 | 323 |
| | yes | no | yes | yes | | 2278 | 22 hours | 1 | 4.0 | 396 |
| | yes | no | yes | yes | | 2279 | 22 hours | 0 | 4.9 | 467 |
| | yes | no | yes | yes | | 2280 | 22 hours | 0 | 4.9 | 526 |
| | yes | no | yes | yes | | 2281 | 22 hours | 0 | 5.2 | 561 |
| | yes | no | yes | yes | | 2282 | 22 hours | 0 | 5.2 | 698 |
| | yes | no | yes | yes | | 2283 | 22 hours | 0 | 6.0 | 732 |
| | | | | | Average | | | | 4.9 | 529 |
| Group 4 | no | yes | no | yes | | 2259 | 22 hours | 0 | 2.5 | 629 |
| | no | yes | no | | | 2260 | 22 hours | 0 | 2.8 | 481 |
| | no | yes | no | | | 2261 | 22 hours | 0 | 2.0 | 478 |
| | no | yes | no | | | 2262 | 22 hours | 0 | 2.1 | 465 |
| | no | yes | no | yes | | 2263 | 22 hours | 0 | 1.8 | 627 |
| | | | | | Average | | | | 2.2 | 536 |
| Group 5 | yes | yes | no | | | 2269 | 22 hours | 0 | 2.2 | 475 |
| | yes | yes | no | | | 2270 | 22 hours | 0 | 2.2 | 288 |
| | yes | yes | no | yes | | 2271 | 22 hours | 0 | 1.6 | 502 |
| | yes | yes | no | yes | | 2272 | 22 hours | 0 | 2.6 | 567 |
| | yes | yes | no | | | 2273 | 22 hours | 0 | 2.7 | 273 |
| | | | | | Average | | | | 2.3 | 421 |
| Group 6 | yes | yes | yes | yes | | 2284 | 22 hours | 19 | 2.0 | 102 |
| | yes | yes | yes | yes | | 2285 | 22 hours | 21 | 2.0 | 149 |
| | yes | yes | yes | yes | | 2286 | 22 hours | 100 | 2.7 | 197 |
| | yes | yes | yes | yes | Euthanized at 48 h | 2287 | 22 hours | 113 | 1.4 | 97 |
| | yes | yes | yes | yes | Found dead at | 2288 | 22 hours | 400 | 1.7 | 85 |
| | | | | | 28 h | | | | | |
| | yes | yes | yes | yes | | 2289 | 22 hours | 0 | 3.4 | 139 |
| | yes | yes | yes | yes | Euthanized at | 2290 | 22 hours | 79 | 1.7 | 133 |
| | | | | | 144 h | | | | | |
| | | | | | Average | | | | 2.1 | 128.9 |
| | yes | yes | yes | yes | | 2287 | Final | n/c | 3.0 | 111 |
| | yes | yes | yes | yes | | 2290 | Final | | 5.3 | 46 |

Blood samples were analyzed for bacterial counts, white blood cells (WBC), and platelets (PLT). Plasma was obtained from the blood samples and some samples were sent to Rules-Based Medicine, Inc. (RBM) for analyte measurement. Samples sent to RBM for analysis were: 2255, 2257, 2266, 2268, 2277, 2278, 2279, 2280, 2281, 2282, 2283, 2259, 2263, 2271, 2272, 2284, 2285, 2286, 2287, 2288, 2289, 2290, 2287 Final, and 2290 Final. The data obtained by RBM are shown in the table at Appendix A (Experiment c). In the table at Appendix A, which has columns A-Z, AA-AZ, and BA-BK and rows 1-188, the column letter is printed across the top of each page and the row number is printed on the left hand side of each page.

Other experiments were performed similarly. In one experiment, all the animals used were irradiated. In that experiment, pouches were created in C3H/HeN according to the same procedures as described above. One day later animals received 413 rads. Six days after the pouches were created, pouches were infected by injecting 1.7×10⁶ of E. coli bort in PBS. Twenty-two hours after infection, the animals were bled. Blood samples were analyzed for bacterial counts, WBC, and platelets. Plasma was obtained from the blood samples and some samples were sent to Rules Based Medicine for analyte measurement. Samples were sent to RBM at 3 different time points: March, June and September as indicated in Tables 4 and 5. The data obtained by RBM are shown in Appendix A (Experiment d).

TABLE 4
BLOOD SAMPLES COLECTED AT 22 H AFTER INFECTION

| Sample | | | | |
|---|---|---|---|---|
| sent to | Animal | | | |
| RBM | number | CFU/25 ul blood | WBC | PLT |
| June | 6505 | 2 | 3.3 | 442 |
| June | 6506 | 0 | 2.4 | 173 |
| March | 6507 | 0 | 2.8 | 200 |
| March | 6508 | 0 | 2.5 | 255 |
| June | 6509 | 72 | 2.1 | 331 |
| | 6510 | 0 | 3 | 124 |
| | 6511 | 0 | 2.7 | 266 |
| March | 6512 | 0 | 3.3 | 230 |
| | 6513 | 0 | 2 | 154 |
| March | 6514 | 34 | 2.4 | 165 |
| June | 6515 | 5 | 2.5 | 141 |
| June | 6516 | 2 | 2.1 | 326 |
| | 6517 | 0 | 2.9 | 298 |
| | 6518 | 0 | 1.6 | 244 |
| June | 6519 | 0 | 2.9 | 303 |
| June | 6520 | 0 | 1.6 | 299 |
| | 6521 | 3 | 2.2 | 303 |
| | 6522 | 0 | 3.8 | 226 |
| | 6523 | 0 | 2.2 | 187 |
| | 6524 | 0 | 1.8 | 137 |
| | 6525 | 0 | 3.2 | 448 |
| March | 6526 | 1 | 1.6 | 221 |
| | 6527 | 0 | 2.7 | 313 |
| June | 6528 | 0 | 2.5 | 192 |
| | 6529 | 0 | 3.7 | 161 |
| March | 6530 | 250 | 2.5 | 226 |
| | 6531 | 10 | 2.3 | 261 |
| March | 6532 | 2 | 5.6 | 494 |
| | 6533 | 2 | 3.1 | 135 |
| March | 6534 | 0 | 1.8 | 127 |
| March | 6535 | 105 | 1.5 | 138 |
| | 6536 | 1 | 1.6 | 222 |
| March | 6537 | 0 | 3.7 | 450 |

TABLE 5
BLOOD SAMPLES COLECTED AT EUTHANASIA

| Sample | Health | | Time of | |
|---|---|---|---|---|
| sent to | status at | Animal | blood | CFU/25 ul |
| RBM | euthanasia | number | collection h | blood |
| Sep | Healthy | 6505 | 144 | 0 |
| Sep | Healthy | 6506 | 144 | 0 |
| | Moribund | 6507 | 288 | ND |
| | Healthy | 6508 | ND | ND |
| June | Moribund | 6509 | 115 | TNTC |
| | Moribund | 6510 | 67 | ND |
| | Moribund | 6511 | 170 | ND |
| | Healthy | 6512 | ND | ND |
| | Moribund | 6513 | 170 | TNTC |
| | Moribund | 6514 | 67 | ND |
| March | Moribund | 6515 | 75 | TNTC |
| Sep | Healthy | 6516 | 144 | 0 |
| | Moribund | 6517 | 92 | ND |
| | Moribund | 6518 | 75 | TNTC |
| Sep | Healthy | 6519 | 144 | 4 |
| | Healthy | 6520 | 92 | ND |
| March | Moribund | 6521 | 92 | TNTC |
| | Moribund | 6522 | 115 | TNTC |
| | Moribund | 6523 | 115 | TNTC |
| | Moribund | 6524 | 92 | ND |
| | Moribund | 6525 | 170 | TNTC |
| | Moribund | 6526 | 46 | TNTC |
| | Moribund | 6527 | 118 | TNTC |
| June | Moribund | 6528 | 92 | TNTC |
| Sep | Healthy | 6529 | 144 | 2 |
| March | Moribund | 6530 | 27 | TNTC |
| March | Moribund | 6531 | 92 | TNTC |
| | Healthy | 6532 | ND | ND |
| | Moribund | 6533 | 187 | ND |
| June | Moribund | 6534 | 50 | TNTC |
| June | Moribund | 6535 | 46 | TNTC |
| | Moribund | 6536 | 67 | ND |
| | Healthy | 6537 | ND | ND |

Another experiment (see Table 6) was performed using 25 C3H/HeN animals. In this experiment, pouches were created according to the same procedures as described above. One day later 20 animals received about 385 rads gamma irradiation. Six days after the pouches were created, pouches were infected by injecting 1.8×10⁶ CFU of E. coli bort in PBS. Twenty-three hours after infection, the animals were bled and blood samples were analyzed for bacterial counts. Plasma was obtained from the blood samples and some samples were sent to Rules-Based Medicine for analysis. At the time of euthanasia, samples from moribund animals were collected and 2 pools were prepared. Pool 1 contained terminal (final) samples from animals 6615, 6622, 6624, 6626, and 6630. Pool 2 contained terminal samples from animals 6627, 6628, and 6631. Aliquots from each pool were submitted to RBM for analysis. The data obtained by RBM are shown in Appendix A (Experiment e).

TABLE 6

| Sample | | | CFU/25 ul | CFU/25 ul | | Health |
|---|---|---|---|---|---|---|
| sent to | | Animal | blood at | blood at | Time at | status at |
| RBM | XR 385rads | number | 23 hrs | Euthanasia | Euthanasia h | Euthanasia |
| | Non-XR Infected | 6609 | 0 | | | Healthy |
| | Non-XR Infected | 6610 | 42 | | | Healthy |
| | Non-XR Infected | 6611 | 1 | | | Healthy |
| | Non-XR Infected | 6612 | 0 | | | Healthy |
| | Non-XR Infected | 6613 | 0 | | | Healthy |
| yes | XR Infected | 6614 | 0 | | | Healthy |
| yes | XR Infected | 6615 | 1 | TNTC | 90 | Moribund |
| yes | XR Infected | 6616 | 0 | TNTC | 160 | Moribund |
| | XR Infected | 6617 | 0 | | | Healthy |
| yes | XR Infected | 6618 | 2 | | | Healthy |
| | XR Infected | 6619 | 0 | | | Healthy |
| | XR Infected | 6620 | 0 | | | Healthy |
| | XR Infected | 6621 | 0 | | | Healthy |
| yes | XR Infected | 6622 | 0 | TNTC | 96 | Moribund |
| | XR Infected | 6623 | 0 | | 96 | Moribund |
| | XR Infected | 6624 | 0 | TNTC | 90 | Moribund |
| yes | XR Infected | 6625 | 0 | | | Healthy |
| | XR Infected | 6626 | 0 | TNTC | 96 | Moribund |
| yes | XR Infected | 6627 | 25 | TNTC | 115 | Moribund |
| | XR Infected | 6628 | 0 | TNTC | 115 | Moribund |
| | XR Infected | 6629 | 2 | | | Healthy |
| | XR Infected | 6630 | 0 | TNTC | 96 | Moribund |
| | XR Infected | 6631 | 0 | TNTC | 115 | Moribund |
| | XR Infected | 6632 | 0 | | | Healthy |
| yes | XR Infected | 6633 | 0 | | | Healthy |

TNTC = Too numerous to count

XR=Irradiation
RBM=Rules-Based Medicine

In an additional experiment, 48 animals were pouched (see data in Table 7). The following day, 44 mice received an irradiation dose of 413 rads each and 4 mice were not irradiated. Six days after the pouches were created, 44 mice had good pouches. Thirty-five XR mice were injected with 1.5×10⁶ CFU E. coli bort. Four non-XR mice were injected, and nine XR mice were not injected. The data obtained by RBM for the animals in this experiment are shown in Appendix A (Experiment f).

TABLE 7

| | Sent to RBM | | | CFU/25 ul | Time at | CFU/25 ul | Health |
|---|---|---|---|---|---|---|---|
| Sent to RBM | Euthanasia | | Animal | Blood at | Euthanasia | Blood at | Status at |
| 22 hr Sample | Sample | Treatment | Number | 22 h | (hr) | 22 h | Euthanasia |
| | | Non-XR, Infected | 7315 | 48 | | | Healthy |
| | | Non-XR, Infected | 7316 | 0 | | | Healthy |
| | | Non-XR, Infected | 7317 | 2 | | | Healthy |
| | | Non-XR, Infected | 7318 | 0 | 144 | | Moribund |
| yes | yes | XR, Infected | 7319 | 1 | 68 | TNTC | Moribund |
| yes | yes | XR, Infected | 7320 | 0 | 92 | TNTC | Moribund |
| | | XR, Infected | 7321 | 3 | 92 | TNTC | Moribund |
| yes | yes | XR, Infected | 7322 | 0 | 98 | TNTC | Moribund |
| yes | | XR, Infected | 7323 | 0 | | | Healthy |
| | | XR, Infected | 7324 | 0 | 172 | | Moribund |
| | | XR, Infected | 7325 | 3 | 172 | TNTC | Moribund |
| | | XR, Infected | 7326 | | | | Healthy |
| yes | | XR, Infected | 7327 | 84 | | | Healthy |
| | | XR, Infected | 7328 | 86 | 126 | | Moribund |
| yes | | XR, Infected | 7329 | 1 | | | Healthy |
| yes | yes | XR, Infected | 7330 | 1 | 98 | TNTC | Moribund |
| | | XR, Infected | 7331 | 3 | 76 | TNTC | Moribund |
| yes | | XR, Infected | 7332 | 2 | | | Healthy |
| yes | | XR, Infected | 7333 | 1 | | | Healthy |
| yes | yes | XR, Infected | 7334 | 0 | 68 | TNTC | Moribund |
| | | XR, Infected | 7335 | 2 | 126 | | Moribund |
| | | XR, Infected | 7336 | 0 | | | Healthy |
| yes | | XR, Infected | 7337 | 0 | | | Healthy |
| | | XR, Infected | 7338 | 130 | 68 | | Moribund |
| | | XR, Infected | 7339 | | | | Healthy |
| | | XR, Infected | 7340 | 70 | 212 | | Moribund |
| yes | yes | XR, Infected | 7341 | 0 | 98 | TNTC | Moribund |
| | | XR, Infected | 7342 | 0 | 126 | TNTC | Moribund |
| | | XR, Infected | 7343 | 0 | 146 | TNTC | Moribund |
| | | XR, Infected | 7344 | 13 | 98 | TNTC | Moribund |
| yes | yes | XR, Infected | 7345 | 1 | 76 | TNTC | Moribund |
| yes | | XR, Infected | 7346 | 0 | | | Healthy |
| | | XR, Infected | 7347 | 0 | 212 | | Moribund |
| yes | | XR, Infected | 7348 | 0 | | | Healthy |
| | | XR, Infected | 7349 | 0 | 144 | TNTC | Moribund |
| yes | yes | XR, Infected | 7350 | 0 | 76 | TNTC | Moribund |
| | | XR, Infected | 7351 | 0 | 212 | | Moribund |
| | | XR, Infected | 7352 | 9 | 126 | | Moribund |
| | | XR, Infected | 7353 | 7 | 68 | | Moribund |
| yes | | XR, Non-Infected | 7354 | 0 | | | Healthy |
| yes | | XR, Non-Infected | 7355 | 0 | | | Healthy |
| | | XR, Non-Infected | 7356 | 0 | | | Healthy |
| yes | | XR, Non-Infected | 7357 | 0 | | | Healthy |
| yes | | XR, Non-Infected | 7358 | 0 | | | Healthy |
| yes | | XR, Non-Infected | 7359 | 0 | | | Healthy |
| yes | | XR, Non-Infected | 7360 | 0 | | | Healthy |
| yes | | XR, Non-Infected | 7361 | 0 | | | Healthy |
| yes | | XR, Non-Infected | 7362 | 0 | | | Healthy |

The resulting data indicate that the survival rate for animals that were not irradiated, but were infected (with from 1.5-1.8×10⁶ CFU/mouse) was 94% ( 15/16). The survival rate for animals that were irradiated, (from 385 to 424 rads) but were not infected was 100%. The survival rate at Day 8 for animals that were infected and also irradiated (infection with 1.5-1.8×10⁶ CFU/mouse and irradiation from 385 to 424 rads) varied from 30 to 57%. The moribund animals that were euthanized and tested for the presence of bacteria in their blood were all found to have had bacteremia at the time of euthanasia.

### Example 2

### Identification of a Biomarker Panel in an Immunocompromised Mouse Model at 22 Hours Post-Infection

In an experiment using mice immunocompromised as described above, 22 mice were tested. Of these animals, 8 were doomed and 8 survived. As described in the survival study in Example 1, blood samples were taken from mice at 22 hours after infection. These samples were analyzed and used to derive a model to predict the outcome, i.e., survived or doomed, for animals that were both irradiated and infected with bacteria.

The 59 analytes measured in the samples were Apolipoprotein A1, β2 Microglobulin, C Reactive Protein, D-dimer, EGF, Endothelin-1, Eotaxin, Factor VII, FGF-9, FGF-Basic, Fibrinogen, GCP-2, LIX, GM-CSF, Growth Hormone, GST, Haptoglobin, IFN-α, IgA, IL-10, IL-11, IL-12p70, IL-17, IL-18, IL-1α, IL-1β, IL-2, IL-3, IL-4, IL-5, IL-6, IL-7, Insulin, IP-10, KC-GRO, Leptin, LIF, Lymphotactin, MCP-1-JE, MCP-3, MCP-5, M-CSF, MDC, MIP-1α, MIP-1β, MIP-1α, MIP-2, MIP-3β, Myoglobin, OSM, RANTES, SCF, SGOT, TIMP-1, Tissue Factor, TNF-α, TPO, VCAM-1, VEGF, and VWF. These analytes were found to be predictive of death versus survival in the mouse model.

Identification of a panel of six biomarkers predictive of survival vs. death was accomplished as described below. First, the data were transformed to the log scale (natural base). T-tests were performed on the dataset, for each analyte, to determine which analytes were present at statistically-significantly different concentrations between doomed animals and survived animals at the 22-hour timepoint. A total of 13 analytes were selectable at the significance level 0.05, and 6 analytes were selectable at the significance level 0.02.

Next, the performance, in terms of discriminating between survived and doomed animals, of the 13 analytes and the 6 analytes was checked by principle component analysis. Both subsets of analytes showed similar performance, so the 6 analytes were chosen as the final discrimination marker. They were: MCP-1-JE, IL-6, MCP-3, IL-3, MIP-1β, and KC-GRO. The raw data obtained using the 6 analytes are shown in Table I.

Then, a discrimination function using the 6 analytes was derived using a two-step technique. First, a principle component analysis performed on the 6 analytes showed that only the first 2 principle components (each a linear combination of the original 6 analytes) were needed to explain more than 96% variation in the original data. Therefore, the dimensionality of the data was reduced from 6 to 2. Linear discriminant analysis (LDA) was then performed on the 2 principle components, giving the best linear combination of the 2 principle components in terms of maximizing the difference between doomed and survived animals.

The end product of the above analysis was a linear combination of the original 6 analytes, which was used to assign a score for each animal. Score=19(MCP-1-JE)+27(IL-6)+18(MCP-3)+21(IL-3)+18(MIP-1β)+25(KC-GRO).

A threshold was set which gave a 100% correct prediction of doomed animals, resulting in an 87.5% correct prediction of survived animals.

### Example 3

### Use of Biomarker Panel Identified in Immunocompromised Mouse Model to Predict Disease Outcome-I

The discrimination function derived as described in Example 2 was applied to a set of mice. The discrimination model correctly predicted 100% doomed and 100% survived animals.

### Example 4

### Use of Biomarker Panel Identified in Immunocompromised Mouse Model to Predict Disease Outcome-II

The discrimination function derived as described in Example 2 was further applied to another set of mice. In this case, the discrimination model correctly predicted 100% doomed and 62.5% survived animals.

### Example 5

### Identification of a Biomarker Panel at Selected Timepoints Post-Infection

The results described in Examples 1-4 showed that in this mouse model, the level of analytes measured in plasma collected at 22 hours post-infection was predictive of death vs. survival. To expand on these findings and determine whether the set of analytes identified at 22-hours post infection would be predictive of death risk when analyte levels were measured at different timepoints after onset of infection, a time-course experiment was performed, sampling blood at 4, 10, 24, 48, and 96 hours post infection. Because a single animal should not be bled five times, an experiment was designed in which many animals were used and bled only once. To ensure an even distribution of samples in the two groups, survivor vs. doomed, conditions were selected that resulted in >90% survival or >90% death. For the survivor group, infected, non-irradiated mice were used. The experiments described above (see Table 3) showed that irradiated and infected animals that survived had an analyte profile similar to animals that were infected and non-irradiated. For the doomed group, higher doses of irradiation and infection were used, which had previously shown to be lethal to more than 90% of animals.

A total of 156 C3H/HeN mice were used in this experiment. Animals were divided into six treatment groups as shown in Table 8. Group 1: non-pouched, non-irradiated, non-infected (15); Group 2: pouched, non-irradiated, non-infected (14); Group 3: pouched, non-irradiated, infected (36); Group 4: non-pouched, irradiated, non-infected (12); Group 5: pouched, irradiated, non-infected (14); Group 6: pouched, irradiated, infected (65).

TABLE 8

| | Group # | | | | | |
|---|---|---|---|---|---|---|
| | 1 | 2 | 3 | 4 | 5 | 6 |
| | | Treatment | | | | |
| | | | Pouch and | | | XR-Pouch and |
| | | Pouch | Infection | XR | XR-Pouch | Infection |
| number of | 15 | 14 | 36 | 12 | 15 | 65 |
| mice | | | | | | |

Mice were pouched and irradiated (450 rads) 24 hours later. Five days after irradiation, mice were infected with a 100-μl bacterial suspension containing 2.2×10⁶ CFU of E. coli Bort/mouse. As shown in Table 9, mice were sacrificed and bled at the selected times. Before each timepoint, animals that were deemed too sick to survive until the next time point were euthanized. These samples were labeled “d” or “F,” where F indicates animals appearing to be sicker than d animals. After removing these sick animals, four to seven animals from the infected and four to seven from the infected and irradiated groups were euthanized. Control animals (non-infected) were euthanized at 0, 48, and 96 hours post infection. Sample collection was terminated at 96 hours after infection. Blood samples were divided into aliquots. One aliquot of 20 μl was used for bacterial counts. A second aliquot of 100 μl was concentrated by centrifugation and plasma was collected, divided into two aliquots, and stored frozen.

TABLE 9

| | NO-XR | | | | | | XR-450 | | | | | |
|---|---|---|---|---|---|---|---|---|---|---|---|---|
| | Group | | | | | | | | | | | |
| | 1 | | 2 | | 3 | | 4 | | 5 | | 6 | |
| | Treatment | | | | | | | | | | | |
| | | | | | Pouch | | | | | | Pouch | |
| | no Pouch | | Pouch | | and Infection | | no Pouch | | Pouch | | and Infection | |
| Hours after | #of | | # of | | # of | | # of | | # of | | # of | |
| Infection | mice | an. # | mice | an. # | mice | an. # | mice | an. # | mice | an. # | mice | an. # |
| 0 | 5 | 1-5 | 4 | 10-13 | | | 4 | 6-9 | 4 | 14-17 | | |
| 4 | | | | | 6 | 18-23 | | | | | 7 | 24-30 |
| 10 | | | | | 6 | 37-42 | | | | | 6 | 31-36 |
| 24 | | | | | 5 | 43-47 | | | | | 6 | 48-53 |
| 48 | 5 | 64-68 | 5 | 69-73 | 5 | 54-58 | 4 | 79-82 | 5 | 74-78 | 5 | 59-63 |
| | | | | | | 3d | | | | | | 1d, 2d, 4d |
| | | | | | | | | | | | | 1-5F |
| 72 | | | | | 4 | 84-87 | | | | | 5 | 88-92 |
| | | | | | | | | | | | | 5-7d, 6-8F |
| 96 | 5 | 119-123 | 5 | 105-109 | 5 | 93-97 | 4 | 115-118 | 5 | 110-114 | 7 | 98-104 |
| | | | | | | | | | | | | 9-12F |

Selected plasma samples (Table 10) were sent to RBM for analyte determination. The rest of the blood, 300-500 μl was added to 4.5 ml of RNA Wiz for RNA isolation and stored at −80° C.

TABLE 10

| Euthanized | | | Bacterial |
|---|---|---|---|
| Hours post | | | counts |
| infection | XR | An # | CFU/ml |
| 0 | − | 1 | 0.0E+00 |
| 0 | − | 2 | 0.0E+00 |
| 0 | − | 3 | 0.0E+00 |
| 0 | − | 4 | 0.0E+00 |
| 0 | + | 6 | 0.0E+00 |
| 0 | + | 7 | 0.0E+00 |
| 0 | + | 8 | 0.0E+00 |
| 0 | + | 9 | 0.0E+00 |
| 0 | − | 10 | 0.0E+00 |
| 0 | − | 11 | 0.0E+00 |
| 0 | − | 12 | 0.0E+00 |
| 0 | − | 13 | 0.0E+00 |
| 0 | + | 14 | 0.0E+00 |
| 0 | + | 15 | 0.0E+00 |
| 0 | + | 16 | 0.0E+00 |
| 0 | + | 17 | 0.0E+00 |
| 4 | − | 18 | 0.0E+00 |
| 4 | − | 19 | 0.0E+00 |
| 4 | − | 20 | 0.0E+00 |
| 4 | − | 21 | 0.0E+00 |
| 4 | − | 22 | 0.0E+00 |
| 4 | − | 23 | 0.0E+00 |
| 4 | + | 26 | 0.0E+00 |
| 4 | + | 27 | 0.0E+00 |
| 4 | + | 28 | 0.0E+00 |
| 4 | + | 29 | 0.0E+00 |
| 4 | + | 30 | 0.0E+00 |
| 10 | + | 31 | 0.0E+00 |
| 10 | + | 32 | 0.0E+00 |
| 10 | + | 33 | 0.0E+00 |
| 10 | + | 34 | 0.0E+00 |
| 10 | + | 36 | 2.8E+02 |
| 10 | − | 37 | 0.0E+00 |
| 10 | − | 39 | 0.0E+00 |
| 10 | − | 40 | 0.0E+00 |
| 10 | − | 41 | 0.0E+00 |
| 10 | − | 42 | 0.0E+00 |
| 24 | − | 43 | 4.0E+04 |
| 24 | − | 44 | 0.0E+00 |
| 24 | − | 45 | 0.0E+00 |
| 24 | − | 46 | 0.0E+00 |
| 24 | − | 47 | 0.0E+00 |
| 24 | + | 48 | 0.0E+00 |
| 24 | + | 49 | 0.0E+00 |
| 24 | + | 50 | 0.0E+00 |
| 24 | + | 51 | 0.0E+00 |
| 24 | + | 52 | 0.0E+00 |
| 24 | + | 53 | TNTC* |
| 48 | − | 54 | 5.6E+02 |
| 48 | − | 55 | 4.0E+04 |
| 48 | − | 56 | 8.0E+02 |
| 48 | − | 57 | 5.0E+03 |
| 48 | − | 58 | 2.4E+02 |
| 48 | + | 59 | 8.0E+03 |
| 48 | + | 60 | 4.0E+01 |
| 48 | + | 61 | 1.2E+02 |
| 48 | + | 62 | 4.0E+01 |
| 48 | + | 63 | 4.0E+01 |
| 72 | − | 84 | 0.0E+00 |
| 72 | − | 85 | 0.0E+00 |
| 72 | − | 86 | 0.0E+00 |
| 72 | − | 87 | 0.0E+00 |
| 72 | + | 88 | 0.0E+00 |
| 72 | + | 89 | 0.0E+00 |
| 72 | + | 90 | 6.0E+08 |
| 72 | + | 91 | 2.0E+04 |
| 72 | + | 92 | 0.0E+00 |
| 96 | − | 93 | 0.0E+00 |
| 96 | − | 94 | 0.0E+00 |
| 96 | − | 95 | 0.0E+00 |
| 96 | − | 96 | 0.0E+00 |
| 96 | − | 97 | 0.0E+00 |
| 96 | + | 98 | 2.0E+08 |
| 96 | + | 99 | 2.0E+03 |
| 96 | + | 100-101 | 0.0E+00 |
| 96 | + | 102 | 0.0E+00 |
| 96 | + | 103 | 1.3E+08 |
| 96 | + | 104 | 2.0E+06 |
| 48 | + | 1d | 2.6E+09 |
| 48 | + | 2d | 2.2E+09 |
| 48 | − | 3d | TNTC* |
| 72 | + | 5d | 1.2E+09 |
| 48 | + | 1F | 7.0E+07 |
| 48 | + | 2F | 5.0E+08 |
| 48 | + | 3F | 3.0E+06 |
| 48 | + | 4F | 8.0E+08 |
| 48 | + | 5F | 1.0E+08 |
| 72 | + | 6F | 8.0E+08 |
| 72 | + | 7F | 6.0E+08 |
| 72 | + | 8F | 6.0E+08 |
| 96 | + | 9F | 5.0E+08 |
| 96 | + | 10F | 1.2E+09 |
| 96 | + | 11F | 2.2E+09 |

*TNTC = too numerous to count

Appendix D shows the level of analytes for plasma samples obtained at different time points after infection. These data were analyzed using different statistical approaches, described below.

The statistical analyses and figures, unless indicated otherwise, were produced using the statistical software available from the R Project For Statistical Computing at http://www.r-protect.org, Ihaka et al., 1996, Journal of Computational and Graphical Statistics and Insightful S-plus® software (http://www.insightful.com/products/splus/default.asp).

A two-way analysis of variance (ANOVA) model was used to fit data for each analyte considering time and treatment group as two factors. The simplest ANOVA model is one-way ANOVA, which may be employed if it is desirable to determine if all the means from multiple different groups are equal (i.e., one factor with multiple levels). When only two groups (i.e., one factor with 2 levels), the ANOVA approach reduces to a simple t-test approach.

This approach may be extended to multifactor analysis. In the present analysis, two factors were considered: time, which has 7 levels (i.e., 7 timepoints), and treatment group, which has 2 levels (i.e., animal groups). In a two-way ANOVA analysis, the effects of two factors are tested separately (their main effects) and (sometimes) together (their interaction effect). If the interaction effect between time and treatment group for a particular analyte is significant (if the interaction p value <0.05), this is interpreted to indicate that the time-profiles of this analyte are significantly different between the two treatment groups. The p values corresponding to the main effects and interaction effect from the ANOVA analysis are listed in the Table 11 below. Analyte measurements of zero were replaced by 0.001; all measurement values were log based 2 transformed before fitting the model.

TABLE 11

| | time | group | |
|---|---|---|---|
| | Main effect | Main effect | time * group |
| Analytes | p value | p value | Interaction p value |
| KC . . . GROalpha | 0.000 | 0.000 | 0.000 |
| IL.6 | 0.000 | 0.001 | 0.000 |
| TIMP.1 | 0.000 | 0.604 | 0.000 |
| IL.3 | 0.000 | 0.003 | 0.001 |
| IL.5 | 0.001 | 0.011 | 0.001 |
| Fibrinogen | 0.000 | 0.046 | 0.001 |
| M.CSF | 0.052 | 0.004 | 0.005 |
| VCAM.1 | 0.000 | 0.000 | 0.005 |
| TPO | 0.014 | 0.377 | 0.006 |
| IL.1alpha | 0.015 | 0.056 | 0.006 |
| GCP.2 . . . LIX | 0.011 | 0.546 | 0.007 |
| IL.10 | 0.378 | 0.004 | 0.014 |
| MIP.2 | 0.000 | 0.003 | 0.015 |
| IL.1beta | 0.138 | 0.907 | 0.016 |
| TF | 0.011 | 0.049 | 0.017 |
| MCP.3 | 0.000 | 0.000 | 0.019 |
| VEGF | 0.008 | 0.023 | 0.024 |
| RANTES | 0.000 | 0.003 | 0.027 |
| IL.18 | 0.000 | 0.430 | 0.027 |
| OSM | 0.032 | 0.000 | 0.031 |
| MIP.1.alpha | 0.161 | 0.152 | 0.035 |
| Haptoglobin | 0.000 | 0.092 | 0.036 |
| IL.11 | 0.004 | 0.022 | 0.046 |
| MIP.1.beta | 0.000 | 0.011 | 0.055 |
| MCP.1 . . . JE | 0.000 | 0.000 | 0.069 |
| MIP.1gamma | 0.000 | 0.641 | 0.078 |
| FGF.9 | 0.002 | 0.002 | 0.085 |
| MCP.5 | 0.000 | 0.000 | 0.090 |
| Leptin | 0.154 | 0.000 | 0.111 |
| IgA | 0.015 | 0.006 | 0.136 |
| vWF | 0.001 | 0.452 | 0.146 |
| MDC | 0.000 | 0.000 | 0.183 |
| IL.12p70 | 0.110 | 0.519 | 0.215 |
| IP.10 | 0.000 | 0.013 | 0.220 |
| IFN.g | 0.000 | 0.040 | 0.229 |
| Apolipoprotein.A1 | 0.000 | 0.863 | 0.243 |
| Endothelin.1 | 0.018 | 0.068 | 0.275 |
| IL.4 | 0.075 | 0.018 | 0.291 |
| Factor.VII | 0.011 | 0.062 | 0.322 |
| IL.17 | 0.013 | 0.119 | 0.379 |
| SCF | 0.116 | 0.010 | 0.401 |
| LIF | 0.564 | 0.013 | 0.437 |
| IL.7 | 0.215 | 0.662 | 0.438 |
| GM.CSF | 0.629 | 0.203 | 0.463 |
| FGF.basic | 0.001 | 0.008 | 0.474 |
| C.Reactive.Protein | 0.045 | 0.905 | 0.484 |
| IL.2 | 0.190 | 0.395 | 0.506 |
| Lymphotactin | 0.150 | 0.026 | 0.530 |
| GST | 0.163 | 0.853 | 0.532 |
| SGOT | 0.110 | 0.516 | 0.540 |
| MIP.3beta | 0.512 | 0.119 | 0.540 |
| Growth.Hormone | 0.332 | 0.066 | 0.622 |
| EGF | 0.046 | 0.056 | 0.743 |
| TNF.alpha | 0.020 | 0.002 | 0.760 |
| Myoglobin | 0.016 | 0.706 | 0.828 |
| Insulin | 0.004 | 0.000 | 0.917 |
| Eotaxin | 0.181 | 0.001 | 0.941 |

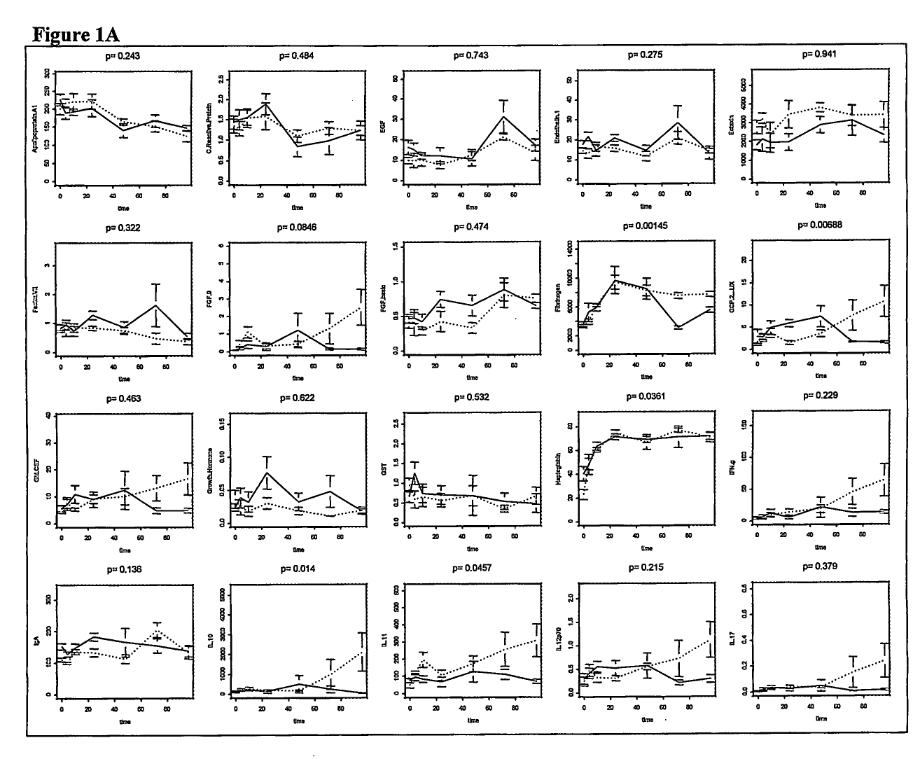

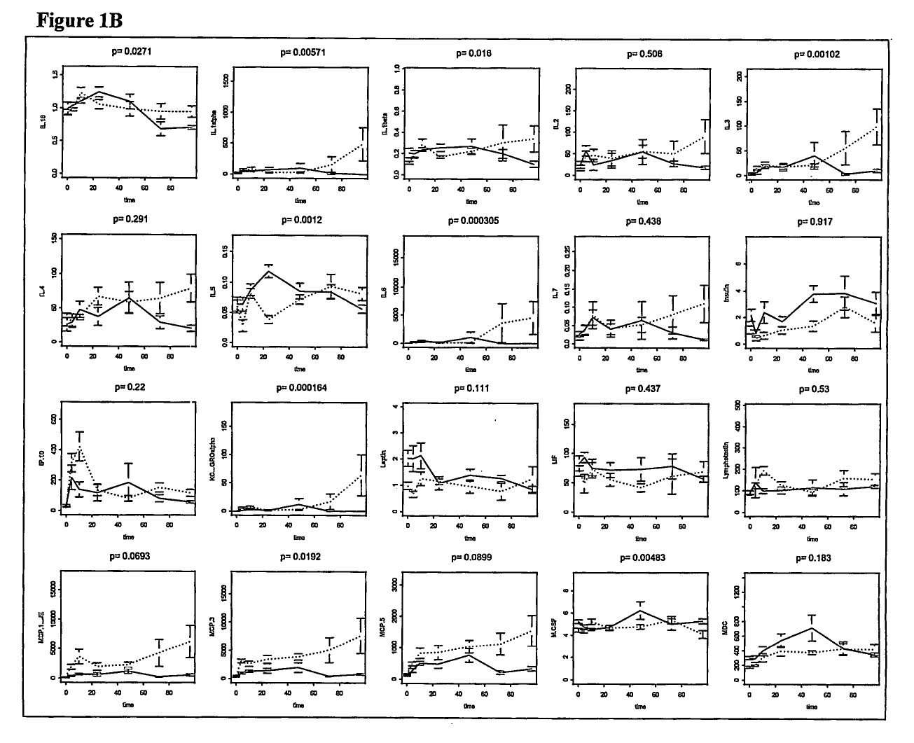

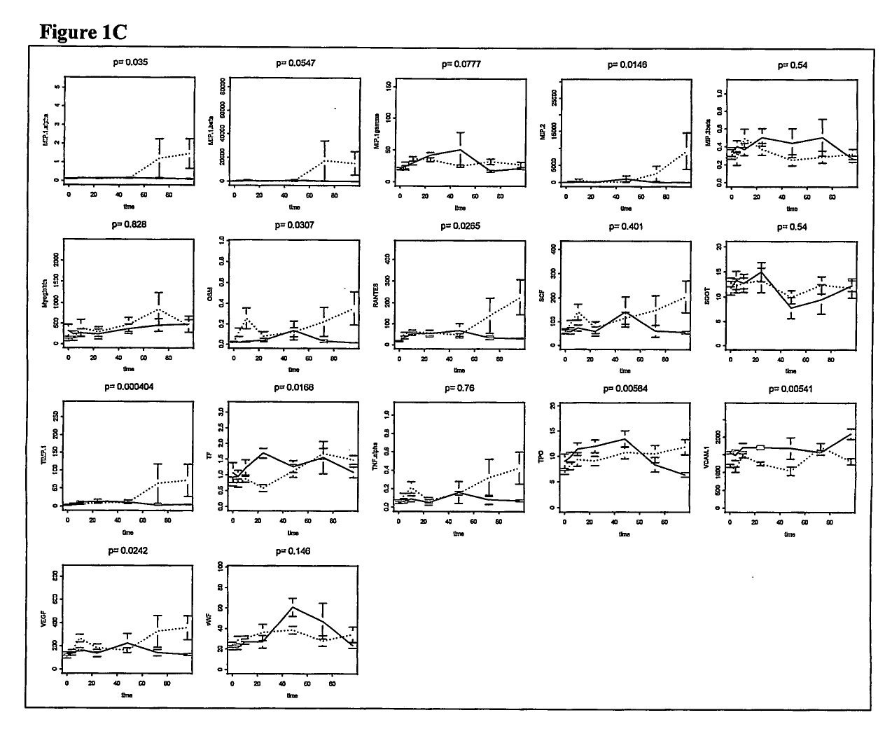

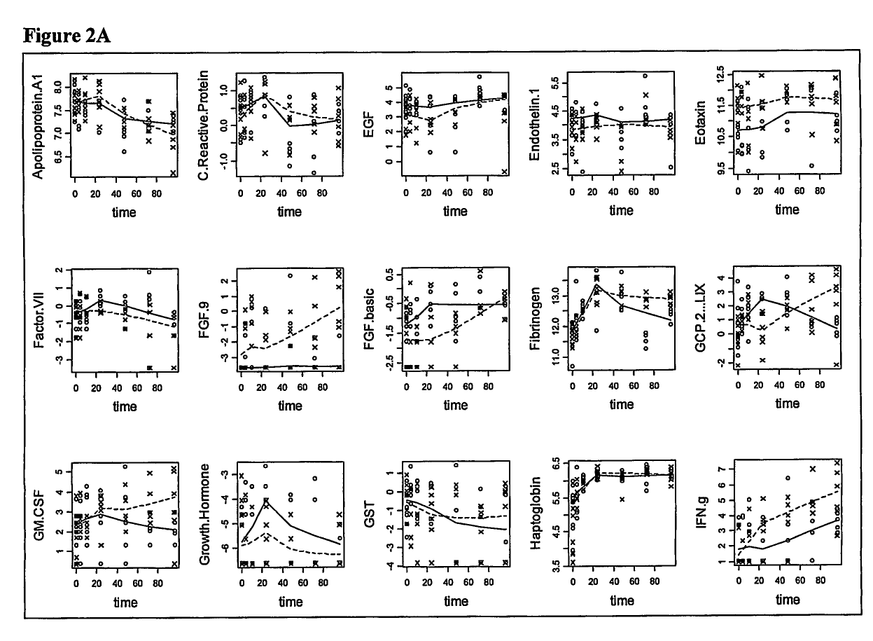

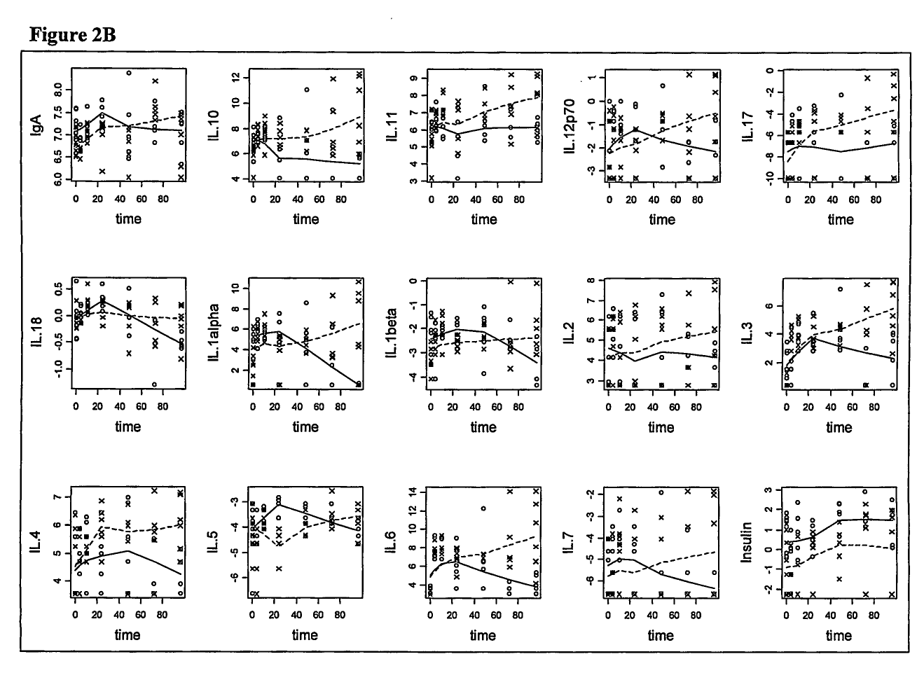

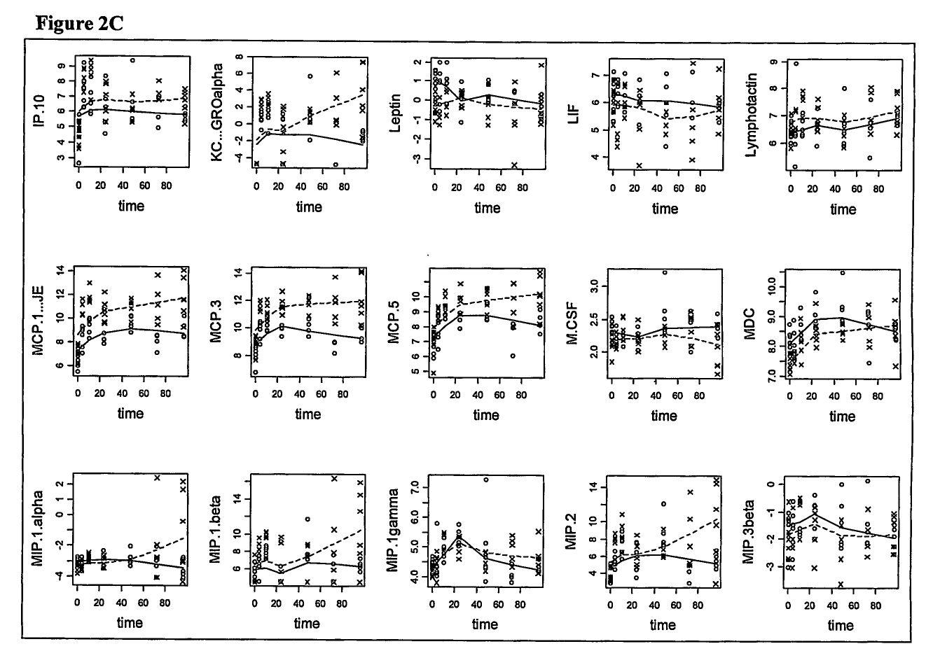

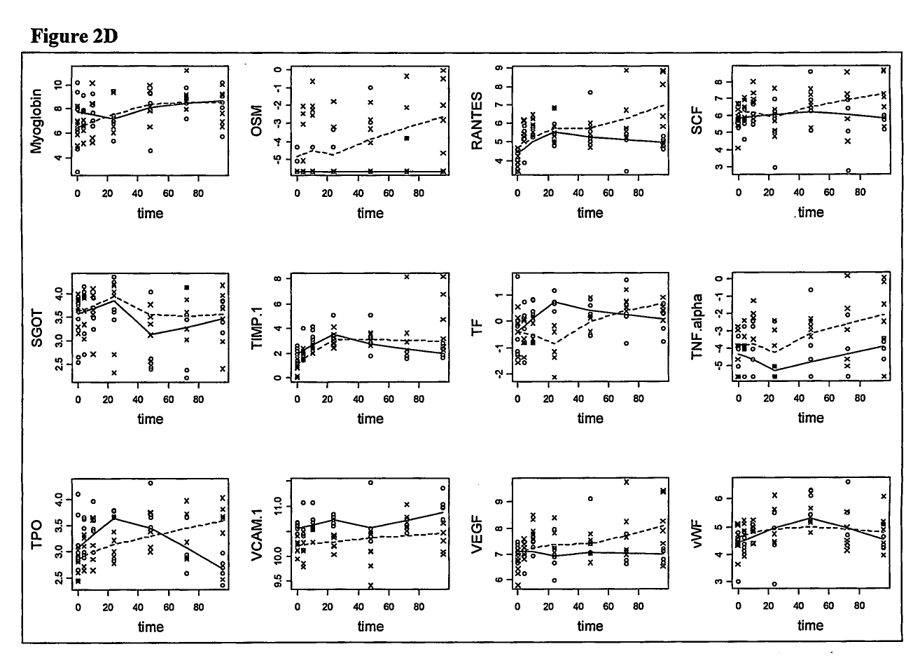

The time-profiles of each analyte are also graphically represented in standard and log2-transformed formats (FIGS. 1A-1C and FIGS. 2A-2D, respectively). The results show that, among the analytes tested, fibrinogen, GCP2/LIX, haptoglobin, IL-10, IL-11, IL-18, IL-1α, IL-1β, IL-3, IL-S, IL-6, KC-GROα, M-CSF, MIP-1a, MIP-2, OSM, RANTES, TIMP1, TF, TPO, VCAM1, and VEGF had an interaction p value<0.05.

The analyte measurements were further analyzed to determine linear trend differences between the INFECTED and XR.INFECTED groups. Each analyte measurement for each group was summarized across each timepoint and assigned a score. The scores for each analyte were then compared between the two treatment groups. The procedure for the data analysis is described in more detail below.

More particularly, measurements of zero are replaced with 0.01, and all the data then log2 transformed. Letting x_{t,i,l} represent an analyte measurement at time t, taken from i^{th} animal in treatment group l, the mean analyte measurement at time t is calculated as

$${y}_{t \cdot l} = \frac{{\sum }_{l} {x}_{til}}{n} ,$$

where n is number of animals at time t of group l. Letting score1=y_{4·1}+y_{10·1}+y_{24·1}+y_{48·1}+2×y_{72·1}+2×y_{96·1}−8×y_{0·1}, then the variance of score1 is calculated, var(score1)=var(y_{4·1})+var(y_{10 ·1})+var(y_{24·1})+var(y_{48·1})+4×var(y_{72 ·1})+4×var(y_{96·1})+64×var(y_{0·1}) Then, the test statistics for comparing the difference in linear trend of the two treatment groups is

$$\frac{score 1 - score 2}{\sqrt{var ( score 1 ) + var ( score 2 )}} ,$$

which follows a t distribution with 76 degrees of freedom under the null hypothesis. The results are shown in Table 12 below.

TABLE 12

| | | Trend difference | ANOVA |
|---|---|---|---|
| Analytes | Test statistics | P value | Interaction.p |
| KC . . . GROalpha | −6.11 | 3.96E−08 | 0.000164 |
| OSM | −4.63 | 1.46E−05 | 0.0307 |
| IL.6 | −4.6 | 1.68E−05 | 0.000305 |
| TIMP.1 | −4.57 | 1.84E−05 | 0.0166 |
| IL.3 | −4.32 | 4.74E−05 | 0.00102 |
| VEGF | −3.81 | 0.000283 | 0.0242 |
| FGF.9 | −3.77 | 0.000326 | 0.0846 |
| MCP.1 . . . JE | −3.52 | 0.000737 | 0.00483 |
| IL.11 | −3.43 | 0.000982 | 0.0457 |
| IL.10 | −3.11 | 0.00266 | 0.014 |
| MCP.3 | −3.05 | 0.00312 | 0.0693 |
| MIP.2 | −2.91 | 0.00468 | 0.0146 |
| MIP.1.beta | −2.76 | 0.0072 | 0.0547 |
| MIP.1.alpha | −2.54 | 0.013 | 0.035 |
| MDC | −2.54 | 0.0131 | 0.183 |
| RANTES | −2.5 | 0.0144 | 0.0265 |
| IL.1beta | −2.47 | 0.0156 | 0.016 |
| Haptoglobin | −2.38 | 0.0201 | 0.0361 |
| Fibrinogen | −2.36 | 0.021 | 0.00145 |
| MCP.5 | −2.29 | 0.025 | 0.0192 |
| MIP.1gamma | −2.27 | 0.026 | 0.0777 |
| SCF | −2.23 | 0.0285 | 0.401 |
| IgA | −2.14 | 0.0354 | 0.136 |
| IP.10 | −2.06 | 0.0432 | 0.22 |
| IL.1alpha | −2.03 | 0.0459 | 0.00571 |
| IL.7 | −1.87 | 0.0657 | 0.438 |
| TNF.alpha | −1.81 | 0.074 | 0.76 |
| TPO | −1.77 | 0.0802 | 0.00564 |
| IL.17 | −1.75 | 0.0835 | 0.379 |
| IFN.g | −1.72 | 0.0888 | 0.229 |
| IL.2 | −1.61 | 0.112 | 0.506 |
| Factor.VII | 1.59 | 0.115 | 0.322 |
| Growth.Hormone | 1.48 | 0.143 | 0.622 |
| IL.18 | −1.43 | 0.158 | 0.0271 |
| Lymphotactin | −1.37 | 0.175 | 0.53 |
| GM.CSF | −1.37 | 0.176 | 0.463 |
| M.CSF | −1.28 | 0.205 | 0.0899 |
| GCP.2 . . . LIX | −1.21 | 0.231 | 0.00688 |
| GST | 1.16 | 0.249 | 0.532 |
| IL.12p70 | −1.15 | 0.255 | 0.215 |
| Leptin | −0.932 | 0.354 | 0.111 |
| Apolipoprotein.A1 | −0.924 | 0.358 | 0.243 |
| Myoglobin | −0.693 | 0.491 | 0.828 |
| LIF | 0.668 | 0.506 | 0.437 |
| IL.5 | 0.615 | 0.54 | 0.0012 |
| C.Reactive.Protein | −0.608 | 0.545 | 0.484 |
| vWF | 0.564 | 0.574 | 0.146 |
| IL.4 | −0.537 | 0.593 | 0.291 |
| MIP.3beta | 0.493 | 0.623 | 0.54 |
| TF | −0.434 | 0.665 | 0.000404 |
| VCAM.1 | −0.408 | 0.684 | 0.00541 |
| SGOT | 0.324 | 0.747 | 0.54 |
| Insulin | 0.292 | 0.771 | 0.917 |
| EGF | −0.269 | 0.788 | 0.743 |
| Endothelin.1 | −0.26 | 0.796 | 0.275 |
| Eotaxin | 0.257 | 0.798 | 0.941 |
| FGF.basic | 0.167 | 0.868 | 0.474 |

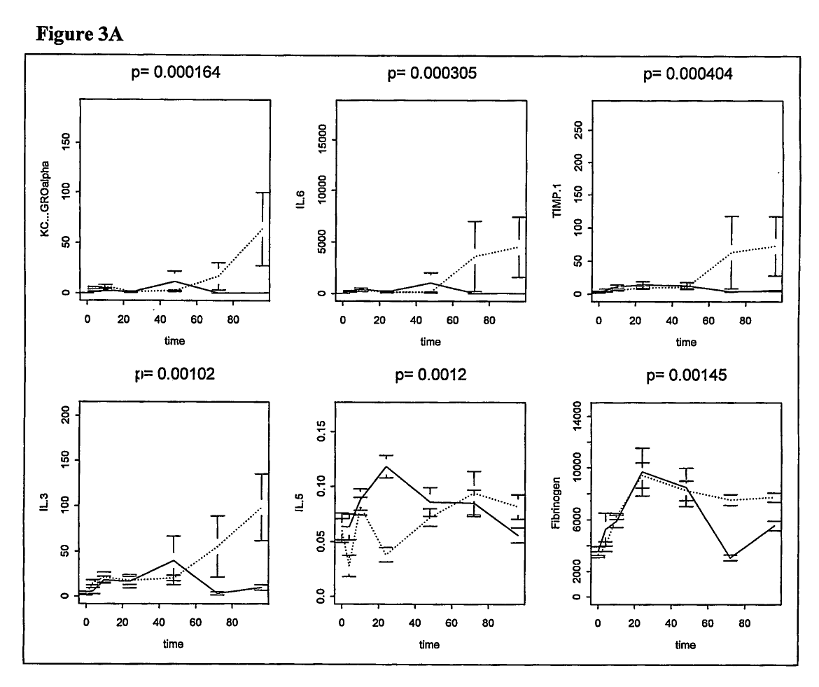

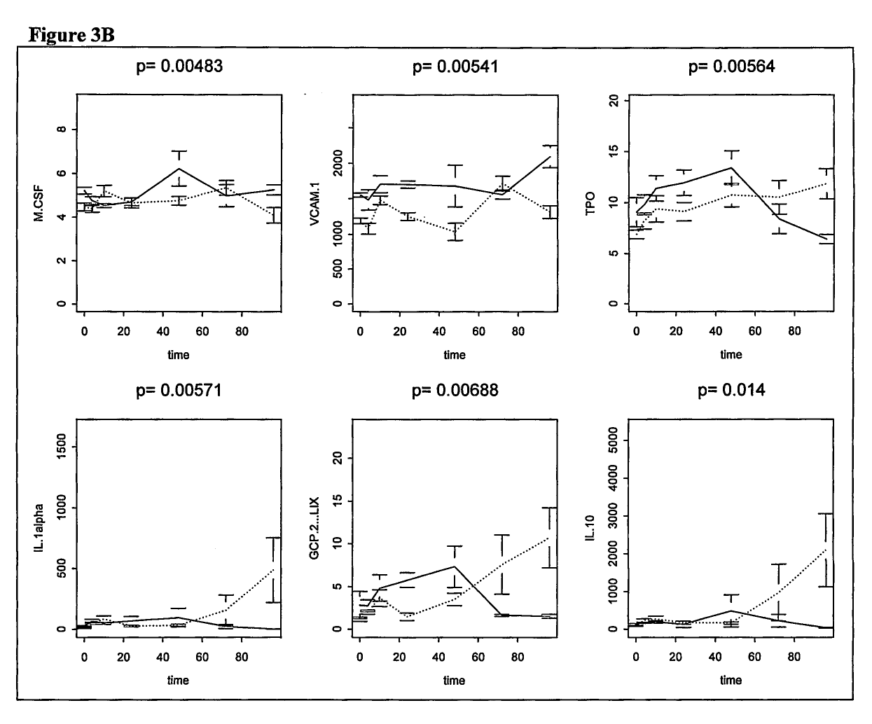

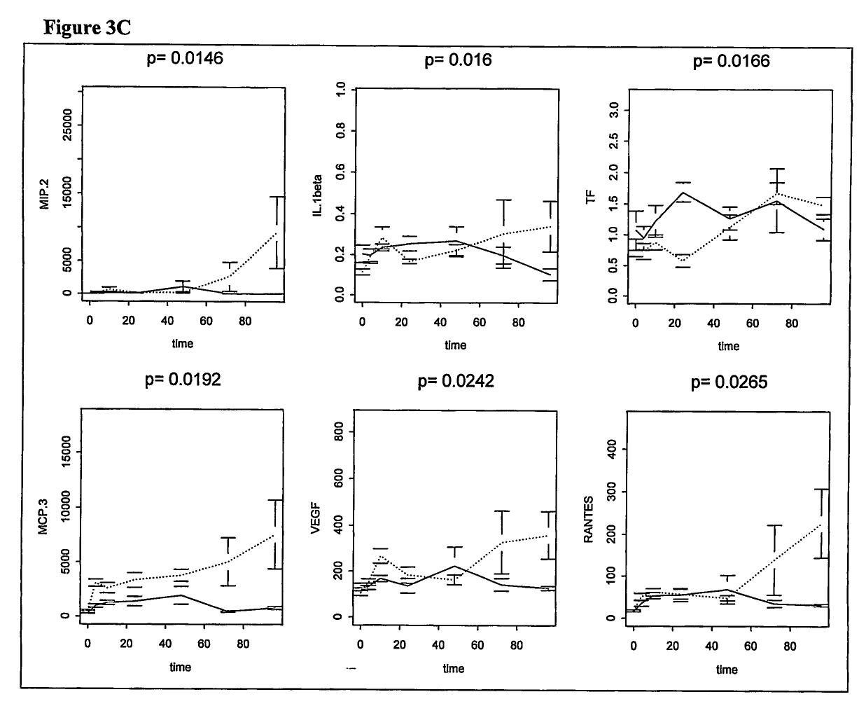

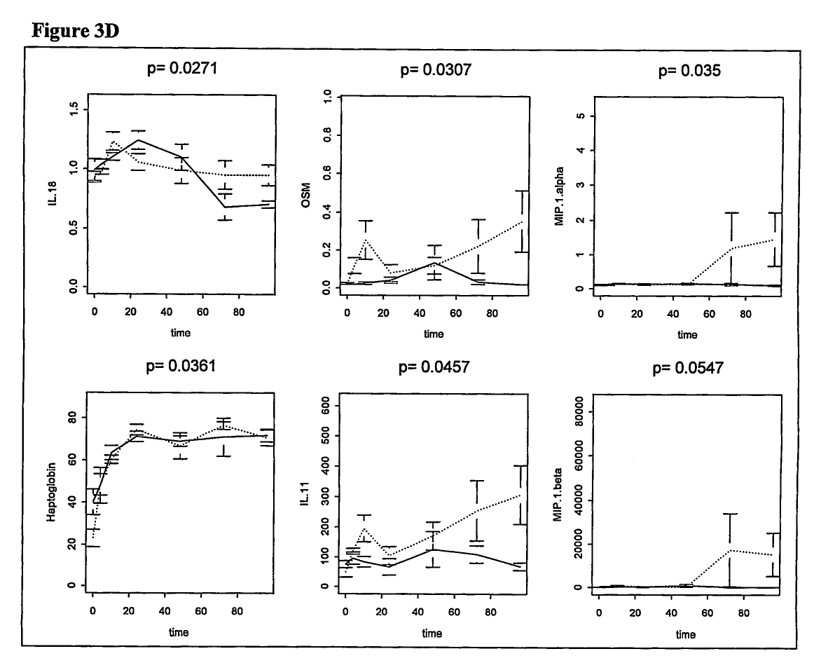

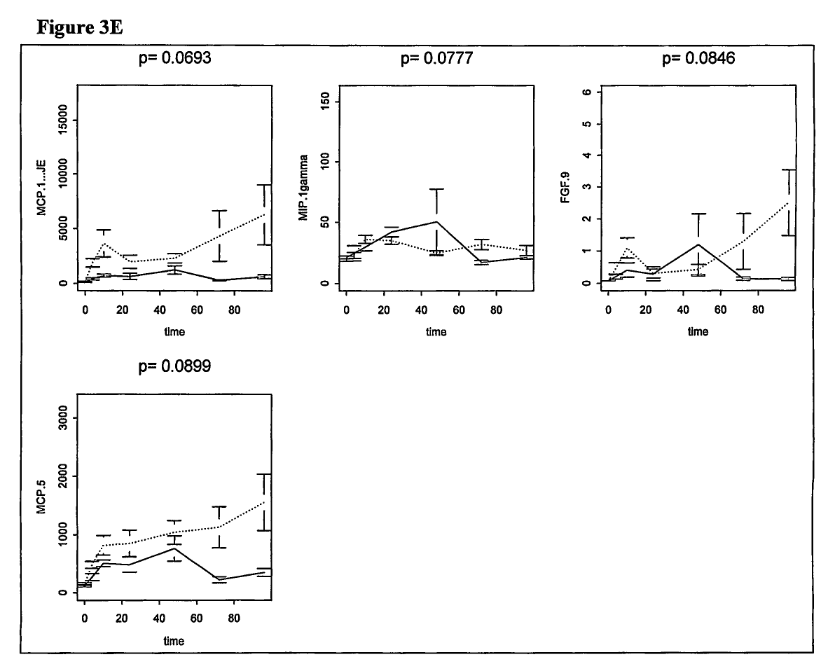

Analytes that displayed significant differences (p<0.1) in their time-profile between the two treatment groups are shown in FIGS. 3A-3E.

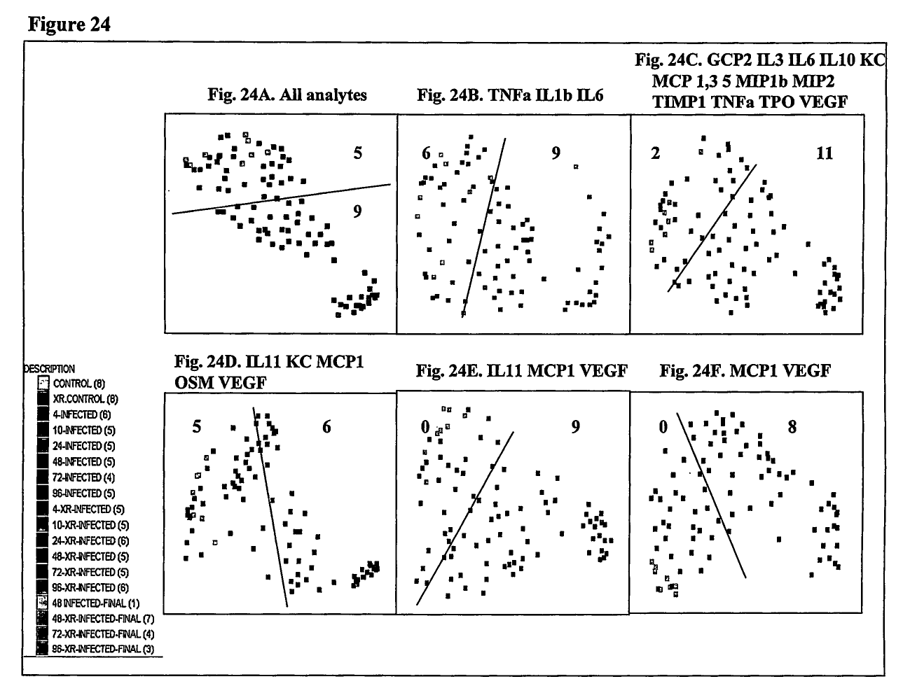

Using another data-analysis or statistical approach, a principle component analysis (PCA) with the Galaxy data-visualization tool from OmniViz was also performed, representing the analyte values obtained for each animal rather than the average values calculated for the samples obtained at a selected timepoint. In this representation of data, each symbol represents the analyte levels for one animal. A Galaxy map is shown for six different groups of analytes. Results are shown in FIGS. 24A-24F. When the levels of all the analytes were considered (FIG. 24A), the best separation between survivor and doomed groups resulted in five doomed animals in the survivors area and 9 survivors in the doomed area. In comparison, when the classical pro-inflammatory factors, INFa, IL1b, and IL-6 were used (FIG. 24B), the separation between survivors and doomed misclassified nine survivor and six doomed animals. When the 14 analytes identified in Appendix were used (see FIG. 24C), only two doomed animals were misclassified, and eleven survivors were found in the doomed area. According to the analytes that differentiate survivor from doomed groups at 4 and 10 hours after infection (FIG. 24D), six survivor and five doomed animals were misclassified. Removing KC and OSM from this analysis (FIG. 24E) resulted in a better separation, which was further improved by the removal of IL-11. The best separation between survivors and doomed animals was achieved when MCP-1 and VEGF were used to estimate the risk of death (FIG. 24F). In this case, all the doomed animals were assigned to an area where only eight survivors can be found. MCP-1 and VEGF were selected because both induce vascular permeability. It is postulated that that high plasma levels of VEGF and MCP-1 induce systemic microvascular permeability that results in multiple organ dysfunction and death.

Examination of Interaction Effect Between INFECTED and XR.INFECTED Groups at Specific Time Points:

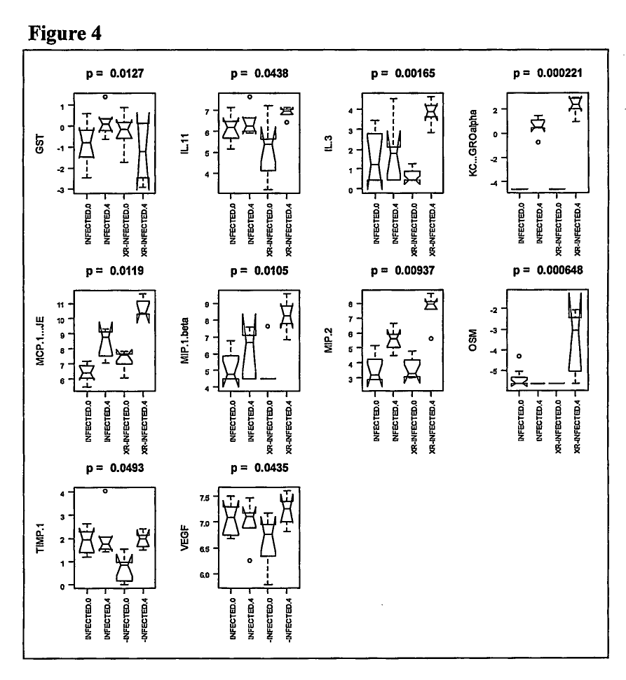

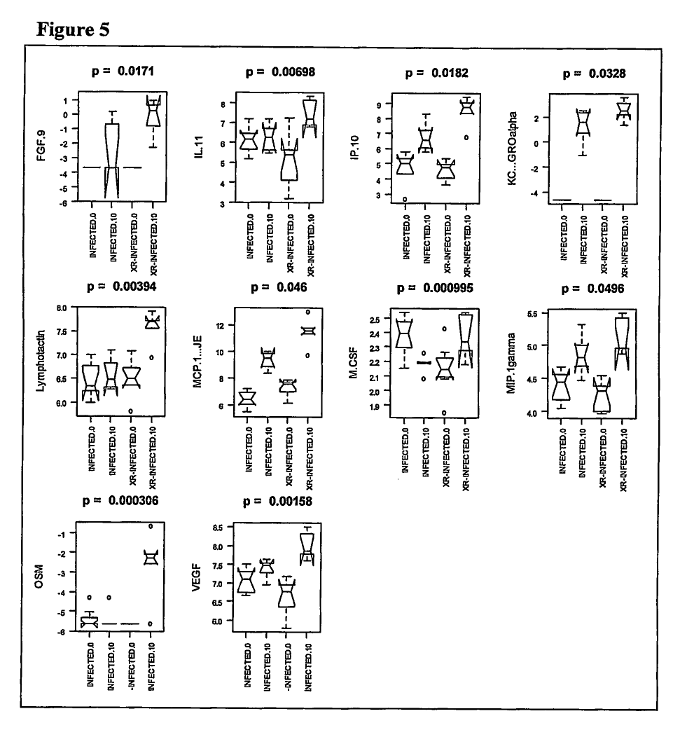

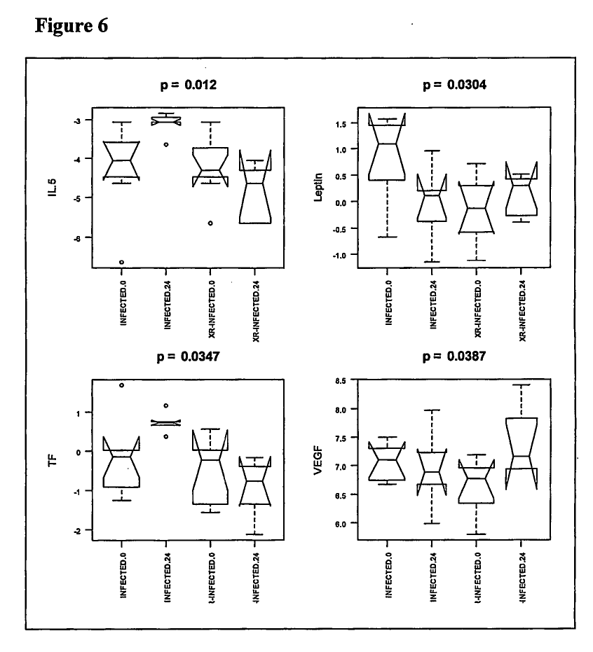

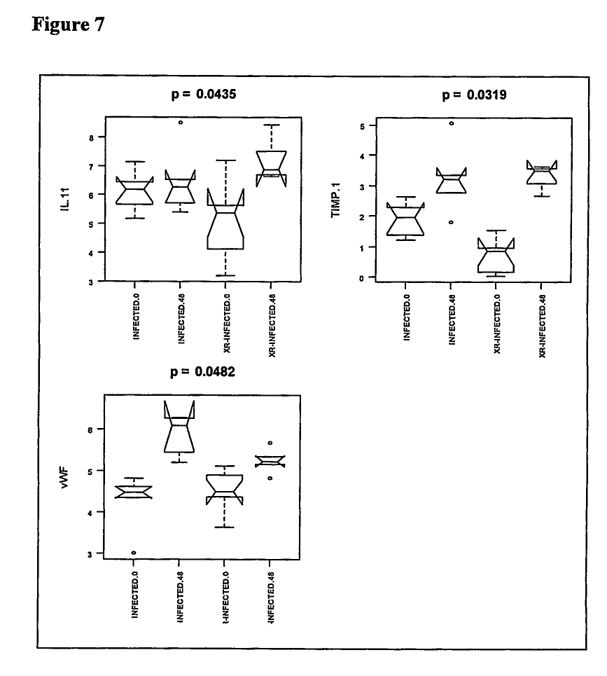

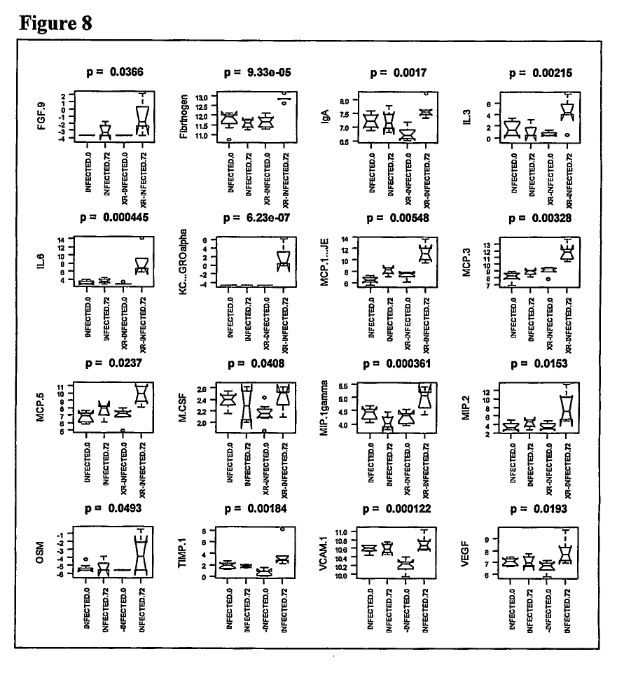

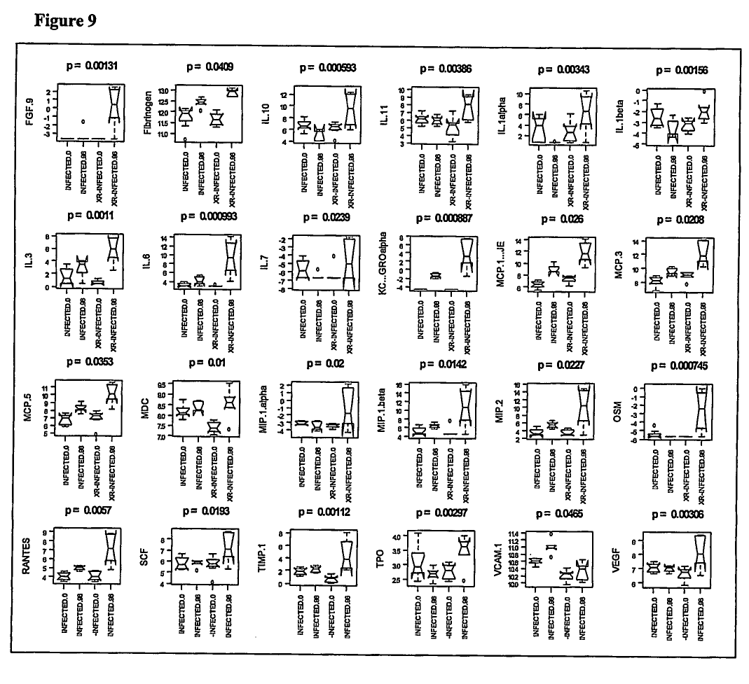

Here a similar two-way ANOVA analysis was used, but the factor of time had only two levels (x hours vs. 0 hr). Group, hour, and interaction p values are shown in Tables 13 through 18 below, for four hour vs. zero hour (Table 13), ten hours vs. zero hour (Table 14), 24 hour vs. zero hour (Table 15), 48 hours vs. zero hour (Table 16), 72 hours vs. zero hour (Table 17), and 96 hours vs. zero hour (Table 18). The corresponding standard box-and-whisker plots of the data presented in Tables 13 through 18 are depicted in FIG. 4 through FIG. 9, respectively.

TABLE 13
4 hours vs. 0 hour (ranked by the interaction p value)

| | group.P | hour.P | Interaction.P |
|---|---|---|---|
| KC . . . GROalpha | 0.0372 | 2.14E−20 | 0.000221 |
| OSM | 0.033 | 0.00829 | 0.000648 |
| IL.3 | 0.692 | 0.000532 | 0.00165 |
| MIP.2 | 0.0498 | 1.88E−08 | 0.00937 |
| MIP.1.beta | 0.187 | 5.75E−05 | 0.0105 |
| MCP.1 . . . JE | 2.84E−05 | 5.84E−10 | 0.0119 |
| GST | 0.554 | 0.884 | 0.0127 |
| VEGF | 0.254 | 0.112 | 0.0435 |
| IL.11 | 0.166 | 0.00673 | 0.0438 |
| TIMP.1 | 0.00306 | 0.00896 | 0.0493 |
| IL.5 | 0.141 | 0.153 | 0.0587 |
| LIF | 0.0237 | 0.404 | 0.0636 |
| MCP.3 | 5.41E−05 | 3.98E−09 | 0.0684 |
| Haptoglobin | 0.0519 | 0.00719 | 0.0763 |
| Apolipoprotein.A1 | 0.923 | 0.506 | 0.104 |
| SCF | 0.453 | 0.301 | 0.12 |
| IP.10 | 0.769 | 6.51E−09 | 0.163 |
| IL.6 | 0.447 | 4.05E−16 | 0.172 |
| RANTES | 0.273 | 2.52E−05 | 0.196 |
| IL.1beta | 0.126 | 0.19 | 0.198 |
| Endothelin.1 | 0.0223 | 0.688 | 0.199 |
| IL.10 | 0.654 | 0.00353 | 0.208 |
| TNF.alpha | 0.294 | 0.0651 | 0.209 |
| FGF.9 | 0.408 | 0.00103 | 0.234 |
| MDC | 2.90E−05 | 0.782 | 0.234 |
| MCP.5 | 0.127 | 0.000102 | 0.237 |
| M.CSF | 0.00228 | 0.142 | 0.323 |
| MIP.3beta | 0.272 | 0.965 | 0.356 |
| Factor.VII | 0.716 | 0.982 | 0.373 |
| Growth.Hormone | 0.911 | 0.976 | 0.419 |
| Leptin | 0.000496 | 0.303 | 0.466 |
| SGOT | 0.658 | 0.795 | 0.473 |
| Lymphotactin | 0.511 | 0.409 | 0.523 |
| GM.CSF | 0.958 | 0.285 | 0.537 |
| IL.4 | 0.597 | 0.46 | 0.539 |
| IgA | 8.66E−05 | 0.0369 | 0.544 |
| IL.7 | 0.279 | 0.14 | 0.548 |
| Eotaxin | 0.0119 | 0.565 | 0.559 |
| vWF | 0.149 | 0.495 | 0.579 |
| Fibrinogen | 0.343 | 0.0634 | 0.584 |
| MIP.1.alpha | 0.06 | 0.694 | 0.587 |
| IL.12p70 | 0.847 | 0.0761 | 0.605 |
| MIP.1gamma | 0.576 | 0.351 | 0.611 |
| Myoglobin | 0.182 | 0.441 | 0.696 |
| IFN.g | 0.607 | 0.746 | 0.702 |
| VCAM.1 | 1.78E−05 | 0.133 | 0.733 |
| GCP.2 . . . LIX | 0.304 | 0.0687 | 0.742 |
| EGF | 0.0489 | 0.857 | 0.756 |
| FGF.basic | 0.267 | 0.827 | 0.766 |
| Insulin | 0.104 | 0.0205 | 0.766 |
| IL.17 | 0.313 | 0.0343 | 0.767 |
| C.Reactive.Protein | 0.578 | 0.981 | 0.834 |
| TPO | 0.068 | 0.198 | 0.836 |
| IL.1alpha | 0.405 | 0.000689 | 0.86 |
| IL.18 | 0.385 | 0.327 | 0.872 |
| IL.2 | 0.171 | 0.00373 | 0.96 |
| TF | 0.341 | 0.897 | 0.973 |

TABLE 14
10 hours vs. 0 hour (ranked by the interaction p value)

| | group.P | hour.P | interaction.P |
|---|---|---|---|
| OSM | 0.0137 | 0.000255 | 0.000306 |
| M.CSF | 0.228 | 0.843 | 0.000995 |
| VEGF | 0.947 | 9.07E−06 | 0.00158 |
| Lymphotactin | 0.00911 | 0.000409 | 0.00394 |
| IL.11 | 0.659 | 0.00326 | 0.00698 |
| FGF.9 | 0.0535 | 4.58E−06 | 0.0171 |
| IP.10 | 0.138 | 3.49E−08 | 0.0182 |
| KC . . . GROalpha | 0.0855 | 1.15E−16 | 0.0328 |
| MCP.1 . . . JE | 0.000118 | 6.88E−11 | 0.046 |
| MIP.1gamma | 0.832 | 1.10E−06 | 0.0496 |
| MIP.1.beta | 0.405 | 4.33E−09 | 0.0505 |
| IgA | 0.00239 | 0.19 | 0.0862 |
| SCF | 0.373 | 0.0108 | 0.0902 |
| MIP.1.alpha | 0.16 | 0.000336 | 0.0941 |
| VCAM.1 | 8.78E−06 | 0.000811 | 0.103 |
| Haptoglobin | 0.025 | 4.33E−05 | 0.111 |
| IL.1beta | 0.147 | 0.00438 | 0.121 |
| IL.2 | 0.909 | 0.235 | 0.123 |
| IL.3 | 0.149 | 3.03E−08 | 0.138 |
| TNF.alpha | 0.215 | 0.00555 | 0.146 |
| Apolipoprotein.A1 | 0.724 | 0.708 | 0.159 |
| MIP.2 | 0.251 | 1.86E−09 | 0.178 |
| GST | 0.697 | 0.346 | 0.207 |
| Endothelin.1 | 0.806 | 0.714 | 0.245 |
| MDC | 0.000406 | 0.00173 | 0.249 |
| IL.18 | 0.827 | 0.00552 | 0.278 |
| IL.10 | 0.642 | 0.00441 | 0.381 |
| Growth.Hormone | 0.928 | 0.522 | 0.408 |
| Insulin | 0.0139 | 0.691 | 0.42 |
| IL.12p70 | 0.228 | 0.0361 | 0.425 |
| MIP.3beta | 0.795 | 0.162 | 0.436 |
| IL.1alpha | 0.836 | 0.000752 | 0.469 |
| IL.4 | 0.608 | 0.0628 | 0.491 |
| SGOT | 0.573 | 0.766 | 0.505 |
| Fibrinogen | 0.962 | 2.90E−06 | 0.518 |
| GM.CSF | 0.362 | 0.185 | 0.526 |
| IL.6 | 0.154 | 2.39E−16 | 0.531 |
| MCP.5 | 0.195 | 5.66E−08 | 0.534 |
| Eotaxin | 0.118 | 0.504 | 0.602 |
| TIMP.1 | 1.15E−05 | 4.23E−08 | 0.62 |
| IL.17 | 0.747 | 0.000555 | 0.621 |
| LIF | 0.591 | 0.867 | 0.64 |
| Leptin | 0.00398 | 0.502 | 0.677 |
| IL.7 | 0.222 | 0.000626 | 0.684 |
| GCP.2 . . . LIX | 0.44 | 0.00794 | 0.698 |
| RANTES | 0.556 | 4.35E−09 | 0.728 |
| MCP.3 | 0.000606 | 4.05E−09 | 0.741 |
| Factor.VII | 0.514 | 0.779 | 0.759 |
| Myoglobin | 0.524 | 0.178 | 0.775 |
| FGF.basic | 0.257 | 0.373 | 0.799 |
| IFN.g | 0.751 | 0.0132 | 0.857 |
| IL.5 | 0.939 | 0.0538 | 0.862 |
| vWF | 0.334 | 0.0528 | 0.889 |
| TF | 0.282 | 0.346 | 0.918 |
| C.Reactive.Protein | 0.754 | 0.431 | 0.923 |
| EGF | 0.103 | 0.621 | 0.945 |
| TPO | 0.0763 | 0.027 | 0.978 |

TABLE 15
24 hours vs. 0 hour (ranked by the interaction p value)

| | group.P | hour.P | interaction.P |
|---|---|---|---|
| IL.5 | 0.0412 | 0.497 | 0.012 |
| Leptin | 0.0503 | 0.306 | 0.0304 |
| TF | 0.00827 | 0.464 | 0.0347 |
| VEGF | 0.805 | 0.0903 | 0.0387 |
| Haptoglobin | 0.0702 | 1.07E−06 | 0.0521 |
| IL.11 | 0.604 | 0.516 | 0.0578 |
| IL.10 | 0.569 | 0.653 | 0.0714 |
| M.CSF | 0.0177 | 0.507 | 0.0842 |
| GCP.2 . . . LIX | 0.0207 | 0.0471 | 0.0994 |
| IL.3 | 0.362 | 1.28E−07 | 0.103 |
| IFN.g | 0.225 | 0.0478 | 0.12 |
| Factor.VII | 0.475 | 0.115 | 0.134 |
| TIMP.1 | 0.00271 | 1.20E−08 | 0.137 |
| Growth.Hormone | 0.552 | 0.149 | 0.144 |
| MCP.1 . . . JE | 0.000169 | 3.17E−09 | 0.162 |
| GST | 0.729 | 0.193 | 0.214 |
| FGF.basic | 0.0727 | 0.366 | 0.245 |
| Apolipoprotein.A1 | 0.708 | 0.94 | 0.26 |
| SGOT | 0.994 | 0.547 | 0.27 |
| MDC | 0.00039 | 1.23E−06 | 0.333 |
| IL.6 | 0.546 | 1.59E−08 | 0.353 |
| MCP.3 | 0.000152 | 4.30E−09 | 0.363 |
| IL.18 | 0.228 | 0.016 | 0.387 |
| SCF | 0.728 | 0.798 | 0.39 |
| Lymphotactin | 0.301 | 0.0916 | 0.407 |
| MCP.5 | 0.0923 | 3.82E−07 | 0.418 |
| IP.10 | 0.651 | 8.25E−05 | 0.421 |
| IL.17 | 0.859 | 0.0295 | 0.433 |
| OSM | 0.947 | 0.044 | 0.455 |
| IL.2 | 0.689 | 0.382 | 0.469 |
| Myoglobin | 0.761 | 0.268 | 0.499 |
| IL.4 | 0.0956 | 0.0231 | 0.506 |
| C.Reactive.Protein | 0.407 | 0.344 | 0.507 |
| MIP.3beta | 0.406 | 0.191 | 0.507 |
| MIP.1.beta | 0.904 | 0.117 | 0.519 |
| MIP.1gamma | 0.131 | 4.85E−09 | 0.533 |
| VCAM.1 | 7.26E−09 | 0.0464 | 0.538 |
| FGF.9 | 0.534 | 0.0157 | 0.539 |
| TNF.alpha | 0.556 | 0.912 | 0.542 |
| vWF | 0.207 | 0.192 | 0.572 |
| LIF | 0.21 | 0.215 | 0.579 |
| GM.CSF | 0.895 | 0.0992 | 0.587 |
| Endothelin.1 | 0.0684 | 0.24 | 0.619 |
| Eotaxin | 0.0155 | 0.574 | 0.676 |
| EGF | 0.193 | 0.209 | 0.704 |
| IL.1beta | 0.015 | 0.0274 | 0.706 |
| Fibrinogen | 0.818 | 9.35E−08 | 0.72 |
| KC . . . GROalpha | 0.612 | 3.63E−05 | 0.733 |
| IL.12p70 | 0.456 | 0.0729 | 0.756 |
| MIP.2 | 0.589 | 2.25E−05 | 0.778 |
| IL.7 | 0.272 | 0.226 | 0.782 |
| MIP.1.alpha | 0.0637 | 0.139 | 0.799 |
| TPO | 0.0523 | 0.015 | 0.826 |
| RANTES | 0.484 | 3.87E−07 | 0.866 |
| IgA | 0.000361 | 0.0323 | 0.92 |
| IL.1alpha | 0.546 | 0.0945 | 0.967 |
| Insulin | 0.0532 | 0.963 | 0.969 |

TABLE 16
48 hours vs. 0 hour (ranked by the interaction p value)

| | group.P | hour.P | interaction.P |
|---|---|---|---|
| TIMP.1 | 0.0139 | 3.14E−07 | 0.0319 |
| IL.11 | 0.406 | 0.00626 | 0.0435 |
| vWF | 0.537 | 9.74E−06 | 0.0482 |
| IL.17 | 0.423 | 0.00871 | 0.0809 |
| Apolipoprotein.A1 | 0.99 | 0.000573 | 0.0867 |
| Haptoglobin | 0.0275 | 1.63E−05 | 0.122 |
| EGF | 0.692 | 0.539 | 0.153 |
| C.Reactive.Protein | 0.536 | 0.019 | 0.224 |
| VCAM.1 | 0.000157 | 0.403 | 0.23 |
| MIP.2 | 0.375 | 7.13E−08 | 0.231 |
| IL.7 | 0.719 | 0.179 | 0.259 |
| TNF.alpha | 0.351 | 0.016 | 0.282 |
| IL.1beta | 0.133 | 0.0375 | 0.289 |
| IL.2 | 0.844 | 0.0506 | 0.289 |
| FGF.basic | 0.0887 | 0.749 | 0.305 |
| IL.3 | 0.153 | 1.84E−07 | 0.316 |
| IL.10 | 0.967 | 0.554 | 0.336 |
| OSM | 0.822 | 0.0013 | 0.341 |
| MIP.3beta | 0.321 | 0.685 | 0.375 |
| MIP.1.beta | 0.233 | 1.91E−05 | 0.419 |
| IL.12p70 | 0.945 | 0.0127 | 0.432 |
| IFN.g | 0.64 | 0.0122 | 0.442 |
| Myoglobin | 0.8 | 0.0555 | 0.446 |
| Growth.Hormone | 0.984 | 0.636 | 0.452 |
| M.CSF | 0.00221 | 0.0679 | 0.454 |
| MCP.3 | 0.00168 | 1.11E−08 | 0.458 |
| LIF | 0.183 | 0.065 | 0.462 |
| SGOT | 0.147 | 0.0147 | 0.512 |
| MIP.1gamma | 0.287 | 0.0482 | 0.543 |
| GM.CSF | 0.893 | 0.159 | 0.547 |
| Leptin | 0.0047 | 0.326 | 0.549 |
| Insulin | 0.0157 | 0.111 | 0.561 |
| IL.1alpha | 0.781 | 0.0578 | 0.636 |
| IL.6 | 0.97 | 5.25E−07 | 0.639 |
| MIP.1.alpha | 0.0531 | 0.0154 | 0.643 |
| MCP.5 | 0.289 | 3.71E−08 | 0.669 |
| IL.18 | 0.416 | 0.422 | 0.682 |
| VEGF | 0.101 | 0.0128 | 0.682 |
| IL.4 | 0.558 | 0.0305 | 0.686 |
| IL.5 | 0.817 | 0.125 | 0.712 |
| Factor.VII | 0.922 | 0.766 | 0.716 |
| Lymphotactin | 0.967 | 0.751 | 0.742 |
| GCP.2 . . . LIX | 0.169 | 0.00102 | 0.743 |
| Endothelin.1 | 0.177 | 0.133 | 0.78 |
| RANTES | 0.994 | 1.01E−05 | 0.787 |
| Eotaxin | 0.0179 | 0.00938 | 0.795 |
| Fibrinagen | 0.788 | 8.61E−08 | 0.801 |
| MCP.1 . . . JE | 0.00247 | 1.01E−11 | 0.808 |
| TF | 0.383 | 0.0913 | 0.83 |
| SCF | 0.809 | 0.0154 | 0.849 |
| IP.10 | 0.578 | 0.00035 | 0.861 |
| MDC | 2.35E−05 | 1.82E−07 | 0.905 |
| GST | 0.287 | 0.0487 | 0.92 |
| IgA | 0.0144 | 0.883 | 0.923 |
| KC . . . GROalpha | 0.939 | 4.04E−11 | 0.923 |
| FGF.9 | 0.954 | 0.000459 | 0.941 |
| TPO | 0.0605 | 0.000942 | 0.98 |

TABLE 17
72 hours vs. 0 hour (ranked by the interaction p value)

| | group.P | hour.P | interaction.P |
|---|---|---|---|
| KC . . . GROalpha | 1.33E−05 | 2.09E−07 | 6.23E−07 |
| Fibrinogen | 0.0038 | 0.000758 | 9.33E−05 |
| VCAM.1 | 0.00175 | 4.53E−05 | 0.000122 |
| MIP.1gamma | 0.058 | 0.0752 | 0.000361 |
| IL.6 | 0.00692 | 4.70E−05 | 0.000445 |
| IgA | 0.289 | 0.000886 | 0.0017 |
| TIMP.1 | 0.834 | 0.00142 | 0.00184 |
| IL.3 | 0.268 | 0.0084 | 0.00215 |
| MCP.3 | 1.84E−05 | 1.65E−05 | 0.00328 |
| MCP.1 . . . JE | 4.19E−05 | 1.67E−07 | 0.00548 |
| MIP.2 | 0.0373 | 0.00102 | 0.0153 |
| VEGF | 0.747 | 0.0105 | 0.0193 |
| MCP.5 | 0.0134 | 0.000135 | 0.0237 |
| FGF.9 | 0.0756 | 0.00105 | 0.0366 |
| M.CSF | 0.19 | 0.205 | 0.0408 |
| OSM | 0.26 | 0.0131 | 0.0493 |
| MDC | 0.0235 | 0.000216 | 0.0519 |
| IFN.g | 0.118 | 5.93E−05 | 0.052 |
| IL.11 | 0.538 | 0.00533 | 0.0624 |
| Haptoglobin | 0.101 | 9.00E−06 | 0.0632 |
| IL.18 | 0.387 | 0.0798 | 0.0693 |
| RANTES | 0.0843 | 0.000212 | 0.0734 |
| MIP.1.beta | 0.25 | 0.0156 | 0.0798 |
| IP.10 | 0.268 | 4.60E−06 | 0.0875 |
| Growth.Hormone | 0.447 | 0.455 | 0.0925 |
| GM.CSF | 0.349 | 0.116 | 0.0979 |
| GCP.2 . . . LIX | 0.716 | 0.0366 | 0.102 |
| TPO | 0.675 | 0.172 | 0.114 |
| Factor.VII | 0.3 | 0.229 | 0.12 |
| MIP.1.alpha | 0.504 | 0.106 | 0.124 |
| SCF | 0.376 | 0.637 | 0.13 |
| IL.17 | 0.489 | 0.0129 | 0.137 |
| IL.10 | 0.604 | 0.192 | 0.148 |
| vWF | 0.84 | 0.0485 | 0.153 |
| IL.1alpha | 0.583 | 0.223 | 0.157 |
| C.Reactive.Protein | 0.539 | 0.171 | 0.179 |
| IL.12p70 | 0.602 | 0.203 | 0.207 |
| TNF.alpha | 0.298 | 0.0963 | 0.238 |
| Lymphotactin | 0.271 | 0.0968 | 0.275 |
| IL.7 | 0.722 | 0.263 | 0.282 |
| GST | 0.666 | 0.02 | 0.287 |
| IL.1beta | 0.239 | 0.169 | 0.292 |
| TF | 0.908 | 0.0116 | 0.354 |
| Myoglobin | 0.949 | 0.00382 | 0.37 |
| MIP.3beta | 0.345 | 0.737 | 0.387 |
| LIF | 0.194 | 0.232 | 0.409 |
| SGOT | 0.175 | 0.274 | 0.454 |
| IL.2 | 0.541 | 0.141 | 0.565 |
| IL.4 | 0.17 | 0.152 | 0.595 |
| Eotaxin | 0.0968 | 0.155 | 0.62 |
| Leptin | 0.00498 | 0.0817 | 0.717 |
| EGF | 0.141 | 0.00248 | 0.758 |
| Endothelin.1 | 0.224 | 0.019 | 0.825 |
| FGF.basic | 0.5 | 0.00328 | 0.841 |
| Insulin | 0.127 | 0.0559 | 0.844 |
| Apolipoprotein.A1 | 0.147 | 0.00315 | 0.915 |
| IL.5 | 0.82 | 0.0603 | 0.93 |

TABLE 18
96 hours vs. 0 hour (ranked by the interaction p value)

| | group.P | hour.P | interaction.P |
|---|---|---|---|
| IL.10 | 0.0146 | 0.137 | 0.000593 |
| OSM | 0.0103 | 0.00177 | 0.000745 |
| KC . . . GROalpha | 0.00166 | 4.60E−09 | 0.000887 |
| IL.6 | 0.00592 | 2.31E−05 | 0.000993 |
| IL.3 | 0.143 | 2.10E−06 | 0.0011 |
| TIMP.1 | 0.469 | 0.000107 | 0.00112 |
| FGF.9 | 0.00365 | 8.90E−05 | 0.00131 |
| IL.1beta | 0.479 | 0.482 | 0.00156 |
| TPO | 0.361 | 0.289 | 0.00297 |
| VEGF | 0.284 | 0.00429 | 0.00306 |
| IL.1alpha | 0.0426 | 0.472 | 0.00343 |
| IL.11 | 0.721 | 0.00491 | 0.00386 |
| RANTES | 0.00715 | 5.51E−06 | 0.0057 |
| MDC | 0.0292 | 0.000219 | 0.01 |
| MIP.1.beta | 0.0547 | 0.000329 | 0.0142 |
| SCF | 0.0906 | 0.0245 | 0.0193 |
| MIP.1.alpha | 0.124 | 0.0613 | 0.02 |
| MCP.3 | 7.96E−05 | 9.32E−07 | 0.0208 |
| MIP.2 | 0.0327 | 8.17E−05 | 0.0227 |
| IL.7 | 0.47 | 0.31 | 0.0239 |
| MCP.1 . . . JE | 0.00011 | 4.17E−09 | 0.026 |
| MCP.5 | 0.00951 | 7.85E−07 | 0.0353 |
| Fibrinogen | 0.138 | 1.32E−07 | 0.0409 |
| VCAM.1 | 1.43E−07 | 0.000631 | 0.0465 |
| IL.18 | 0.305 | 0.0652 | 0.0509 |
| IL.2 | 0.548 | 0.0591 | 0.0538 |
| GCP.2 . . . LIX | 0.415 | 0.0372 | 0.0569 |
| Leptin | 0.0909 | 0.0948 | 0.061 |
| Haptoglobin | 0.0508 | 1.87E−06 | 0.0816 |
| MIP.1gamma | 0.753 | 0.0559 | 0.0826 |
| IP.10 | 0.266 | 1.83E−05 | 0.0892 |
| IFN.g | 0.14 | 5.24E−06 | 0.0944 |
| IL.12p70 | 0.341 | 0.024 | 0.109 |
| IL.17 | 0.363 | 0.00106 | 0.116 |
| IL.4 | 0.0196 | 0.0709 | 0.12 |
| TNF.alpha | 0.154 | 0.00541 | 0.141 |
| Factor.VII | 0.32 | 0.00339 | 0.16 |
| GM.CSF | 0.382 | 0.185 | 0.161 |
| TF | 0.89 | 0.028 | 0.175 |
| Endothelin.1 | 0.843 | 0.25 | 0.22 |
| IgA | 0.0532 | 0.95 | 0.254 |
| M.CSF | 0.000516 | 0.361 | 0.307 |
| FGF.basic | 0.808 | 0.00353 | 0.353 |
| SGOT | 0.787 | 0.745 | 0.372 |
| IL.5 | 0.46 | 0.342 | 0.442 |
| LIF | 0.683 | 0.234 | 0.523 |
| Lymphotactin | 0.382 | 0.00309 | 0.574 |
| MIP.3beta | 0.956 | 0.635 | 0.579 |
| vWF | 0.167 | 0.173 | 0.604 |
| Insulin | 0.0389 | 0.595 | 0.614 |
| Apolipoprotein.A1 | 0.0535 | 1.87E−05 | 0.632 |
| Growth.Hormone | 0.814 | 0.328 | 0.646 |
| Myoglobin | 0.635 | 0.0268 | 0.692 |
| EGF | 0.117 | 0.865 | 0.747 |
| Eotaxin | 0.0362 | 0.234 | 0.783 |
| GST | 0.283 | 0.049 | 0.933 |
| C.Reactive.Protein | 0.65 | 0.409 | 0.975 |

### Example 6

### Evaluation of Analytes and Biomarker Panel Identified in Mice Using Visualization Analysis

Data obtained from analyte measurements were assessed using OmniViz software for Galaxy map visualization analysis. This analysis was performed using an OmniViz Galaxy map to evaluate whether analytes distinguished between groups of animals having different disease outcomes.

### Example 7

### Immunocompromised Mouse Model of Contained Infection Used for Validation of Potential Drug Targets and Testing of Therapeutic Compounds

In order to test therapies intended at controlling systemic inflammatory response rather than the infection, it is desirable to control the infection to avoid problems that can derive from a high bacterial load. To this end we controlled the infection by using antibiotics. In this experiment, a subcutaneous pouch was induced in C3H/HeN animals. On the following day, all mice were irradiated with 490 rads—a dose of irradiation that in previous experiments was shown to be associated with 100% mortality. At Day 6 after induction of the pouches, mice were infected with 4.5×10⁶ CFU/mouse. As animals became sick (as detected by a ruffled fur), each animal was assigned to one of two different groups, i.e. a group to be treated with 0.3 mg/mouse of ceftriaxone and a group to stay untreated. Thirteen animals did not receive any treatment and 21 were treated. Once an animal was assigned to the treated group, it received a daily injection of antibiotic until the animal succumbed to death. Appendix C shows the survival curves for the 2 animal groups. The upper curve shows the data obtained using the antibiotic-treated-animals, and the lower curve corresponds to the untreated animals. At death, spleens were removed from the animals, homogenized in PBS, and the CFU determined. Table 19 (Experiment g) shows the bacterial counts obtained for the animals that remained untreated as compared to count for the treated animals.

The bacterial counts in the spleens of treated animals are about 3 logs of magnitude lower than in the untreated animals. The conditions employed should therefore be useful for testing therapies to prevent the progression from sepsis to septic shock in the absence of overwhelming bacterial infection.

TABLE 19

| Ceftriaxone | | Ceftriaxone | |
|---|---|---|---|
| 0.3 mg/mouse | CFU/spleen | 0.3 mg/mouse | CFU/spleen |
| NO | 1.40E+08 | YES | 1.20E+04 |
| NO | 2.80E+07 | YES | 2.00E+03 |
| NO | ND | YES | 8.00E+05 |
| NO | 2.00E+06 | YES | 4.00E+04 |
| NO | 8.00E+06 | YES | 6.00E+06 |
| NO | 3.60E+08 | YES | 2.60E+04 |
| NO | 2.40E+08 | YES | 3.00E+03 |
| NO | 1.80E+08 | YES | 8.00E+03 |
| No | 3.00E+07 | YES | 8.00E+05 |
| NO | 1.60E+08 | YES | 1.80E+04 |
| NO | 3.00E+08 | YES | 6.00E+02 |
| NO | 1.60E+07 | YES | a |
| NO | 1.80E+08 | YES | a |
| Average | 1.37E+08 | YES | a |
| | | YES | a |
| | | YES | a |
| | | YES | a |
| | | YES | a |
| | | YES | a |
| | | YES | a |
| | | Average | 7.01E+05 |

### Example 8

### Immunocompromised Mouse Model of Contained Infection Used for Assessment of Potential Treatments Aimed at Providing Survival Advantage Under Conditions of Sepsis/Septic Shock

The experiments outlined in Example 7 show that treatment with an antibiotic such as ceftriaxone can contain infection derived from high bacterial load in the immunocompromised mouse model. The experiments outlined below were performed to determine the ability of several different treatments to confer a survival advantage to mice in the context of the immunocompromised, infection-contained background. The following general experimental procedure was employed in all of the experiments with potential sepsis treatments described in this example.

Mice were pouched six days and irradiated five days before infection. Eight- to 12-week-old C3H/HeN mice were anesthetized with isofluorane and wiped with alcohol in the area caudal to their ears. Pouches were created at this site by subcutaneous injection of 2-3 ml of air, followed by the subcutaneous injection of 0.2 ml of a 0.5% solution of croton oil in olive oil. Twenty-four hours later, mice were irradiated using a gamma irradiator. Five days after irradiation, animals were infected with E. coli strain Bort by direct injection of the bacterial suspension into the pouches. After infection, animals were treated as described for each individual experiment. Animals were checked daily for signs of pain and distress, including diarrhea, lethargy, ruffled fur, lack of appetite, and poor body condition. Animals were euthanized when they became very lethargic and unable to move when touched. It was previously determined that when mice reach such conditions they will die within 6-8 hours.

Testing with Ethyl Pyruvate:

It is known that ethyl pyruvate (EP) improves survival in animal models of cecal ligation and puncture (CLP)-induced sepsis and mesenteric ischemia-reperfusion. Ethyl pyruvate is also known to be an antioxidant, a reactive oxygen species scavenger, and an anti-inflammatory agent by virtue of its ability to inhibit NF-kB activation. Treatment with ethyl pyruvate and ceftriatxone was tested for its ability to confer a survival advantage in the immunocompromised mouse model.

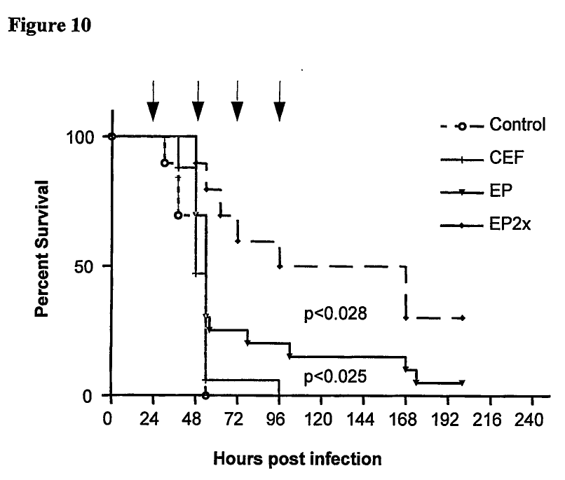

Mice were pouched and irradiadiated as described above. The mice were assigned to four different groups: (1) ten mice were untreated (control mice); (2) nineteen mice were treated with 0.1 mg/mouse of ceftriaxone (CEF) once every 24 hours for days (saline control mice); (3) twenty mice were treated with 0.1 mg/mouse ceftriaxone and 35 mg/ml ethyl pyruvate once every 24 hours for four days (EP mice); and (4) ten mice were treated as for group (3) and received an additional injection of 35 mg/ml of EP at 30 and 54 hour timepoints (EP 2x mice). The data provided in Table 20 below and depicted in FIG. 10 indicates that treatment with ethyl pyruvate confers a significant survival advantage to immunocompromised, infected mice relative to nontreated or CEF-treated controls.

TABLE 20

| | | | Bacterial | | Time | |
|---|---|---|---|---|---|---|
| Group No | Bad | Treatment | Counts | Status | death | Status.dead |
| 1 | 0 | No | 4.0E+08 | 1 | 30 | DEAD |
| 1 | 0 | No | 1.3E+05 | 1 | 38 | DEAD |
| 1 | 0 | No | 2.5E+05 | 1 | 38 | DEAD |
| 1 | 0 | No | 2.2E+04 | 1 | 54 | DEAD |
| 1 | 0 | No | 3.0E+04 | 1 | 54 | DEAD |
| 1 | 0 | No | 4.2E+04 | 1 | 54 | DEAD |
| 1 | 0 | No | 5.0E+04 | 1 | 54 | DEAD |
| 1 | 0 | No | 6.4E+04 | 1 | 54 | DEAD |
| 1 | 0 | No | 1.0E+05 | 1 | 54 | DEAD |
| 1 | 0 | No | 1.0E+05 | 1 | 54 | DEAD |
| 2 | 0 | Saline | 1.0E+05 | 1 | 38 | DEAD |
| 2 | 0 | Saline | 2.0E+05 | 1 | 38 | DEAD |
| 2 | 0 | Saline | 2.3E+04 | 1 | 48 | DEAD |
| 2 | 0 | Saline | 2.5E+04 | 1 | 48 | DEAD |
| 2 | 0 | Saline | 3.0E+04 | 1 | 48 | DEAD |
| 2 | 0 | Saline | 8.0E+04 | 1 | 48 | DEAD |
| 2 | 1 | Saline | 8.0E+04 | 1 | 48 | DEAD |
| 2 | 0 | Saline | 1.6E+05 | 1 | 48 | DEAD |
| 2 | 0 | Saline | 3.0E+05 | 1 | 48 | DEAD |
| 2 | 0 | Saline | 7.0E+03 | 1 | 54 | DEAD |
| 2 | 0 | Saline | 1.1E+04 | 1 | 54 | DEAD |
| 2 | 0 | Saline | 1.5E+04 | 1 | 54 | DEAD |
| 2 | 0 | Saline | 1.6E+04 | 1 | 54 | DEAD |
| 2 | 0 | Saline | 1.8E+04 | 1 | 54 | DEAD |
| 2 | 0 | Saline | 3.4E+04 | 1 | 54 | DEAD |
| 2 | 0 | Saline | 1.0E+05 | 1 | 54 | DEAD |
| 2 | 0 | Saline | 2.7E+05 | 1 | 96 | DEAD |
| 3 | 0 | EP | 1.0E+04 | 1 | 48 | DEAD |
| 3 | 1 | EP | 3.0E+04 | 1 | 48 | DEAD |
| 3 | 0 | EP | 1.2E+05 | 1 | 48 | DEAD |
| 3 | 0 | EP | 2.0E+05 | 1 | 48 | DEAD |
| 3 | 0 | EP | 2.0E+05 | 1 | 48 | DEAD |
| 3 | 0 | EP | 3.0E+05 | 1 | 48 | DEAD |
| 3 | 0 | EP | 1.3E+04 | 1 | 54 | DEAD |
| 3 | 0 | EP | 2.5E+04 | 1 | 54 | DEAD |
| 3 | 0 | EP | 3.5E+04 | 1 | 54 | DEAD |
| 3 | 0 | EP | 6.5E+04 | 1 | 54 | DEAD |
| 3 | 0 | EP | 7.6E+04 | 1 | 54 | DEAD |
| 3 | 0 | EP | 8.0E+04 | 1 | 54 | DEAD |
| 3 | 0 | EP | 2.0E+05 | 1 | 54 | DEAD |
| 3 | 1 | EP | 3.0E+05 | 1 | 54 | DEAD |
| 3 | 1 | EP | 1.2E+04 | 1 | 56 | DEAD |
| 3 | 1 | EP | 2.0E+03 | 1 | 78 | DEAD |
| 3 | 0 | EP | 1.6E+03 | 1 | 102 | DEAD |
| 3 | 0 | EP | 1.6E+03 | 1 | 168 | DEAD |
| 3 | 0 | EP | 1.6E+04 | 1 | 174 | DEAD |
| 3 | 0 | EP | 4.0E+04 | 0 | 174 | ALIVE |
| 4 | 0 | EP 2x | 2.0E+05 | 1 | 48 | DEAD |
| 4 | 0 | EP 2x | 5.0E+04 | 1 | 54 | DEAD |
| 4 | 0 | EP 2x | 3.0E+04 | 1 | 62 | DEAD |
| 4 | 0 | EP 2x | 5.0E+04 | 1 | 72 | DEAD |
| 4 | 0 | EP 2x | 1.0E+04 | 1 | 96 | DEAD |
| 4 | 0 | EP 2x | 1.7E+03 | 1 | 168 | DEAD |
| 4 | 0 | EP 2x | 3.0E+04 | 1 | 168 | DEAD |
| 4 | 0 | EP 2x | 0.0E+00 | 0 | 174 | ALIVE |
| 4 | 0 | EP 2x | 1.0E+03 | 0 | 174 | ALIVE |
| 4 | 0 | EP 2x | 2.4E+03 | 0 | 174 | ALIVE |

Treatment with Anti-VEGF Antibody:

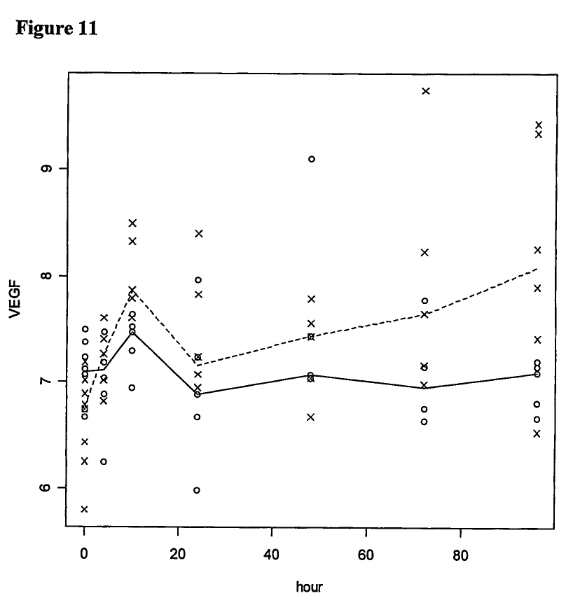

VEGF is known to be a potent vascular permeability factor, inducing adema, hypotension via induction of iNOS, which results in the production of nitrous oxide (NO), and poor tissue perfusion. VEGF was also found to be elevated in doomed immunocompromised animals (see FIG. 11).

To determine if high plasma levels of VEGF contribute to the morbidity of sepsis and lead to septic shock, four different experiments were carried out using the inventive mouse model. The protocols for each experiment are described below and summarized in Table 21.

TABLE 21
Experiments A, B, C, and D

| Exp. A | 24 hr. | 48 hr. | 72 hr. | 96 hr. | 120 hr. |
|---|---|---|---|---|---|
| Control Group (24) | Control Ab + Cef | Control Ab | Control Ab + Cef | Control Ab | |
| Treatment Group (21) | anti VEGF + Cef | anti VEGF | anti VEGF + Cef | anti-VEGF | |
| Exp. B | 24 hr. | 48 hr. | 72 hr. | 96 hr. | 120 hr. |
| Control Group (29) | 1. Control Ab + Cef (10) | 1. Control Ab | 1. Control Ab | 1. Control Ab | 1. Control Ab |
| | 2. Control Ab (19) | 2. Control Ab + Cef | 2. Control Ab | 2. Control Ab | 2. Control Ab |
| Treatment Group (31) | 1. anti-VEGF + Cef (10) | 1. anti-VEGF | 1. anti-VEGF | 1. anti-VEGF | 1. anti-VEGF |
| | 2. anit-VEGF (21) | 2. anti-VEGF + Cef | 2. anti-VEGF | 2. anti-VEGF | 2. anti-VEGF |
| Exp. C | 4 hr. | 48 hr. | 72 hr. | 96 hr. | 120 hr. |
| Control Group (16) | Control Ab | Control Ab + Cef | | | |
| Treatment Group (16) | anti-VEGF | anti-VEGF + Cef | | | |
| Exp. D | 12 hr. | 36 hr. | 72 hr. | 96 hr. | 120 hr. |
| Control Group (20) | Control Ab | Control Ab + Cef | | | |
| Treatment Group (20) | anti-VEGF | anti-VEGF + Cef | | | |

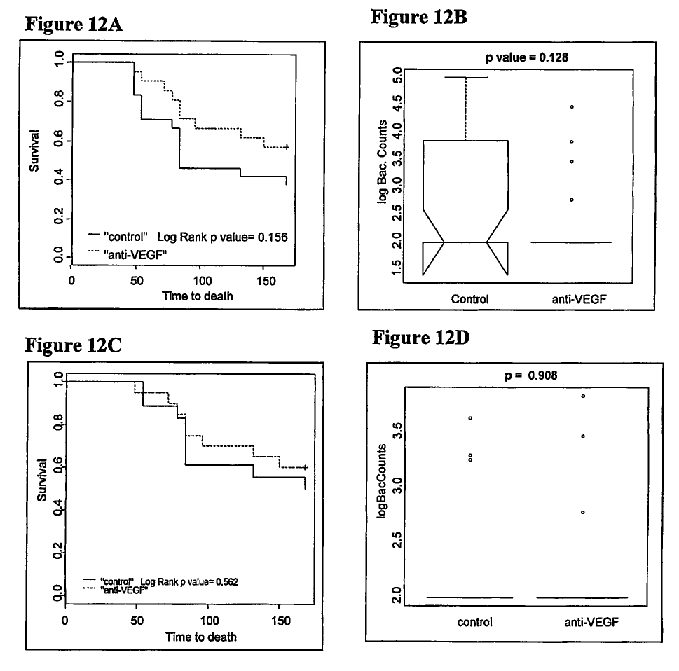

Experiment A: Using the procedure described above, 45 mice were pouched, irradiated (495 rads) and infected (0.2 ml of 0.1 OD 600). The animals were randomly assigned to control and treatment groups. The animals in the treatment group received daily treatment with anti-VEGF antibody (goat anti-mouse VEGF neutralizing antibody; R&D Systems, Inc. Catalog# AF-493-NA), while the control group received daily treatment of isotype control antibody (starting at 24 hours and for 4 days). Antibodies were injected at the concentration of 250 μg/mouse. At 24 and 72 hours, injected solutions contained ceftriaxone to yield a dose of 100 μg/mouse. Animals were bled at 24 hours after infection and before treatment. Blood was used to determine bacterial counts and to prepare plasma. Plasma aliquots were stored at −80 C. The results are provided in Table 22 and are graphically represented in FIGS. 12A-12D. The survival difference between the control and treatment groups is depicted in FIG. 12A. As apparent from the results, there is no significant difference in terms of bacterial count (FIG. 12B) and health between the two groups. FIGS. 12C and 12D show similar plots, but which exclude data for animals with bacterial counts >10⁴.

TABLE 22

| AnimalNo | CageNo | Time.ED | Status.dead | Treatment | HealthStatus.24am | logBacCounts |
|---|---|---|---|---|---|---|
| 8120 | 38.1 | 84 | 1 | C | 1 | 4.079181246 |
| 8121 | 38.1 | 168 | 1 | C | 1 | 2 |
| 8124 | 38.1 | 168 | 0 | C | 1 | 2 |
| 8125 | 38.2 | 168 | 0 | C | 1 | 2 |
| 8127 | 38.2 | 48 | 1 | C | 2 | 4.544068044 |
| 8128 | 38.2 | 168 | 0 | C | 1 | 2 |
| 8129 | 38.2 | 168 | 0 | C | 1 | 3.301029996 |
| 8130 | 38.3 | 96 | 1 | T | 1 | 2 |
| 8131 | 38.3 | 168 | 0 | T | 2 | 3.477121255 |
| 8132 | 38.3 | 84 | 1 | T | 1 | 2 |
| 8133 | 38.3 | 168 | 0 | T | 1 | 2 |
| 8134 | 38.3 | 150 | 1 | T | 2 | 2.77815125 |
| 8135 | 38.4 | 84 | 1 | C | 1 | 2 |
| 8136 | 38.4 | 54 | 1 | C | 2 | 4.397940009 |
| 8137 | 38.4 | 54 | 1 | C | 2 | 3.255272505 |
| 8138 | 38.4 | 54 | 1 | C | 2 | 3.643452676 |
| 8139 | 38.4 | 168 | 0 | C | 1 | 2 |
| 8140 | 38.5 | 132 | 1 | T | 2 | 2 |
| 8141 | 38.5 | 84 | 1 | T | 2 | 2 |
| 8142 | 38.5 | 48 | 1 | T | 2.5 | 3.84509804 |
| 8143 | 38.5 | 168 | 0 | T | 1 | 2 |
| 8144 | 38.6 | 84 | 1 | C | 1 | 2 |
| 8145 | 38.6 | 84 | 1 | C | 1 | 2 |
| 8146 | 38.6 | 48 | 1 | C | 2 | 4.301029996 |
| 8147 | 38.6 | 168 | 0 | C | 1 | 2 |
| 8148 | 38.6 | 132 | 1 | C | 1 | 2 |
| 8149 | 38.7 | 168 | 0 | T | 1 | 2 |
| 8150 | 38.7 | 168 | 0 | T | 1 | 2 |
| 8151 | 38.7 | 168 | 0 | T | 1 | 2 |
| 8152 | 38.7 | 168 | 0 | T | 1 | 2 |
| 8153 | 38.7 | 168 | 0 | T | 1 | 2 |
| 8154 | 38.8 | 168 | 0 | C | 1 | 2 |
| 8155 | 38.8 | 84 | 1 | C | 1 | 2 |
| 8156 | 38.8 | 48 | 1 | C | 3 | 5 |
| 8157 | 38.8 | 48 | 1 | C | 2 | 4.740362689 |
| 8159 | 38.9 | 168 | 0 | T | 1 | 2 |
| 8160 | 38.9 | 54 | 1 | T | 3 | 4.477121255 |
| 8162 | 38.9 | 168 | 0 | T | 1 | 2 |
| 8163 | 38.9 | 168 | 0 | T | 2 | 2 |
| 8164 | 38.1 | 78 | 1 | T | 1 | 2 |
| 8166 | 38.1 | 72 | 1 | T | 1 | 2 |
| 8167 | 38.1 | 168 | 0 | T | 1 | 2 |
| 8168 | 38.11 | 168 | 0 | C | 1 | 2 |
| 8169 | 38.11 | 168 | 0 | C | 1 | 2 |
| 8170 | 38.11 | 78 | 1 | C | 1 | 2 |

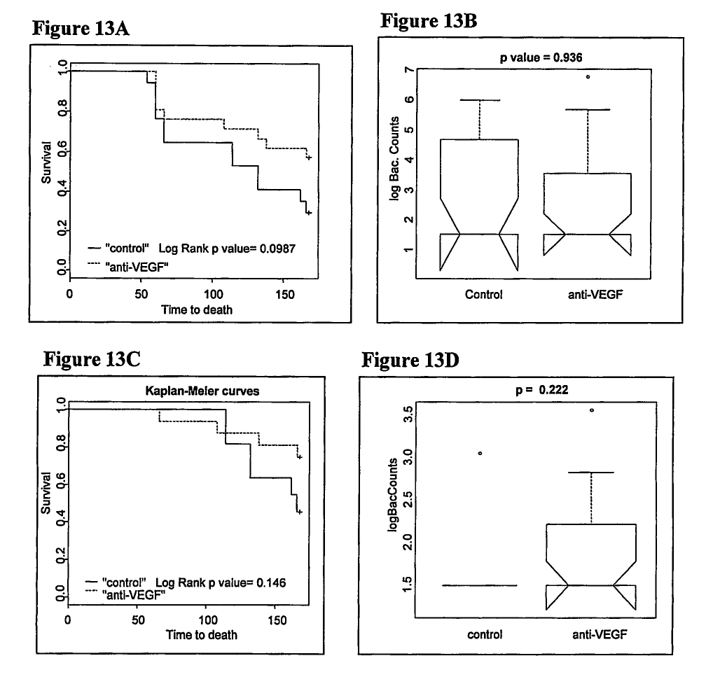

Experiment B: Using the procedure described above, 60 mice were pouched, irradiated (495 rads) and infected (0.2 ml of 0.1 OD 600). The animals were randomly assigned to control and treatment groups. Controls received 250 μg/mouse of isotype control and treated received 250 μg/mouse of anti-VEGF antibody. At 24 h, 10 of the 30 animals (sickest animals) in each group were bled and injected with the appropriate solution containing ceftriaxone (Group 1). The remaining 20 animals per group were injected with the antibodies, but without ceftriaxone (Group 2). At 48 hours, Group 1 animals received antibody and no ceftriaxone, while Group 2 animals were bled and received antibody and ceftriaxone. All animals were injected with antibodies daily for a total of 5 days. Blood was used to determine bacterial counts and to prepare plasma. Plasma aliquots were stored at −80° C. The results are provided in Table 23 and are depicted in FIGS. 13A-13D. Results obtained from animals that received ceftriaxone at 48 hours are shown. The survival difference between the control and treatment groups is depicted in FIG. 13A. There is no significant difference in terms of bacterial count (FIG. 13B) and health between the two groups. FIGS. 13C and 13D show similar plots, but which exclude animals with bacterial counts >10⁴.

TABLE 23

| AnimalNo | CageNo | Time.ED | Status.dead | logBacCounts | Treatment | HealthStatus.24am | Cef |
|---|---|---|---|---|---|---|---|
| 8195 | 40.1 | 78 | 1 | 1.51851394 | C | 2 | 24 |
| 8196 | 40.1 | 54 | 1 | 1.819543936 | C | 1 | 24 |
| 8197 | 40.1 | 168 | 0 | 1.51851394 | C | 1 | 24 |
| 8198 | 40.1 | 168 | 0 | 1.51851394 | C | 1 | 24 |
| 8199 | 40.1 | 162 | 1 | 1.51851394 | C | 1 | 24 |
| X33 | 40.2 | 168 | 0 | 1.51851394 | T | 1 | 48 |
| X34 | 40.2 | 168 | 0 | 1.51851394 | T | 1 | 48 |
| X35 | 40.2 | 162 | 1 | 2 | T | 2 | 24 |
| X36 | 40.2 | 54 | 1 | 3.544068044 | T | 2 | 24 |
| X37 | 40.2 | 168 | 0 | 1.51851394 | T | 1 | 48 |
| X38 | 40.3 | 132 | 1 | 1.51851394 | C | 1 | 48 |
| X39 | 40.3 | 54 | 1 | 3.84509804 | C | 2 | 24 |
| X40 | 40.3 | 108 | 1 | 1.51851394 | C | 2 | 24 |
| X41 | 40.3 | 60 | 1 | 4.568201724 | C | 1 | 48 |
| X42 | 40.3 | 66 | 1 | 4.903089987 | C | 1 | 48 |
| X43 | 40.4 | 66 | 1 | 2 | T | 2 | 24 |
| X44 | 40.4 | 168 | 0 | 1.51851394 | T | 1 | 24 |
| X45 | 40.4 | 108 | 1 | 2 | T | 1 | 24 |
| X46 | 40.4 | 168 | 0 | 1.819543936 | T | 1 | 24 |
| X47 | 40.4 | 90 | 1 | 1.51851394 | T | 1 | 24 |
| X48 | 40.5 | 168 | 0 | 1.51851394 | C | 1 | 48 |
| X49 | 40.5 | 138 | 1 | 3.903089987 | C | 2 | 24 |
| X50 | 40.5 | 114 | 1 | 3.079181246 | C | 1 | 48 |
| X51 | 40.5 | 168 | 0 | 1.51851394 | C | 1 | 48 |
| X52 | 40.5 | 48 | 1 | 5.176091259 | C | 2 | 24 |
| X53 | 40.6 | 60 | 1 | 5.698970004 | T | 1 | 48 |
| X54 | 40.6 | 168 | 0 | 1.51851394 | T | 1 | 48 |
| X55 | 40.6 | 168 | 0 | 1.51851394 | T | 1 | 48 |
| X56 | 40.6 | 54 | 1 | 3.568201724 | T | 2 | 24 |
| X57 | 40.6 | 138 | 1 | 1.51851394 | T | 1 | 48 |
| X58 | 40.7 | 54 | 1 | 4.012837225 | C | 2 | 24 |
| X59 | 40.7 | 168 | 0 | 1.51851394 | C | 1 | 48 |
| X60 | 40.7 | 132 | 1 | 1.51851394 | C | 1 | 48 |
| X61 | 40.7 | 168 | 0 | 1.51851394 | C | 1 | 48 |
| X62 | 40.7 | 114 | 1 | 1.51851394 | C | 1 | 48 |
| X63 | 40.8 | 60 | 1 | 6.77815125 | T | 1 | 48 |
| X64 | 40.8 | 168 | 0 | 1.51851394 | T | 1 | 48 |
| X66 | 40.8 | 84 | 1 | 2.698970004 | T | 2 | 24 |
| X67 | 40.8 | 60 | 1 | 4.84509804 | T | 1 | 48 |
| X68 | 40.9 | 66 | 1 | 4.698970004 | C | 1 | 48 |
| X69 | 40.9 | 166 | 1 | 1.51851394 | C | 1 | 48 |
| X70 | 40.9 | 48 | 1 | | C | 1 | dead.48 |
| X71 | 40.9 | 168 | 0 | 1.51851394 | C | 1 | 48 |
| X72 | 40.9 | 54 | 1 | 6 | C | 1 | 48 |
| X73 | 40.1 | 168 | 0 | 2.84509804 | T | 1 | 48 |
| X74 | 40.1 | 168 | 0 | 1.51851394 | T | 1 | 48 |
| X75 | 40.1 | 60 | 1 | 4.77815125 | T | 1 | 48 |
| X76 | 40.1 | 108 | 1 | 2 | T | 1 | 48 |
| X77 | 40.1 | 166 | 1 | 1.51851394 | T | 1 | 48 |
| X78 | 40.11 | 162 | 1 | 1.51851394 | C | 1 | 48 |
| X79 | 40.11 | 60 | 1 | 5.301029998 | C | 1 | 48 |
| X80 | 40.11 | 60 | 1 | 5.602059991 | C | 1 | 48 |
| X81 | 40.11 | 48 | 1 | | C | 1 | dead.48 |
| X83 | 40.12 | 132 | 1 | 4.230448921 | T | 1 | 48 |
| X84 | 40.12 | 168 | 0 | 2.477121255 | T | 1 | 48 |
| X85 | 40.12 | 168 | 0 | 1.51851394 | T | 1 | 48 |
| X86 | 40.12 | 168 | 0 | 1.51851394 | T | 1 | 48 |
| X90 | 40.13 | 66 | 1 | 3.579783597 | T | 1 | 48 |
| X91 | 40.13 | 168 | 0 | 2.84509804 | T | 1 | 48 |
| X92 | 40.13 | 48 | 1 | 5 | T | 2 | 24 |

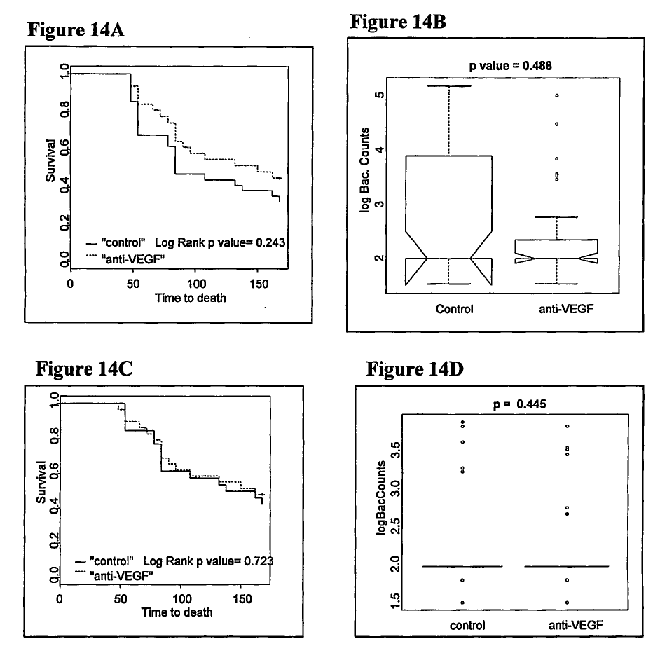

FIGS. 14A-14D shows plots of the combined data for animals that received ceftriaxone from experiments A and B above. The survival difference between the combined control and treatment groups is depicted in FIG. 14A. There is no difference in terms of bacterial count (FIG. 14B) and health between the two groups. FIGS. 14C and 14D show similar plots, but which exclude animals with bacterial counts >10⁴.

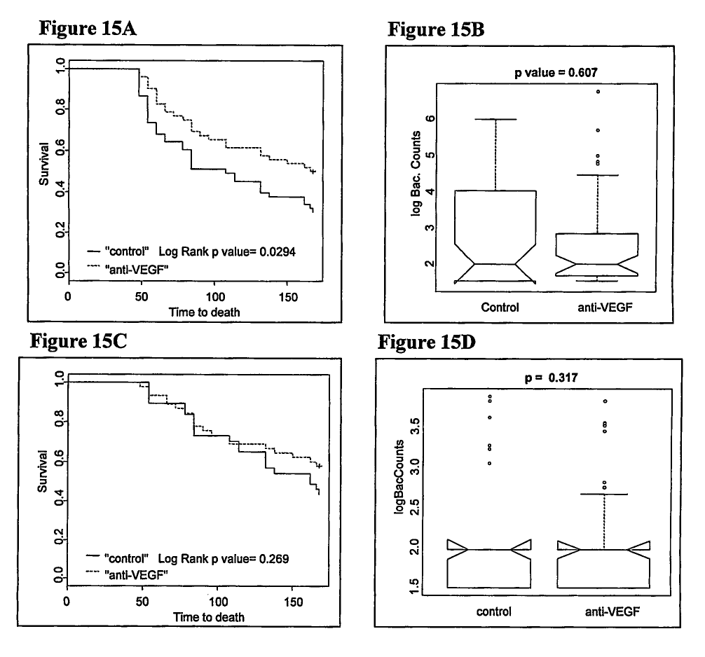

FIGS. 15A-15D shows plots of the combined data for all animals used in experiments A and B above. The survival difference between the combined control and treatment groups is depicted in FIG. 15A. There is no difference in terms of bacterial count (FIG. 15B) and health between the two groups. FIGS. 15C and 15D show similar plots, but which exclude data for animals with bacterial counts >10⁴.

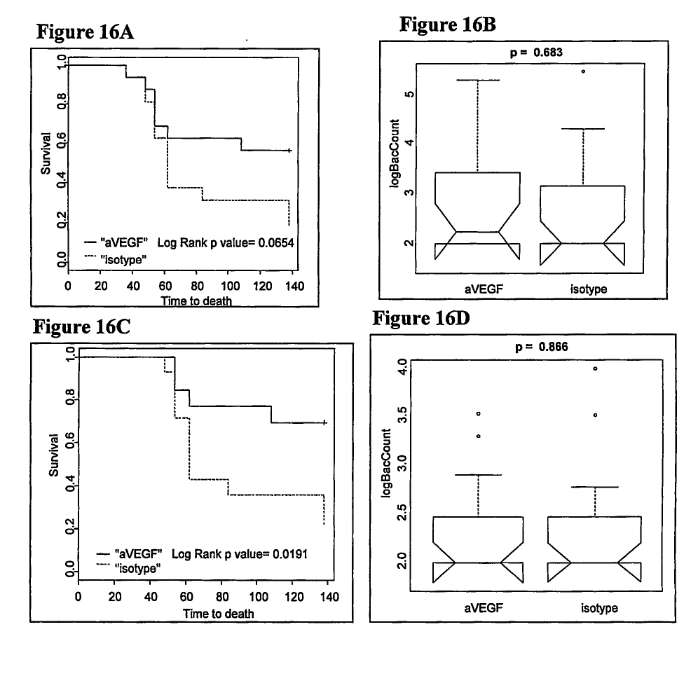

Experiment C: Using the procedure described above, 32 mice were pouched, irradiated (495 rads) and infected (0.2 ml of 0.1 OD 600). The animals were randomly assigned to control and treatment groups. Four hours after infection, controls received 250 μg/mouse of isotype control and treated received 250 μg/mouse of anti-VEGF antibody. At 24 h after infection animals were bled. At 30 h after infections all animals were injected with saline. At 48 h after infection animals were injected with the respective antibody solutions containing ceftriaxone at a concentration to yield 0.1 mg/mouse. At 53 h animals were bled. Blood was used to determine bacterial counts and to prepare plasma. Plasma aliquots were stored at −80 C. The results are provided in Table 24 and are graphically represented in FIGS. 16A-16D. In particular, the survival difference between the control and treatment groups is depicted in FIG. 16A. There is no difference in terms of bacterial count (FIG. 16B) and health between the two groups. FIGS. 16C and 16D show similar plots, but which exclude animals with bacterial counts >10⁴.

TABLE 24

| AnimalNo | CageNo | Infection | Time.dead | Status.dead | Treatment | Score.d1.am | cumWL.d1 | logBacCount.d1 |
|---|---|---|---|---|---|---|---|---|
| 1526 | 1 | YES | 54 | 1 | isotype | 1 | −4.608294931 | 2 |
| 1527 | 1 | YES | 138 | 0 | aVEGF | 1 | −4.545454545 | 2 |
| 1528 | 1 | YES | 54 | 1 | aVEGF | 2 | −8.095238095 | 4.477121255 |
| 1529 | 1 | YES | 62 | 1 | isotype | 2 | −7.881773399 | 2.477121255 |
| 1530 | 1 | YES | 54 | 1 | isotype | 2 | −2.34741784 | 2 |
| 1531 | 2 | YES | 138 | 0 | aVEGF | 1 | −8.212560386 | 2 |
| 1532 | 2 | YES | 84 | 1 | isotype | 1 | −5.11627907 | 2.301029996 |
| 1533 | 2 | YES | 48 | 1 | aVEGF | 2 | −10.05025126 | 4.176091259 |
| 1534 | 2 | YES | 138 | 1 | isotype | 2 | −6.060606061 | 2 |
| 1535 | 2 | YES | 62 | 1 | isotype | 1 | −4.245283019 | 2 |
| 1536 | 3 | YES | 36 | 1 | aVEGF | 3.5 | −12.44019139 | 5.301029996 |
| 1537 | 3 | YES | 54 | 1 | isotype | 2 | −10.95238095 | 3.51851394 |
| 1538 | 3 | YES | 138 | 0 | aVEGF | 1 | −4.444444444 | 2 |
| 1539 | 3 | YES | 48 | 1 | isotype | 2 | −8.482142857 | 4 |
| 1540 | 3 | YES | 108 | 1 | aVEGF | 1 | −8.298755187 | 2.477121255 |
| 1541 | 4 | YES | 138 | 0 | aVEGF | 1.5 | −4.07239819 | 2 |
| 1542 | 4 | YES | 138 | 0 | isotype | 1 | −4.285714286 | 2 |
| 1543 | 4 | YES | 62 | 1 | isotype | 2 | −8.878504673 | 2.77815125 |
| 1544 | 4 | YES | 62 | 1 | aVEGF | 1.5 | −8.095238095 | 2.477121255 |
| 1545 | 4 | YES | 138 | 0 | aVEGF | 1.5 | −3.619909502 | 2 |
| 1546 | 5 | YES | 138 | 0 | isotype | 1.5 | −4.845814978 | 2 |
| 1547 | 5 | YES | 138 | 0 | aVEGF | 1 | −3.720930233 | 2 |
| 1548 | 5 | YES | 138 | 0 | isotype | 1 | −4.147465438 | 2 |
| 1549 | 5 | YES | 54 | 1 | aVEGF | 1 | −9.589041096 | 3.301029996 |
| 1550 | 5 | YES | 138 | 0 | aVEGF | 1 | −4.464285714 | 2.903089987 |
| 1651 | 6 | YES | 138 | 0 | aVEGF | 1.5 | −6.666666667 | 2 |
| 1652 | 6 | YES | 138 | 1 | isotype | 1 | −1.435406699 | 2 |
| 1653 | 6 | YES | 138 | 0 | aVEGF | 1.5 | −2.764976959 | 2 |
| 1654 | 6 | YES | 36 | 1 | isotype | 2.5 | −7.373271889 | 5.477121255 |
| 1655 | 6 | YES | 48 | 1 | isotype | 2 | −8.035714286 | 4.301029996 |
| 1656 | 7 | YES | 54 | 1 | aVEGF | 2 | −9.76744186 | 3.531478917 |
| 1657 | 7 | YES | 62 | 1 | isotype | 1 | −2.314814815 | 2 |

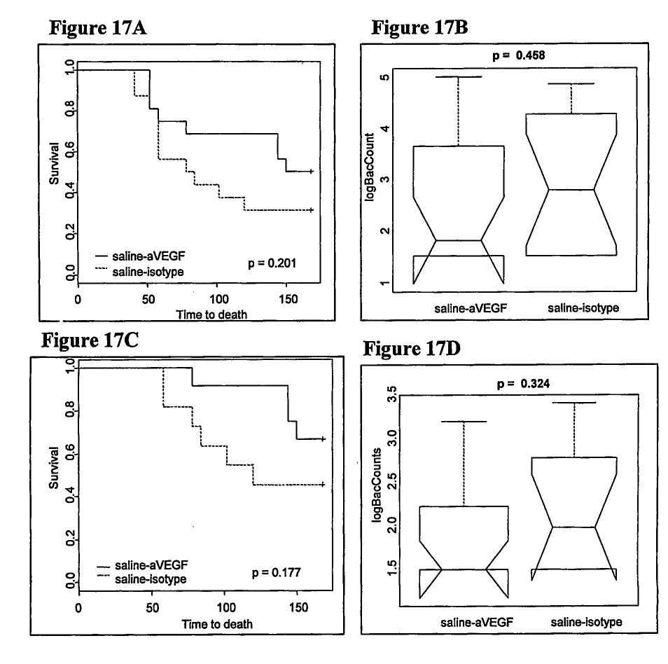

Experiment D: Using the procedure described above, 40 mice were pouched, irradiated (495 rads) and infected (0.2 ml of 0.1 OD 600). The animals were randomly assigned to control and treatment groups. Twelve hours after infection, controls received 250 μg/mouse of isotype control and treated received 250 μg/mouse of anti-VEGF antibody. At 24 h after infection, animals were bled. At 36 h after infection, animals were injected with the respective antibody solutions containing ceftriaxone at a concentration to yield 0.1 mg/mouse. Blood was used to determine bacterial counts and to prepare plasma. Plasma aliquots were stored at −80° C. The results are provided in Table 25 and are graphically represented in FIGS. 17A-17D. The survival difference between the control and treatment groups is depicted in FIG. 17A. There is no significant difference in terms of bacterial count (FIG. 17B) and health between the two groups. FIGS. 17C and 17D show similar plots, but which exclude animals with bacterial counts >10⁴.

TABLE 25

| | Time.- | | | HealthScore.- |
|---|---|---|---|---|
| Treatment2 | dead | Status.dead | logBacCount.d1 | d1.10am |
| aVEGF | 168 | 0 | 2.73E+00 | a |
| aVEGF | 168 | 0 | 1.52E+00 | a |
| aVEGF | 144 | 1 | 3.22E+00 | a |
| aVEGF | 168 | 0 | 1.52E+00 | a |
| aVEGF | 58 | 1 | 4.79E+00 | b |
| aVEGF | 144 | 1 | 1.52E+00 | a |
| aVEGF | 168 | 0 | 1.52E+00 | a |
| aVEGF | 78 | 1 | 2.12E+00 | a |
| aVEGF | 52 | 1 | 5.02E+00 | b-c |
| aVEGF | 52 | 1 | 4.08E+00 | b |
| aVEGF | 168 | 0 | 1.52E+00 | a |
| aVEGF | 168 | 0 | 2.37E+00 | a |
| aVEGF | 150 | 1 | 1.52E+00 | a |
| aVEGF | 168 | 0 | 1.52E+00 | a |
| aVEGF | 52 | 1 | 4.88E+00 | b-c |
| aVEGF | 168 | 0 | 1.52E+00 | a |
| isotype | 41 | 1 | 4.27E+00 | b |
| isotype | 41 | 1 | 4.88E+00 | b |
| isotype | 168 | 0 | 1.52E+00 | a |
| isotype | 168 | 0 | 2.12E+00 | a-b |
| isotype | 168 | 0 | 1.52E+00 | a |
| isotype | 58 | 1 | 4.29E+00 | b |
| isotype | 168 | 0 | 1.52E+00 | a |
| isotype | 120 | 1 | 1.52E+00 | b |
| isotype | 168 | 0 | 1.52E+00 | a |
| isotype | 78 | 1 | 3.43E+00 | b |
| isotype | 84 | 1 | 2.00E+00 | a |
| isotype | 58 | 1 | 4.70E+00 | b |
| isotype | 102 | 1 | 3.12E+00 | b |
| isotype | 52 | 1 | 4.40E+00 | b |
| isotype | 58 | 1 | 2.90E+00 | a |
| isotype | 58 | 1 | 2.70E+00 | b |

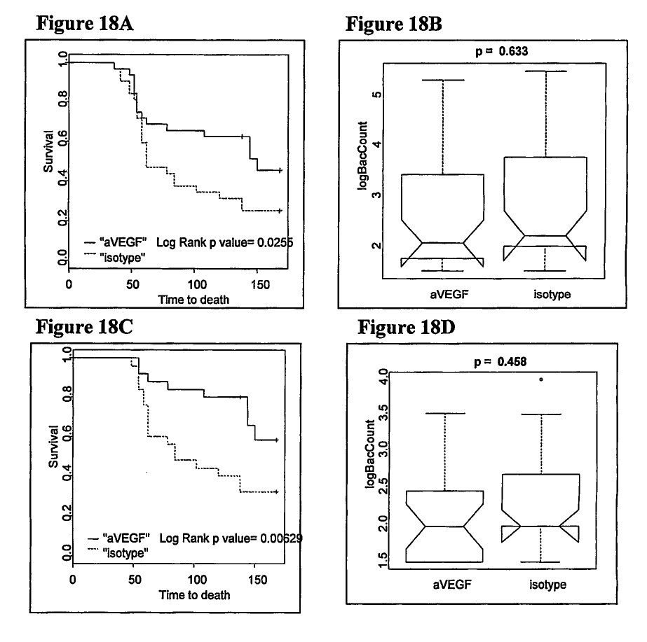

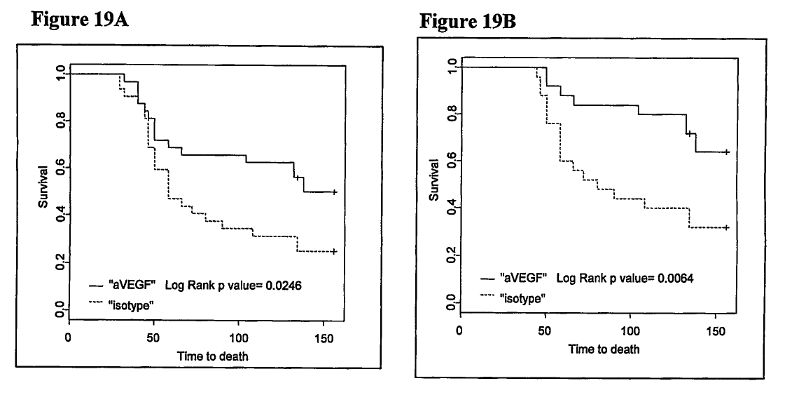

FIGS. 18A-18D depict plots of the combined data for animals that received anti-VEGF antibody or VEGF isotype control antibody treatment from Experiments C and D. The survival difference between the combined control and treatment groups is depicted in FIG. 18A. There is no significant difference in terms of bacterial count (FIG. 18B) and health between the two groups. FIGS. 18C and 18D show similar plots, but which exclude animals with bacterial counts >10⁴. FIGS. 19A-19B shows plots of the combined data for all animals used in experiments A and B above, but with the survival time considered to have started at the time of treatment rather than the time of infection.

Treatment with Anti-JE (MCP-1) Antibody:

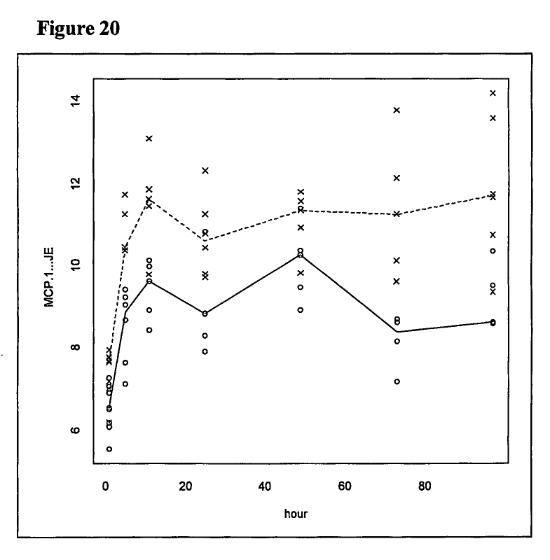

Previous experiments showed that treating septic animals with an anti-VEGF antibody improved their survival as compared to an untreated group. Similar to VEGF, experiments were conducted with anti-JE antibody, and JE (murine MCP-1) levels were found to be elevated in doomed, immunocompromised animals as compared to those animals that survived (FIG. 20).

The antibody was prepared as follows. Twenty-week old Sprague Dawley rats were immunized subcutaneously with rMuMCP-1 (R&D Systems, Inc. Cat# 479-JE/CFz). Each rat was injected with a 0.5 mL combination of rMuMCP-1, Benadryl (Sigma), and Freund's Adjuvant (Sigma) divided between 2 injection sites given intradermally (ID) and intraperitoneally (IP). The prescribed immunization protocol was for each rat to receive a total of 9 injections over a 9-month timeframe. The first and second injections consisted of 50 μg rMuMCP-1 in 250 μL PBS+36 μL Benadryl emulsified with an equal volume of Complete Freund's adjuvant. For the rest of the injections, each rat received 50 μg rMuMCP-1+Benadryl as before with the exception of Incomplete Freund's Adjuvant (see De St. Groth, F, S and D Scheidegger, Production of Monoclonal Antibody: Strategy and Tactics. Journal of Immunological Methods 35:1-21, 1980). The rats were bled at various time-points throughout the immunization schedule. Blood collections were performed by retro-orbital puncture and serum was collected, frozen, and shipped on dry ice for titer determination by solid phase EIA. Seven days following the 9^{th} injection, rats C73 and C74 were given a final IV booster injection of 10 μg rMuMCP-1 diluted in 120 μL PBS. Three days later the rats were euthanized by C0₂ asphyxiation, and the spleens aseptically removed and immersed in 10 mL cold PBS/PSA (PBS containing PSA which is 100 U/ml penicillin, 100 μg/ml streptomycin, and 0.25 μg/ml amphotericin B). The splenocytes were harvested by sterilely perfusing the spleen with cold perfusion medium (DMEM, 20% FBS, 1 mM sodium pyruvate, 4 mM L-glutamine, 1% MEM nonessential amino acids, and 1% Origen (IGEN)). The cells were enumerated on a Coulter counter, washed once, and resuspended in 10 mL perfusion medium.

The non-secreting mouse myeloma fusion partner, P3×63 Ag 8.653 (653), cell line was expanded in RPMI 1640 medium (JRH Biosciences) supplemented with 10% (v/v) FBS (Cell Culture Labs), 1 mM sodium pyruvate, 0.1 mM NEAA, 2 mM L-glutamine (all from JRH Biosciences) and cryopreserved in 95% FBS and 5% DMSO (Sigma), then stored in a vapor phase liquid nitrogen freezer. The cell bank was sterile and free of mycoplasma (Bionique Laboratories).

A cell bank of the non-secreting Balb/c mouse myeloma fusion partner FO was purchased from ATCC (# CRL-1646). One frozen vial of FO cells was thawed and resuspended in αMEM (modified) medium (JRH Biosciences) supplemented with 10% (v/v) FBS (Cell Culture Labs), 1 mM sodium pyruvate, 0.1 mM NEAA, 2 mM L-glutamine (all from JRH Biosciences). The cells were expanded, cryopreserved in 95% FBS and 5% DMSO (Sigma) and stored in a vapor phase liquid nitrogen freezer. The cell bank was sterile and free of mycoplasma (Bionique Laboratories).

Prior to fusion, myeloma cells were thawed and maintained at log phase in the media described above. On fusion day, the cells were washed in PBS, counted, and viability determined (>95%) via trypan blue dye exclusion.

Fusion was carried out at a 1:1 ratio of FO or 653 murine myeloma cells to viable spleen cells (Rat#C73 with FO, Rat#C74 with 653). Spleen and myeloma cells were mixed together and pelleted. The pellet was resuspended with 5 mL of 50% (w/v) PEG/PBS solution (using PEG molecular weight 1450 for rat #C74 fusion and PEG molecular weight 3000 for rat #C73) at 37° C. Cell fusion was allowed to occur for 2 minutes at 37° C. The fusion was stopped by slowly adding 25 mL DMEM (no additives) at 37° C. Fused cells were centrifuged for 5 minutes at 1000 rpm, drawn up into 25 mL pipette, and expelled into a 225 cm² flask (Costar, 431082) containing 240 mL of Fusion Medium (DMEM, 20% FBS, 1 mM sodium pyruvate, 4 mM L-glutamine, 1% MEM nonessential amino acids, 1% Origen, 25 μg/ml gentamicin, 100 μM hypoxanthine, 0.4 μM aminopterin, and 16 μM thymidine). The cells were allowed to sit for 4 hours at 37° C., an additional 360 mL of 37° C. Fusion Medium was added to the flask, the flask was swirled to resuspend the cells. The cells were then seeded at 200 μL/well in thirty 96-well flat bottom tissue culture plates (Costar, 3595) per fusion. The fusion plates were placed in a humidified 37° C. incubator at 5% CO₂ for 7-10 days. The media was changed by taking off 100 μl medium adding 100 μl HT medium after 7 days (5, 6).

Solid phase EIA was used to screen rat sera for antibodies specific for rMuMCP-1. Briefly, plates (Costar, 9018) were coated with rMuMCP-1 at 1 μg/mL in PBS, pH 7.4 on to 96-well EIA plates (Nunc) and incubated overnight at 4° C. The plates were then washed three times in 0.15 M saline with 0.02% v/v Tween 20, the wells were then blocked with 1% (w/v) BSA (Sigma) in PBS, 200 μL/well for 1 hour at 37° C. Plates were used immediately or frozen at −20° C. for future use. The diluted sera were incubated on the rMuMCP-1 coated plates at 50 μL/well at 37° C. for 0.5 hour. The plates were washed and then probed with 50 μL/well HRP-labeled goat anti-Rat IgG (Fc) specific antibody (Jackson Immune Research Cat#112-035-071) diluted 1:20,000 in 1% BSA-PBS for 30 minutes at 37° C. The plates were again washed and 100 μL/well of citrate-phosphate substrate solution (0.1M citric acid, 0.2M sodium phosphate, 0.01% H₂O₂, 1 mg/mL OPD (Sigma) was added for approximately 15 minutes at RT. The reaction was stopped by the addition of 25 μL/well, 4N H₂SO₄. The absorbance was measured at 490 nm by an automated plate spectrophotometer.

Hybridomas arising from the fusion of rat lymphocytes with murine myeloma cells were evaluated by EIA for their ability to secrete anti-MuMCP-1 antibodies. Briefly, plates were coated with rMuMCP-1 at 1 μg/mL in PBS overnight at 4° C., washed and blocked as above. Undiluted hybridoma supernatants were incubated on plates for 30 minutes at RT (room temperature). All fusion plates were tested. The plates were washed and then probed with 50 μL/well HRP-labeled goat anti-Rat IgG Fc specific antibody diluted 1:20,000 in 1% BSA-PBS for 30 minutes at 37° C. The plates were washed again and incubated with citrate-phosphate substrate solution as described above. Cells in positive wells were transferred to 24-well plates to increase cell numbers and later subcloned by limiting dilution.

Isotype determination of the antibodies was accomplished by use of Rat MonoAB ID/SP kit (Zymed Cat#93-9550) in EIA format Plates were coated at 50 μL/well overnight at 4° C. with rMuMCP-1 at 1 μg/ml in PBS, washed, and blocked as above. Spent supernatant from each Mab applied to 96-well plate at 50 μL/well. The plates were incubated at 37° C. for 30 minutes and then washed. Next, one drop of biotinylated antibody control or subclass specific biotinylated anti-rat immunoglobulin was added to each column, incubated at 37° C. for 30 minutes, and washed. Diluted HRP-Streptavidin {one drop concentrated conjugate/2.5 ml PBS-Tween (50 mM PBS+one drop of 50% Tween20 for every 50 ml buffer)} was added to all the wells and incubated at 37° C. for 30 minutes. Plates were again washed then incubated for 15 minutes at RT with 50 μL/well of citrate-phosphate substrate solution (0.1M citric acid and 0.2M sodium phosphate, 0.01% H₂O₂, and 1 mg/mL OPD). Substrate development was stopped by addition of 4N sulfuric acid at 50 μL/well and the absorbance was measured at 490 nm via an automated plate spectrophotometer.

During the time-course experiment, the increase in JE/MCP-1 levels from time 0 to 4 hours and time 0 to 10 hours after infection was higher in irradiated and infected animals (doomed) as compared to non-irradiated and infected animals (survivors). Also similar to VEGF, JE/MCP-1 has the ability to induce angiogenesis and vascular permeability. Finally, VEGF is known to induce JE/MCP-1 expression. Therefore, two experiments were performed to determine if neutralization of JE/MCP-1 improves survival of septic animals.

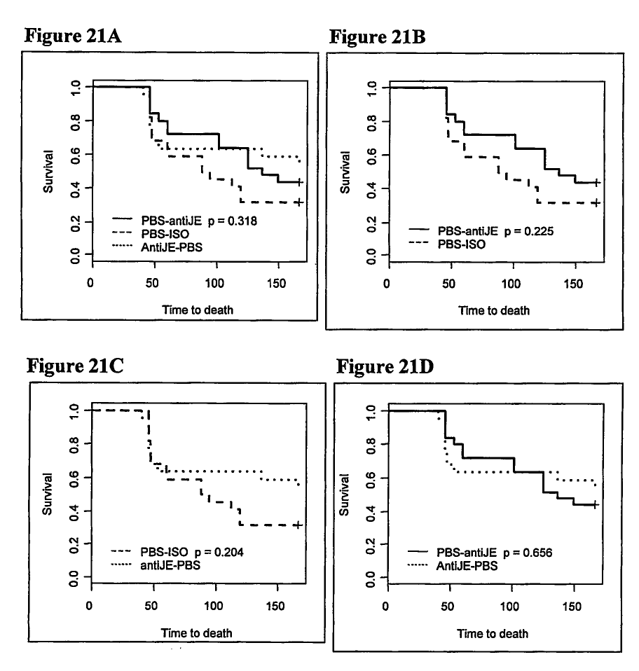

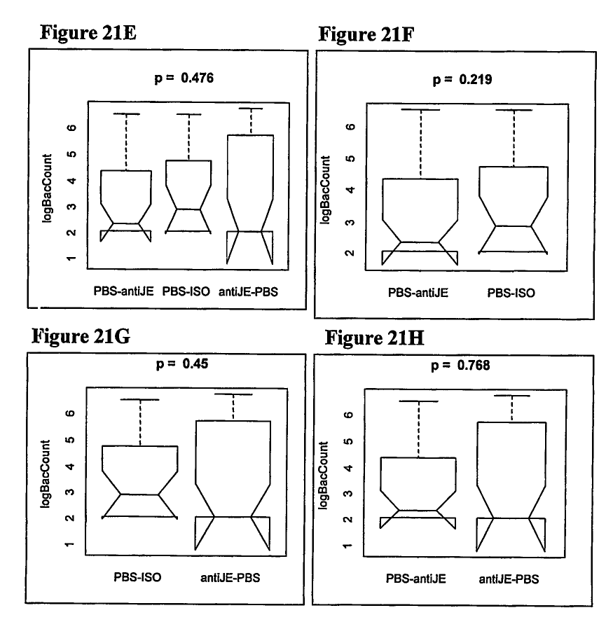

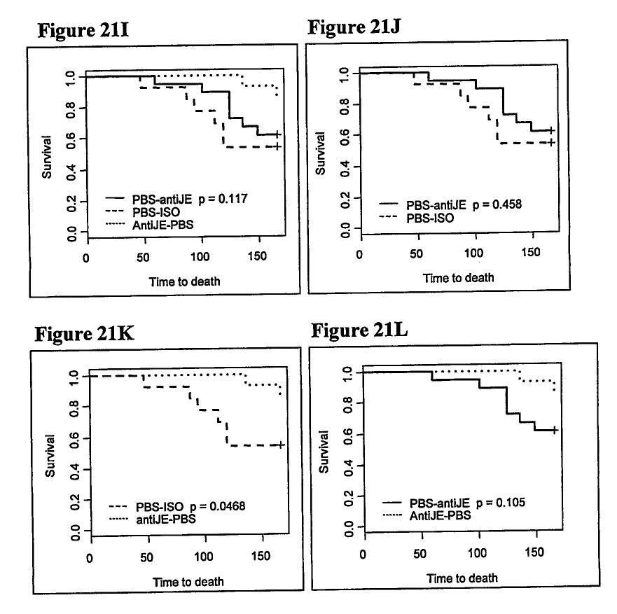

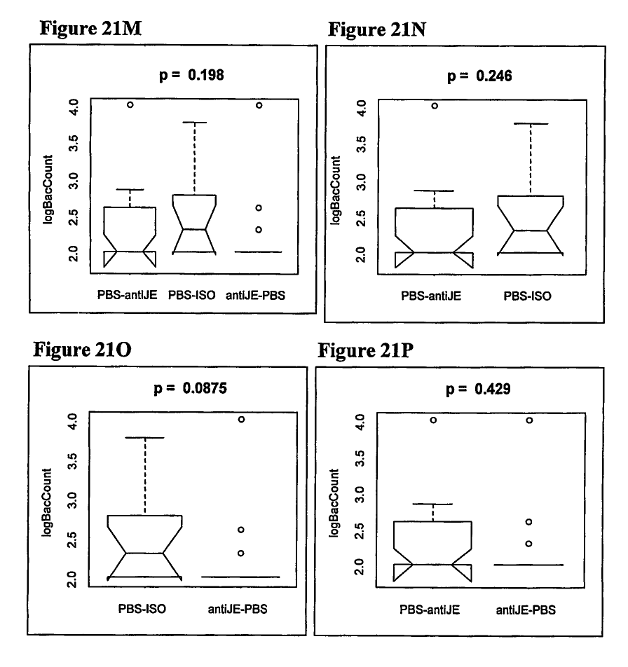

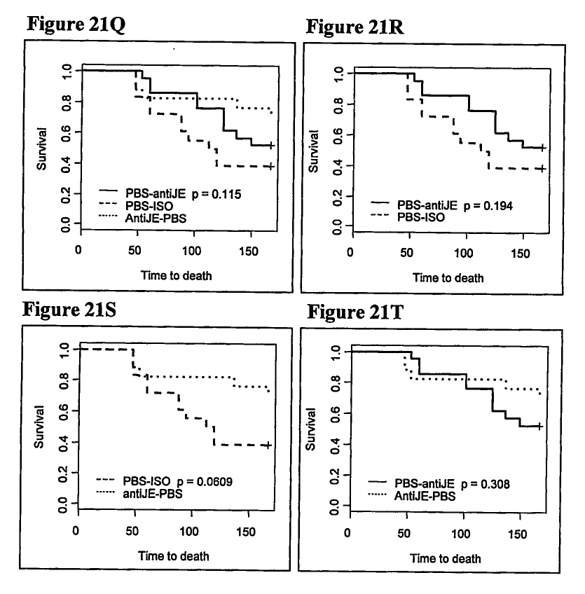

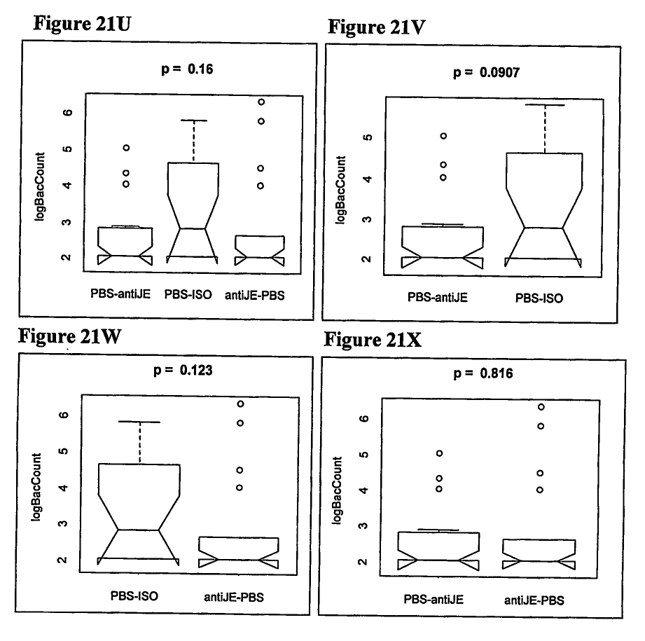

Experiment A: Using the procedure described above, 76 mice were pouched, irradiated (495 rads) and infected (0.2 ml of 0.1 OD 600). Sixteen hours after infection, animals were separated into treatment groups according to a computer-generated random sequence and were injected with 0.4 ml of PBS (Groups A and C) or 0.4 ml of an anti-MCP1/JE antibody (400 μg/mouse) in PBS (Group B). After 24 hours (40 hours post-infection), each animal was bled (150 μl/mouse in a capillary tube containing 20 μl EDTA) and injected as follows: Group A, 0.4 ml isotype control (450 μg/mouse in PBS); Group B, 0.4 ml PBS; and Group C, 0.4 ml of PBS containing 450 μg/mouse of anti-MCP1/JE. At 40 h after injection, all injections contained ceftriaxone to yield a dose of 100 μg/mouse. Blood was used to determine bacterial counts and to prepare plasma. Two aliquots of 20 μl and an extra aliquot were prepared and stored at −80° C. The results are provided in Table 26 and are graphically represented in FIGS. 21A-21X. FIGS. 21A-21H show plots of data from all animals used in experiment A. The survival differences among groups A, B, and C are depicted in FIG. 21A. The survival difference between groups A and C is depicted in FIG. 21B. The survival difference between groups A and B is depicted in FIG. 21C. The survival difference between groups B and C is depicted in FIG. 21D. There is no significant difference in terms of bacterial count and health between the three groups, as seen in FIGS. 21E-21H. FIGS. 21I-21L show plots of data from animals used in experiment A that had bacterial counts <10⁴. The survival differences among groups A, B, and C are depicted in FIG. 21I. The survival difference between groups A and C is depicted in FIG. 21J. The survival difference between groups A and B is depicted in FIG. 21K. The survival difference between groups B and C is depicted in FIG. 21L. There is no significant difference in terms of bacterial count and health between the three groups, as seen in FIGS. 21M-21P. FIGS. 21Q-21X show plots of data from animals used in experiment A that did not die and were not euthanized before the second treatment. The survival differences among groups A, B, and C are depicted in FIG. 21Q. The survival difference between groups A and C is depicted in FIG. 21R. The survival difference between groups A and B is depicted in FIG. 21S. The survival difference between groups B and C is depicted in FIG. 21T. There is no significant difference in terms of bacterial count and health between the three groups, as seen in FIGS. 21U-21X.

TABLE 26

| CageNo | AnimalNo | Bad | Treat1 | Treat2 | logBC | status | time | status.dead |
|---|---|---|---|---|---|---|---|---|
| 1 | 380 | 0 | anti-JE | PBS | 5.778151 | FD | 47 | 1 |
| 1 | 381 | 0 | anti-JE | PBS | 2 | LIVE | 166 | 0 |
| 1 | 498 | 0 | PBS | anti-JE | 2.30103 | LIVE | 166 | 0 |
| 1 | 499 | 0 | PBS | anti-JE | 2 | LIVE | 166 | 0 |
| 1 | 500 | 0 | PBS | anti-JE | 2.60206 | LIVE | 166 | 0 |
| 2 | 382 | 0 | PBS | ISO | 3.763428 | FD | 88 | 1 |
| 2 | 383 | 0 | PBS | ISO | 2.30103 | LIVE | 166 | 0 |
| 2 | 384 | 0 | PBS | ISO | 5.30103 | EU | 60 | 1 |
| 2 | 385 | 0 | PBS | anti-JE | 2 | LIVE | 166 | 0 |
| 2 | 386 | 0 | PBS | anti-JE | 2 | EU | 125 | 1 |
| 3 | 387 | 0 | PBS | ISO | 2 | LIVE | 166 | 0 |
| 3 | 388 | 0 | PBS | ISO | 2 | FD | 119 | 1 |
| 3 | 389 | 0 | anti-JE | PBS | 6.30103 | FD | 47 | 1 |
| 3 | 390 | 0 | anti-JE | PBS | 2 | LIVE | 166 | 0 |
| 3 | 391 | 0 | anti-JE | PBS | 2 | LIVE | 166 | 0 |
| 4 | 392 | 0 | PBS | ISO | 2 | LIVE | 166 | 0 |
| 4 | 393 | 1 | PBS | ISO | 2 | LIVE | 166 | 0 |
| 4 | 394 | 0 | PBS | ISO | 2 | LIVE | 166 | 0 |
| 4 | 395 | 0 | PBS | anti-JE | 2 | EU | 125 | 1 |
| 4 | 396 | 0 | PBS | anti-JE | 2.778151 | LIVE | 166 | 0 |
| 5 | 397 | 0 | anti-JE | PBS | 2 | LIVE | 166 | 0 |
| 5 | 398 | 0 | anti-JE | PBS | 2 | LIVE | 166 | 0 |
| 5 | 399 | 0 | anti-JE | PBS | 4 | LIVE | 166 | 0 |
| 5 | 400 | 0 | PBS | anti-JE | 4.30103 | EU | 53 | 1 |
| 5 | 402 | 0 | PBS | anti-JE | 4.30103 | EU | 101 | 1 |
| 6 | 404 | 0 | PBS | ISO | 3.653213 | FD | 112 | 1 |
| 6 | 406 | 0 | PBS | ISO | 2.477121 | LIVE | 166 | 0 |
| 6 | 407 | 0 | PBS | anti-JE | 2 | EU | 101 | 1 |
| 6 | 408 | 0 | PBS | anti-JE | 6.477121 | EU | 46 | 1 |
| 6 | 410 | 0 | PBS | anti-JE | 2 | EU | 149 | 1 |
| 7 | 411 | 1 | anti-JE | PBS | 3.812913 | EU | 101 | 1 |
| 7 | 412 | 0 | anti-JE | PBS | 5.69897 | EU | 46 | 1 |
| 7 | 413 | 0 | anti-JE | PBS | 4.477121 | EU | 53 | 1 |
| 7 | 414 | 0 | PBS | anti-JE | 5.60206 | EU | 46 | 1 |
| 7 | 415 | 0 | PBS | anti-JE | 5.477121 | EU | 46 | 1 |
| 8 | 416 | 0 | anti-JE | PBS | 2 | ED | 166 | 1 |
| 8 | 417 | 0 | anti-JE | PBS | 2.30103 | FD | 136 | 1 |
| 8 | 418 | 0 | anti-JE | PBS | 2 | LIVE | 166 | 0 |
| 8 | 419 | 0 | anti-JE | PBS | 2 | LIVE | 166 | 0 |
| 8 | 423 | 0 | anti-JE | PBS | 2 | LIVE | 166 | 0 |
| 9 | 421 | 0 | PBS | ISO | 2.778151 | LIVE | 166 | 0 |
| 9 | 422 | 0 | PBS | ISO | 5.30103 | FD | 47 | 1 |
| 9 | 420 | 1 | PBS | PBS | 5.30103 | EU | 53 | 1 |
| 9 | 424 | 1 | PBS | PBS | 2 | LIVE | 166 | 0 |
| 9 | 425 | 1 | PBS | PBS | 5.30103 | EU | 53 | 1 |
| 10 | 426 | 0 | PBS | ISO | 4.69897 | FD | 88 | 1 |
| 10 | 427 | 0 | PBS | ISO | 4.60206 | EU | 60 | 1 |
| 10 | 428 | 0 | anti-JE | PBS | 6.477121 | EU | 46 | 1 |
| 10 | 429 | 0 | anti-JE | PBS | | FD | 40 | 1 |
| 10 | 430 | 0 | anti-JE | PBS | 6.69897 | EU | 46 | 1 |
| 11 | 431 | 0 | PBS | ISO | 5.778151 | FD | 47 | 1 |
| 11 | 432 | 0 | PBS | ISO | 2 | FD | 119 | 1 |
| 11 | 433 | 0 | PBS | anti-JE | 4 | EU | 60 | 1 |
| 11 | 434 | 0 | PBS | anti-JE | 2 | LIVE | 166 | 0 |
| 11 | 435 | 0 | PBS | anti-JE | 2 | EU | 125 | 1 |
| 12 | 436 | 0 | PBS | ISO | 6.30103 | EU | 46 | 1 |
| 12 | 437 | 0 | PBS | ISO | 6.477121 | EU | 46 | 1 |
| 12 | 438 | 0 | PBS | ISO | 4.146128 | EU | 46 | 1 |
| 12 | 439 | 0 | PBS | anti-JE | 2 | LIVE | 166 | 0 |
| 12 | 440 | 0 | PBS | anti-JE | 2.69897 | LIVE | 166 | 0 |
| 13 | 441 | 0 | anti-JE | PBS | 2 | LIVE | 166 | 0 |
| 13 | 442 | 0 | anti-JE | PBS | 2.60206 | LIVE | 166 | 0 |
| 13 | 443 | 0 | PBS | anti-JE | 5 | EU | 60 | 1 |
| 13 | 444 | 0 | PBS | anti-JE | 2 | LIVE | 166 | 0 |
| 13 | 445 | 0 | PBS | anti-JE | 2 | LIVE | 166 | 0 |
| 14 | 446 | 0 | PBS | ISO | 2 | LIVE | 166 | 0 |
| 14 | 447 | 0 | PBS | ISO | 2.778151 | FD | 47 | 1 |
| 14 | 448 | 0 | PBS | ISO | 2.845098 | EU | 94 | 1 |
| 14 | 449 | 1 | anti-JE | anti-JE | 2 | LIVE | 166 | 0 |
| 14 | 405 | 1 | anti-JE | anti-JE | 2.30103 | EU | 149 | 1 |
| 15 | 450 | 0 | PBS | anti-JE | 2 | LIVE | 166 | 0 |
| 15 | 451 | 0 | PBS | anti-JE | 5.30103 | EU | 46 | 1 |
| 15 | 403 | 0 | PBS | anti-JE | 2.845098 | FD | 136 | 1 |
| 15 | 474 | 0 | anti-JE | PBS | 6.30103 | EU | 46 | 1 |
| 15 | 475 | 0 | anti-JE | PBS | 2 | LIVE | 166 | 0 |
| 16 | | 0 | PBS | ISO | | EU | 46 | 1 |

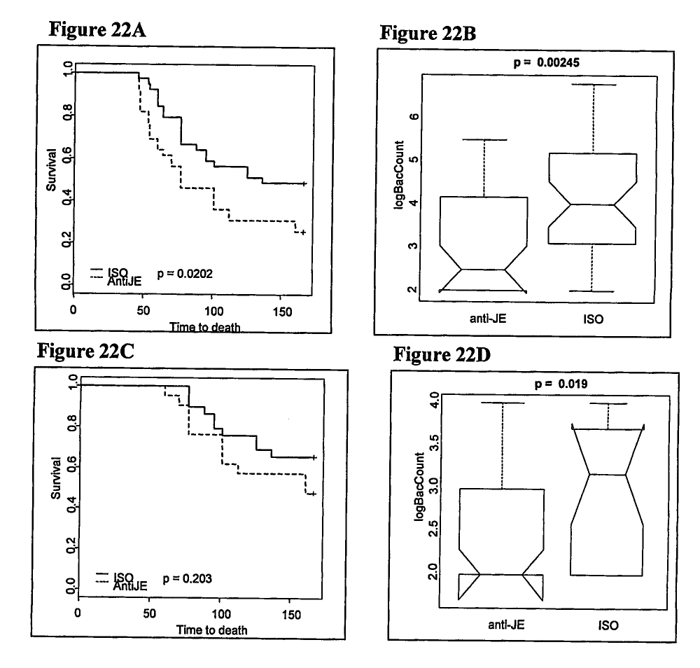

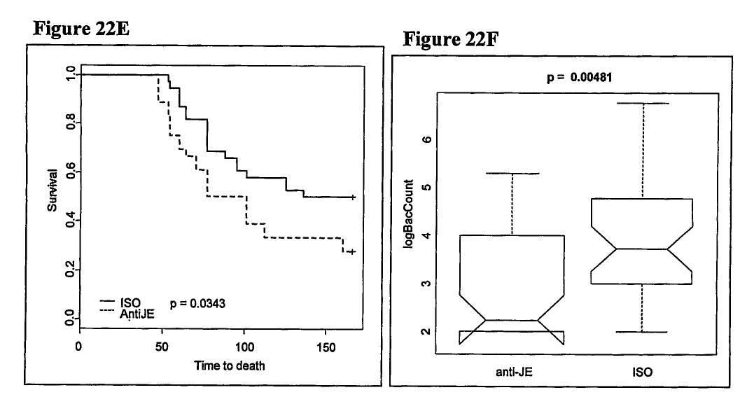

Experiment B: Using the procedure described above, eighty mice were pouched, irradiated (495 rads), and infected (0.2 ml of 0.1 OD 600 equivalent to 4-5×10⁶ CFU/mouse). Sixteen hours after infection, animals were separated into treatment groups according to a computer-generated random sequence and injected: for Group A, with 0.4 ml isotype as a control (450 μg/mouse in PBS); and for Group B, with 0.4 ml of PBS containing 450 μg/mouse of anti-MCP1/JE. After 24 hours (40 hours after infection), each animal was bled (150 μg/mouse in a capillary tube containing 20 μl EDTA) and injected with ceftriaxone (100 μg/mouse). Blood was used for determining bacterial counts and preparing plasma. Two aliquots of 20 μl of plasma and an extra aliquot were prepared and stored at −80° C. At 72-80 hours, some sick (c-d) animals were euthanized and bled. At 96 hours, mice that had no counts at 40 hours were euthanized as controls. At 96 hours, all animals were injected with ceftriaxone (100 μg/mouse). Seven animals were eliminated because they either had a failed pouch or were injected with the wrong solution at 16 hours. The data are provided in Table 27 and are depicted in FIGS. 22A-22H. FIGS. 22A-22F show plots of data from all animals used in Experiment B. The survival difference between groups A and B is depicted in FIG. 22A. There are no significant differences in terms of bacterial count and health among the three groups, as seen in FIG. 22B. The survival difference between groups A and B, excluding animals with bacterial counts >10⁴, is depicted in FIG. 22C. There are no significant differences in terms of bacterial count and health among the three groups, as seen in FIG. 22D. The survival difference between groups A and B, excluding animals that were euthanized before ceftriaxone treatment, is depicted in FIG. 22E. There are no significant differences in terms of bacterial count and health among the three groups, as seen in FIG. 22F.

TABLE 27

| CangeNo | AnimalNo | Treatment | bacCount | logBacCount | Time.dead | Status.dead | Status | Bad |
|---|---|---|---|---|---|---|---|---|
| 1 | 201 | ISO | 100 | 2 | 166 | 0 | ALIVE | 0 |
| 1 | 202 | ISO | 1000 | 3 | 166 | 0 | ALIVE | 0 |
| 1 | 203 | ISO | 20000 | 4.301029996 | 112 | 1 | FD | 0 |
| 1 | 204 | ISO | 70000 | 4.84509804 | 53 | 1 | ED | 0 |
| 1 | 205 | ISO | 3000 | 3.477121255 | 166 | 0 | ALIVE | 0 |
| 2 | 206 | anti-JE | 30000 | 4.477121255 | 64 | 1 | FD | 0 |
| 2 | 207 | anti-JE | 50000 | 4.698970004 | 77 | 1 | EU | 0 |
| 2 | 208 | anti-JE | 50000 | 4.698970004 | 64 | 1 | FD | 0 |
| 2 | 209 | anti-JE | 100 | 2 | 166 | 0 | ALIVE | 0 |
| 2 | 210 | anti-JE | 2000 | 3.301029996 | 77 | 1 | EU | 0 |
| 3 | 211 | ISO | 2100 | 3.322219295 | 77 | 1 | EU | 0 |
| 3 | 212 | ISO | 200000 | 5.301029996 | 53 | 1 | ED | 0 |
| 3 | 213 | ISO | 50000 | 4.698970004 | 64 | 1 | FD | 0 |
| 3 | 214 | ISO | 100 | 2 | 166 | 0 | ALIVE | 0 |
| 3 | 215 | ISO | 150000 | 5.176091259 | 54 | 1 | FD | 0 |
| 4 | 216 | anti-JE | 20000 | 4.301029996 | 77 | 1 | EU | 0 |
| 4 | 217 | anti-JE | 7000 | 3.84509804 | 88 | 1 | FD | 0 |
| 4 | 218 | anti-JE | 100 | 2 | 166 | 0 | ALIVE | 0 |
| 4 | 219 | anti-JE | 5000 | 3.698970004 | 77 | 1 | EU | 0 |
| 4 | 220 | anti-JE | 100000 | 5 | 60 | 1 | EU | 0 |
| 5 | 221 | ISO | 6000000 | 6.77815125 | 47 | 1 | FD | 0 |
| 5 | 222 | ISO | 40000 | 4.602059991 | 60 | 1 | EU | 0 |
| 5 | 223 | anti-JE | 100 | 2 | 166 | 0 | ALIVE | 0 |
| 5 | 224 | anti-JE | 100 | 2 | 166 | 0 | ALIVE | 0 |
| 5 | 225 | anti-JE | 100 | 2 | 166 | 0 | ALIVE | 0 |
| 6 | 226 | ISO | 5600 | 3.748188027 | 77 | 1 | EU | 0 |
| 6 | 227 | ISO | 100 | 2 | 166 | 0 | ALIVE | 0 |
| 6 | 228 | ISO | 1000 | 3 | 160 | 1 | FD | 0 |
| 6 | 229 | anti-JE | | | 166 | 0 | ALIVE | 1 |
| 6 | 230 | anti-JE | 100 | 2 | 166 | 0 | ALIVE | 0 |
| 7 | 231 | ISO | 4000 | 3.602059991 | 101 | 1 | EU | 0 |
| 7 | 232 | ISO | 400000 | 5.602059991 | 47 | 1 | FD | 0 |
| 7 | 233 | anti-JE | 800 | 2.903089987 | 95 | 1 | FD | 0 |
| 7 | 234 | anti-JE | 1000 | 3 | 125 | 1 | EU | 0 |
| 7 | 235 | anti-JE | 200000 | 5.301029996 | 53 | 1 | FD | 0 |
| 8 | 236 | ISO | 30000 | 4.477121255 | 77 | 1 | EU | 0 |
| 8 | 237 | ISO | 400000 | 5.602059991 | 47 | 1 | FD | 0 |
| 8 | 238 | ISO | 200000 | 5.301029996 | 54 | 1 | FD | 0 |
| 8 | 239 | anti-JE | 10000 | 4 | 136 | 1 | FD | 0 |
| 8 | 240 | anti-JE | 100000 | 5 | 54 | 1 | FD | 0 |
| 9 | 241 | anti-JE | 100 | 2 | 166 | 0 | ALIVE | 0 |
| 9 | 242 | anti-JE | 130000 | 5.113943352 | 60 | 1 | EU | 0 |
| 9 | 243 | ISO | 400000 | 5.602059991 | 47 | 1 | FD | 0 |
| 9 | 244 | ISO | 5000 | 3.698970004 | 60 | 1 | EU | 0 |
| 9 | 245 | ISO | 100 | 2 | 166 | 0 | ALIVE | 0 |
| 10 | 246 | anti-JE | 20000 | 4.301029996 | 60 | 1 | EU | 0 |
| 10 | 247 | anti-JE | 100 | 2 | 166 | 0 | ALIVE | 0 |
| 10 | 248 | anti-JE | 100 | 2 | 166 | 0 | ALIVE | 0 |
| 10 | 249 | ISO | 700 | 2.84509804 | 166 | 0 | ALIVE | 0 |
| 10 | 250 | ISO | 5000 | 3.698970004 | 112 | 1 | FD | 0 |
| 11 | 251 | anti-JE | 100 | 2 | 166 | 0 | ALIVE | 0 |
| 11 | 252 | anti-JE | 100 | 2 | 166 | 0 | ALIVE | 0 |
| 11 | 253 | ISO | 10000 | 4 | 70 | 1 | ED | 0 |
| 11 | 254 | ISO | 400 | 2.602059991 | 166 | 0 | ALIVE | 0 |
| 11 | 255 | ISO | 4400 | 3.643452676 | 160 | 1 | FD | 0 |
| 12 | 256 | anti-JE | 100 | 2 | 166 | 0 | ALIVE | 0 |
| 12 | 257 | anti-JE | 100 | 2 | 166 | 0 | ALIVE | 0 |
| 12 | 258 | anti-JE | 5000 | 3.698970004 | 95 | 1 | FD | 0 |
| 12 | 259 | ISO | 10000 | 4 | 101 | 1 | EU | 0 |
| 12 | 260 | ISO | 200000 | 5.301029996 | 54 | 1 | FD | 0 |
| 13 | 261 | anti-JE | 100 | 2 | 166 | 0 | ALIVE | 0 |
| 13 | 262 | anti-JE | 100 | 2 | 166 | 0 | ALIVE | 0 |
| 13 | 263 | ISO | 1500 | 3.176091259 | 101 | 1 | EU | 0 |
| 13 | 264 | ISO | 2000000 | 6.301029996 | 46 | 1 | EU | 0 |
| 13 | 265 | ISO | | | 166 | 0 | ALIVE | 1 |
| 14 | 266 | anti-JE | 100 | 2 | 166 | 0 | ALIVE | 0 |
| 14 | 267 | anti-JE | 100 | 2 | 166 | 0 | ALIVE | 0 |
| 14 | 268 | anti-JE | 10000 | 4 | 77 | 1 | EU | 0 |
| 14 | 269 | ISO | 20000 | 4.301029996 | 101 | 1 | EU | 0 |
| 14 | 270 | ISO | 100 | 2 | 166 | 0 | ALIVE | 0 |
| 15 | 271 | ISO | 2000000 | 6.301029996 | 46 | 1 | EU | 0 |
| 15 | 272 | ISO | 150000 | 5.176091259 | 46 | 1 | EU | 0 |
| 15 | 273 | anti-JE | 300 | 2.477121255 | 125 | 1 | EU | 0 |
| 15 | 274 | anti-JE | 100 | 2 | 166 | 0 | ALIVE | 0 |
| 15 | 275 | anti-JE | 300000 | 5.477121255 | 46 | 1 | EU | 0 |
| 16 | 276 | ISO | 5000 | 3.698970004 | 77 | 1 | EU | 0 |
| 16 | 277 | ISO | 100 | 2 | 166 | 0 | ALIVE | 0 |
| 16 | 278 | ISO | 30000 | 4.477121255 | 70 | 1 | EU | 0 |
| 16 | 279 | anti-JE | 1100 | 3.041392685 | 101 | 1 | EU | 0 |
| 16 | 280 | anti-JE | 100 | 2 | 166 | 0 | ALIVE | 0 |

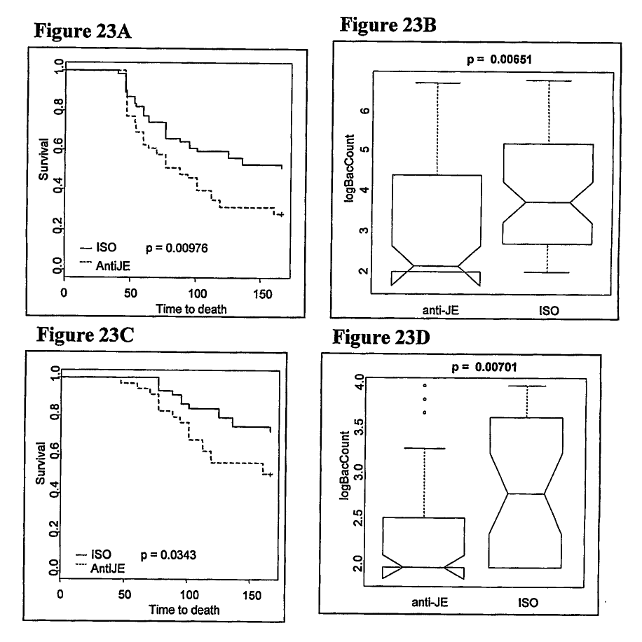

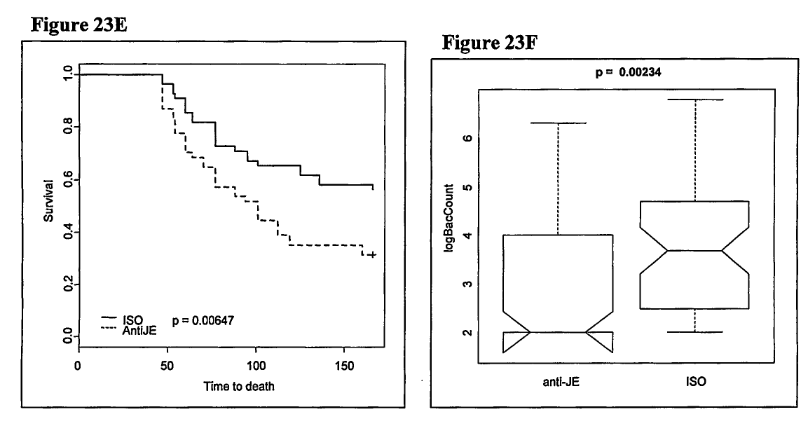

The survival difference between the combined control and treatment groups used in experiments A and B above is depicted in FIG. 23A. There is no significant difference in terms of bacterial count (FIG. 23B) and health between the two groups. FIGS. 23C and 23D show similar plots, but which exclude animals with bacterial counts >10⁴. FIGS. 23E-23F show plots of the combined data for all animals used in experiments A and B, but which exclude animals that died or were euthanized before the second treatment.

Treatment with VEGF Receptor Antagonists:

VEGF is known to be a potent vascular permeability factor, inducing adema, hypotension via induction of iNOS, which results in the production of nitrous oxide (NO), and poor tissue perfusion. VEGF was also found to be elevated in doomed immunocompromised animals (FIG. 11). Additionally, the experiments described above showed that treating septic animals with an anti-VEGF antibody improved their survival as compared to an untreated group. The following experiment was performed in order to determine the effects of treating animals with test VEGF antagonists.

Using the procedure described above, 76 mice were pouched, irradiated (495 rads) and infected (0.2 ml of 0.1 OD 600). Sixteen hours later, animals were injected with 0.2 ml of diluent, Compound I or Compound II (100 mg/Kg), which have the following structures: 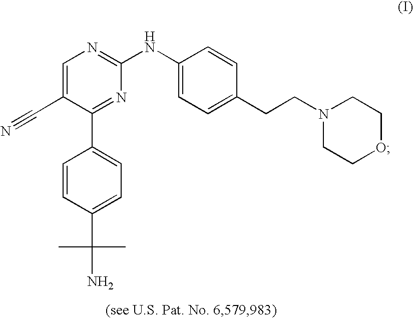
(I) (see U.S. Pat. No. 6,579,983);

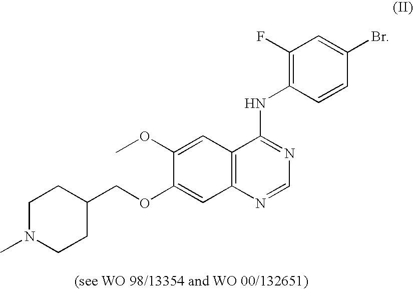

(II) (see WO 98/13354 and WO 00/132651). At 40 hours after infection, animals were bled and injected with the same solutions to which ceftriaxone was added to yield a solution containing 50 ug/mouse. Animals were injected with the solutions (no ceftriaxone) for 2 more days. Blood was used for BC and plasma. Two aliquots of 20 ul and an extra aliquot were prepared and stored at −80. Table 28 reports the bacterial counts and the time of euthanasia.

TABLE 28

| | | Time of | |
|---|---|---|---|
| Treatment | Bacterial counts | Death | Status |
| Control | FD | 40 | 1 |
| Control | FD | 40 | 1 |
| Control | 2.0E+06 | 48 | 1 |
| Control | 1.0E+06 | 48 | 1 |
| Control | 9.0E+05 | 48 | 1 |
| Control | 3.0E+05 | 64 | 1 |
| Control | 2.0E+05 | 70 | 1 |
| Control | 1.5E+05 | 48 | 1 |
| Control | 7.0E+04 | 70 | 1 |
| Control | 6.0E+04 | 54 | 1 |
| Control | 3.5E+04 | 48 | 1 |
| Control | 7.0E+03 | 72 | 1 |
| Control | 4.6E+03 | 78 | 1 |
| Control | 1.0E+03 | 112 | 1 |
| Control | 2.0E+02 | 168 | 0 |
| Control | 2.0E+02 | 160 | 1 |
| Control | <100 | 168 | 0 |
| Control | <100 | 72 | 1 |
| Control | <100 | 112 | 1 |
| Control | <100 | 168 | 0 |
| Control | <100 | 112 | 1 |
| Control | <100 | 112 | 1 |
| Control | <100 | 160 | 1 |
| Control | <100 | 168 | 0 |
| Control | <100 | 168 | 0 |
| Compound I | FD | 40 | 1 |
| Compound I | FD | 40 | 1 |
| Compound I | FD | 40 | 1 |
| Compound I | 1.3E+07 | 46 | 1 |
| Compound I | 4.0E+06 | 46 | 1 |
| Compound I | 3.0E+06 | 46 | 1 |
| Compound I | 2.0E+06 | 46 | 1 |
| Compound I | 1.0E+06 | 48 | 1 |
| Compound I | 3.0E+05 | 64 | 1 |
| Compound I | 3.0E+05 | 48 | 1 |
| Compound I | 3.0E+05 | 48 | 1 |
| Compound I | 2.0E+05 | 46 | 1 |
| Compound I | 2.0E+05 | 48 | 1 |
| Compound I | 3.0E+04 | 88 | 1 |
| Compound I | 1.7E+03 | 94 | 1 |
| Compound I | 1.0E+03 | 112 | 1 |
| Compound I | 1.0E+02 | 112 | 1 |
| Compound I | 1.0E+02 | 160 | 1 |
| Compound I | 1.0E+02 | 96 | 1 |
| Compound I | 1.0E+02 | 112 | 1 |
| Compound I | 1.0E+02 | 112 | 1 |
| Compound I | <100 | 96 | 1 |
| Compound I | <100 | 112 | 1 |
| Compound I | <100 | 112 | 1 |
| Compound I | <100 | 112 | 1 |
| Compound I | <100 | 112 | 1 |
| Compound I | <100 | 96 | 1 |
| Compound I | <100 | 168 | 0 |
| Compound II | FD | 40 | 1 |
| Compound II | FD | 40 | 1 |
| Compound II | 1.0E+09 | 46 | 1 |
| Compound II | 1.0E+07 | 46 | 1 |
| Compound II | 9.0E+06 | 48 | 1 |
| Compound II | 3.0E+06 | 46 | 1 |
| Compound II | 2.0E+06 | 48 | 1 |
| Compound II | 2.0E+06 | 48 | 1 |
| Compound II | 2.0E+06 | 64 | 1 |
| Compound II | 5.0E+05 | 48 | 1 |
| Compound II | 3.0E+05 | 48 | 1 |
| Compound II | 3.0E+05 | 46 | 1 |
| Compound II | 5.0E+04 | 64 | 1 |
| Compound II | 3.0E+04 | 64 | 1 |
| Compound II | 1.6E+04 | 48 | 1 |
| Compound II | 2.0E+03 | 160 | 1 |
| Compound II | 1.0E+02 | 112 | 1 |
| Compound II | 1.0E+02 | 48 | 1 |
| Compound II | <100 | 112 | 1 |
| Compound II | <100 | 112 | 1 |
| Compound II | <100 | 168 | 0 |
| Compound II | <100 | 160 | 1 |
| Compound II | <100 | 160 | 1 |
| Compound II | <100 | 168 | 0 |
| Compound II | <100 | 168 | 0 |
| Compound II | <100 | 168 | 0 |
| Compound II | <100 | 64 | 1 |

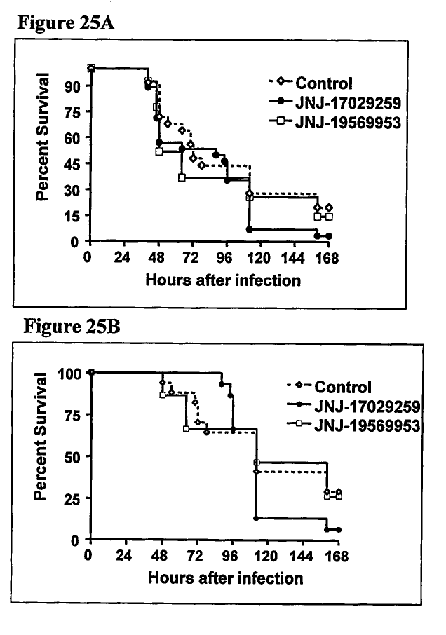

FIGS. 25A-25B show the survival curves. While no statistically significant survival difference was observed, a survival advantage was noted for animals with less than 10e5 bacterial counts as compared to the control. This survival advantage is noted from the hours from 48 to 88. During this period, 6 out of 17 animals died in the control group, while zero out of 15 animals died in the treatment group.

Treatment with a PPARγ Agonist:

It is known that treatment with rosiglitazone improves survival in animal models of CLP sepsis. Rosiglitazone is also an antidiabetic drug, and diabetes is a known risk condition for sepsis and septic shock. The efficacy of rosiglitazone in treating sepsis was therefore modeled as follows.

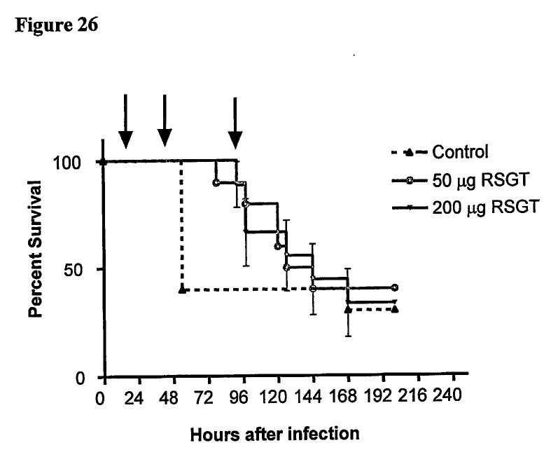

Sixty-one mice were pouched, irradiated, and infected in the manner described above. Sixteen hours post-infection, 20 mice were injected with a 0.2 ml rosiglitazone solution to a final concentration of 50 μg/mouse, 20 mice were injected with a 0.2 ml rosiglitazone solution to a final concentration of 200 μg/mouse, and 21 mice were injected with 0.2 ml of diluent alone. At 40 and 92 hours post-infection, each group of mice were injected with the same solution that they were injected with at forty hours post-infection, to which was added ceftriaxone to deliver 100 μg/mouse. FIG. 26 shows the survival rates for the three groups of animals, which indicate that both the 50 μg/ml and the 200 μg/ml rosiglitazone treatments each confers a significant survival advantage compared to the treatment with diluent alone.

### Example 9

### Determination of a Biomarker Panel in an Immunocompromised Mouse Model Using a Larger Data Pool

Using the data obtained in Experiments c, d, e and f described in Example 1 and shown in Appendix A together, an additional biomarker panel was identified. Analysis of variance (ANOVA) with each experiment treated as a random block was used to assess each analyte's discrimination power between Doomed and Survived animals. There were 11 analytes having test p values are less than 0.01, and 14 analytes having test p values less than 0.05. The weight for each analyte was defined as the standardized fixed effect size from the above analysis. The score for each animal was defined as the sum of the product of the log 2 value of each analyte's measured level with its corresponding weight over all 7 analytes.

The seven analytes identified were MCP-3, MCP-5, TIMP-1, RANTES, TPO, TNFα, and IL-3. This biomarker panel was successfully used to predict disease outcome in the animal model in a manner similar to that described in Examples 3, 4, and 5. The results from these studies are shown in Appendix B. Accordingly, this group of analytes constitutes a preferred embodiment of a biomarker panel.

Although the invention has been described above by reference to a detailed description of illustrative and preferred features and embodiments, it will be understood that the invention is intended not to be limited by the foregoing, but to be defined by the appended claims as properly construed under principles of patent law.

APPENDIX A
This appendix contains all the data obtained by RBM for the samples reported on Tables for experiments c, d, e,
and f. Pool 3 refers to control plasma samples obtained from C3H/HeJ mice hat did not receive any treatment and represent a pool
of samples

| | | | RBM | Apo A-1 | B2M | CRP | D-dimer | EGF | Endothelin-1 | Eotaxin | Factor 7 |
|---|---|---|---|---|---|---|---|---|---|---|---|
| Exp. | Description | Animal Number | test date | ug/ml | pg/ml | ug/ml | ng/ml | pg/ml | pg/ml | pg/ml | ng/ml |
| c | CONTROL | 2255 | NOV | 84.9 | 905 | | 2.36 | 9.13 | 31.1 | 1530 | 1.62 |
| c | CONTROL | 2257 | NOV | 77.3 | 866 | | 3.43 | 11.2 | 39.5 | 1870 | 1.11 |
| c | CONTROL | 2259 | NOV | 81.1 | 981 | | 4.66 | 17.8 | 29.8 | 1940 | 2.14 |
| c | CONTROL | 2263 | NOV | 95.2 | 862 | | 4.38 | 20.1 | 46.1 | 1450 | 2.36 |
| c | CONTROL | 2266 | NOV | 89.8 | 961 | | 2.76 | 13.4 | 39.5 | 1210 | 1.58 |
| c | CONTROL | 2268 | NOV | 85.4 | 985 | | 6.03 | 17.8 | 41.7 | 1690 | 2.4 |
| c | CONTROL | 2271 | NOV | 73.2 | 916 | | 3.03 | 9.13 | 24.4 | 2360 | 1.33 |
| c | CONTROL | 2272 | NOV | 78 | 780 | | 1.22 | 3.15 | 24.4 | 1500 | 0.617 |
| c | DOOMED | 2287 | NOV | 79.1 | 981 | | 3.57 | 20.1 | 37.2 | 4120 | 1.4 |
| c | DOOMED | 2288 | NOV | 75.3 | 3010 | | 11.7 | 40 | 41.7 | 5240 | 1.91 |
| c | DOOMED | 2290 | NOV | 85.9 | 981 | | 6.03 | 15.6 | 43.9 | 4330 | 2.1 |
| c | FINAL | 2287 | NOV | 63.9 | 1500 | | 8.49 | 50.8 | 70.4 | 5680 | 4.44 |
| c | FINAL | 2290 | NOV | 55.3 | 1270 | | 5.21 | 20.1 | 41.7 | 5050 | 1.84 |
| c | INFECTED | 2277 | NOV | 99.8 | 1050 | | 5.48 | 21.2 | 43.9 | 2950 | 1.91 |
| c | INFECTED | 2282 | NOV | 101 | 1000 | | 6.31 | 17.8 | 43.9 | 1980 | 1.8 |
| c | INFECTED | 2283 | NOV | 93.8 | 1190 | | 3.84 | 16.7 | 41.7 | 2730 | 1.54 |
| c | SURVIVED | 2286 | NOV | 81.9 | 988 | | 3.03 | 14.5 | 21.6 | 2600 | 1.4 |
| c | INFECTED | 2278 | DEC | 91.9 | 7450 | | 3.04 | 21.2 | 46.5 | 1390 | 1.9 |
| c | INFECTED | 2279 | DEC | 68.7 | 6730 | | 1.43 | 14.2 | 33.3 | 1270 | 1.5 |
| c | INFECTED | 2280 | DEC | 77.8 | 7140 | | 1.18 | 11.3 | 30.9 | 909 | 1.75 |
| c | INFECTED | 2281 | DEC | 78.7 | 6860 | | 2.31 | 5.68 | 40.1 | 1090 | 1.75 |
| c | SURVIVED | 2284 | DEC | 77.2 | 7370 | | 3.34 | 21.2 | 42.3 | 2050 | 1.9 |
| c | SURVIVED | 2285 | DEC | 81.5 | 6460 | | 3.1 | 19.2 | 44.4 | 1960 | 2.19 |
| c | SURVIVED | 2289 | DEC | 77.2 | 7450 | | 1.68 | 23.2 | 48.6 | 3460 | 2.77 |
| d | FINAL | 6515 | MARCH | | 785 | | | 3.57 | 31 | 1700 | 0.649 |
| d | FINAL | 6521 | MARCH | | 1490 | | | 20.4 | 31 | 1700 | 1.72 |
| d | FINAL | 6530 | MARCH | | 785 | | | 11.3 | 31 | 1700 | 0.313 |
| d | FINAL | 6531 | MARCH | | 896 | | | 14.5 | 41.8 | 1700 | 0.807 |
| c | CONTROL | 2255 | MARCH | | 209 | | | 2.27 | 90.7 | 48.3 | 3.9 |
| c | CONTROL | 2257 | MARCH | | 350 | | | 14.5 | 96.1 | 191 | 2.45 |
| c | CONTROL | 2259 | MARCH | | 459 | | | 7.78 | 96.1 | 145 | 4.38 |
| c | CONTROL | 2263 | MARCH | | 404 | | | 7.78 | 96.1 | 70.9 | 4.38 |
| c | CONTROL | 2266 | MARCH | | 209 | | | 2.27 | 62.5 | 16.4 | 1.57 |
| c | CONTROL | 2268 | MARCH | | | | | | | | |
| c | CONTROL | 2271 | MARCH | | 567 | | | 2.27 | 79.1 | 249 | 3.56 |
| c | CONTROL | 2272 | MARCH | | 567 | | | 2.27 | 90.7 | 197 | 1.87 |
| c | DOOMED | 2290 | MARCH | | 246 | | | 2.27 | 66 | 1080 | 3.15 |
| c | FINAL | 2287 | MARCH | | | | | | | | |
| c | FINAL | 2290 | MARCH | | 3310 | | | 44.2 | 140 | 1700 | 6.39 |
| c | INFECTED | 2277 | MARCH | | 1130 | | | 20.4 | 123 | 1700 | 3.97 |
| c | INFECTED | 2282 | MARCH | | 703 | | | 14.5 | 101 | 1620 | 3.28 |
| c | INFECTED | 2283 | MARCH | | 1370 | | | 14.5 | 96.1 | 1700 | 3.42 |
| c | SURVIVED | 2286 | MARCH | | 431 | | | 26 | 101 | 1700 | 5.08 |
| d | CONTROL | 2260 | MARCH | | 350 | | | 3.57 | 41.8 | 1700 | 3.01 |
| d | CONTROL | 2261 | MARCH | | 513 | | | 11.3 | 87.9 | 1700 | 4.52 |
| d | CONTROL | 2262 | MARCH | | 896 | | | 17.5 | 96.1 | 1700 | 6.53 |
| d | DOOMED | 6514 | MARCH | | 785 | | | 2.27 | 96.1 | 1700 | 4.66 |
| d | DOOMED | 6526 | MARCH | | 1690 | | | 3.57 | 90.7 | 1700 | 3.97 |
| d | DOOMED | 6530 | MARCH | | 1340 | | | 17.5 | 101 | 1700 | 3.56 |
| d | DOOMED | 6534 | MARCH | | 1430 | | | 14.5 | 93.4 | 1700 | 3.56 |
| d | DOOMED | 6535 | MARCH | | 1620 | | | 14.5 | 85 | 1700 | 2.45 |
| d | SURVIVED | 6507 | MARCH | | 785 | | | 7.78 | 50.8 | 1700 | 4.24 |
| d | SURVIVED | 6508 | MARCH | | 513 | | | 7.78 | 90.7 | 1700 | 3.69 |
| d | SURVIVED | 6512 | MARCH | | 1130 | | | 9.59 | 90.7 | 1700 | 3.69 |
| d | SURVIVED | 6532 | MARCH | | 1980 | | | 21.8 | 72.8 | 1700 | 5.22 |
| d | SURVIVED | 6537 | MARCH | | 1040 | | | 17.5 | 96.1 | 1700 | 3.01 |
| d | DOOMED | 6509 | JUNE | 107 | 882 | 0.407 | | 12.5 | 28.8 | 2600 | 0.349 |
| d | DOOMED | 6509 | JUNE | 113 | 1330 | 0.387 | | 16.9 | 52.3 | 2590 | 0.53 |
| d | DOOMED | 6515 | JUNE | 128 | 675 | 0.606 | | 29.6 | 28.8 | 2410 | 0.964 |
| d | DOOMED | 6515 | JUNE | 138 | 397 | 0.751 | | 26.2 | 28.8 | 2480 | 1.01 |
| d | DOOMED | 6520 | JUNE | 125 | 1460 | 0.221 | | 17.6 | 22.8 | 2270 | 1.71 |
| d | DOOMED | 6520 | JUNE | 126 | 1340 | 0.221 | | 3.73 | 43.7 | 2200 | 1.67 |
| d | DOOMED | 6528 | JUNE | 116 | 1290 | 0.429 | | 22.8 | 6.07 | 3190 | 0.964 |
| d | DOOMED | 6528 | JUNE | 113 | 1140 | 0.268 | | 14.2 | 52.3 | 3290 | 0.706 |
| d | FINAL | 6509 | JUNE | 111 | 1400 | 0.972 | | 5.5 | 198 | 2180 | 0.055 |
| d | FINAL | 6509 | JUNE | 117 | 2210 | 0.837 | | 5.5 | 231 | 2150 | 0.53 |
| d | FINAL | 6528 | JUNE | 116 | 2850 | 0.494 | | 19.4 | 173 | 2760 | 0.53 |
| d | FINAL | 6528 | JUNE | 130 | 2740 | 0.445 | | 26.2 | 194 | 2790 | 1.09 |
| d | FINAL | 6534 | JUNE | 115 | 2670 | 0.799 | | 19.4 | 6.07 | 1640 | 1.05 |
| d | FINAL | 6534 | JUNE | 125 | 2050 | 0.821 | | 19.4 | 6.07 | 1570 | 0.53 |
| d | FINAL | 6535 | JUNE | 67.1 | 5200 | 0.373 | | 96.6 | 97.4 | 2780 | 4.02 |
| d | FINAL | 6535 | JUNE | 76.9 | 6000 | 0.617 | | 110 | 87 | 3120 | 3.61 |
| d | SURVIVED | 6505 | JUNE | 146 | 61.5 | 0.815 | | 12.5 | 28.8 | 1660 | 0.44 |
| d | SURVIVED | 6505 | JUNE | 147 | 61.5 | 0.931 | | 1.95 | 6.07 | 1700 | 0.485 |
| d | SURVIVED | 6506 | JUNE | 191 | 61.5 | 1.91 | | 1.95 | 6.07 | 2940 | 0.349 |
| d | SURVIVED | 6506 | JUNE | 203 | 61.5 | 1.82 | | 1.95 | 6.07 | 2790 | 0.055 |
| d | SURVIVED | 6516 | JUNE | 110 | 703 | 0.533 | | 5.5 | 6.07 | 2850 | 0.964 |
| d | SURVIVED | 6516 | JUNE | 120 | 1190 | 0.688 | | 5.5 | 15.8 | 2760 | 0.793 |
| d | SURVIVED | 6519 | JUNE | 115 | 806 | 0.353 | | 12.5 | 39.1 | 2570 | 1.13 |
| d | SURVIVED | 6519 | JUNE | 129 | 1060 | 0.493 | | 12.5 | 43.7 | 2580 | 0.706 |
| e | DOOMED | 6615 | JUNE | 185 | 825 | 2.17 | | 5.5 | 22.8 | 2830 | 0.879 |
| e | DOOMED | 6615 | JUNE | 189 | 591 | 2.15 | | 1.95 | 6.07 | 2800 | 1.22 |
| e | DOOMED | 6616 | JUNE | 191 | 388 | 1.69 | | 9 | 28.8 | 3420 | 0.44 |
| e | DOOMED | 6616 | JUNE | 199 | 731 | 1.7 | | 19.4 | 6.07 | 3500 | 1.05 |
| e | DOOMED | 6622 | JUNE | 184 | 572 | 2.16 | | 9 | 34.2 | 2200 | 0.964 |
| e | DOOMED | 6622 | JUNE | 192 | 684 | 2.16 | | 1.95 | 28.8 | 2000 | 0.706 |
| e | DOOMED | 6627 | JUNE | 165 | 1190 | 2.49 | | 1.95 | 15.8 | 2150 | 0.158 |
| e | DOOMED | 6627 | JUNE | 181 | 968 | 2.55 | | 9 | 6.07 | 2170 | 0.255 |
| e | SURVIVED | 6614 | JUNE | 187 | 712 | 2.13 | | 1.95 | 22.8 | 2390 | 0.619 |
| e | SURVIVED | 6614 | JUNE | 207 | 825 | 2.13 | | 1.95 | 15.8 | 2340 | 0.575 |
| e | SURVIVED | 6618 | JUNE | 192 | 977 | 1.9 | | 9 | 15.8 | 2460 | 0.879 |
| e | SURVIVED | 6618 | JUNE | 196 | 1030 | 1.94 | | 5.5 | 39.1 | 2620 | 0.53 |
| e | SURVIVED | 6625 | JUNE | 193 | 507 | 2.28 | | 1.95 | 6.07 | 2250 | 0.879 |
| e | SURVIVED | 6625 | JUNE | 216 | 121 | 2.38 | | 19.4 | 22.8 | 1990 | 0.706 |
| e | SURVIVED | 6633 | JUNE | 182 | 164 | 2.33 | | 1.95 | 6.07 | 1770 | 0.349 |
| e | SURVIVED | 6633 | JUNE | 181 | 61.5 | 2.37 | | 1.95 | 34.2 | 1620 | 0.879 |
| e-pool1 | FINAL | e-pool1 | JUNE | 88.8 | 2770 | 0.625 | | 33 | 415 | 1900 | 0.879 |
| e-pool1 | FINAL | e-pool1 | JUNE | 85.4 | 2250 | 0.749 | | 19.4 | 386 | 1710 | 1.05 |
| e-pool1 | FINAL | e-pool1 | JUNE | 81.3 | 2490 | 0.598 | | 22.8 | 400 | 1700 | 0.964 |
| e-pool1 | FINAL | e-pool1 | JUNE | 82.5 | 2110 | 0.632 | | 21.1 | 397 | 1740 | 0.879 |
| e-pool1 | FINAL | e-pool1 | JUNE | 84.9 | 3070 | 0.642 | | 19.4 | 435 | 1870 | 0.879 |
| e-pool1 | FINAL | e-pool1 | JUNE | 82.9 | 2890 | 0.787 | | 26.2 | 390 | 1760 | 0.793 |
| e-pool1 | FINAL | e-pool1 | JUNE | 93.1 | 2610 | 0.86 | | 33 | 404 | 1730 | 1.62 |
| e-pool1 | FINAL | e-pool1 | JUNE | 93.7 | 2410 | 0.833 | | 33 | 367 | 1710 | 1.58 |
| e-pool1 | FINAL | e-pool1 | JUNE | 82.4 | 2610 | 0.691 | | 43.1 | 399 | 2060 | 1.62 |
| e-pool1 | FINAL | e-pool1 | JUNE | 84.2 | 2670 | 0.717 | | 43.1 | 361 | 1830 | 1.05 |
| e-pool3 | FINAL | e-pool2 | JUNE | 71.9 | 2110 | 0.636 | | 26.2 | 238 | 954 | 0.836 |
| e-pool2 | FINAL | e-pool2 | JUNE | 78.5 | 1210 | 0.635 | | 19.4 | 257 | 955 | 0.793 |
| e-pool2 | FINAL | e-pool2 | JUNE | 81.3 | 2190 | 0.221 | | 22.8 | 222 | 991 | 0.663 |
| e-pool2 | FINAL | e-pool2 | JUNE | 86.4 | 1960 | 0.37 | | 29.6 | 231 | 1000 | 0.964 |
| e-pool2 | FINAL | e-pool2 | JUNE | 81.6 | 1580 | 0.601 | | 19.4 | 235 | 1020 | 0.793 |
| e-pool2 | FINAL | e-pool2 | JUNE | 83 | 1810 | 0.65 | | 15.9 | 236 | 920 | 1.05 |
| e-pool2 | FINAL | e-pool2 | JUNE | 83.4 | 1430 | 0.47 | | 14.2 | 244 | 1050 | 0.964 |
| e-pool2 | FINAL | e-pool2 | JUNE | 85.7 | 1730 | 0.672 | | 19.4 | 235 | 1010 | 0.706 |
| e-pool2 | FINAL | e-pool2 | JUNE | 84.1 | 1540 | 0.452 | | 29.6 | 246 | 868 | 0.663 |
| e-pool2 | FINAL | e-pool2 | JUNE | 77.8 | 1520 | 0.501 | | 5.5 | 222 | 814 | 0.53 |
| f | CONTROL | 7354 | AUG | 170 | | 1.17 | | 26.7 | 22.2 | 1500 | 2.94 |
| f | CONTROL | 7355 | AUG | 159 | | 1.33 | | 21.7 | 22.2 | 1980 | 0.228 |
| f | CONTROL | 7357 | AUG | 142 | | 1.32 | | 22 | 22.2 | 1450 | 0.228 |
| f | CONTROL | 7358 | AUG | 153 | | 1.24 | | 22 | 22.2 | 1700 | 0.228 |
| f | CONTROL | 7359 | AUG | 166 | | 1.05 | | 3.4 | 99.8 | 2080 | 0.747 |
| f | CONTROL | 7360 | AUG | 160 | | 1.23 | | 22.4 | 67 | 1790 | 0.228 |
| f | CONTROL | 7361 | AUG | 158 | | 1.21 | | 13.7 | 22.2 | 1920 | 0.228 |
| f | CONTROL | 7362 | AUG | 140 | | 1.05 | | 11 | 61.7 | 1930 | 0.228 |
| f | DOOMED | 7319 | AUG | 154 | | 1.38 | | 3.7 | 22.2 | 1780 | 0.228 |
| f | DOOMED | 7320 | AUG | 157 | | 1.06 | | 18.5 | 22.2 | 2780 | 0.228 |
| f | DOOMED | 7322 | AUG | 135 | | 1.2 | | 9.65 | 22.2 | 2700 | 0.228 |
| f | DOOMED | 7330 | AUG | 152 | | 1.18 | | 32.2 | 22.2 | 1870 | 0.228 |
| f | DOOMED | 7334 | AUG | 185 | | 1.34 | | 12 | 22.2 | 3050 | 0.584 |
| f | DOOMED | 7341 | AUG | 148 | | 1.27 | | 9.33 | 22.2 | 2900 | 0.228 |
| f | DOOMED | 7345 | AUG | 155 | | 1.58 | | 18.1 | 113 | 1820 | 0.747 |
| f | DOOMED | 7350 | AUG | 153 | | 1.45 | | 32.6 | 22.2 | 2520 | 0.228 |
| f | FINAL | 7319 | AUG | 96.2 | | 0.418 | | 9.98 | 161 | 4120 | 1.96 |
| f | FINAL | 7320 | AUG | 78.3 | | 0.739 | | 29.3 | 119 | 9180 | 4.39 |
| f | FINAL | 7322 | AUG | 75.1 | | 0.465 | | 9.65 | 232 | 1900 | 1.52 |
| f | FINAL | 7330 | AUG | 74.8 | | 0.684 | | 20.6 | 180 | 4610 | 3.54 |
| f | FINAL | 7334 | AUG | 110 | | 2.01 | | 17.4 | 143 | 822 | 0.684 |
| f | FINAL | 7341 | AUG | 98.1 | | 0.465 | | 35.9 | 140 | 2170 | 3.01 |
| f | FINAL | 7345 | AUG | 114 | | 0.922 | | 14 | 140 | 3390 | 1.52 |
| f | FINAL | 7350 | AUG | 91.3 | | 0.368 | | 40.7 | 172 | 1880 | 3.61 |
| f | SURVIVED | 7323 | AUG | 112 | | 1.06 | | 27.4 | 22.2 | 2780 | 0.228 |
| f | SURVIVED | 7327 | AUG | 128 | | 0.964 | | 5.83 | 22.2 | 2370 | 0.228 |
| f | SURVIVED | 7329 | AUG | 151 | | 1.37 | | 18.5 | 22.2 | 2480 | 0.228 |
| f | SURVIVED | 7332 | AUG | 154 | | 1.26 | | 27.8 | 22.2 | 2060 | 0.414 |
| f | SURVIVED | 7333 | AUG | 208 | | 1.08 | | 7.08 | 22.2 | 2770 | 0.228 |
| f | SURVIVED | 7337 | AUG | 126 | | 1.41 | | 13.7 | 22.2 | 1380 | 0.414 |
| f | SURVIVED | 7346 | AUG | 152 | | 1.28 | | 6.14 | 22.2 | 1950 | 0.228 |
| f | SURVIVED | 7348 | AUG | 166 | | 1.52 | | 11.6 | 22.2 | 1870 | 0.584 |
| e-pool1 | FINAL | e-pool1 | AUG | 75.7 | | 0.191 | | 18.5 | 203 | 2230 | 1.66 |
| e-pool1 | FINAL | e-pool1 | AUG | 73.9 | | 0.383 | | 14.3 | 206 | 2060 | 1.22 |
| e-pool1 | FINAL | e-pool1 | AUG | 75.9 | | 0.375 | | 22 | 201 | 1930 | 1.81 |
| e-pool1 | FINAL | e-pool1 | AUG | 77.8 | | 0.411 | | 13 | 210 | 1770 | 1.37 |
| e-pool1 | FINAL | e-pool1 | AUG | 81.5 | | 0.444 | | 18.5 | 180 | 1860 | 1.22 |
| e-pool1 | FINAL | e-pool1 | AUG | 80 | | 0.39 | | 19.9 | 195 | 1670 | 1.37 |
| pool3 | CONTROL | pool3 | AUG | 159 | | 1.8 | | 22 | 22.2 | 506 | 0.228 |
| pool3 | CONTROL | pool3 | AUG | 165 | | 1.6 | | 20.6 | 56 | 443 | 0.228 |
| pool3 | CONTROL | pool3 | AUG | 181 | | 1.8 | | 25.6 | 42.4 | 526 | 1.06 |
| pool3 | CONTROL | pool3 | AUG | 159 | | 1.74 | | 18.5 | 22.2 | 531 | 0.228 |
| pool3 | CONTROL | pool3 | AUG | 154 | | 1.92 | | 31.5 | 49.7 | 494 | 0.906 |
| pool3 | CONTROL | pool3 | AUG | 168 | | 1.9 | | 26.4 | 49.7 | 493 | 0.906 |
| pool3 | CONTROL | pool3 | SEP | 217 | | 1.07 | | 77.9 | 15.4 | 546 | 0.606 |
| pool3 | CONTROL | pool3 | SEP | 205 | | 0.914 | | 77.6 | 15.4 | 478 | 0.783 |
| pool3 | CONTROL | pool3 | SEP | 206 | | 0.981 | | 61.7 | 15.4 | 521 | 0.577 |
| pool3 | CONTROL | pool3 | SEP | 205 | | 0.917 | | 64.2 | 25.7 | 482 | 0.577 |
| e-pool1 | FINAL | e-pool1 | SEP | 94 | | 0.0855 | | 103 | 314 | 2510 | 1.59 |
| e-pool1 | FINAL | e-pool1 | SEP | 78.4 | | 0.0855 | | 113 | 297 | 2140 | 1.65 |
| e-pool1 | FINAL | e-pool1 | SEP | 89.8 | | 0.0855 | | 87.4 | 282 | 2130 | 1.53 |
| d | S FINAL | 6505 | SEP | 145 | | 0.225 | | 63.9 | 15.4 | 718 | 0.489 |
| d | S FINAL | 6506 | SEP | 243 | | 1.19 | | 74.1 | 25.7 | 358 | 0.695 |
| d | S FINAL | 6516 | SEP | 180 | | 0.497 | | 110 | 15.4 | 812 | 0.695 |
| d | S FINAL | 6519 | SEP | 117 | | 0.0855 | | 173 | 42.2 | 1100 | 0.754 |
| d | S FINAL | 6529 | SEP | 218 | | 1.17 | | 11.7 | 38.4 | 425 | 0.43 |

| | | | Fibrinogen | GCP-2 | GM-CSF | Growth Horm | GST | Haptoglobin | IFNg | IgA | IL-10 |
|---|---|---|---|---|---|---|---|---|---|---|---|
| Exp. | FGF-9 ng/ml | FGFb ng/ml | ug/ml | ng/ml | pg/mL | ng/ml | ng/ml | ug/ml | pg/ml | ug/ml | pg/ml |
| c | 0.502 | 0.552 | | 0.279 | 0.565 | 0.11 | 4.39 | | 54.1 | | 139 |
| c | 1 | 1.93 | | 0.506 | 2.32 | 0.0845 | 4.02 | | 77 | | 170 |
| c | 0.211 | 1.93 | | 0.691 | 1.12 | 0.0931 | 8.76 | | 65.4 | | 79.5 |
| c | 0.917 | 2.88 | | 0.315 | 0.565 | 0.163 | 10.9 | | 272 | | 139 |
| c | 1.13 | 0.552 | | 0.374 | 0.565 | 0.137 | 2.03 | | 77 | | 170 |
| c | 0.693 | 1.47 | | 0.829 | 1.12 | 0.145 | 7.52 | | 145 | | 221 |
| c | 0.784 | 0.552 | | 0.266 | 1.7 | 0.0931 | 4.39 | | 77 | | 159 |
| c | 0.211 | 0.552 | | 0.194 | 1.7 | 0.0342 | 1.14 | | 54.1 | | 159 |
| c | 5.09 | 1.93 | | 2.26 | 12.1 | 0.0674 | 7.11 | | 466 | | 2790 |
| c | 8.53 | 5.85 | | 3.49 | 40.2 | 0.0931 | 11.7 | | 687 | | 4340 |
| c | 3.97 | 3.85 | | 0.864 | 8.46 | 0.106 | 6.91 | | 396 | | 2780 |
| c | 10.8 | 37.7 | | 3.68 | 93.1 | 0.248 | 15 | | 1160 | | 7310 |
| c | 10.2 | 21.7 | | 3.38 | 61 | 0.106 | 13 | | 1050 | | 7830 |
| c | 2.42 | 3.85 | | 1.26 | 5.79 | 0.128 | 8.13 | | 300 | | 1650 |
| c | 1.39 | 3.36 | | 1.32 | 4.35 | 0.171 | 6.31 | | 258 | | 596 |
| c | 1.3 | 1.01 | | 1.69 | 1.7 | 0.0845 | 6.71 | | 132 | | 559 |
| c | 1.13 | 0.552 | | 0.308 | 6.54 | 0.0589 | 11.7 | | 258 | | 1610 |
| c | 1.35 | 3.25 | | 1.56 | 6.42 | 0.0754 | 5.2 | 3.28 | 167 | 725 | 1130 |
| c | 0.999 | 1.13 | | 0.789 | 5.86 | 0.0573 | 7.13 | 3.74 | 129 | 551 | 549 |
| c | 1.06 | 1.13 | | 0.517 | 6.14 | 0.0521 | 5.94 | 4.1 | 107 | 627 | 421 |
| c | 0.843 | 1.13 | | 0.917 | 3 | 0.078 | 4.15 | 2.68 | 77.9 | 669 | 241 |
| c | 2.18 | 2.59 | | 0.715 | 7.57 | 0.078 | 6.24 | 1.33 | 160 | 855 | 1570 |
| c | 1.6 | 3.89 | | 0.341 | 5.31 | 0.106 | 6.53 | 3.18 | 205 | 653 | 1190 |
| c | 2.05 | 2.24 | | 0.508 | 7.57 | 0.119 | 7.72 | 2.53 | 205 | 704 | 1570 |
| d | 1.59 | 5.02 | | 2.86 | 17.7 | 0.108 | 3.49 | | 131 | | 1510 |
| d | 1.45 | 12.8 | | 2.78 | 12.8 | 0.205 | 5.99 | | 56.4 | | 1620 |
| d | 1.14 | 0.682 | | 1.53 | 9.83 | 0.187 | 6.67 | | 22.8 | | 237 |
| d | 1.14 | 10 | | 2.94 | 21.7 | 0.196 | 3.65 | | 88.1 | | 1490 |
| c | 1.52 | 5.02 | | 0.314 | 2.75 | 0.168 | 4.98 | | 64.6 | | 169 |
| c | 0.815 | 0.682 | | 0.66 | 0.991 | 0.148 | 3 | | 39.5 | | 102 |
| c | 0.815 | 1.79 | | 1.12 | 0.53 | 0.241 | 8.05 | | 14.1 | | 120 |
| c | 0.815 | 2.85 | | 0.452 | 0.53 | 0.338 | 7.36 | | 48 | | 132 |
| c | 0.467 | 3.39 | | 0.387 | 0.53 | 0.128 | 1.75 | | 14.1 | | 71.7 |
| c | 0.815 | | | | 0.53 | | | | 39.5 | | 156 |
| c | 1.45 | 3.93 | | 0.401 | 3.2 | 0.187 | 4.64 | | 95.6 | | 243 |
| c | 0.268 | 0.682 | | 0.318 | 0.53 | 0.187 | 2.37 | | 27.1 | | 59.7 |
| c | 0.467 | 1.79 | | 1.12 | 1.43 | 0.187 | 3.65 | | 22.8 | | 193 |
| c | 2.97 | | | | 67.2 | | | | 131 | | 1420 |
| c | 3.67 | 46.8 | | 3.17 | 43.2 | 0.688 | 12.2 | | 187 | | 2560 |
| c | 0.268 | 10 | | 1.88 | 3.65 | 0.386 | 8.39 | | 88.1 | | 144 |
| c | 0.815 | 5.02 | | 1.57 | 0.53 | 0.314 | 4.98 | | 72.6 | | 162 |
| c | 0.268 | 3.93 | | 2.3 | 0.53 | 0.25 | 3.98 | | 39.5 | | 83.6 |
| c | 0.268 | 7.23 | | 0.329 | 2.3 | 0.275 | 9.43 | | 14.1 | | 95.6 |
| d | 0.268 | 2.32 | | 1.46 | 0.53 | 0.241 | 3 | | 14.1 | | 114 |
| d | 0.268 | 0.682 | | 2.67 | 0.53 | 0.168 | 4.98 | | 14.1 | | 47.7 |
| d | 0.646 | 2.85 | | 1.86 | 0.991 | 0.214 | 8.22 | | 22.8 | | 59.7 |
| d | 2.31 | 7.23 | | 2.34 | 4.11 | 0.187 | 3.98 | | 76.5 | | 575 |
| d | 0.467 | 10.6 | | 3.23 | 0.53 | 0.168 | 5.15 | | 14.1 | | 89.6 |
| d | 0.467 | 4.47 | | 1.91 | 3.2 | 0.168 | 4.64 | | 39.5 | | 193 |
| d | 0.467 | 2.85 | | 3.14 | 8.86 | 0.205 | 4.64 | | 48 | | 250 |
| d | 0.268 | 9.45 | | 3.7 | 4.57 | 0.205 | 3.65 | | 18.5 | | 193 |
| d | 0.467 | 5.02 | | 1.27 | 0.53 | 0.148 | 6.33 | | 14.1 | | 47.7 |
| d | 0.268 | 6.67 | | 1.53 | 1.43 | 0.275 | 5.99 | | 22.8 | | 132 |
| d | 0.646 | 8.34 | | 1.55 | 2.3 | 0.241 | 5.32 | | 64.6 | | 181 |
| d | 0.732 | 2.85 | | 2.71 | 1.43 | 0.168 | 7.36 | | 60.5 | | 71.7 |
| d | 0.268 | 5.02 | | 1.76 | 2.3 | 0.378 | 3.65 | | 127 | | 132 |
| d | 0.0695 | 2.97 | 4290 | 4.25 | 6.06 | 0.0996 | 1.92 | 38.4 | 28.1 | 99.1 | 115 |
| d | 0.0695 | 8.38 | 5540 | 5.93 | 5.51 | 0.174 | 4.8 | 38 | 31.3 | 109 | 115 |
| d | 0.246 | 1.3 | 5690 | 1.61 | 3.12 | 0.208 | 3.02 | 36.4 | 68.4 | 126 | 75.7 |
| d | 0.0695 | 5.81 | 6810 | 1.64 | 1.59 | 0.252 | 3.02 | 39.3 | 24.3 | 138 | 60.5 |
| d | 0.246 | 3.72 | 2650 | 2.47 | 13.1 | 0.294 | 4.27 | 34.2 | 76.2 | 107 | 245 |
| d | 0.495 | 0.151 | 3090 | 2.53 | 10.6 | 0.151 | 3.38 | 35.2 | 130 | 128 | 256 |
| d | 0.666 | 2.97 | 3660 | 1.92 | 6.6 | 0.284 | 5.16 | 35.3 | 168 | 81.5 | 195 |
| d | 0.722 | 6.14 | 5200 | 1.93 | 7.12 | 0.219 | 2.66 | 36.5 | 76.2 | 82.7 | 215 |
| d | 0.61 | 13.2 | 137 | 17.4 | 36.8 | 0.284 | 4.45 | 44.9 | 213 | 105 | 2750 |
| d | 0.375 | 14 | 137 | 22.5 | 41.4 | 0.315 | 4.27 | 47.1 | 107 | 110 | 2650 |
| d | 0.939 | 23.4 | 137 | 37.9 | 74.9 | 0.483 | 6.9 | 32.8 | 243 | 107 | 4390 |
| d | 1.75 | 28 | 137 | 41.7 | 70 | 0.558 | 9.49 | 34.4 | 243 | 110 | 4170 |
| d | 0.831 | 16.6 | 137 | 19.7 | 83.3 | 0.405 | 7.25 | 35.8 | 122 | 186 | 1380 |
| d | 1.25 | 12.6 | 137 | 20.7 | 101 | 0.366 | 6.21 | 39.3 | 122 | 203 | 1370 |
| d | 2.08 | 104 | 6370 | 27 | 48.9 | 0.668 | 15.3 | 26.9 | 156 | 251 | 1390 |
| d | 1.99 | 102 | 9470 | 30.5 | 51.8 | 0.65 | 10.3 | 28.2 | 328 | 276 | 1390 |
| d | 0.0695 | 2.18 | 4440 | 0.562 | 1.59 | 0.052 | 1.73 | 36.6 | 24.3 | 92.1 | 18.9 |
| d | 0.0695 | 1.3 | 4580 | 0.546 | 1.59 | 0.126 | 2.29 | 33 | 31.3 | 95.5 | 33.3 |
| d | 0.0695 | 1.3 | 6790 | 0.757 | 1.59 | 0.0251 | 0.703 | 44 | 3.44 | 147 | 18.9 |
| d | 0.0695 | 0.151 | 5670 | 0.729 | 1.59 | 0.0251 | 0.703 | 47.1 | 3.44 | 156 | 44.8 |
| d | 0.553 | 0.151 | 4960 | 2.28 | 7.12 | 0.151 | 1.14 | 35.4 | 36.5 | 71.6 | 115 |
| d | 0.246 | 0.151 | 5370 | 2.28 | 8.66 | 0.0251 | 3.02 | 39 | 31.3 | 80.3 | 95.6 |
| d | 0.0695 | 5.14 | 2900 | 1.57 | 6.6 | 0.0996 | 2.29 | 25 | 107 | 117 | 135 |
| d | 0.495 | 1.3 | 4020 | 1.54 | 7.64 | 0.197 | 4.8 | 26.1 | 76.2 | 132 | 95.6 |
| e | 0.0695 | 0.151 | 8170 | 1.17 | 4.36 | 0.138 | 3.02 | 54.7 | 17.4 | 174 | 105 |
| e | 0.246 | 1.3 | 7650 | 1.12 | 4.36 | 0.126 | 2.29 | 53.4 | 20.8 | 192 | 105 |
| e | 0.0695 | 2.97 | 5370 | 0.777 | 1.59 | 0.174 | 5.16 | 43.8 | 3.44 | 153 | 55.4 |
| e | 0.312 | 3.72 | 5710 | 0.775 | 4.94 | 0.23 | 2.66 | 44.3 | 31.3 | 168 | 105 |
| e | 0.0695 | 2.18 | 7070 | 1.67 | 1.59 | 0.126 | 4.45 | 54.1 | 3.44 | 164 | 75.7 |
| e | 0.0695 | 1.3 | 7510 | 1.61 | 5.51 | 0.0699 | 1.53 | 54.9 | 3.44 | 169 | 65.6 |
| e | 0.0695 | 0.151 | 7160 | 1.76 | 4.36 | 0.052 | 3.38 | 50.8 | 28.1 | 185 | 125 |
| e | 0.0695 | 1.3 | 12200 | 1.72 | 1.59 | 0.151 | 1.92 | 55.6 | 17.4 | 177 | 75.7 |
| e | 0.495 | 1.3 | 9850 | 1.28 | 7.64 | 0.126 | 2.66 | 55.2 | 31.3 | 182 | 39.2 |
| e | 0.0695 | 2.97 | 8240 | 1.28 | 1.59 | 0.0996 | 1.14 | 55.9 | 10.4 | 202 | 18.9 |
| e | 0.666 | 0.151 | 7580 | 1.25 | 9.66 | 0.174 | 4.27 | 50.3 | 68.4 | 184 | 105 |
| e | 0.246 | 7.12 | 8890 | 1.24 | 8.66 | 0.197 | 7.25 | 52.2 | 27.8 | 205 | 65.6 |
| e | 0.0695 | 0.151 | 5770 | 0.728 | 3.12 | 0.0251 | 1.92 | 55.4 | 3.44 | 186 | 105 |
| e | 0.375 | 0.151 | 6450 | 0.698 | 8.66 | 0.219 | 2.29 | 52.8 | 36.5 | 180 | 85.7 |
| e | 0.0695 | 0.151 | 8930 | 1.38 | 1.59 | 0.113 | 3.38 | 54.6 | 3.44 | 184 | 18.9 |
| e | 0.0695 | 2.18 | 7480 | 1.29 | 1.59 | 0.0251 | 3.2 | 52.6 | 3.44 | 176 | 18.9 |
| e-pool1 | 1.45 | 27.1 | 5360 | 13.5 | 32.2 | 0.425 | 17.5 | 38.1 | 317 | 110 | 4650 |
| e-pool1 | 1.35 | 23.4 | 5830 | 17.5 | 34 | 0.366 | 9.32 | 37.2 | 246 | 98.8 | 4130 |
| e-pool1 | 1.35 | 28.3 | 5790 | 13.8 | 31.2 | 0.325 | 18.8 | 36.1 | 269 | 98.8 | 4510 |
| e-pool1 | 1.45 | 21.7 | 8280 | 17.2 | 28 | 0.415 | 12.2 | 39.1 | 272 | 103 | 4410 |
| e-pool1 | 1.45 | 25.7 | 4280 | 14 | 40.5 | 0.445 | 16.4 | 37.5 | 317 | 99.3 | 4830 |
| e-pool1 | 1.25 | 21.1 | 4010 | 13.4 | 34 | 0.366 | 9.66 | 39.2 | 298 | 107 | 4800 |
| e-pool1 | 1.75 | 22.3 | 6250 | 15.3 | 42.4 | 0.325 | 26.8 | 40.2 | 328 | 106 | 4430 |
| e-pool1 | 1.85 | 22.8 | 5980 | 15.9 | 35.9 | 0.445 | 14.4 | 38.7 | 302 | 106 | 4580 |
| e-pool1 | 1.55 | 26.2 | 5440 | 14.2 | 32.2 | 0.425 | 24.5 | 36.6 | 328 | 105 | 5750 |
| e-pool1 | 1.45 | 26.8 | 6140 | | 41.4 | 0.549 | 13.7 | 39.7 | 377 | 107 | 4780 |
| e-pool3 | 1.65 | 22.3 | 6730 | 15.2 | 34.9 | 0.405 | 14.4 | 37.2 | 332 | 98.4 | 2390 |
| e-pool2 | 1.55 | 24 | 8010 | 19.2 | 25.7 | 0.386 | 11 | 35 | 250 | 96.7 | 2160 |
| e-pool2 | 1.35 | 29.7 | 4550 | 16.8 | 34 | 0.425 | 14.4 | 33.5 | 228 | 101 | 2420 |
| e-pool2 | 1.25 | 24.5 | 5540 | 16.5 | 29.9 | 0.425 | 8.28 | 35.9 | 257 | 100 | 2320 |
| e-pool2 | 1.35 | 26.8 | 6730 | 15.8 | 31.2 | 0.445 | 9.32 | 35 | 243 | 97.1 | 2330 |
| e-pool2 | 0.939 | 21.1 | 4930 | 19.8 | 28.5 | 0.366 | 8.46 | 38.6 | 175 | 92.8 | 2250 |
| e-pool2 | 1.04 | 26 | 5710 | 17.1 | 29.4 | 0.356 | 7.25 | 36.8 | 175 | 96.6 | 2350 |
| e-pool2 | 1.25 | 24 | 6500 | 19.1 | 28.5 | 0.445 | 5.16 | 36 | 175 | 92.7 | 2120 |
| e-pool2 | 0.831 | 20.5 | 6760 | 26.5 | 24.3 | 0.335 | 12.4 | 37 | 265 | 104 | 2050 |
| e-pool2 | 1.15 | 21.4 | 5940 | 20.1 | 28.5 | 0.284 | 6.21 | 35.4 | 145 | 94 | 2330 |
| f | 0.281 | 2.89 | 2390 | 0.432 | 4.12 | 0.435 | 1.81 | 53 | 18.6 | 209 | 143 |
| f | 0.281 | 0.377 | 2910 | 0.718 | 4.12 | 0.0261 | 0.449 | 45.2 | 18.6 | 89.5 | 143 |
| f | 0.457 | 0.377 | 3030 | 0.424 | 17.1 | 0.0261 | 0.0798 | 53 | 18.6 | 94.6 | 143 |
| f | 0.876 | 0.377 | 2620 | 0.615 | 14.4 | 0.0261 | 0.349 | 14.3 | 18.6 | 95.4 | 143 |
| f | 0.457 | 0.377 | 2710 | 0.353 | 4.12 | 0.0261 | 0.0798 | 45.1 | 18.6 | 117 | 143 |
| f | 0.281 | 0.377 | 2580 | 0.173 | 4.12 | 0.0261 | 2.87 | 28.3 | 18.6 | 88.8 | 143 |
| f | 0.876 | 0.377 | 2580 | 0.31 | 13.5 | 0.0261 | 0.554 | 52 | 34.1 | 101 | 143 |
| f | 0.457 | 0.377 | 3680 | 1.01 | 6.51 | 0.0261 | 0.554 | 58.9 | 18.6 | 109 | 143 |
| f | 0.281 | 0.377 | 14000 | 1.13 | 4.12 | 0.0261 | 0.0798 | 71.3 | 18.6 | 110 | 143 |
| f | 0.281 | 0.377 | 5070 | 1.5 | 18 | 0.0261 | 0.0798 | 60.2 | 18.6 | 88.8 | 143 |
| f | 0.281 | 0.377 | 9020 | 1.38 | 4.12 | 0.0261 | 0.349 | 67.7 | 18.6 | 101 | 143 |
| f | 0.457 | 0.377 | 5250 | 1.82 | 12.6 | 0.0261 | 0.253 | 76.6 | 58 | 184 | 143 |
| f | 0.69 | 0.377 | 9690 | 1.02 | 4.12 | 0.0579 | 0.554 | 84 | 18.6 | 170 | 143 |
| f | 0.281 | 0.377 | 5910 | 1.22 | 6.51 | 0.0261 | 0.0798 | 80 | 46.5 | 92.2 | 143 |
| f | 0.281 | 0.377 | 11400 | 1.55 | 5.36 | 0.0261 | 1.42 | 82.3 | 18.6 | 122 | 143 |
| f | 0.457 | 0.691 | 5910 | 1.43 | 4.12 | 0.105 | 0.449 | 67.7 | 18.6 | 93.1 | 143 |
| f | 1.78 | 0.377 | 3430 | 15.1 | 30.3 | 0.0261 | 3.25 | 57.7 | 46.5 | 70 | 2410 |
| f | 1.59 | 0.377 | 4900 | 26.3 | 38.6 | 0.0579 | 1.55 | 60.4 | 145 | 143 | 4740 |
| f | 1.83 | 0.691 | 2580 | 9.65 | 21.4 | 0.0261 | 2.74 | 51.5 | 175 | 87.7 | 8120 |
| f | 1.47 | 1.03 | 2970 | 29 | 33.4 | 0.15 | 0.0798 | 49.5 | 89.4 | 324 | 5490 |
| f | 0.583 | 0.377 | 12500 | 1.34 | 13.5 | 0.0261 | 0.904 | 70.8 | 18.6 | 189 | 738 |
| f | 1.19 | 0.691 | 2910 | 6.8 | 24.7 | 0.0676 | 3.13 | 61.9 | 46.5 | 179 | 1810 |
| f | 2.58 | 0.377 | 8450 | 5.22 | 34.1 | 0.0261 | 1.29 | 71.7 | 74.1 | 369 | 1620 |
| f | 1.83 | 1.19 | 3290 | 12.1 | 34.1 | 0.305 | 2.61 | 56.2 | 162 | 128 | 4300 |
| f | 1.19 | 0.377 | 5910 | 0.981 | 14.4 | 0.0261 | 1.03 | 79 | 52.3 | 92.1 | 143 |
| f | 0.876 | 0.377 | 6170 | 0.737 | 16.2 | 0.0261 | 0.0798 | 64.6 | 18.6 | 142 | 143 |
| f | 0.281 | 0.377 | 6770 | 0.199 | 6.51 | 0.0261 | 0.554 | 66.1 | 18.6 | 106 | 143 |
| f | 1.19 | 0.377 | 5450 | 0.31 | 4.12 | 0.0261 | 0.554 | 82.7 | 18.6 | 171 | 143 |
| f | 0.281 | 0.377 | 9020 | 0.769 | 4.12 | 0.0261 | 0.0798 | 65 | 18.6 | 207 | 143 |
| f | 0.876 | 0.377 | 5450 | 1.23 | 6.51 | 0.0261 | 0.0798 | 75.1 | 18.6 | 177 | 143 |
| f | 0.69 | 0.377 | 9020 | 1.4 | 4.12 | 0.0261 | 0.0798 | 77.2 | 16.6 | 114 | 143 |
| f | 1.19 | 0.377 | 5910 | 0.379 | 6.51 | 0.0261 | 1.42 | 78.4 | 18.6 | 106 | 143 |
| e-pool1 | 2 | 0.377 | 2860 | 15.2 | 43 | 0.0261 | 11.3 | 53.2 | 118 | 86.3 | 5650 |
| e-pool1 | 1.47 | 0.377 | 3030 | 15.8 | 40.1 | 0.0376 | 13.6 | 63.2 | 123 | 87.6 | 5630 |
| e-pool1 | 2.95 | 0.691 | 4450 | 13.6 | 49.9 | 0.0376 | 15.2 | 63.7 | 171 | 88.7 | 5810 |
| e-pool1 | 2.48 | 0.377 | 2670 | 12.9 | 56.7 | 0.0261 | 12.1 | 60 | 175 | 85.6 | 5300 |
| e-pool1 | 1.33 | 0.377 | 3290 | 13 | 44.4 | 0.0771 | 17.1 | 63.2 | 210 | 97.8 | 5250 |
| e-pool1 | 1.47 | 0.377 | 4320 | 13.8 | 37.1 | 0.0579 | 16.6 | 60.5 | 150 | 95.2 | 4920 |
| pool3 | 0.281 | 0.377 | 1150 | 1.05 | 4.12 | 0.0261 | 0.0798 | 16.7 | 18.6 | 193 | 143 |
| pool3 | 0.457 | 0.377 | 1050 | 0.945 | 8.63 | 0.0261 | 0.449 | 14.6 | 18.6 | 177 | 143 |
| pool3 | 0.281 | 0.377 | 1210 | 1 | 4.12 | 0.0261 | 1.29 | 17.2 | 18.6 | 209 | 143 |
| pool3 | 0.281 | 0.377 | 1060 | 1.06 | 4.12 | 0.0261 | 0.664 | 17.7 | 18.6 | 193 | 143 |
| pool3 | 0.281 | 0.377 | 996 | 0.975 | 4.12 | 0.0261 | 4.12 | 15.2 | 18.6 | 184 | 143 |
| pool3 | 1.33 | 0.377 | 1140 | 0.963 | 10.6 | 0.0261 | 0.449 | 16.3 | 52.3 | 185 | 143 |
| pool3 | 0.161 | 0.455 | 1810 | 0.969 | 7.22 | 0.0496 | 0.954 | 12.4 | 16.8 | 160 | 49.1 |
| pool3 | 0.417 | 0.412 | 2060 | 0.934 | 4.7 | 0.0645 | 2.33 | 13.9 | 28.6 | 158 | 49.1 |
| pool3 | 0.974 | 0.19 | 1560 | 0.905 | 4.7 | 0.11 | 2.88 | 14.6 | 34.6 | 156 | 74.9 |
| pool3 | 0.417 | 0.19 | 1770 | 0.893 | 12.3 | 0.00964 | 2.47 | 16.4 | 1.83 | 158 | 49.1 |
| e-pool1 | 2.2 | 0.873 | 4570 | 18.4 | 44.7 | 0.125 | 6.79 | 52.6 | 138 | 74.6 | 6640 |
| e-pool1 | 2.27 | 1.05 | 5070 | 16.1 | 46.1 | 0.14 | 4.67 | 45.6 | 138 | 68.9 | 6260 |
| e-pool1 | 2.97 | 0.838 | 4930 | 15.6 | 48.8 | 0.11 | 3.85 | 50.6 | 191 | 71.3 | 6150 |
| d | 0.761 | 0.19 | 643 | 0.472 | 5.96 | 0.0194 | 1.22 | 12.7 | 1.83 | 89.4 | 49.1 |
| d | 0.761 | 0.365 | 2340 | 0.0471 | 4.7 | 0.0348 | 2.05 | 29.7 | 11.1 | 116 | 49.1 |
| d | 0.417 | 0.19 | 1120 | 1.19 | 4.7 | 0.057 | 3.16 | 58.9 | 1.83 | 55.3 | 49.1 |
| d | 0.832 | 0.365 | 122 | 1.66 | 7.22 | 0.0794 | 3.85 | 62.2 | 28.6 | 101 | 74.9 |
| d | 0.832 | 0.19 | 3550 | 0.453 | 6.59 | 0.0645 | 0.561 | 74 | 53.4 | 122 | 49.1 |

| | IL-11 | IL-12p70 | IL-17 | IL-18 | IL-1a | IL-1b | IL-2 | IL-3 | IL-4 | IL-5 | IL-6 | IL-7 | Insulin |
|---|---|---|---|---|---|---|---|---|---|---|---|---|---|
| Exp. | pg/ml | ng/ml | ng/ml | ng/ml | pg/ml | ng/ml | pg/ml | pg/ml | pg/ml | ng/ml | pg/ml | ng/ml | uIU/ml |
| c | 91.5 | 0.139 | 0.0129 | 1.18 | 223 | 0.208 | 7.54 | 16.5 | 26.9 | 0.0891 | 15 | 0.198 | |
| c | 82.2 | 0.243 | 0.0344 | 0.98 | 302 | 0.172 | 15.9 | 26.4 | 20.1 | 0.112 | 22.2 | 0.198 | |
| c | 91.5 | 0.166 | 0.0129 | 1.22 | 252 | 0.208 | 9.52 | 19.5 | 18.4 | 0.0891 | 16 | 0.198 | |
| c | 96.3 | 0.447 | 0.0684 | 1.1 | 207 | 0.276 | 11.6 | 33.1 | 39.8 | 0.112 | 33.5 | 0.198 | |
| c | 82.2 | 0.0545 | 0.0235 | 1.24 | 199 | 0.276 | 7.54 | 19.8 | 23.6 | 0.156 | 14 | 0.198 | |
| c | 111 | 0.243 | 0.0569 | 1.26 | 367 | 0.225 | 12.6 | 34.3 | 20.1 | 0.134 | 18 | 0.198 | |
| c | 140 | 0.0848 | 0.0235 | 1.1 | 210 | 0.243 | 13.7 | 17.6 | 69.5 | 0.0891 | 17 | 0.198 | |
| c | 63.7 | 0.0848 | 0.0569 | 0.856 | 103 | 0.243 | 13.7 | 12.2 | 20.1 | 0.0433 | 18 | 0.198 | |
| c | 487 | 1.24 | 0.152 | 2.24 | 1130 | 0.341 | 63.9 | 299 | 115 | 0.222 | 1900 | 0.198 | |
| c | 690 | 1.78 | 0.272 | 2.55 | 1710 | 0.446 | 116 | 500 | 158 | 0.244 | 7100 | 0.351 | |
| c | 318 | 1.02 | 0.134 | 1.78 | 1060 | 0.341 | 59.9 | 273 | 133 | 0.2 | 731 | 0.198 | |
| c | 917 | 2.67 | 0.509 | 1.84 | 3040 | 0.77 | 143 | 792 | 251 | 0.411 | 78800 | 0.487 | |
| c | 852 | 2.32 | 0.52 | 1.93 | 2880 | 0.309 | 199 | 876 | 243 | 0.244 | 78800 | 0.324 | |
| c | 278 | 0.849 | 0.0684 | 1.75 | 902 | 0.372 | 30.1 | 172 | 103 | 0.2 | 527 | 0.198 | |
| c | 228 | 0.574 | 0.116 | 1.58 | 518 | 0.372 | 22.8 | 91.3 | 83.4 | 0.233 | 269 | 0.198 | |
| c | 238 | 0.294 | 0.0344 | 1.56 | 445 | 0.341 | 25.2 | 71.8 | 42.9 | 0.178 | 241 | 0.198 | |
| c | 263 | 0.625 | 0.0978 | 1.26 | 855 | 0.172 | 45.4 | 176 | 77.9 | 0.134 | 365 | 0.198 | |
| c | 221 | 0.578 | 0.0746 | 1.57 | 535 | 0.371 | 27.4 | 112 | 47.3 | 0.152 | 209 | 0.0946 | |
| c | 123 | 0.39 | 0.0896 | 1.11 | 313 | 0.404 | 19.5 | 52.3 | 46.3 | 0.0762 | 230 | 0.0341 | |
| c | 150 | 0.321 | 0.0821 | 1.14 | 229 | 0.139 | 23 | 51.7 | 36.3 | 0.0614 | 93.7 | 0.0225 | |
| c | 105 | 0.338 | 0.0265 | 1.37 | 219 | 0.292 | 16.2 | 40.5 | 40.3 | 0.106 | 110 | 0.0225 | |
| c | 224 | 0.941 | 0.0821 | 2.09 | 635 | 0.292 | 39.5 | 164 | 70.1 | 0.159 | 330 | 0.118 | |
| c | 244 | 0.72 | 0.0746 | 1.66 | 498 | 0.338 | 24.7 | 129 | 48.3 | 0.121 | 209 | 0.0655 | |
| c | 191 | 0.803 | 0.136 | 1.66 | 679 | 0.268 | 66.7 | 172 | 101 | 0.121 | 532 | 0.0618 | |
| d | 85.5 | 0.494 | 1.24 | 1.15 | 236 | 0.218 | 48.3 | 160 | 99.5 | 0.0649 | 11900 | 0.87 | 5.26 |
| d | 13.1 | 0.402 | 0.719 | 1.99 | 190 | 0.57 | 39.6 | 136 | 70.2 | 0.116 | 6540 | 0.252 | 10.8 |
| d | 195 | 0.283 | 0.121 | 2.19 | 94 | 0.325 | 52.6 | 82.4 | 64.8 | 0.0566 | 1360 | 0.618 | 3.15 |
| d | 55.1 | 0.371 | 0.817 | 1.84 | 202 | 0.542 | 39.6 | 137 | 64.8 | 0.133 | 6600 | 0.618 | 4.33 |
| c | 47.3 | 0.283 | 0.121 | 1.13 | 164 | 0.626 | 39.6 | 50.3 | 75.4 | 0.032 | 8.07 | 0.89 | 1.77 |
| c | 33.3 | 0.184 | 0.061 | 0.974 | 153 | 0.179 | 30 | 35.1 | 44.1 | 0.0817 | 14.1 | 0.87 | 0.766 |
| c | 47.3 | 0.12 | 0.0435 | 1.1 | 169 | 0.325 | 6.19 | 25.4 | 34.1 | 0.0649 | 4.79 | 0.48 | 2.06 |
| c | 18.2 | 0.133 | 0.0168 | 0.889 | 87.7 | 0.57 | 6.19 | 29.5 | 37.5 | 0.0159 | 6.48 | 0.362 | 2.85 |
| c | 13.1 | 0.108 | 0.0168 | 0.705 | 115 | 0.883 | 10.2 | 28.5 | 27.1 | 0.0484 | 4.79 | 0.469 | 1.62 |
| c | 38.4 | 0.184 | 0.0697 | | 258 | | 6.19 | 25.4 | 53.3 | | 9.61 | 0.618 | |
| c | 55.1 | 0.133 | 0.0168 | 1.02 | 115 | 0.39 | 74.2 | 45.2 | 108 | 0.032 | 11.1 | 0.533 | 2.45 |
| c | 5.39 | 0.0276 | 0.0168 | 0.932 | 71.6 | 0.255 | 39.6 | 23.3 | 40.8 | 0.0817 | 6.48 | 0.185 | 0.882 |
| c | 23.2 | 0.133 | 0.0168 | 1.02 | 158 | 0.57 | 10.2 | 45.2 | 40.8 | 0.0484 | 140 | 0.252 | 2.27 |
| c | 118 | 0.587 | 0.865 | | 750 | | 39.6 | 162 | 94.9 | | 11900 | 0.576 | |
| c | 123 | 1.01 | 1.15 | 2.11 | 363 | 1.4 | 180 | 181 | 133 | 0.379 | 11500 | 1.03 | 6.75 |
| c | 102 | 0.297 | 0.0347 | 1.66 | 195 | 0.57 | 18.2 | 64.3 | 56.3 | 0.2 | 102 | 0.555 | 2.88 |
| c | 55.1 | 0.432 | 0.0871 | 1.28 | 118 | 0.513 | 18.2 | 48 | 80.4 | 0.133 | 46.7 | 0.983 | 2.41 |
| c | 47.3 | 0.283 | 0.0168 | 1.37 | 195 | 0.39 | 6.19 | 48.4 | 59.2 | 0.0986 | 67.2 | 1.03 | 2.62 |
| c | 47.3 | 0.158 | 0.0168 | 1.42 | 118 | 0.57 | 6.19 | 38.5 | 27.1 | 0.166 | 60.1 | 0.469 | 3.15 |
| d | 2.77 | 0.184 | 0.0168 | 0.974 | 74.9 | 0.179 | 6.19 | 23.3 | 40.8 | 0.032 | 4.79 | 0.138 | 1.43 |
| d | 2.77 | 0.0276 | 0.0168 | 1.32 | 136 | 0.325 | 6.19 | 6.15 | 15 | 0.116 | 4.79 | 0.459 | 1.06 |
| d | 2.77 | 0.043 | 0.0168 | 1.32 | 164 | 0.39 | 10.2 | 10.9 | 47.2 | 0.0484 | 6.48 | 0.448 | 2.82 |
| d | 82.8 | 0.525 | 0.156 | 1.46 | 210 | 0.733 | 52.6 | 93.6 | 59.2 | 0.258 | 291 | 1.48 | 3.01 |
| d | 18.2 | 0.204 | 0.0168 | 1.42 | 106 | 0.68 | 18.2 | 64.7 | 27.1 | 0.133 | 220 | 0.448 | 2.95 |
| d | 96.2 | 0.108 | 0.0871 | 2.26 | 166 | 0.39 | 39.6 | 55.3 | 34.1 | 0.0986 | 1540 | 0.241 | 1.62 |
| d | 35.8 | 0.402 | 0.121 | 1.39 | 236 | 0.325 | 82.6 | 77.3 | 34.1 | 0.107 | 547 | 0.618 | 1.69 |
| d | 23.2 | 0.204 | 0.104 | 1.84 | 112 | 0.883 | 6.19 | 62.1 | 30.6 | 0.149 | 486 | 0.426 | 3.21 |
| d | 2.77 | 0.0276 | 0.0347 | 1.32 | 147 | 0.179 | 18.2 | 45.2 | 53.3 | 0.0817 | 137 | 0.34 | 0.92 |
| d | 50.9 | 0.108 | 0.0258 | 1.21 | 106 | 0.453 | 6.19 | 33.6 | 53.3 | 0.116 | 90.9 | 0.0845 | 2.55 |
| d | 49 | 0.228 | 0.0697 | 1.13 | 118 | 0.325 | 65.6 | 54.4 | 47.2 | 0.166 | 60.1 | 0.597 | 2.13 |
| d | 13.1 | 0.0824 | 0.0258 | 1.62 | 136 | 0.707 | 6.19 | 37.5 | 40.8 | 0.116 | 155 | 0.565 | 3.54 |
| d | 33.3 | 0.255 | 0.0523 | 1.46 | 112 | 0.453 | 31.3 | 41.4 | 90.1 | 0.183 | 77 | 0.533 | 2.41 |
| d | 30.1 | 0.337 | 0.0718 | 1.71 | 72.4 | 0.353 | 11.6 | 34.1 | 17 | 0.181 | 223 | 0.0709 | 0.558 |
| d | 17.2 | 0.337 | 0.0274 | 1.5 | 58.3 | 0.437 | 11.6 | 34.1 | 17 | 0.291 | 239 | 0.0709 | 0.558 |
| d | 17.2 | 0.337 | 0.0493 | 1.5 | 48.5 | 0.375 | 19.6 | 28.7 | 17 | 0.125 | 127 | 0.0709 | 0.558 |
| d | 17.2 | 0.337 | 0.00486 | 1.69 | 53.5 | 0.264 | 11.6 | 26 | 17 | 0.232 | 132 | 0.0709 | 0.558 |
| d | 139 | 0.337 | 0.0346 | 1.69 | 81.4 | 0.556 | 26.4 | 37.6 | 56.5 | 0.28 | 183 | 0.0912 | 3.62 |
| d | 124 | 0.337 | 0.0493 | 1.57 | 85.8 | 0.309 | 26.4 | 37.6 | 17 | 0.367 | 204 | 0.118 | 1.7 |
| d | 180 | 0.337 | 0.0949 | 1.64 | 103 | 0.353 | 50.3 | 57.8 | 78.1 | 0.291 | 157 | 0.0709 | 0.558 |
| d | 154 | 0.337 | 0.126 | 1.78 | 94.5 | 0.556 | 26.4 | 54.6 | 17 | 0.168 | 141 | 0.144 | 0.558 |
| d | 180 | 0.628 | 1.56 | 3.21 | 332 | 0.517 | 157 | 169 | 118 | 0.154 | 42000 | 0.131 | 1.7 |
| d | 226 | 0.729 | 1.66 | 3.01 | 362 | 0.437 | 157 | 164 | 148 | 0.232 | | 0.158 | 2.21 |
| d | 339 | 0.956 | 1.81 | 4.28 | 2180 | 1.4 | 218 | 192 | 137 | 0.207 | 139000 | 0.144 | 0.558 |
| d | 329 | 0.919 | 1.73 | 4.72 | 2160 | 1.5 | 238 | 212 | 162 | 0.181 | 161000 | 0.292 | 1.61 |
| d | 247 | 0.521 | 1.12 | 1.4 | 590 | 0.875 | 168 | 151 | 118 | 0.207 | 31000 | 0.184 | 0.558 |
| d | 293 | 0.521 | 1.24 | 1.24 | 645 | 0.613 | 137 | 161 | 83 | 0.207 | 32900 | 0.211 | 0.558 |
| d | 483 | 0.455 | 1.37 | 2.03 | 1390 | 2.81 | 147 | 156 | 110 | 1.36 | 16000 | 0.415 | 3.5 |
| d | 503 | 0.385 | 1.61 | 1.95 | 1400 | 2.8 | 147 | 151 | 126 | 1.3 | 18000 | 0.312 | 3.23 |
| d | 17.2 | 0.337 | 0.00486 | 1.18 | 155 | 0.0497 | 11.6 | 1.71 | 17 | 0.125 | 9.09 | 0.0709 | 0.558 |
| d | 17.2 | 0.337 | 0.00486 | 1.04 | 171 | 0.0497 | 11.6 | 1.71 | 17 | 0.0773 | 14.4 | 0.0709 | 0.558 |
| d | 17.2 | 0.337 | 0.00486 | 1.18 | 63.1 | 0.113 | 11.6 | 15.1 | 17 | 0.125 | 25.7 | 0.0709 | 0.558 |
| d | 17.2 | 0.337 | 0.00486 | 0.798 | 63.1 | 0.0497 | 11.6 | 10.8 | 17 | 0.0591 | 24.9 | 0.0709 | 0.558 |
| d | 62.6 | 0.337 | 0.0642 | 1.69 | 122 | 0.264 | 19.6 | 34.1 | 17 | 0.257 | 244 | 0.0709 | 0.558 |
| d | 109 | 0.337 | 0.119 | 1.53 | 107 | 0.517 | 61.6 | 36.5 | 17 | 0.0941 | 221 | 0.0709 | 0.558 |
| d | 154 | 0.337 | 0.142 | 1.3 | 72.4 | 0.375 | 26.4 | 24.9 | 36.6 | 0.28 | 74 | 0.0709 | 0.558 |
| d | 124 | 0.337 | 0.0642 | 1.32 | 48.5 | 0.458 | 38.7 | 23.4 | 50.4 | 0.207 | 68.6 | 0.0709 | 0.558 |
| e | 17.2 | 0.337 | 0.00486 | 1.48 | 109 | 0.192 | 38.7 | 27.2 | 17 | 0.195 | 105 | 0.0709 | 0.558 |
| e | 17.2 | 0.337 | 0.0949 | 0.939 | 115 | 0.167 | 61.6 | 27.2 | 17 | 0.154 | 89.3 | 0.0709 | 0.558 |
| e | 17.2 | 0.337 | 0.00486 | 1.45 | 143 | 0.309 | 11.6 | 19.6 | 17 | 0.168 | 66.8 | 0.0709 | 0.558 |
| e | 52.1 | 0.337 | 0.0642 | 1.6 | 151 | 0.396 | 72.6 | 24.9 | 62.3 | 0.0591 | 81.2 | 0.0709 | 0.558 |
| e | 17.2 | 0.337 | 0.00486 | 1.13 | 103 | 0.309 | 11.6 | 18.1 | 17 | 0.168 | 172 | 0.0709 | 0.558 |
| e | 17.2 | 0.337 | 0.00486 | 0.834 | 81.4 | 0.141 | 11.6 | 18.9 | 17 | 0.0591 | 155 | 0.0709 | 0.558 |
| e | 17.2 | 0.337 | 0.0567 | 1.18 | 101 | 0.0497 | 50.3 | 36.5 | 17 | 0.0941 | 212 | 0.0709 | 0.558 |
| e | 17.2 | 0.337 | 0.0203 | 1.21 | 88 | 0.0497 | 11.6 | 32.2 | 17 | 0.125 | 185 | 0.0709 | 0.558 |
| e | 17.2 | 0.337 | 0.0493 | 1.07 | 63.1 | 0.0497 | 11.6 | 14 | 50.4 | 0.14 | 65 | 0.0709 | 0.558 |
| e | 17.2 | 0.337 | 0.00486 | 1.07 | 38.1 | 0.113 | 11.6 | 10.1 | 17 | 0.0941 | 67.7 | 0.0709 | 0.558 |
| e | 52.1 | 0.337 | 0.0795 | 1.45 | 139 | 0.217 | 11.6 | 21.9 | 17 | 0.0591 | 66.8 | 0.0709 | 0.558 |
| e | 24 | 0.337 | 0.00486 | 1.45 | 98.7 | 0.353 | 11.6 | 12.2 | 17 | 0.28 | 52.5 | 0.0709 | 0.558 |
| e | 17.2 | 0.337 | 0.00486 | 1.5 | 92.3 | 0.113 | 26.4 | 18.9 | 17 | 0.181 | 43.7 | 0.0709 | 0.558 |
| e | 17.2 | 0.337 | 0.0795 | 1.24 | 107 | 0.309 | 105 | 16.6 | 50.4 | 0.154 | 52.5 | 0.0709 | 0.558 |
| e | 17.2 | 0.337 | 0.00486 | 1.13 | 60.7 | 0.0497 | 11.6 | 14.4 | 17 | 0.0591 | 112 | 0.0709 | 0.558 |
| e | 24 | 0.337 | 0.00486 | 1.3 | 76.9 | 0.167 | 11.6 | 7.89 | 17 | 0.125 | 98.4 | 0.0709 | 0.558 |
| e-pool1 | 380 | 0.768 | 1.92 | 2.83 | 411 | 1.44 | 198 | 184 | 141 | 0.456 | 38500 | 0.171 | 4 |
| e-pool1 | 257 | 0.607 | 1.85 | 2.58 | 388 | 1.2 | 208 | 174 | 118 | 0.447 | 50800 | 0.211 | 4 |
| e-pool1 | 360 | 0.807 | 1.99 | 2.63 | 377 | 1.23 | 213 | 174 | 148 | 0.466 | 40200 | 0.292 | 3.81 |
| e-pool1 | 303 | 0.648 | 1.77 | 2.73 | 356 | 1.16 | 188 | 175 | 175 | 0.408 | 53100 | 0.211 | 3.87 |
| e-pool1 | 350 | 1.06 | 2.03 | 2.9 | 415 | 1.21 | 223 | 193 | 162 | 0.503 | 40500 | 0.333 | 3.37 |
| e-pool1 | 411 | 0.768 | 1.76 | 2.9 | 411 | 1.31 | 267 | 201 | 134 | 0.456 | 45300 | 0.299 | 3.1 |
| e-pool1 | 324 | 0.882 | 2.06 | 2.97 | 464 | 1.44 | 208 | 185 | 200 | 0.572 | 39900 | 0.265 | 4 |
| e-pool1 | 339 | 0.919 | 1.96 | 3.13 | 407 | 1.19 | 296 | 181 | 162 | 0.547 | | 0.346 | 3.1 |
| e-pool1 | 401 | 1.03 | 2.1 | 3 | 468 | 1.41 | 253 | 212 | 188 | 0.538 | 43100 | 0.387 | 4.58 |
| e-pool1 | 380 | 1.2 | 1.85 | 2.93 | 415 | 1.27 | 277 | 208 | 197 | 0.484 | | 0.251 | 4.23 |
| e-pool3 | 319 | 0.729 | 2.27 | 1.95 | 366 | 1.16 | 188 | 173 | 134 | 0.456 | 37600 | 0.278 | 5.45 |
| e-pool2 | 288 | 0.607 | 2.14 | 1.74 | 339 | 1.04 | 188 | 149 | 148 | 0.408 | | 0.224 | 4.91 |
| e-pool2 | 314 | 0.689 | 2.14 | 1.78 | 313 | 1.16 | 168 | 152 | 126 | 0.447 | 38800 | 0.251 | 5.24 |
| e-pool2 | 278 | 0.565 | 2.17 | 1.74 | 369 | 1.16 | 208 | 169 | 162 | 0.447 | 49400 | 0.184 | 5.13 |
| e-pool2 | 175 | 0.648 | 2.07 | 1.87 | 347 | 1 | 162 | 161 | 110 | 0.367 | 35900 | 0.158 | 4.91 |
| e-pool2 | 226 | 0.337 | 2.14 | 1.62 | 324 | 0.941 | 126 | 147 | 134 | 0.493 | | 0.144 | 4.41 |
| e-pool2 | 257 | 0.385 | 2.01 | 1.74 | 337 | 1.04 | 147 | 137 | 130 | 0.484 | 37900 | 0.191 | 4 |
| e-pool2 | 206 | 0.521 | 1.72 | 1.74 | 293 | 0.973 | 116 | 134 | 92.4 | 0.408 | | 0.105 | 3.93 |
| e-pool2 | 185 | 0.521 | 1.87 | 1.82 | 328 | 1.02 | 88.9 | 142 | 118 | 0.346 | 54900 | 0.144 | 3.62 |
| e-pool2 | 206 | 0.455 | 1.85 | 1.55 | 313 | 0.973 | 126 | 146 | 110 | 0.428 | 52200 | 0.0912 | 2.96 |
| f | 3.92 | 0.0682 | 0.0561 | 0.00777 | 40.6 | 0.0689 | 12.5 | 5.32 | 71.1 | 0.0295 | 8.46 | 0.0322 | <LOW> |
| f | 3.92 | 0.0682 | 0.0561 | 0.00777 | 93.7 | 0.0266 | 12.5 | 5.32 | 71.1 | 0.0295 | 8.46 | 0.0508 | <LOW> |
| f | 3.92 | 0.0682 | 0.0561 | 0.723 | 87.7 | 0.0266 | 12.5 | 5.32 | 71.1 | 0.0295 | 8.46 | 0.0687 | <LOW> |
| f | 12.7 | 0.0682 | 0.0561 | 0.00777 | 118 | 0.0689 | 12.5 | 5.32 | 71.1 | 0.0295 | 16.9 | 0.0598 | <LOW> |
| f | 3.92 | 0.198 | 0.107 | 0.00777 | 44.4 | 0.135 | 12.5 | 5.32 | 71.1 | 0.0295 | 8.46 | 0.0322 | <LOW> |
| f | 3.92 | 0.0682 | 0.0561 | 0.64 | 5.97 | 0.119 | 12.5 | 5.32 | 71.1 | 0.105 | 8.46 | 0.0322 | <LOW> |
| f | 50.1 | 0.299 | 0.0561 | 0.00777 | 12 | 0.0266 | 30.4 | 5.32 | 108 | 0.0295 | 10 | 0.0687 | <LOW> |
| f | 3.92 | 0.0682 | 0.0561 | 0.00777 | 261 | 0.0266 | 12.5 | 5.32 | 71.1 | 0.0295 | 14.3 | 0.0508 | <LOW> |
| f | 12.7 | 0.0682 | 0.0561 | 0.00777 | 32.5 | 0.0266 | 12.5 | 5.32 | 71.1 | 0.0295 | 166 | 0.143 | <LOW> |
| f | 35.5 | 0.516 | 0.0771 | 0.00777 | 158 | 0.0689 | 12.5 | 8.5 | 71.1 | 0.0705 | 98.2 | 0.134 | <LOW> |
| f | 19.6 | 0.0682 | 0.155 | 0.373 | 46.3 | 0.0689 | 21.7 | 14.4 | 71.1 | 0.0295 | 171 | 0.124 | <LOW> |
| f | 35.5 | 0.39 | 0.197 | 0.168 | 80.1 | 0.135 | 81.5 | 22 | 71.1 | 0.0705 | 221 | 0.143 | <LOW> |
| f | 26.2 | 0.0682 | 0.0561 | 0.882 | 109 | 0.0266 | 63.8 | 10.3 | 71.1 | 0.23 | 99.3 | 0.162 | <LOW> |
| f | 26.2 | 0.0682 | 0.0561 | 0.00777 | 14.4 | 0.0266 | 12.5 | 9.71 | 71.1 | 0.0295 | 106 | 0.0322 | <LOW> |
| f | 3.92 | 0.0682 | 0.0561 | 1.18 | 53.6 | 0.31 | 12.5 | 10.9 | 71.1 | 0.0295 | 234 | 0.0322 | <LOW> |
| f | 63.7 | 0.0682 | 0.107 | 0.723 | 75.4 | 0.135 | 12.5 | 16.2 | 71.1 | 0.0295 | 193 | 0.0508 | <LOW> |
| f | 316 | 2.73 | 1.39 | 1.83 | 211 | 0.268 | 195 | 139 | 193 | 0.471 | 25000 | 0.572 | <LOW> |
| f | 376 | 2.81 | 1.22 | 3.63 | 298 | 0.135 | 195 | 152 | 210 | 0.802 | 74400 | 0.433 | <LOW> |
| f | 428 | 2.81 | 1.25 | 1.32 | 231 | 0.826 | 132 | 128 | 202 | 0.342 | 35300 | 0.376 | <LOW> |
| f | 376 | 2.52 | 1.24 | 5.27 | 238 | 0.391 | 195 | 135 | 175 | 0.72 | 55900 | 0.395 | <LOW> |
| f | 103 | 1.37 | 0.896 | 0.882 | 115 | 0.166 | 30.4 | 41.3 | 71.1 | 0.23 | 3120 | 0.0831 | <LOW> |
| f | 218 | 1.7 | 0.939 | 4.95 | 209 | 0.103 | 90.2 | 72.3 | 71.1 | 0.656 | 3820 | 0.221 | <LOW> |
| f | 206 | 1.86 | 0.794 | 2.06 | 188 | 0.119 | 90.2 | 73.9 | 161 | 0.446 | 17000 | 0.337 | <LOW> |
| f | 491 | 2.56 | 1.38 | 1.58 | 238 | 0.43 | 225 | 105 | 145 | 0.519 | 21000 | 0.405 | <LOW> |
| f | 77 | 0.299 | 0.236 | 0.168 | 166 | 0.0266 | 63.8 | 12.7 | 145 | 0.0295 | 78.9 | 0.0322 | <LOW> |
| f | 206 | 0.39 | 0.133 | 2.79 | 48.2 | 0.0266 | 30.4 | 22 | 92 | 0.0295 | 82.3 | 0.153 | <LOW> |
| f | 3.92 | 0.0682 | 0.0771 | 0.723 | 44.4 | 0.0266 | 12.5 | 5.32 | 71.1 | 0.0295 | 34.4 | 0.0831 | <LOW> |
| f | 50.1 | 0.299 | 0.0771 | 0.373 | 38.6 | 0.0266 | 12.5 | 12.7 | 128 | 0.0295 | 67.4 | 0.0508 | <LOW> |
| f | 12.7 | 0.0682 | 0.0581 | 0.168 | 30.4 | 0.0689 | 12.5 | 5.32 | 71.1 | 0.0295 | 58.2 | 0.0687 | <LOW> |
| f | 35.5 | 0.0682 | 0.0771 | 0.723 | 53.6 | 0.103 | 12.5 | 5.32 | 71.1 | 0.105 | 117 | 0.143 | <LOW> |
| f | 3.92 | 0.0682 | 0.0561 | 0.168 | 14.4 | 0.166 | 12.5 | 5.32 | 108 | 0.0295 | 107 | 0.0322 | <LOW> |
| f | 19.6 | 0.0682 | 0.0561 | 0.168 | 5.97 | 0.135 | 12.5 | 5.32 | 71.1 | 0.138 | 58.2 | 0.0508 | <LOW> |
| e-pool1 | 507 | 3.05 | 1.45 | 2.49 | 368 | 0.693 | 240 | 148 | 193 | 0.471 | 45600 | 0.49 | <LOW> |
| e-pool1 | 434 | 2.6 | 1.44 | 2.69 | 360 | 0.637 | 275 | 154 | 225 | 0.471 | 46600 | 0.433 | <LOW> |
| e-pool1 | 491 | 3.05 | 1.56 | 2.69 | 372 | 0.704 | 254 | 160 | 206 | 0.421 | 45900 | 0.545 | <LOW> |
| e-pool1 | 411 | 3.01 | 1.42 | 2.28 | 347 | 0.637 | 140 | 152 | 236 | 0.421 | 42400 | 0.508 | <LOW> |
| e-pool1 | 411 | 2.77 | 1.38 | 2.39 | 333 | 0.615 | 268 | 144 | 218 | 0.421 | 45500 | 0.452 | <LOW> |
| e-pool1 | 328 | 2.56 | 1.29 | 2.59 | 297 | 0.591 | 164 | 126 | 156 | 0.434 | 36100 | 0.357 | <LOW> |
| pool3 | 3.92 | 0.0682 | 0.0561 | 0.168 | 108 | 0.0266 | 12.5 | 5.32 | 71.1 | 0.0295 | 8.46 | 0.0322 | <LOW> |
| pool3 | 3.92 | 0.198 | 0.107 | 0.723 | 129 | 0.0266 | 44.9 | 5.32 | 71.1 | 0.105 | 8.46 | 0.0322 | <LOW> |
| pool3 | 3.92 | 0.0682 | 0.0561 | 0.723 | 81.6 | 0.135 | 12.5 | 5.32 | 71.1 | 0.105 | 8.46 | 0.0322 | <LOW> |
| pool3 | 3.92 | 0.25 | 0.0933 | 0.554 | 126 | 0.0266 | 12.5 | 5.32 | 71.1 | 0.0515 | 8.46 | 0.0322 | <LOW> |
| pool3 | 3.92 | 0.198 | 0.0561 | 0.554 | 105 | 0.0266 | 44.9 | 5.32 | 92 | 0.17 | 15.6 | 0.0322 | <LOW> |
| pool3 | 63.7 | 0.198 | 0.133 | 1.03 | 107 | 0.0266 | 44.9 | 5.32 | 71.1 | 0.105 | 27.1 | 0.0322 | <LOW> |
| pool3 | 73.1 | 0.23 | 0.00855 | 1.98 | 109 | 0.342 | 68.6 | 3.43 | 101 | 0.252 | | 0.0453 | 0.529 |
| pool3 | 61.9 | 0.333 | 0.0594 | 2.34 | 170 | 0.301 | 46.2 | 3.43 | 144 | 0.202 | 3.95 | 0.0453 | 1.12 |
| pool3 | 13.6 | 0.1 | 0.0897 | 2.16 | 156 | 0.194 | 68.6 | 3.43 | 131 | 0.252 | 9.24 | 0.0453 | 0.529 |
| pool3 | 61.9 | 0.426 | 0.0897 | 2.13 | 139 | 0.342 | 139 | 3.43 | 39.9 | 0.202 | 14 | 0.0453 | 0.529 |
| e-pool1 | 641 | 3.4 | 2.3 | 3.42 | 499 | 1.05 | 356 | 216 | 292 | 0.605 | 49500 | 0.581 | 4.68 |
| e-pool1 | 660 | 3.09 | 1.95 | 3.58 | 459 | 1.03 | 289 | 214 | 221 | 0.482 | 47200 | 0.733 | 3.74 |
| e-pool1 | 525 | 3.19 | 1.68 | 3.07 | 486 | 0.87 | 334 | 226 | 231 | 0.472 | 44500 | 0.517 | 4.09 |
| d | 29.5 | 0.1 | 0.0494 | 1.91 | 30.1 | 0.226 | 56.9 | 3.43 | 39.9 | 0.202 | 5.67 | 0.0453 | 1.72 |
| d | 7.97 | 0.1 | 0.00855 | 1.84 | 30.1 | 0.21 | 45.2 | 3.43 | 39.9 | 0.15 | 3.95 | 0.0453 | 0.529 |
| d | 50.9 | 0.1 | 0.00855 | 2.4 | 30.1 | 0.382 | 74.5 | 5.21 | 84.1 | 0.252 | 27.3 | 0.0453 | 1.97 |
| d | 191 | 0.595 | 0.0296 | 2.67 | 37.3 | 0.445 | 185 | 18.5 | 84.1 | 0.389 | 46.1 | 0.234 | 2.61 |
| d | 7.97 | 0.513 | 0.0694 | 1.98 | 30.1 | 0.315 | 68.6 | 3.43 | 156 | 0.228 | 23.1 | 0.0679 | 0.529 |

| | | | | | | MCP-1/ | | | | | | |
|---|---|---|---|---|---|---|---|---|---|---|---|---|
| | IP-10 | KC/GRO | Leptin | LIF | Lymphotactir | JE | MCP-3 | MCP-5 | M-CSF | MDC | MIP-1a | MIP-1b |
| Exp. | pg/ml | ng/ml | ng/ml | pg/ml | pg/ml | pg/ml | pg/ml | pg/ml | ng/ml | pg/ml | ng/ml | pg/ml |
| c | 93.4 | 0.128 | 1.4 | 28.5 | 154 | 64.3 | 500 | 294 | 1.98 | 142 | 6.74 | 61.9 |
| c | 121 | 0.167 | 1.19 | 42.2 | 176 | 111 | 888 | 358 | 2.75 | 138 | 4.53 | 61.9 |
| c | 104 | 0.224 | 0.985 | 42.2 | 184 | 77 | 450 | 235 | 1.87 | 81.7 | 6.38 | 9.4 |
| c | 127 | 0.154 | 1.4 | 42.2 | 193 | 77.8 | 475 | 283 | 2.05 | 79 | 6.74 | 48.6 |
| c | 139 | 0.0734 | 1.46 | 42.2 | 228 | 70.3 | 377 | 230 | 2.95 | 148 | 6.74 | 22.7 |
| c | 104 | 0.261 | 1.35 | 49.3 | 124 | 91.2 | 528 | 265 | 1.98 | 154 | 6.74 | 35.6 |
| c | 174 | 0.189 | 0.97 | 28.5 | 193 | 75.3 | 522 | 321 | 2.56 | 92.3 | 4.96 | 61.9 |
| c | 82.5 | 0.0975 | 0.93 | 1.78 | 141 | 56.3 | 317 | 161 | 1.12 | 61.2 | 4.96 | 9.4 |
| c | 2740 | 14.4 | 0.778 | 85.9 | 587 | 3850 | 6910 | 2970 | 3.74 | 603 | 9.8 | 2870 |
| c | 2770 | 70.6 | 0.985 | 120 | 700 | 14700 | 7740 | 3710 | 5.42 | 520 | 10.5 | 4850 |
| c | 2110 | 3.51 | 0.682 | 63.7 | 537 | 3390 | 7510 | 2790 | 2.87 | 302 | 8.47 | 1070 |
| c | 2210 | 128 | 1.57 | 378 | 603 | 36200 | 7360 | 5100 | 4.11 | 466 | 10.3 | 9550 |
| c | 2640 | 56.9 | 0.458 | 132 | 537 | 8920 | 7230 | 4180 | 2.7 | 435 | 13.3 | 11100 |
| c | 1190 | 3.75 | 1.02 | 71 | 424 | 1320 | 4990 | 1920 | 3.91 | 423 | 9.14 | 654 |
| c | 479 | 2.03 | 0.989 | 42.2 | 246 | 463 | 2550 | 960 | 3.67 | 256 | 9.47 | 203 |
| c | 277 | 2.99 | 0.682 | 63.7 | 193 | 379 | 1980 | 748 | 3.98 | 251 | 7.79 | 188 |
| c | 1500 | 1.45 | 0.503 | 21.8 | 394 | 779 | 3830 | 1500 | 1.32 | 279 | 6.07 | 420 |
| c | 907 | 2.19 | 0.679 | 50.3 | 206 | 816 | 3900 | 999 | 3.08 | 373 | 4.85 | 316 |
| c | 208 | 1.41 | 0.728 | 31.4 | 139 | 218 | 1780 | 550 | 1.38 | 208 | 4.21 | 102 |
| c | 224 | 0.311 | 0.543 | 26.8 | 142 | 220 | 1320 | 465 | 1.18 | 154 | 4.02 | 93.3 |
| c | 239 | 0.904 | 0.571 | 43.1 | 148 | 252 | 1190 | 421 | 2.6 | 215 | 5.1 | 75.3 |
| c | 2750 | 2.43 | 0.551 | 59.9 | 275 | 980 | 4650 | 1410 | 2.5 | 356 | 5.1 | 509 |
| c | 1990 | 0.874 | 0.408 | 36.1 | 351 | 980 | 4410 | 1010 | 2.42 | 279 | 4.76 | 375 |
| c | 1070 | 2 | 0.649 | 29.1 | 263 | 980 | 4650 | 1560 | 1.51 | 320 | 6.18 | 471 |
| d | 374 | 15.1 | 1.04 | 43.1 | 110 | 4890 | 5390 | 1950 | 1.62 | 433 | 1.79 | 11000 |
| d | 257 | 22.5 | 5.73 | 31.2 | 79 | 4640 | 6010 | 1870 | 1.74 | 201 | 2.65 | 8460 |
| d | 192 | 10.8 | 2.36 | 25.5 | 57.2 | 4150 | 5810 | 2570 | 2.5 | 248 | 0.747 | 616 |
| d | 338 | 31.9 | 5.68 | 49.3 | 53.6 | 5320 | 6380 | 2330 | 1.5 | 194 | 2.79 | 8700 |
| c | 71.2 | 0.0954 | 2.14 | 31.2 | 269 | 112 | 412 | 306 | 2.6 | 12 | 0.747 | 191 |
| c | 39.6 | 0.0335 | 1.41 | 17.2 | 118 | 106 | 531 | 281 | 2.84 | 8.84 | 0.574 | 0.876 |
| c | 39.6 | 0.0759 | 1.33 | 37.1 | 194 | 83.5 | 311 | 158 | 2.35 | 7.61 | 0.483 | 42.3 |
| c | 26.4 | 0.0335 | 1.47 | 25.5 | 147 | 67.5 | 280 | 155 | 2.29 | 4.15 | 0.662 | 11.2 |
| c | 28 | 0.0335 | 1.31 | 5.02 | 86.4 | 51.3 | 174 | 109 | 2.39 | 3.08 | 0.291 | 0.876 |
| c | 57 | 0.0954 | | | 143 | 113 | 331 | 201 | | | | 33.9 |
| c | 39.6 | 0.0556 | 1.01 | 31.2 | 181 | 67.5 | 313 | 189 | 2.87 | 7.61 | 0.574 | 91.8 |
| c | 23.2 | 0.0335 | 2.37 | 34.1 | 122 | 53.8 | 187 | 148 | 2.07 | 5.26 | 0.618 | 3.81 |
| c | 533 | 1:18 | 0.476 | 19.9 | 210 | 2400 | 5880 | 1780 | 2.26 | 21.1 | 0.389 | 235 |
| c | 542 | 35.3 | | | 210 | 12500 | 6470 | 2800 | | | | 6100 |
| c | 740 | 0.0335 | 0.73 | 316 | 329 | 12500 | 21100 | 4910 | 3.43 | 884 | 2.99 | 9050 |
| c | 288 | 1.53 | 0.735 | 68.6 | 219 | 1280 | 3500 | 1730 | 2.8 | 673 | 1.07 | 191 |
| c | 69.4 | 0.963 | 0.644 | 25.5 | 71.6 | 432 | 1520 | 769 | 1.74 | 293 | 0.747 | 72.6 |
| c | 50 | 1.35 | 0.59 | 43.1 | 160 | 468 | 1450 | 740 | 2.57 | 330 | 0.662 | 72.6 |
| c | 351 | 0.404 | 0.466 | 75.3 | 118 | 791 | 2420 | 1330 | 1.06 | 429 | 1.22 | 78.9 |
| d | 23.2 | 0.0335 | 2.03 | 5.02 | 71.6 | 104 | 553 | 263 | 1.51 | 108 | 0.389 | 0.876 |
| d | 17.1 | 0.0449 | 1.94 | 25.5 | 57.2 | 68.3 | 328 | 164 | 1.7 | 155 | 0.662 | 0.876 |
| d | 17.1 | 0.0759 | 2.28 | 37.1 | 106 | 86.6 | 350 | 164 | 1.69 | 167 | 0.483 | 24.3 |
| d | 727 | 4.2 | 0.735 | 58.8 | 293 | 4010 | 8760 | 2440 | 3.52 | 475 | 1.07 | 772 |
| d | 201 | 4.1 | 0.982 | 62.1 | 168 | 2250 | 5730 | 1920 | 2.98 | 448 | 1.22 | 547 |
| d | 254 | 8.39 | 1.89 | 43.1 | 36.5 | 1850 | 3180 | 1440 | 2.19 | 465 | 0.831 | 807 |
| d | 264 | 7.43 | 0.529 | 25.5 | 189 | 3040 | 4240 | 2310 | 2.02 | 414 | 1.15 | 1190 |
| d | 695 | 6.31 | 1.21 | 82.1 | 236 | 3040 | 5720 | 2260 | 4.07 | 759 | 1.15 | 1080 |
| d | 137 | 0.969 | 0.549 | 25.5 | 223 | 887 | 3520 | 1150 | 2.58 | 316 | 0.747 | 78.9 |
| d | 338 | 0.974 | 0.701 | 31.2 | 160 | 819 | 3170 | 1160 | 2.48 | 415 | 0.913 | 176 |
| d | 205 | 0.811 | 1.04 | 68.6 | 185 | 801 | 2740 | 1040 | 2.91 | 392 | 0.993 | 162 |
| d | 76.6 | 1.92 | 0.807 | 31.2 | 126 | 620 | 2030 | 726 | 3.4 | 324 | 1.07 | 206 |
| d | 118 | 0.737 | 1.03 | 19.9 | 177 | 381 | 1600 | 572 | 2.63 | 248 | 1.07 | 36.8 |
| d | 451 | 3.6 | 0.969 | 60.5 | 124 | 1730 | 7290 | 797 | 5.78 | 452 | 0.196 | 317 |
| d | 430 | 3.54 | 1.07 | 27.1 | 118 | 1840 | 7840 | 809 | 6.01 | 435 | 0.261 | 348 |
| d | 415 | 1.58 | 0.811 | 55 | 182 | 1430 | 5980 | 775 | 4.52 | 399 | 0.351 | 240 |
| d | 382 | 1.58 | 0.739 | 32.7 | 156 | 1340 | | 856 | 4.74 | 402 | 0.322 | 240 |
| d | 320 | 2.03 | 0.989 | 43.9 | 291 | 1650 | 6050 | 789 | 6.08 | 323 | 0.357 | 250 |
| d | 283 | 2.13 | 0.999 | 49.5 | 256 | 1630 | | 812 | 6.28 | 328 | 0.236 | 256 |
| d | 397 | 2.42 | 0.77 | 49.5 | 308 | 2550 | 9740 | 1080 | 6.17 | 385 | 0.261 | 411 |
| d | 385 | 2.41 | 0.687 | 27.1 | 272 | 2470 | 11000 | 1060 | 6.21 | 370 | 0.322 | 391 |
| d | 369 | 178 | 2.11 | 188 | 153 | 20400 | 37600 | 1660 | 3.81 | 287 | 17.4 | 33500 |
| d | 340 | 198 | 2.09 | 216 | 182 | 20600 | 38300 | 1620 | 3.96 | 279 | 19 | 43900 |
| d | 635 | 228 | 1.43 | 1230 | 160 | 23400 | 27400 | 1340 | 6.1 | 404 | 13.5 | 35500 |
| d | 658 | 227 | 1.51 | 1520 | 160 | 20500 | 26900 | 1340 | 6.13 | 489 | 13.8 | 37000 |
| d | 471 | 67.7 | 1.28 | 250 | 150 | 14600 | 26500 | 1490 | 4.39 | 446 | 1.15 | 8370 |
| d | 578 | 62.7 | 1.17 | 255 | 163 | 11000 | 22600 | 1640 | 4.56 | 410 | 1.07 | 7610 |
| d | 778 | 74.5 | 1.91 | 1150 | 346 | 11500 | 21700 | 1580 | 7.06 | 1120 | 1.15 | 6310 |
| d | 888 | 87.1 | 1.84 | 1090 | 324 | 11900 | 23400 | 1640 | 7.08 | 1150 | 1.2 | 6790 |
| d | 106 | 0.103 | 0.435 | 3.53 | 124 | 144 | 539 | 166 | 4.17 | 169 | 0.183 | 36.3 |
| d | 102 | 0.0564 | 0.397 | 3.53 | 105 | 131 | 542 | 170 | 4.34 | 174 | 0.169 | 25.7 |
| d | 189 | 0.544 | 0.77 | 3.53 | 40.4 | 850 | 4540 | 823 | 2.29 | 254 | 0.169 | 181 |
| d | 186 | 0.593 | 0.78 | 3.53 | 34 | 793 | | 787 | 2.08 | 251 | 0.169 | 161 |
| d | 179 | 3.48 | 1.31 | 27.1 | 137 | 1840 | 7360 | 725 | 4.77 | 275 | 0.249 | 348 |
| d | 176 | 3.57 | 1.38 | 21.3 | 163 | 1840 | | 708 | 5.09 | 305 | 0.196 | 315 |
| d | 183 | 0.947 | 0.515 | 52.2 | 234 | 730 | 3410 | 555 | 5.09 | 313 | 0.249 | 117 |
| d | 154 | 0.869 | 0.635 | 38.3 | 208 | 618 | | 531 | 5.22 | 310 | 0.261 | 130 |
| e | 145 | 1 | 0.76 | 9.63 | 118 | 1050 | 7520 | 797 | 3.33 | 296 | 0.183 | 149 |
| e | 156 | 1.09 | 0.729 | 15.5 | 118 | 1070 | | 873 | 3.29 | 287 | 0.169 | 149 |
| e | 145 | 0.713 | 0.692 | 9.63 | 85.7 | 932 | 6350 | 628 | 3.41 | 254 | 0.236 | 121 |
| e | 159 | 0.781 | 0.677 | 9.63 | 105 | 1010 | | 685 | 3.68 | 260 | 0.236 | 114 |
| e | 98.7 | 2.19 | 0.667 | 35.5 | 46.9 | 806 | 4600 | 546 | 3.07 | 231 | 0.236 | 185 |
| e | 91.2 | 2.16 | 0.583 | 21.3 | 72.8 | 809 | | 517 | 2.98 | 206 | 0.183 | 167 |
| e | 528 | 2.22 | 0.499 | 12.6 | 240 | 1150 | 5930 | 706 | 3.47 | 224 | 0.118 | 209 |
| e | 459 | 1.79 | 0.551 | 3.53 | 182 | 1170 | | 596 | 3.37 | 211 | 0.183 | 152 |
| e | 71.9 | 0.781 | 0.551 | 3.53 | 131 | 299 | 1960 | 394 | 3.12 | 173 | 0.196 | 66.2 |
| e | 55.7 | 0.593 | 0.562 | 21.3 | 59.8 | 304 | | 387 | 3.07 | 183 | 0.155 | 59.7 |
| e | 128 | 0.577 | 0.477 | 24.2 | 131 | 479 | 3510 | 548 | 3.55 | 268 | 0.223 | 98.4 |
| e | 83.6 | 0.51 | 0.53 | 27.1 | 144 | 437 | | 508 | 3.46 | 273 | 0.249 | 66.2 |
| e | 277 | 0.475 | 0.277 | 12.6 | 69.5 | 739 | 5050 | 592 | 2.97 | 286 | 0.155 | 141 |
| e | 238 | 0.56 | 0.327 | 15.5 | 72.8 | 799 | | 587 | 2.89 | 236 | 0.183 | 108 |
| e | 63.9 | 0.766 | 0.614 | 15.5 | 59.8 | 469 | 2620 | 390 | 3.24 | 171 | 0.141 | 79.2 |
| e | 55.7 | 0.642 | 0.625 | 9.63 | 40.4 | 463 | | 357 | 2.92 | 164 | 0.169 | 43.1 |
| e-pool1 | 346 | 68 | 5.97 | 456 | 237 | 14400 | 17400 | 1410 | 5.33 | 418 | 47.8 | 95600 |
| e-pool1 | 337 | 77.3 | 5.63 | 426 | 169 | 16600 | 19200 | 1280 | 5.07 | 400 | 45.5 | 147000 |
| e-pool1 | 344 | 68.8 | 5.67 | 446 | 195 | 15300 | 18400 | 1320 | 5.28 | 416 | 48.9 | 94100 |
| e-pool1 | 349 | 82.9 | 6.07 | 406 | 211 | 16500 | 19500 | 1300 | 5.28 | 427 | 46.7 | 134000 |
| e-pool1 | 397 | 67.8 | 6.01 | 466 | 246 | 15100 | 16700 | 1400 | 5.63 | 427 | 48 | 96400 |
| e-pool1 | 346 | 74.3 | 5.92 | 419 | 295 | 17300 | | 1340 | 5.31 | 426 | 46.2 | |
| e-pool1 | 361 | 67.7 | 5.91 | 454 | 253 | 15900 | 18400 | 1300 | 5.32 | 426 | 45.8 | 93500 |
| e-pool1 | 334 | | 5.68 | 391 | 240 | | | 1330 | 5.41 | 404 | 44.5 | |
| e-pool1 | 396 | 71.9 | 6.51 | 496 | 285 | 14700 | 17700 | 1380 | 5.57 | 507 | 53.4 | 92300 |
| e-pool1 | 329 | | 6.1 | 479 | 285 | | | 1390 | 5.75 | 454 | 49.6 | |
| e-pool3 | 253 | 52.1 | 3.14 | 265 | 189 | 15000 | 12400 | 1210 | 4.97 | 479 | 17 | 81200 |
| e-pool2 | 219 | | 3.11 | 285 | 189 | | | 1130 | 5.02 | 464 | 17 | |
| e-pool2 | 267 | 56.1 | 3.39 | 280 | 185 | 16300 | 13700 | 1250 | 5.24 | 522 | 17.9 | 89300 |
| e-pool2 | 261 | 58.2 | 3.24 | 341 | 169 | 18800 | | 1260 | 5.1 | 491 | 18.6 | |
| e-pool2 | 209 | 56.5 | 2.91 | 280 | 182 | 15600 | 13200 | 1110 | 4.74 | 514 | 18.3 | 83600 |
| e-pool2 | 212 | | 2.99 | 296 | 131 | | | 1070 | 4.98 | 446 | 16.1 | |
| e-pool2 | 242 | 55.4 | 3.08 | 270 | 179 | 15400 | 13800 | 1180 | 5.05 | 464 | 17.1 | 86100 |
| e-pool2 | 209 | | 3.01 | 326 | 105 | | | 1120 | 4.81 | 478 | 17.4 | |
| e-pool2 | 219 | 82.5 | 2.76 | 252 | 124 | 23500 | 18000 | 1090 | 4.81 | 441 | 18.1 | 125000 |
| e-pool2 | 199 | 72.3 | 2.52 | 229 | 92.1 | 21400 | 18500 | 1040 | 4.67 | 413 | 16.8 | 144000 |
| f | 27.7 | 0.137 | 0.83 | 7.3 | 105 | 55.2 | 344 | 42 | 4.65 | 115 | 0.177 | 40.2 |
| f | 54.9 | 0.137 | 0.236 | 7.3 | 105 | 121 | 615 | 112 | 4.71 | 102 | 0.0283 | 20.3 |
| f | 27.7 | 0.137 | 1.03 | 7.3 | 147 | 61.6 | 340 | 87.8 | 4.63 | 64.5 | 0.0283 | 22.7 |
| f | 32.5 | 0.137 | 0.876 | 7.3 | 94.7 | 70.1 | 352 | 108 | 4.79 | 84.3 | 0.0283 | 4.99 |
| f | 20.3 | 0.137 | 0.368 | 7.3 | 94.7 | 68 | 352 | 67.8 | 4.21 | 108 | 0.0283 | 27.7 |
| f | 22.8 | 0.137 | 0.706 | 7.3 | 89.3 | 68 | 309 | 67.8 | 3.67 | 96 | 0.0283 | 4.99 |
| f | 59.2 | 0.137 | 0.417 | 7.3 | 195 | 61.6 | 260 | 42 | 4.16 | 115 | 0.0283 | 25.2 |
| f | 37.1 | 0.137 | 0.563 | 7.3 | 147 | 61.6 | 344 | 94.6 | 4.79 | 104 | 0.0283 | 15.3 |
| f | 76.4 | 0.896 | 0.318 | 7.3 | 186 | 398 | 3250 | 519 | 4.96 | 183 | 0.0283 | 70.9 |
| f | 106 | 1.11 | 0.449 | 7.3 | 195 | 493 | 3940 | 486 | 4.79 | 192 | 0.0283 | 83.8 |
| f | 82.8 | 1.54 | 0.121 | 7.3 | 137 | 513 | 4190 | 558 | 5.37 | 227 | 0.177 | 78.6 |
| f | 216 | 2.95 | 0.384 | 7.3 | 256 | 715 | 4620 | 581 | 5.2 | 206 | 0.0283 | 99.3 |
| f | 216 | 1.38 | 1.05 | 7.3 | 242 | 640 | 6180 | 581 | 5.18 | 332 | 0.0283 | 122 |
| f | 178 | 0.989 | 0.17 | 7.3 | 142 | 485 | 4740 | 510 | 4.38 | 279 | 0.0283 | 76 |
| f | 84.9 | 1.87 | 0.351 | 95.3 | 166 | 550 | 4870 | 540 | 4.57 | 231 | 0.104 | 102 |
| f | 192 | 2.1 | 0.368 | 7.3 | 195 | 832 | 5240 | 604 | 4.65 | 203 | 0.0283 | 260 |
| f | 584 | 129 | 3.28 | 640 | 322 | 25600 | 39100 | 1660 | 5.37 | 624 | 3.95 | 17200 |
| f | 561 | 140 | 0.968 | 613 | 322 | 19100 | 48600 | 1880 | 7.23 | 796 | 1.46 | 10600 |
| f | 316 | 31.9 | 2.93 | 631 | 269 | 7650 | 11000 | 803 | 5.2 | 376 | 49.4 | 152000 |
| f | 532 | 109 | 1.02 | 850 | 287 | 21800 | 49200 | 1420 | 6.9 | 513 | 2.5 | 15700 |
| f | 231 | 4.73 | 2.19 | 121 | 94.7 | 1350 | 3070 | 598 | 4.49 | 149 | 0.531 | 16400 |
| f | 446 | 52.6 | 0.482 | 534 | 223 | 22000 | 27700 | 1300 | 6.6 | 406 | 1.28 | 10400 |
| f | 470 | 29.6 | 0.285 | 442 | 242 | 18500 | 31000 | 1510 | 4.9 | 689 | 0.489 | 5010 |
| f | 616 | 41.9 | 1.76 | 528 | 481 | 9770 | 11900 | 976 | 6.71 | 521 | 3.15 | 47200 |
| f | 216 | 0.564 | 0.153 | 7.3 | 233 | 997 | 8720 | 871 | 5.81 | 351 | 0.0283 | 188 |
| f | 379 | 1.11 | 0.409 | 7.3 | 278 | 644 | 6580 | 652 | 4.87 | 388 | 0.0283 | 203 |
| f | 122 | 0.137 | 0.236 | 7.3 | 205 | 489 | 5120 | 519 | 5.2 | 206 | 0.0283 | 70.9 |
| f | 224 | 0.488 | 0.277 | 7.3 | 233 | 567 | 3940 | 641 | 3.61 | 294 | 0.0283 | 112 |
| f | 174 | 0.684 | 0.587 | 7.3 | 205 | 264 | 1290 | 450 | 5.22 | 294 | 0.0283 | 76 |
| f | 59.2 | 1.44 | 0.466 | 7.3 | 171 | 302 | 1940 | 324 | 4.54 | 145 | 0.104 | 45.3 |
| f | 50.5 | 1.5 | 0.137 | 7.3 | 147 | 307 | 2900 | 334 | 4.76 | 156 | 0.0283 | 35.2 |
| f | 67.9 | 0.137 | 0.401 | 7.3 | 166 | 270 | 1940 | 298 | 3.94 | 162 | 0.0283 | 45.3 |
| e-pool1 | 403 | 75.8 | 5.68 | 625 | 313 | 16800 | 24400 | 1400 | 5.59 | 564 | 43.1 | 131000 |
| e-pool1 | 382 | 78.8 | 5.53 | 637 | 313 | 17400 | 23400 | 1330 | 5.64 | 502 | 41.6 | 118000 |
| e-pool1 | 377 | 74.4 | 5.68 | 649 | 352 | 15300 | 21500 | 1320 | 5.75 | 505 | 40.6 | 104000 |
| e-pool1 | 349 | 63 | 4.84 | 558 | 300 | 14900 | 19700 | 1170 | 5.01 | 462 | 36.4 | 106000 |
| e-pool1 | 335 | 70.8 | 5.22 | 631 | 309 | 15400 | 21500 | 1160 | 5.92 | 459 | 37.8 | 126000 |
| e-pool1 | 286 | 64.3 | 4.7 | 558 | 223 | 13400 | 19000 | 1020 | 5.2 | 430 | 36.6 | 103000 |
| pool3 | 20.3 | 0.137 | 2.48 | 34.1 | 8.06 | 33.8 | 75 | 24 | 5.61 | 104 | 0.0283 | 4.99 |
| pool3 | 41.6 | 0.137 | 2.19 | 7.3 | 72.5 | 32.6 | 61.9 | 32.8 | 5.09 | 92.1 | 0.0283 | 10.4 |
| pool3 | 20.3 | 0.137 | 2.35 | 43.4 | 23.2 | 30.2 | 67.2 | 15.6 | 5.31 | 119 | 0.0283 | 15.3 |
| pool3 | 32.5 | 0.137 | 2.43 | 34.1 | 8.06 | 35 | 61.9 | 24 | 6.14 | 108 | 0.0283 | 22.7 |
| pool3 | 39.3 | 0.137 | 2.33 | 52.1 | 89.3 | 41.9 | 77.7 | 35.8 | 5.61 | 109 | 0.0283 | 35.2 |
| pool3 | 41.6 | 0.137 | 2.27 | 84 | 121 | 44.1 | 72.4 | 74.4 | 5.15 | 111 | 0.0283 | 17.8 |
| pool3 | 74.4 | 0.0529 | 2.88 | 86.2 | 44.5 | 52.4 | 86.8 | 55.4 | 7.72 | 171 | 0.172 | 34.4 |
| pool3 | 83.6 | 0.185 | 2.81 | 52.9 | 91.9 | 48 | 65.5 | 48.5 | 7.11 | 176 | 0.191 | 77.9 |
| pool3 | 60.7 | 0.0807 | 2.85 | 65.5 | 75.8 | 49.1 | 86.8 | 27.2 | 6.17 | 208 | 0.172 | 25 |
| pool3 | 56.2 | 0.108 | 2.68 | 102 | 29 | 31.3 | 62.9 | 41.5 | 6.23 | 168 | 0.21 | 15.6 |
| e-pool1 | 605 | 79.5 | 6.5 | 801 | 490 | 17800 | 21700 | 1480 | 8.76 | 766 | 44.5 | 133000 |
| e-pool1 | 500 | 78.4 | 6.08 | 752 | 397 | 16800 | 21100 | 1450 | 8.07 | 732 | 41.7 | 131000 |
| e-pool1 | 531 | 73.1 | 5.76 | 702 | 387 | 17600 | 20000 | 1400 | 8.15 | 671 | 40.3 | 111000 |
| d | 69.9 | 0.0529 | 1.13 | 61.3 | 133 | 63.3 | 318 | 82.5 | 5.08 | 236 | 0.162 | 44 |
| d | 24.5 | 0.0529 | 1.31 | 86 | 25.1 | 55.7 | 216 | 75.8 | 5.47 | 125 | 0.108 | 39.2 |
| d | 156 | 0.241 | 1.52 | 94.3 | 168 | 187 | 708 | 152 | 5.24 | 282 | 0.237 | 97.4 |
| d | 134 | 0.599 | 0.685 | 181 | 285 | 437 | 870 | 250 | 5.71 | 298 | 0.313 | 198 |
| d | 74.4 | 0.135 | 0.465 | 52.9 | 87.8 | 197 | 419 | 99.2 | 6.84 | 152 | 0.172 | 48.8 |

| | | | | | | | | | | Tissue | | |
|---|---|---|---|---|---|---|---|---|---|---|---|---|
| | MIP-1g | MIP-2 | MIP-3b | Myoglobin | OSM | RANTES | SCF | SGOT | TIMP-1 | Factor | TNFa | TPO |
| Exp. | ng/ml | pg/ml | ng/ml | ng/ml | ng/ml | pg/ml | pg/ml | ug/ml | ng/ml | ng/ml | ng/ml | ng/ml |
| c | | 29.8 | 0.193 | 13.9 | 0.0616 | 61.2 | 21.1 | 0.733 | 1.8 | 6 | 0.0358 | 6.67 |
| c | | 32.9 | 0.193 | 13.8 | 0.0616 | 93.3 | 21.1 | 1.24 | 2.62 | 5.6 | 0.0591 | 6.88 |
| c | | 17.7 | 0.267 | 97 | 0.0616 | 54 | 21.1 | 1.42 | 1.57 | 8.32 | 0.0221 | 8.18 |
| c | | 29.8 | 0.243 | 189 | 0.0616 | 90.8 | 21.1 | 1.99 | 2.53 | 8.64 | 0.033 | 8.24 |
| c | | 29.8 | 0.243 | 3.28 | 0.0616 | 51.6 | 21.1 | 0.373 | 3.18 | 5.2 | 0.033 | 6.53 |
| c | | 36 | 0.34 | 51 | 0.0616 | 90.8 | 21.1 | 2.92 | 3.78 | 8.4 | 0.0443 | 7.37 |
| c | | 42.3 | 0.267 | 16.8 | 0.0616 | 49.3 | 21.1 | 1.24 | 1.95 | 6.16 | 0.0386 | 7.77 |
| c | | 14.7 | 0.0942 | 3.18 | 0.0616 | 42.3 | 21.1 | 10.4 | 1.47 | 4.64 | 0.0275 | 5.46 |
| c | | 1140 | 0.614 | 24.5 | 0.372 | 849 | 302 | 0.568 | 38.8 | 7.52 | 0.523 | 10.9 |
| c | | 4590 | 0.941 | 52.4 | 0.61 | 1180 | 528 | 0.167 | 63 | 9 | 0.875 | 13.8 |
| c | | 298 | 0.434 | 30.8 | 0.27 | 726 | 185 | 0.38 | 31.4 | 7.6 | 0.366 | 10.8 |
| c | | 17400 | 1.51 | 189 | 0.849 | 1790 | 954 | 0.983 | 50.1 | 15.5 | 1.27 | 12.9 |
| c | | 14300 | 1.02 | 32.1 | 0.74 | 1900 | 682 | 4.32 | 33.8 | 9.36 | 1.24 | 12.5 |
| c | | 240 | 0.434 | 47 | 0.155 | 474 | 97.3 | 0.568 | 14.5 | 8.24 | 0.184 | 9.36 |
| c | | 111 | 0.387 | 18 | 0.0616 | 272 | 21.1 | 0.88 | 11.9 | 7.4 | 0.124 | 9.36 |
| c | | 164 | 0.387 | 23.6 | 0.0661 | 181 | 43.5 | 0.983 | 9.99 | 7.2 | 0.107 | 8.51 |
| c | | 74.8 | 0.291 | 123 | 0.15 | 552 | 26.4 | 9.04 | 10.3 | 8.64 | 0.163 | 7.91 |
| c | | 154 | 0.472 | 20.3 | 0.142 | 330 | 172 | 1.12 | 12.4 | 5.62 | 0.151 | 6.33 |
| c | | 71.3 | 0.383 | 47.8 | 0.0569 | 186 | 69.7 | 4.74 | 4.53 | 5.85 | 0.0667 | 5.03 |
| c | | 56.5 | 0.294 | 67.1 | 0.0569 | 144 | 69.7 | 7.14 | 3.93 | 5.97 | 0.071 | 5.2 |
| c | | 67.6 | 0.383 | 7.31 | 0.0343 | 118 | 69.7 | 0.488 | 6.26 | 4.55 | 0.0583 | 5.36 |
| c | | 143 | 0.472 | 56 | 0.182 | 443 | 227 | 0.76 | 11.6 | 5.92 | 0.208 | 7.67 |
| c | | 83.5 | 0.472 | 16.4 | 0.138 | 337 | 129 | 0.496 | 8.49 | 5.26 | 0.151 | 7.26 |
| c | | 116 | 0.668 | 47.4 | 0.175 | 454 | 166 | 3.36 | 8.23 | 7.4 | 0.176 | 7.9 |
| d | | 1520 | 0.247 | 84.9 | 0.0979 | 288 | 117 | 6.65 | 61 | 1.03 | 0.479 | 6.63 |
| d | | 6230 | 0.284 | 302 | 0.0677 | 189 | 196 | 6.91 | 46.3 | 1.48 | 0.598 | 7.07 |
| d | | 296 | 0.393 | 302 | 0.0979 | 80.3 | 205 | 4.66 | 37.8 | 1.21 | 0.263 | 7.71 |
| d | | 9140 | 0.321 | 131 | 0.075 | 223 | 134 | 6.18 | 51.8 | 1.14 | 0.585 | 7.42 |
| c | | 18.6 | 0.0252 | 79.2 | 0.0677 | 83 | 214 | 0.932 | 3.4 | 1.44 | 0.207 | 4.45 |
| c | | 9.83 | 0.0252 | 56.4 | 0.0261 | 53.3 | 117 | 4.17 | 2.45 | 0.806 | 0.0369 | 4.05 |
| c | | 10.8 | 0.0637 | 302 | 0.0207 | 47.8 | 85.4 | 0.932 | 2.26 | 1.99 | 0.0369 | 5.14 |
| c | | 12.8 | 0.0252 | 302 | 0.0207 | 53.3 | 81.6 | 0.932 | 2.74 | 2.04 | 0.00622 | 4.52 |
| c | | 4.72 | 0.0637 | 10.2 | 0.00257 | 53.3 | 70.6 | 2.88 | 3.03 | 0.718 | 0.0412 | 3.26 |
| c | | 10.8 | | | 0.0261 | 75 | 134 | | 3.9 | | 0.0636 | |
| c | | 12.1 | 0.1 | 75.4 | 0.0605 | 102 | 101 | 0.932 | 2.05 | 1.23 | 0.0501 | 3.97 |
| c | | 4.28 | 0.0637 | 25.1 | 0.00641 | 36.9 | 57.1 | 5.05 | 1.61 | 0.939 | 0.0281 | 4.21 |
| c | | 108 | 0.0452 | 98.2 | 0.0261 | 80.3 | 77.9 | 2.43 | 19.5 | 1.35 | 0.0728 | 5.37 |
| c | | 9140 | | | 0.118 | 275 | 335 | | 99.7 | | 0.757 | |
| c | | 9140 | 0.893 | 189 | 0.225 | 461 | 408 | 1.65 | 261 | 3.34 | 0.93 | 12.5 |
| c | | 105 | 0.357 | 155 | 0.0156 | 164 | 125 | 0.932 | 10.5 | 2.41 | 0.107 | 8.05 |
| c | | 42.2 | 0.321 | 56.5 | 0.00257 | 125 | 85.4 | 6.79 | 7.63 | 2.22 | 0.0919 | 6.63 |
| c | | 107 | 0.173 | 77.3 | 0.0132 | 112 | 134 | 3.28 | 8.08 | 1.76 | 0.0456 | 7.07 |
| c | | 29.6 | 0.21 | 302 | 0.0108 | 96.4 | 57.1 | 4.62 | 7.78 | 2.66 | 0.0456 | 7.14 |
| d | | 4.72 | 0.0252 | 136 | 0.00257 | 56 | 42.9 | 5.66 | 1.81 | 1.74 | 0.00622 | 5.44 |
| d | | 4.06 | 0.173 | 302 | 0.00257 | 42.3 | 37.4 | 3.17 | 1.31 | 2.34 | 0.00622 | 7.63 |
| d | | 6.97 | 0.0252 | 302 | 0.00641 | 42.3 | 70.6 | 0.932 | 1.63 | 2.95 | 0.00622 | 6.92 |
| d | | 271 | 0.393 | 123 | 0.122 | 184 | 233 | 2.64 | 30.7 | 1.81 | 0.298 | 8.61 |
| d | | 288 | 0.357 | 183 | 0.0359 | 112 | 93.1 | 2.31 | 17 | 2.31 | 0.102 | 9.22 |
| d | | 373 | 0.357 | 140 | 0.0412 | 104 | 57.1 | 3.47 | 24.2 | 1.71 | 0.112 | 8.95 |
| d | | 466 | 0.357 | 137 | 0.0261 | 143 | 109 | 6.57 | 13.4 | 2.41 | 0.153 | 10.1 |
| d | | 594 | 0.429 | 49.7 | 0.0318 | 96.4 | 77.9 | 0.932 | 17.3 | 1.67 | 0.122 | 11.6 |
| d | | 43.9 | 0.173 | 302 | 0.0108 | 85.7 | 70.6 | 4.32 | 16 | 2.18 | 0.0728 | 7.21 |
| d | | 90.6 | 0.229 | 146 | 0.00257 | 56 | 42.9 | 5.13 | 12.1 | 2.04 | 0.0281 | 7.07 |
| d | | 97.6 | 0.284 | 86.8 | 0.0384 | 120 | 142 | 3.84 | 11.3 | 1.85 | 0.0728 | 7.63 |
| d | | 287 | 0.0637 | 302 | 0.0318 | 69.6 | 160 | 0.932 | 13.1 | 2.77 | 0.0682 | 8.33 |
| d | | 49.2 | 0.173 | 32.1 | 0.0261 | 85.7 | 77.9 | 0.932 | 12.7 | 1.76 | 0.0369 | 7.92 |
| d | 39.3 | 353 | 0.189 | 20.7 | 0.0959 | 29.6 | 95.8 | 2.7 | 22.1 | 1.27 | 0.137 | 11.4 |
| d | 46.3 | 344 | 0.399 | 42.1 | 0.11 | 31.7 | 51.8 | 2.82 | 24.4 | 1.72 | 0.137 | 12.6 |
| d | 44 | 152 | 0.455 | 18.9 | 0.0648 | 31.7 | 87.8 | 4.4 | 14.6 | 1.52 | 0.0983 | 10.7 |
| d | 46.5 | 147 | 0.455 | | 0.0648 | 23.8 | 63.9 | 3.58 | 14.7 | 1.3 | 0.0365 | 10.3 |
| d | 34.1 | 189 | 0.371 | 22.5 | 0.218 | 39.8 | 160 | 0.151 | 19.5 | 2.11 | 0.27 | 12.6 |
| d | 41.6 | 202 | 0.342 | | 0.117 | 37.8 | 192 | 0.211 | 22.1 | 1.89 | 0.258 | 11.3 |
| d | 39.3 | 215 | 0.342 | 21.3 | 0.165 | 68.5 | 233 | 1.2 | 22.5 | 1.72 | 0.329 | 12.2 |
| d | 46.8 | 212 | 0.221 | 51.7 | 0.271 | 55.8 | 160 | 0.812 | 20.9 | 1.66 | 0.234 | 13.7 |
| d | 68.2 | 41000 | 0.221 | 41.1 | 0.323 | 164 | 321 | 8.39 | 300 | 2.67 | 1.2 | 9.98 |
| d | 88.8 | 48500 | 0.157 | 75 | 0.349 | 172 | 321 | 7.23 | 326 | 3.09 | 1.13 | 11 |
| d | 130 | 61700 | 0.455 | 606 | 0.455 | 180 | 382 | 4.11 | 505 | 3.57 | 1.73 | 10.6 |
| d | 147 | 72700 | 0.482 | 780 | 0.508 | 191 | 378 | 4.24 | 511 | 4.02 | 1.71 | 11.7 |
| d | 167 | 12200 | 0.482 | 5750 | 0.297 | 131 | 229 | 7.99 | 235 | 2.98 | 0.786 | 12.3 |
| d | 204 | 9050 | 0.427 | 6060 | 0.349 | 123 | 241 | 9.4 | 201 | 2.45 | 1.01 | 11.8 |
| d | 149 | 14100 | 2.47 | 235 | 0.455 | 134 | 374 | 0.151 | 148 | 3.68 | 0.943 | 19 |
| d | 214 | 15700 | 2.55 | 387 | 0.494 | 143 | 442 | 0.151 | 182 | 3.46 | 1.13 | 18.4 |
| d | 24.8 | 18.9 | 0.107 | 75.1 | 0.0648 | 4.71 | 39.6 | 6.3 | 5.71 | 0.984 | 0.0365 | 6.33 |
| d | 28.1 | 18.2 | 0.124 | 74.2 | 0.0648 | 4.71 | 39.6 | 7.75 | 5.94 | 0.814 | 0.0365 | 6.33 |
| d | 37.6 | 53.1 | 0.221 | 10.5 | 0.0648 | 26.2 | 12.2 | 16 | 6.29 | 1.21 | 0.0365 | 7.52 |
| d | 42.5 | 42.9 | 0.157 | | 0.0648 | 4.71 | 12.2 | 17.3 | 5.86 | 0.671 | 0.0365 | 6.33 |
| d | 32.3 | 256 | 0.221 | 36.3 | 0.138 | 44.5 | 156 | 2.51 | 21.9 | 1.55 | 0.204 | 10.5 |
| d | 37.6 | 247 | 0.124 | | 0.152 | 41.7 | 104 | 3.48 | 21.2 | 1.49 | 0.162 | 11.5 |
| d | 31.9 | 99.8 | 0.141 | 35.7 | 0.117 | 27.3 | 120 | 1 | 13.3 | 1.72 | 0.15 | 9.07 |
| d | 32.5 | 77.3 | 0.189 | | 0.0959 | 33.8 | 164 | 0.917 | 12 | 1.55 | 0.131 | 11.3 |
| e | 39.4 | 42.1 | 0.0732 | 161 | 0.0648 | 29.6 | 43.7 | 16.6 | 8.33 | 2.06 | 0.0365 | 9.57 |
| e | | 33.7 | 0.157 | | 0.0648 | 41.7 | 87.8 | 18.2 | 8.61 | 2.03 | 0.0365 | 10.1 |
| e | 31.8 | 49.7 | 0.157 | 63 | 0.0648 | 25 | 12.2 | 13.4 | 6.73 | 1.32 | 0.0365 | 8.3 |
| e | 39.4 | 45.5 | 0.221 | | 0.0648 | 29.6 | 12.2 | 12.7 | 6.65 | 1.58 | 0.0365 | 9.81 |
| e | 35 | 134 | 0.124 | 48.3 | 0.0648 | 35.9 | 12.2 | 18.4 | 9.26 | 2.11 | 0.0365 | 9.65 |
| e | 42.6 | 129 | 0.107 | | 0.0648 | 35.9 | 12.2 | 20.1 | 8.99 | 1.83 | 0.0365 | 8.3 |
| e | 31.5 | 123 | 0.157 | 63 | 0.0809 | 50.7 | 55.9 | 18.9 | 11.6 | 2.06 | 0.112 | 11.3 |
| e | 41.9 | 87.9 | 0.157 | | 0.0648 | 33.8 | 55.9 | 19.7 | 10.2 | 1.55 | 0.0841 | 9.98 |
| e | 32 | 65.5 | 0.124 | 42.3 | 0.0809 | 37.8 | 71.9 | 15.4 | 8 | 1.49 | 0.162 | 10.9 |
| e | 41.6 | 54.2 | 0.0905 | | 0.0648 | 26.2 | 31.2 | 16.1 | 7.64 | 1.27 | 0.0365 | 9.15 |
| e | 31.5 | 67.3 | 0.221 | 108 | 0.0648 | 41.7 | 63.9 | 12.2 | 7.47 | 2.06 | 0.131 | 9.65 |
| e | 44.4 | 36.7 | 0.342 | | 0.0648 | 27.3 | 47.8 | 12.9 | 6.79 | 2.14 | 0.0365 | 10.5 |
| e | 34.1 | 45.9 | 0.221 | 42.9 | 0.0648 | 31.7 | 71.9 | 16.3 | 6.86 | 1.49 | 0.0365 | 8.65 |
| e | | 28.3 | 0.221 | | 0.0648 | 45.4 | 79.9 | 19.2 | 6 | 1.78 | 0.0365 | 7.78 |
| e | 33.4 | 83.5 | 0.0905 | 87.5 | 0.0648 | 17.1 | 12.2 | 18.3 | 8.31 | 1.32 | 0.0365 | 8.98 |
| e | 44.5 | 61 | 0.107 | | 0.0648 | 4.71 | 12.2 | 20 | 7.9 | 1.1 | 0.0365 | 9.32 |
| e-pool1 | 57 | 29100 | 0.637 | 132 | 0.494 | 183 | 261 | 1.03 | 410 | 4.85 | 2 | 14.7 |
| e-pool1 | 78 | 39200 | 0.599 | 204 | 0.402 | 164 | 241 | 1.01 | 476 | 4.8 | 1.73 | 13.1 |
| e-pool1 | 59.1 | 31800 | 0.561 | 118 | 0.508 | 175 | 293 | 0.427 | 426 | 4.52 | 1.84 | 14.4 |
| e-pool1 | 73 | 39900 | 0.509 | 116 | 0.376 | 172 | 329 | 1.29 | 486 | 3.93 | 1.84 | 15.8 |
| e-pool1 | 61.6 | 31700 | 0.455 | 150 | 0.468 | 197 | 386 | 0.359 | 462 | 5.52 | 2.16 | 16.4 |
| e-pool1 | 60 | 36000 | 0.455 | 164 | 0.547 | 187 | 313 | 0.151 | 517 | 4.68 | 2.02 | 14.5 |
| e-pool1 | 62 | 31000 | 0.685 | 128 | 0.508 | 173 | 305 | 0.388 | 448 | 4.88 | 1.83 | 17.4 |
| e-pool1 | 70.2 | | 0.709 | | 0.455 | 172 | 418 | 0.677 | | 4.43 | 1.96 | 14.1 |
| e-pool1 | 58.6 | 28800 | 0.637 | 122 | 0.508 | 201 | 362 | 0.151 | 406 | 5.19 | 2.16 | 16.7 |
| e-pool1 | | | 0.637 | | 0.561 | 205 | 321 | 0.281 | | 5.3 | 2.06 | 16.1 |
| e-pool3 | 51.8 | 17300 | 0.535 | 59.5 | 0.455 | 157 | 245 | 1.97 | 473 | 3.57 | 1.46 | 13.5 |
| e-pool2 | 66.9 | 23700 | 0.586 | | 0.362 | 137 | 224 | 1.93 | | 3.21 | 1.31 | 14.1 |
| e-pool2 | 54.1 | 20100 | 0.586 | 72.2 | 0.362 | 149 | 241 | 0.151 | 474 | 3.4 | 1.41 | 12.8 |
| e-pool2 | 52.8 | 21800 | 0.482 | | 0.428 | 147 | 265 | 0.151 | | 3.51 | 1.37 | 13.1 |
| e-pool2 | 54.4 | 19500 | 0.441 | 54.8 | 0.336 | 137 | 265 | 2.24 | 468 | 3.4 | 1.26 | 13.4 |
| e-pool2 | | 26400 | 0.455 | | 0.284 | 131 | 229 | 1.81 | | 3.09 | 1.22 | 13.7 |
| e-pool2 | 54 | 19000 | 0.509 | 87 | 0.336 | 130 | 233 | 0.151 | 487 | 2.9 | 1.17 | 13.1 |
| e-pool2 | 66.5 | | 0.509 | | 0.343 | 130 | 208 | 2.09 | | 2.84 | 1.18 | 12.6 |
| e-pool2 | 98 | 28700 | 0.535 | 174 | 0.218 | 141 | 200 | 2.53 | 618 | 3.29 | 1.01 | 13.2 |
| e-pool2 | 73 | 24700 | 0.356 | | 0.257 | 136 | 180 | 2.95 | 604 | 3.12 | 1.06 | 12.3 |
| f | 16.4 | 6 | 0.0362 | 82 | 0.0104 | 8.44 | 34 | 11.6 | 2.35 | 4.01 | 0.054 | 6.86 |
| f | 14.1 | 6 | 0.0362 | 180 | 0.0104 | 8.44 | 64.6 | 12 | 1.67 | 0.00656 | 0.054 | 2.84 |
| f | 13.5 | 7.93 | 0.0362 | 102 | 0.0104 | 8.44 | 84.7 | 10.6 | 1.28 | 0.00656 | 0.054 | 2.11 |
| f | 14.7 | 6 | 0.0362 | 108 | 0.0104 | 8.44 | 84.7 | 12.1 | 1.42 | 0.00656 | 0.054 | 1.92 |
| f | 13.8 | 6 | 0.0362 | 17.7 | 0.0104 | 8.44 | 23.4 | 10.8 | 1.1 | 0.924 | 0.054 | 5.41 |
| f | 14.3 | 6 | 0.332 | 121 | 0.0104 | 8.44 | 3.33 | 9.12 | 0.997 | 0.00656 | 0.054 | 1.92 |
| f | 14.2 | 6 | 0.0362 | 28.6 | 0.0692 | 16.8 | 64.6 | 10.4 | 1.45 | 0.00656 | 0.0636 | 1.51 |
| f | 16.3 | 12.5 | 0.0362 | 80.1 | 0.0104 | 8.44 | 64.6 | 11.8 | 1.71 | 0.618 | 0.054 | 3.86 |
| f | 32.9 | 58 | 0.0362 | 21.6 | 0.0104 | 37.8 | 84.7 | 11.3 | 11 | 0.00666 | 0.195 | 2.84 |
| f | 24.1 | 63.9 | 0.0362 | 129 | 0.0104 | 37.8 | 94.8 | 9.55 | 9.91 | 0.3 | 0.166 | 5.11 |
| f | 23.1 | 59.4 | 0.0362 | 34.8 | 0.0104 | 8.44 | 44.3 | 10.5 | 9.93 | 0.514 | 0.122 | 7 |
| f | 27.3 | 91.1 | 0.0362 | 109 | 0.0468 | 8.44 | 120 | 10.5 | 10.6 | 0.188 | 0.181 | 4.81 |
| f | 31.1 | 71.1 | 0.407 | 72.3 | 0.101 | 8.44 | 105 | 10.4 | 9.36 | 0.00656 | 0.152 | 5.41 |
| f | 31.8 | 46.5 | 0.147 | 37.8 | 0.0104 | 8.44 | 74.7 | 10.1 | 8.12 | 0.00656 | 0.0636 | 4.81 |
| f | 29.8 | 53.4 | 0.214 | 139 | 0.0104 | 8.44 | 3.33 | 12.6 | 10.8 | 0.00656 | 0.054 | 4.18 |
| f | 33.5 | 89.8 | 0.0362 | 123 | 0.0104 | 8.44 | 54.4 | 12.2 | 10.9 | 2.46 | 0.0727 | 4.81 |
| f | 84.6 | 10800 | 0.89 | 89.2 | 0.456 | 194 | 295 | 1.51 | 204 | 3.2 | 1.58 | 8.76 |
| f | 144 | 39900 | 2.47 | 776 | 0.401 | 174 | 363 | 4.64 | 366 | 3.2 | 1.87 | 11.7 |
| f | 47.2 | 22900 | 0.407 | 78.9 | 0.651 | 156 | 245 | 1.67 | 457 | 2.37 | 2.39 | 7.82 |
| f | 131 | 33200 | 2.02 | 116 | 0.365 | 156 | 334 | −3.27 | 457 | 2.55 | 1.69 | 8.89 |
| f | 46.5 | 1140 | 0.332 | 99.2 | 0.0231 | 62.3 | 105 | 14.4 | 84.6 | 0.772 | 0.231 | 5.41 |
| f | 92.8 | 6990 | 1.22 | 272 | 0.252 | 88.4 | 270 | 3.93 | 80.6 | 2.6 | 0.702 | 9.67 |
| f | 84.9 | 1210 | 1.02 | 338 | 0.242 | 119 | 245 | 7.76 | 203 | 1.94 | 0.676 | 6.72 |
| f | 60.2 | 5510 | 1.38 | 853 | 0.51 | 183 | 402 | 1.57 | 416 | 5.65 | 1.42 | 9.8 |
| f | 30.9 | 63.9 | 0.183 | 391 | 0.0104 | 35.8 | 74.7 | 8.49 | 9.06 | 0.188 | 0.129 | 4.65 |
| f | 39.2 | 65.7 | 0.11 | 20.2 | 0.0104 | 51.6 | 155 | 6.79 | 19 | 0.00656 | 0.252 | 3.86 |
| f | 24.6 | 15.1 | 0.0362 | 123 | 0.0104 | 31.8 | 39.2 | 11.1 | 7.46 | 0.00656 | 0.054 | 2.84 |
| f | 30.8 | 37 | 0.0362 | 242 | 0.0104 | 22.5 | 74.7 | 10.8 | 9.12 | 0.00656 | 0.054 | 2.11 |
| f | 31 | 36 | 0.0362 | 16.1 | 0.0104 | 16.8 | 74.7 | 10.7 | 8.83 | 0.00656 | 0.054 | 3.53 |
| f | 26 | 55.7 | 0.0362 | 26.1 | 0.0231 | 8.44 | 44.3 | 9.82 | 7.59 | 0.00656 | 0.054 | 5.11 |
| f | 31 | 47.4 | 0.0362 | 35.1 | 0.0104 | 35.8 | 64.6 | 11.1 | 9.82 | 0.3 | 0.054 | 3.19 |
| f | 24.6 | 17.4 | 0.11 | 53.2 | 0.0104 | 8.44 | 54.4 | 12 | 6.38 | 0.0713 | 0.054 | 4.18 |
| e-pool1 | 66.6 | 41000 | 0.825 | 586 | 0.599 | 171 | 314 | 0.894 | 452 | 3.29 | 2.01 | 9.92 |
| e-pool1 | 65 | 39200 | 0.553 | 440 | 0.537 | 182 | 334 | 1.76 | 486 | 2.83 | 2.1 | 9.02 |
| e-pool1 | 60.4 | 37400 | 0.922 | 484 | 0.581 | 191 | 402 | 0.894 | 403 | 3.38 | 2.09 | 8.89 |
| e-pool1 | 55.4 | 31400 | 0.481 | 412 | 0.642 | 180 | 324 | 2.55 | 418 | 2.65 | 1.96 | 8.23 |
| e-pool1 | 62.8 | 38600 | 0.758 | 449 | 0.438 | 169 | 354 | 2.61 | 423 | 3.15 | 1.74 | 9.54 |
| e-pool1 | 57.9 | 32100 | 0.953 | 451 | 0.519 | 158 | 285 | 2.81 | 390 | 3.29 | 1.57 | 8.23 |
| pool3 | 17.7 | 6 | 0.0362 | 80.4 | 0.0104 | 8.44 | 23.4 | 15.9 | 1.2 | 0.00656 | 0.054 | 0.843 |
| pool3 | 15.5 | 7.93 | 0.11 | 88 | 0.0104 | 8.44 | 34 | 15.6 | 1.03 | 0.00656 | 0.054 | 0.843 |
| pool3 | 16.5 | 6 | 0.11 | 83.4 | 0.0104 | 8.44 | 11.8 | 15.5 | 0.938 | 0.721 | 0.054 | 3.19 |
| pool3 | 17.9 | 16.8 | 0.0362 | 89.2 | 0.0104 | 8.44 | 3.33 | 15.2 | 1.09 | 0.408 | 0.054 | 3.86 |
| pool3 | 15.5 | 29.1 | 0.11 | 87.8 | 0.0104 | 8.44 | 3.33 | 15.2 | 0.95 | 0.0713 | 0.054 | 2.84 |
| pool3 | 14.4 | 23.4 | 0.553 | 89.5 | 0.0104 | 8.44 | 54.4 | 15.4 | 0.95 | 0.823 | 0.054 | 3.02 |
| pool3 | 19 | 4.81 | 0.326 | 67.3 | 0.0516 | 34.2 | 14.1 | 10.7 | 1.25 | 2.01 | 0.0206 | 9.06 |
| pool3 | 19.6 | 4.16 | 0.474 | 63.5 | 0.142 | 37.9 | 33.7 | 10.8 | 1.11 | 2.07 | 0.0425 | 8.29 |
| pool3 | 18.1 | 2.87 | 0.474 | 63.5 | 0.134 | 37.9 | 14.1 | 12 | 1.1 | 2.01 | 0.0206 | 8.18 |
| pool3 | 19.2 | 4.16 | 0.543 | 58.8 | 0.0663 | 21.9 | 33.7 | 11.5 | 0.846 | 2.04 | 0.0206 | 8.4 |
| e-pool1 | 84.1 | 39600 | 1.7 | 216 | 0.974 | 244 | 411 | 1.43 | 489 | 6.88 | 2.75 | 19.4 |
| e-pool1 | 70.2 | 38000 | 1.5 | 188 | 0.883 | 213 | 401 | 1.43 | 454 | 5.57 | 2.36 | 15.3 |
| e-pool1 | 68.5 | 32000 | 1.26 | 187 | 0.811 | 218 | 277 | 1.43 | 416 | 6.16 | 2.48 | 16.3 |
| d | 18.8 | 5.48 | 0.192 | 68 | 0.0959 | 12 | 30.3 | 4.61 | 2.39 | 1.5 | 0.0489 | 7.27 |
| d | 21.6 | 2.87 | 0.677 | 89.6 | 0.0442 | 14.8 | 14.1 | 13.9 | 1.47 | 1.75 | 0.0206 | 5.85 |
| d | 37.2 | 38.9 | 0.71 | 233 | 0.0367 | 17.3 | 26.9 | 5.09 | 5.1 | 2.91 | 0.10 | 10.3 |
| d | 29 | 93.4 | 0.677 | 278 | 0.221 | 32.2 | 95.4 | 1.43 | 5.57 | 2.59 | 0.0792 | 13.2 |
| d | 29.2 | 14.2 | 0.402 | 4.69 | 0.0367 | 12 | 40.8 | 11.8 | 2.07 | 1.43 | 0.0206 | 6.09 |

| Exp. | VCAM-1 ng/ml | VEGF pg/ml | vWF ng/ml |
|---|---|---|---|
| c | <HIGH> | 249 | 15.5 |
| c | <HIGH> | 313 | 13.6 |
| c | <HIGH> | 202 | 7.17 |
| c | <HIGH> | 297 | 14.8 |
| c | <HIGH> | 345 | 16.7 |
| c | <HIGH> | 329 | 14.2 |
| c | <HIGH> | 345 | 13.3 |
| c | <HIGH> | 202 | 3.96 |
| c | <HIGH> | 1040 | 18.6 |
| c | <HIGH> | 1540 | 29.1 |
| c | <HIGH> | 949 | 9.9 |
| c | <HIGH> | 2330 | 16.7 |
| c | <HIGH> | 1540 | 13 |
| c | <HIGH> | 676 | 22.3 |
| c | <HIGH> | 503 | 19.5 |
| c | <HIGH> | 440 | 19.8 |
| c | <HIGH> | 440 | 5.1 |
| c | <HIGH> | 370 | 18.6 |
| c | <HIGH> | 195 | 7.12 |
| c | <HIGH> | 153 | 5.71 |
| c | <HIGH> | 249 | 16.8 |
| c | <HIGH> | 459 | 18.8 |
| c | <HIGH> | 437 | 13.7 |
| c | <HIGH> | 392 | 7.12 |
| d | <HIGH> | 274 | 6.99 |
| d | <HIGH> | 213 | 13.4 |
| d | <HIGH> | 144 | 40.8 |
| d | <HIGH> | 240 | 11.4 |
| c | <HIGH> | 111 | 96.6 |
| c | <HIGH> | 58.4 | 76.5 |
| c | <HIGH> | 66.8 | 69.5 |
| c | <HIGH> | 68.9 | 79.2 |
| c | <HIGH> | 60.5 | 81.5 |
| c | | 71.1 | |
| c | <HIGH> | 88.6 | 101 |
| c | <HIGH> | 54.4 | 69.5 |
| c | <HIGH> | 93 | 74.9 |
| c | | 384 | |
| c | <HIGH> | 301 | 96.6 |
| c | <HIGH> | 66.8 | 51.2 |
| c | <HIGH> | 46.9 | 22.9 |
| c | <HIGH> | 66.8 | 52 |
| c | <HIGH> | 15.6 | 32 |
| d | <HIGH> | 35.5 | 28.5 |
| d | <HIGH> | 35.5 | 18.7 |
| d | <HIGH> | 62.5 | 34.2 |
| d | <HIGH> | 155 | 81.1 |
| d | <HIGH> | 93 | 63.4 |
| d | <HIGH> | 97.4 | 62.6 |
| d | <HIGH> | 97.4 | 37.1 |
| d | <HIGH> | 115 | 86.9 |
| d | <HIGH> | 79.8 | 55 |
| d | <HIGH> | 58.4 | 55 |
| d | <HIGH> | 93 | 64.9 |
| d | <HIGH> | 97.4 | 85 |
| d | <HIGH> | 93 | 81.1 |
| d | 584 | 96.5 | 94.2 |
| d | 901 | 98.3 | 104 |
| d | 816 | 77.1 | 82.3 |
| d | | 82.4 | 82.3 |
| d | 559 | 113 | 120 |
| d | | 125 | 121 |
| d | 636 | 140 | 107 |
| d | 831 | 107 | 108 |
| d | 1020 | 599 | 8.24 |
| d | 1390 | 604 | 10.8 |
| d | 1470 | 1520 | 24.1 |
| d | 2050 | 1520 | 24.5 |
| d | 1360 | 185 | 20.2 |
| d | 1670 | 252 | 17.7 |
| d | 1250 | 492 | 241 |
| d | 1720 | 584 | 246 |
| d | 724 | 46.1 | 45.2 |
| d | | 51.2 | 42.2 |
| d | 868 | 31.1 | 33.8 |
| d | | 26.1 | 31.3 |
| d | 569 | 111 | 76.2 |
| d | | 100 | 71.4 |
| d | 759 | 93 | 90.7 |
| d | | 98.3 | 99.8 |
| e | 762 | 36.1 | 25.4 |
| e | | 52.9 | 26.2 |
| e | 768 | 54.6 | 30.5 |
| e | | 49.5 | 27.9 |
| e | 629 | 27.8 | 27.1 |
| e | | 24.4 | 22.8 |
| e | 704 | 75.4 | 21.1 |
| e | | 34.4 | 22 |
| e | 650 | 44.5 | 33.8 |
| e | | 31.1 | 28.8 |
| e | 760 | 51.2 | 28.8 |
| e | | 47.8 | 27.9 |
| e | 764 | 17.6 | 22.8 |
| e | | 42.8 | 24.9 |
| e | 656 | 27.8 | 24.1 |
| e | | 21.1 | 26.2 |
| e-pool1 | 848 | 1350 | 126 |
| e-pool1 | 1300 | 1200 | 117 |
| e-pool1 | 908 | 1340 | 127 |
| e-pool1 | 1180 | 1310 | 145 |
| e-pool1 | 865 | 1290 | 135 |
| e-pool1 | | 1290 | 127 |
| e-pool1 | 940 | 1270 | 132 |
| e-pool1 | | 1270 | 124 |
| e-pool1 | 828 | 1430 | 134 |
| e-pool1 | | 1190 | 132 |
| e-pool3 | 948 | 800 | 116 |
| e-pool2 | | 873 | 111 |
| e-pool2 | 992 | 961 | 140 |
| e-pool2 | | 963 | 125 |
| e-pool2 | 918 | 860 | 123 |
| e-pool2 | | 829 | 112 |
| e-pool2 | 952 | 895 | 125 |
| e-pool2 | | 876 | 111 |
| e-pool2 | 2000 | 800 | 123 |
| e-pool2 | | 754 | 120 |
| f | 830 | 42.2 | 14.5 |
| f | 714 | 42.2 | 21.4 |
| f | 688 | 52 | 16.2 |
| f | 710 | 56.6 | 15.6 |
| f | 636 | 36.9 | 16.8 |
| f | 698 | 24.7 | 26 |
| f | 650 | 31.2 | 19.1 |
| f | 671 | 56.6 | 20.2 |
| f | 840 | 82.9 | 17.9 |
| f | 972 | 82.9 | 15.6 |
| f | 866 | 52 | 24.8 |
| f | 911 | 70.2 | 23.7 |
| f | 936 | 49.6 | 29.5 |
| f | 940 | 61.3 | 24.8 |
| f | 844 | 36.9 | 27.7 |
| f | 714 | 82.9 | 30.6 |
| f | 1470 | 451 | 90.5 |
| f | 1510 | 397 | 86.6 |
| f | 1300 | 2420 | 67.4 |
| f | 1770 | 595 | 86.6 |
| f | 1160 | 189 | 17.9 |
| f | 1770 | 263 | 89.9 |
| f | 1590 | 394 | 76.4 |
| f | 1600 | 719 | 125 |
| f | 1050 | 78.8 | 17.9 |
| f | 1340 | 72.4 | 37.6 |
| f | 978 | 52 | 23.7 |
| f | 899 | 70.2 | 23.1 |
| f | 800 | 65.8 | 25.4 |
| f | 690 | 56.6 | 24.8 |
| f | 777 | 24.7 | 26 |
| f | 793 | 65.8 | 23.7 |
| e-pool1 | 1270 | 1490 | 122 |
| e-pool1 | 1220 | 1390 | 107 |
| e-pool1 | 1150 | 1380 | 107 |
| e-pool1 | 1160 | 1220 | 92.2 |
| e-pool1 | 1110 | 1200 | 98.8 |
| e-pool1 | 995 | 1150 | 93.3 |
| pool3 | 1080 | 15.5 | 5.53 |
| pool3 | 1030 | 42.2 | 8.83 |
| pool3 | 1120 | 52 | 6.62 |
| pool3 | 1130 | 15.5 | 5.53 |
| pool3 | 1030 | 65.8 | 8.83 |
| pool3 | 991 | 42.2 | 8.27 |
| pool3 | 1610 | 50.8 | 11.8 |
| pool3 | 1620 | 56.2 | 10.8 |
| pool3 | 1380 | 27.2 | 9.83 |
| pool3 | 1440 | 38.1 | 14.7 |
| e-pool1 | 1900 | 1600 | 161 |
| e-pool1 | 1700 | 1470 | 143 |
| e-pool1 | 1610 | 1520 | 165 |
| d | 1420 | 72.9 | 12.3 |
| d | 1530 | 38.1 | 19.7 |
| d | 1350 | 86 | 8.38 |
| d | 1730 | 101 | 13.7 |
| d | 1620 | 34.5 | 17.7 |

| | |
|---|---|
| CONTROL | Animals were non infected. Some animals were irradiated some animals were not. |
| INFECTED | Animals were infected and non-irradiated. Blood samples were taken between 22-24 hours |
| SURVIVED | Animals were infected and irradiated and were healthy up to 14d. Blood samples were taken at 22-24 hours |
| DOOMED | Animals were infected and irradiated and became moribund and were euthanized or died. |
| | Blood samples were taken at 22-24 hours |
| S FINAL | Animals were infected and irradiated and were healthy at 144 hours when blood samples were taken. |
| FINAL | Animals were infected and irradiated became moribund and were euthanized. Blood samples |
| | were taken before euthanasia. |
| BLUE NUMBER | RBM gave the value as HIGH. We sobstituted the value with the highest value for |
| | the day for the specific analyte. |
| RED NUMBER | RBM gave the value as LOW. We sobstituted the value with the lowest value for |
| | the day for the specific analyte. |

[image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] [image] APPENDIX D

| | | | Bact. | | C Reactive | | | | Factor | | |
|---|---|---|---|---|---|---|---|---|---|---|---|
| hour | description | animal | counts | Apolipoprotein | Prof | EGF | Endothelin-1 | Eotaxin | VII | FGF-9 | FGF-basic |
| 0 | CONTROL | 1 | 0.00E+00 | 268.00 | 1.76 | 4.00 | 7.94 | 1070.00 | 0.40 | 0.08 | 0.29 |
| 0 | CONTROL | 2 | 0.00E+00 | 285.00 | 1.81 | 15.50 | 22.20 | 1060.00 | 1.15 | 0.08 | 0.46 |
| 0 | CONTROL | 3 | 0.00E+00 | 152.00 | 0.71 | 21.90 | 23.80 | 1860.00 | 1.15 | 0.08 | 0.65 |
| 0 | CONTROL | 4 | 0.00E+00 | 173.00 | 0.76 | 35.00 | 20.50 | 3200.00 | 0.29 | 0.08 | 0.65 |
| 0 | XR.CONTROL | 6 | 0.00E+00 | 288.00 | 2.36 | 8.48 | 15.30 | 1020.00 | 0.92 | 0.08 | 0.79 |
| 0 | XR.CONTROL | 7 | 0.00E+00 | 186.00 | 1.39 | 4.43 | 20.50 | 1930.00 | 1.20 | 0.08 | 0.65 |
| 0 | XR.CONTROL | 8 | 0.00E+00 | 171.00 | 0.80 | 12.60 | 13.30 | 3360.00 | 0.97 | 0.08 | 0.51 |
| 0 | XR.CONTROL | 9 | 0.00E+00 | 226.00 | 1.31 | 8.96 | 9.12 | 2450.00 | 0.74 | 0.08 | 0.16 |
| 0 | CONTROL | 10 | 0.00E+00 | 235.00 | 1.65 | 18.60 | 20.50 | 1540.00 | 0.97 | 0.08 | 0.16 |
| 0 | CONTROL | 11 | 0.00E+00 | 238.00 | 1.47 | 17.00 | 18.00 | 2570.00 | 1.20 | 0.08 | 0.56 |
| 0 | CONTROL | 12 | 0.00E+00 | 206.00 | 1.43 | 7.55 | 16.20 | 1430.00 | 0.63 | 0.08 | 0.51 |
| 0 | CONTROL | 13 | 0.00E+00 | 243.00 | 1.83 | 9.92 | 12.30 | 1780.00 | 0.74 | 0.08 | 0.41 |
| 0 | XR.CONTROL | 14 | 0.00E+00 | 209.00 | 1.13 | 15.70 | 17.10 | 2710.00 | 1.09 | 0.08 | 0.51 |
| 0 | XR.CONTROL | 15 | 0.00E+00 | 188.00 | 1.43 | 13.40 | 15.30 | 2960.00 | 0.97 | 0.08 | 0.16 |
| 0 | XR.CONTROL | 16 | 0.00E+00 | 175.00 | 1.49 | 11.90 | 17.10 | 3010.00 | 0.63 | 0.08 | 0.35 |
| 0 | XR.CONTROL | 17 | 0.00E+00 | 154.00 | 0.84 | 3.37 | 9.12 | 4520.00 | 0.29 | 0.08 | 0.16 |
| 4 | 4-INFECTED | 18 | 0.00E+00 | 202.00 | 1.45 | 8.96 | 22.20 | 1180.00 | 0.52 | 0.08 | 0.41 |
| 4 | 4-INFECTED | 19 | 0.00E+00 | 230.00 | 1.67 | 18.60 | 28.30 | 982.00 | 1.61 | 0.13 | 0.61 |
| 4 | 4-INFECTED | 20 | 0.00E+00 | 230.00 | 1.74 | 28.90 | 12.30 | 1210.00 | 0.92 | 0.08 | 0.70 |
| 4 | 4-INFECTED | 21 | 0.00E+00 | 190.00 | 2.45 | 13.40 | 22.20 | 1010.00 | 0.63 | 0.34 | 0.16 |
| 4 | 4-INFECTED | 22 | 0.00E+00 | 143.00 | 0.79 | 9.44 | 22.20 | 3910.00 | 1.20 | 0.08 | 0.56 |
| 4 | 4-INFECTED | 23 | 0.00E+00 | 136.00 | 0.86 | 11.90 | 22.20 | 4380.00 | 0.74 | 0.57 | 0.41 |
| 4 | 4-XR-INFECTED | 26 | 0.00E+00 | 245.00 | 1.85 | 4.00 | 6.68 | 2400.00 | 0.63 | 0.08 | 0.16 |
| 4 | 4-XR-INFECTED | 27 | 0.00E+00 | 235.00 | 1.48 | 6.18 | 11.30 | 3530.00 | 0.40 | 0.57 | 0.29 |
| 4 | 4-XR-INFECTED | 28 | 0.00E+00 | 211.00 | 0.88 | 21.90 | 19.70 | 2820.00 | 1.61 | 0.46 | 1.15 |
| 4 | 4-XR-INFECTED | 29 | 0.00E+00 | 177.00 | 0.93 | 13.10 | 11.30 | 3930.00 | 0.97 | 1.07 | 0.29 |
| 4 | 4-XR-INFECTED | 30 | 0.00E+00 | 209.00 | 1.25 | 4.00 | 17.10 | 3450.00 | 0.29 | 0.08 | 0.16 |
| 10 | 10-XR-INFECTED | 31 | 0.00E+00 | 227.00 | 1.68 | 18.10 | 13.30 | 1180.00 | 0.69 | 1.21 | 0.41 |
| 10 | 10-XR-INFECTED | 32 | 0.00E+00 | 187.00 | 1.33 | 2.36 | 15.30 | 2510.00 | 0.69 | 0.21 | 0.16 |
| 10 | 10-XR-INFECTED | 33 | 0.00E+00 | 232.00 | 1.78 | 14.40 | 18.90 | 2130.00 | 0.74 | 1.96 | 0.16 |
| 10 | 10-XR-INFECTED | 34 | 0.00E+00 | 154.00 | 0.77 | 10.70 | 11.30 | 4790.00 | 0.63 | 1.53 | 0.29 |
| 10 | 10-XR-INFECTED | 36 | 7.00E+00 | 295.00 | 2.12 | 4.64 | 23.80 | 1030.00 | 1.43 | 0.57 | 0.41 |
| 10 | 10-INFECTED | 37 | 0.00E+00 | 210.00 | 1.50 | 14.90 | 17.10 | 2760.00 | 0.57 | 1.16 | 0.29 |
| 10 | 10-INFECTED | 39 | 0.00E+00 | 207.00 | 1.95 | 8.72 | 5.29 | 1080.00 | 0.52 | 0.08 | 0.51 |
| 10 | 10-INFECTED | 40 | 0.00E+00 | 167.00 | 0.87 | 8.48 | 15.30 | 3340.00 | 0.74 | 0.62 | 0.35 |
| 10 | 10-INFECTED | 41 | 0.00E+00 | 195.00 | 1.83 | 12.40 | 22.20 | 692.00 | 1.38 | 0.08 | 0.79 |
| 10 | 10-INFECTED | 42 | 0.00E+00 | 177.00 | 1.60 | 16.20 | 13.30 | 1740.00 | 0.40 | 0.08 | 0.18 |
| 24 | 24-INFECTED | 43 | 1.00E+03 | 209.00 | 1.78 | 13.10 | 20.50 | 1990.00 | 1.09 | 1.12 | 0.93 |
| 24 | 24-INFECTED | 44 | 0.00E+00 | 277.00 | 2.33 | 1.68 | 20.50 | 913.00 | 1.43 | 0.08 | 0.41 |
| 24 | 24-INFECTED | 45 | 0.00E+00 | 130.00 | 1.19 | 19.70 | 26.80 | 2710.00 | 0.97 | 0.08 | 0.70 |
| 24 | 24-INFECTED | 46 | 0.00E+00 | 196.00 | 2.61 | 5.29 | 18.90 | 1020.00 | 1.78 | 0.08 | 1.08 |
| 24 | 24-INFECTED | 47 | 0.00E+00 | 198.00 | 1.48 | 20.80 | 17.10 | 3120.00 | 1.09 | 0.08 | 0.61 |
| 24 | 24-XR-INFECTED | 48 | 0.00E+00 | 208.00 | 1.85 | 3.79 | 15.30 | 2710.00 | 0.74 | 0.08 | 0.16 |
| 24 | 24-XR-INFECTED | 49 | 0.00E+00 | 240.00 | 2.28 | 7.09 | 20.50 | 1720.00 | 1.20 | 0.08 | 0.29 |
| 24 | 24-XR-INFECTED | 50 | 0.00E+00 | 280.00 | 2.40 | 6.18 | 11.30 | 1710.00 | 0.74 | 0.08 | 0.29 |
| 24 | 24-XR-INFECTED | 51 | 0.00E+00 | 267.00 | 1.77 | 5.51 | 11.30 | 3150.00 | 0.74 | 0.34 | 0.51 |
| 24 | 24-XR-INFECTED | 52 | 0.00E+00 | 189.00 | 0.58 | 15.50 | 17.10 | 5654.00 | 0.80 | 0.28 | 0.16 |
| 24 | 24-XR-INFECTED | 53 | TNTC | 140.00 | 0.58 | 7.09 | 18.90 | 5654.00 | 0.74 | 0.97 | 1.11 |
| 48 | 48-INFECTED | 54 | 1.40E+01 | 212.00 | 1.77 | 1.56 | 11.30 | 1650.00 | 0.40 | 0.08 | 1.11 |
| 48 | 48-INFECTED | 55 | 1.00E+03 | 97.80 | 0.70 | 4.86 | 23.80 | 1970.00 | 1.43 | 5.03 | 0.89 |
| 48 | 48-INFECTED | 56 | 2.00E+01 | 136.00 | 0.64 | 8.96 | 13.30 | 3640.00 | 0.86 | 0.08 | 0.29 |
| 48 | 48-INFECTED | 57 | 1.25E+02 | 122.00 | 0.45 | 16.80 | 9.12 | 3760.00 | 1.15 | 0.21 | 0.46 |
| 48 | 48-INFECTED | 58 | 6.00E+00 | 130.00 | 0.60 | 20.50 | 15.30 | 3300.00 | 0.40 | 0.57 | 0.51 |
| 48 | 48-XR-INFECTED | 59 | 2.00E+02 | 152.00 | 0.56 | 17.60 | 15.30 | 3470.00 | 1.09 | 0.46 | 0.56 |
| 48 | 48-XR-INFECTED | 60 | 1.00E+00 | 139.00 | 1.10 | 5.51 | 15.30 | 4010.00 | 0.57 | 0.21 | 0.35 |
| 48 | 48-XR-INFECTED | 61 | 3.00E+00 | 187.00 | 1.49 | 9.44 | 6.68 | 3080.00 | 0.40 | 0.08 | 0.16 |
| 48 | 48-XR-INFECTED | 62 | 1.00E+00 | 179.00 | 1.12 | 9.92 | 16.20 | 3960.00 | 0.86 | 0.97 | 0.41 |
| 48 | 48-XR-INFECTED | 63 | 1.00E+00 | 160.00 | 1.17 | 19.40 | 5.29 | 4450.00 | 0.74 | 0.40 | 0.16 |
| 72 | 72-INFECTED | 84 | 0.00E+00 | 132.00 | 0.40 | 31.10 | 24.20 | 4290.00 | 1.47 | 0.30 | 0.93 |
| 72 | 72-INFECTED | 85 | 0.00E+00 | 181.00 | 0.54 | 52.10 | 53.30 | 4020.00 | 3.63 | 0.08 | 1.33 |
| 72 | 72-INFECTED | 86 | 0.00E+00 | 207.00 | 1.86 | 13.00 | 20.40 | 770.00 | 0.09 | 0.12 | 0.63 |
| 72 | 72-INFECTED | 87 | 0.00E+00 | 144.00 | 1.09 | 27.90 | 16.00 | 3340.00 | 1.26 | 0.08 | 0.63 |
| 72 | 72-XR-INFECTED | 88 | 0.00E+00 | 206.00 | 1.74 | 20.40 | 16.00 | 1480.00 | 0.09 | 0.20 | 0.63 |
| 72 | 72-XR-INFECTED | 89 | 0.00E+00 | 144.00 | 1.02 | 19.40 | 18.70 | 4350.00 | 0.77 | 0.30 | 0.55 |
| 72 | 72-XR-INFECTED | 90 | 6 × 10⁸ | 114.00 | 0.87 | 17.30 | 33.20 | 4590.00 | 1.02 | 4.66 | 0.67 |
| 72 | 72-XR-INFECTED | 91 | 2 × 10⁴ | 132.00 | 1.47 | 25.80 | 17.90 | 3490.00 | 0.09 | 1.25 | 1.51 |
| 72 | 72-XR-INFECTED | 92 | 0.00E+00 | 159.00 | 1.33 | 22.00 | 17.90 | 2970.00 | 0.31 | 0.08 | 0.63 |
| 96 | 96-INFECTED | 93 | 0.00E+00 | 128.00 | 0.85 | 20.40 | 5.76 | 3810.00 | 0.77 | 0.33 | 0.67 |
| 96 | 96-INFECTED | 94 | 0.00E+00 | 131.00 | 1.08 | 22.80 | 18.70 | 2260.00 | 0.77 | 0.08 | 0.70 |
| 96 | 96-INFECTED | 95 | 0.00E+00 | 155.00 | 1.31 | 22.00 | 16.00 | 1860.00 | 0.31 | 0.08 | 0.48 |
| 96 | 96-INFECTED | 96 | 0.00E+00 | 165.00 | 1.35 | 9.32 | 20.40 | 1600.00 | 0.31 | 0.08 | 0.70 |
| 96 | 96-INFECTED | 97 | 0.00E+00 | 151.00 | 1.53 | 10.90 | 5.78 | 2020.00 | 0.48 | 0.08 | 0.70 |
| 96 | 96-XR-INFECTED | 98 | 2.00E+08 | 104.00 | 0.97 | 6.40 | 17.90 | 5320.00 | 0.09 | 5.97 | 0.93 |
| 96 | 96-XR-INFECTED | 99 | 2.00E+03 | 116.00 | 0.72 | 19.90 | 17.90 | 3510.00 | 0.31 | 0.62 | 0.74 |
| 96 | 96-XR-INFECTED | 100 | 0.00E+00 | 130.00 | 1.21 | 22.60 | 14.00 | 3060.00 | 0.63 | 0.48 | 0.78 |
| 96 | 96-XR-INFECTED | 102 | 0.00E+00 | 174.00 | 1.69 | 21.00 | 12.90 | 1860.00 | 0.09 | 0.08 | 0.48 |
| 96 | 96-XR-INFECTED | 103 | 1.30E+07 | 71.50 | 0.67 | 0.63 | 11.70 | 5290.00 | 0.31 | 4.91 | 0.74 |
| 96 | 96-XR-INFECTED | 104 | 2.00E+06 | 144.00 | 2.10 | 9.32 | 11.70 | 1310.00 | 0.70 | 2.97 | 0.85 |
| 96 | 96-XR-INFECTED-FINAL | 10F | 1.20E+09 | 56.60 | 0.28 | 1.50 | 24.20 | 4230.00 | 0.96 | 5.90 | 0.70 |
| 96 | 96-XR-INFECTED-FINAL | 11F | 2.20E+09 | 65.10 | 0.45 | 3.66 | 5.76 | 5654.00 | 0.56 | 5.88 | 0.59 |
| 48 | 48-XR-INFECTED-FINAL | 1d | 2.60E+09 | 87.90 | 0.05 | 3.17 | 15.30 | 4300.00 | 0.92 | 8.10 | 0.41 |
| 48 | 48-XR-INFECTED-FINAL | 1F | 7.00E+07 | 48.20 | 0.21 | 3.58 | 13.30 | 5640.00 | 0.97 | 7.58 | 0.70 |
| 48 | 48-XR-INFECTED-FINAL | 2d | 2.20E+09 | 218.00 | 0.01 | 5.29 | 27.50 | 2020.00 | 0.80 | 8.52 | 0.70 |
| 48 | 48-XR-INFECTED-FINAL | 2F | 5.00E+08 | 102.00 | 0.81 | 0.74 | 38.90 | 4960.00 | 1.03 | 9.80 | 0.29 |
| 48 | 48 INFECTED-FINAL | 3d | TNTC | 237.00 | 0.03 | 8.48 | 16.20 | 252.00 | 0.92 | 5.97 | 4.03 |
| 48 | 48-XR-INFECTED-FINAL | 3F | 3.00E+08 | 70.70 | 0.01 | 11.90 | 11.30 | 5654.00 | 1.66 | 6.68 | 0.79 |
| 48 | 48-XR-INFECTED-FINAL | 4F | 8.00E+08 | 70.70 | 0.17 | 7.76 | 14.80 | 5654.00 | 1.06 | 6.80 | 1.03 |
| 72 | 72-XR-INFECTED-FINAL | 5d | 1.20E+10 | 31.90 | 0.01 | 15.10 | 21.20 | 337.00 | 1.26 | 4.10 | 2.49 |
| 48 | 48-XR-INFECTED-FINAL | 5F | 1.00E+08 | 48.10 | 0.30 | 6.40 | 5.76 | 5654.00 | 0.31 | 5.35 | 0.67 |
| 72 | 72-XR-INFECTED-FINAL | 6F | 8.00E+08 | 116.00 | 0.17 | 19.40 | 24.20 | 4480.00 | 1.42 | 4.99 | 0.89 |
| 72 | 72-XR-INFECTED-FINAL | 7F | 6.00E+08 | 66.10 | 0.35 | 9.85 | 31.40 | 5640.00 | 1.26 | 6.70 | 0.78 |
| 72 | 72-XR-INFECTED-FINAL | 8F | 6.00E+08 | 78.60 | 0.75 | 7.20 | 36.50 | 3670.00 | 0.31 | 4.76 | 0.81 |
| 96 | 96-XR-INFECTED-FINAL | 9F | 5.00E+08 | 67.10 | 0.36 | 17.30 | 29.60 | 3400.00 | 0.96 | 5.39 | 0.48 |

| hour | Fibrinogen | GCP-2/LIX | GM-CSF | Growth Hormo [symbol] | GST | Haptoglobin | IFN-g | IgA | IL-10 | IL-11 | IL-12p70 | IL-17 | IL-18 |
|---|---|---|---|---|---|---|---|---|---|---|---|---|---|
| 0 | 4480.00 | 0.36 | 2.50 | 0.01 | 0.18 | 44.80 | 2.03 | 194.00 | 97.30 | 72.30 | 0.10 | 0.00 | 0.73 |
| 0 | 4390.00 | 1.03 | 3.99 | 0.05 | 0.43 | 47.40 | 2.03 | 160.00 | 134.00 | 142.00 | 0.10 | 0.00 | 1.06 |
| 0 | 2620.00 | 3.62 | 4.76 | 0.04 | 1.52 | 15.60 | 2.03 | 151.00 | 276.00 | 36.20 | 0.14 | 0.00 | 0.88 |
| 0 | 1670.00 | 13.60 | 5.52 | 0.03 | 0.57 | 26.10 | 2.03 | 191.00 | 179.00 | 72.30 | 0.23 | 0.02 | 1.57 |
| 0 | 3810.00 | 2.36 | 7.00 | 0.04 | 0.50 | 18.30 | 2.03 | 126.00 | 164.00 | 44.50 | 0.10 | 0.00 | 1.22 |
| 0 | 3080.00 | 0.61 | 1.62 | 0.12 | 0.87 | 12.20 | 2.03 | 113.00 | 17.00 | 39.00 | 0.55 | 0.01 | 0.90 |
| 0 | 2540.00 | 1.54 | 5.52 | 0.01 | 1.27 | 14.40 | 2.03 | 100.00 | 127.00 | 55.60 | 0.10 | 0.00 | 0.91 |
| 0 | 3770.00 | 0.22 | 3.26 | 0.01 | 0.94 | 14.80 | 2.03 | 144.00 | 82.40 | 44.50 | 0.10 | 0.00 | 0.84 |
| 0 | 3980.00 | 1.03 | 1.29 | 0.01 | 0.87 | 58.50 | 2.03 | 118.00 | 82.40 | 39.00 | 0.10 | 0.00 | 0.74 |
| 0 | 3530.00 | 0.87 | 7.00 | 0.03 | 0.57 | 41.20 | 10.50 | 123.00 | 40.30 | 66.70 | 0.55 | 0.01 | 1.00 |
| 0 | 4040.00 | 1.71 | 7.00 | 0.01 | 0.87 | 64.00 | 14.60 | 132.00 | 89.90 | 89.30 | 1.00 | 0.02 | 0.97 |
| 0 | 3880.00 | 0.53 | 12.60 | 0.01 | 0.30 | 24.50 | 2.03 | 145.00 | 74.90 | 86.40 | 0.14 | 0.00 | 0.98 |
| 0 | 2750.00 | 1.03 | 5.52 | 0.08 | 1.02 | 42.10 | 2.03 | 93.00 | 74.90 | 147.00 | 0.14 | 0.00 | 0.84 |
| 0 | 2720.00 | 0.87 | 3.99 | 0.03 | 1.87 | 31.40 | 9.16 | 99.20 | 101.00 | 9.15 | 0.75 | 0.00 | 0.85 |
| 0 | 4370.00 | 0.70 | 14.00 | 0.01 | 0.87 | 14.50 | 10.50 | 109.00 | 59.80 | 9.15 | 0.10 | 0.02 | 0.91 |
| 0 | 3400.00 | 2.04 | 1.29 | 0.01 | 0.30 | 36.40 | 2.03 | 91.20 | 105.00 | 33.50 | 0.10 | 0.00 | 0.98 |
| 4 | 3870.00 | 1.71 | 3.26 | 0.01 | 0.87 | 33.60 | 2.03 | 124.00 | 146.00 | 75.10 | 0.10 | 0.01 | 0.90 |
| 4 | 5250.00 | 3.47 | 1.29 | 0.10 | 2.59 | 58.90 | 2.03 | 122.00 | 194.00 | 61.10 | 0.44 | 0.04 | 1.16 |
| 4 | 4670.00 | 1.03 | 7.00 | 0.01 | 1.02 | 46.80 | 2.03 | 151.00 | 120.00 | 63.90 | 0.55 | 0.00 | 1.04 |
| 4 | 11400.00 | 1.45 | 11.90 | 0.01 | 0.64 | 83.70 | 14.60 | 150.00 | 201.00 | 196.00 | 0.10 | 0.06 | 1.02 |
| 4 | 3240.00 | 5.51 | 4.76 | 0.06 | 1.27 | 34.90 | 2.03 | 117.00 | 142.00 | 77.90 | 0.55 | 0.01 | 1.14 |
| 4 | 3010.00 | 3.47 | 14.00 | 0.04 | 1.10 | 30.10 | 16.00 | 99.20 | 186.00 | 97.90 | 0.75 | 0.01 | 0.98 |
| 4 | 5170.00 | 1.20 | 3.99 | 0.01 | 0.18 | 65.90 | 2.03 | 104.00 | 97.30 | 133.00 | 0.44 | 0.00 | 1.00 |
| 4 | 4360.00 | 2.36 | 6.27 | 0.01 | 0.43 | 45.00 | 2.03 | 103.00 | 316.00 | 142.00 | 0.10 | 0.03 | 0.90 |
| 4 | 3570.00 | 2.52 | 7.00 | 0.02 | 1.10 | 43.80 | 5.09 | 99.70 | 327.00 | 112.00 | 0.66 | 0.02 | 1.01 |
| 4 | 3150.00 | 1.87 | 15.40 | 0.07 | 1.10 | 36.40 | 5.09 | 87.40 | 246.00 | 124.00 | 0.84 | 0.00 | 1.01 |
| 4 | 3390.00 | 2.20 | 5.52 | 0.01 | 0.13 | 50.60 | 2.03 | 98.40 | 172.00 | 86.40 | 0.31 | 0.01 | 0.95 |
| 10 | 6000.00 | 2.52 | 5.52 | 0.05 | 0.07 | 53.10 | 6.45 | 150.00 | 209.00 | 142.00 | 0.31 | 0.04 | 1.06 |
| 10 | 6070.00 | 2.04 | 4.76 | 0.01 | 0.43 | 63.10 | 2.03 | 112.00 | 59.80 | 112.00 | 0.44 | 0.02 | 1.22 |
| 10 | 7080.00 | 4.66 | 3.26 | 0.01 | 0.30 | 63.90 | 21.60 | 155.00 | 348.00 | 285.00 | 0.61 | 0.02 | 1.52 |
| 10 | 5880.00 | 7.11 | 7.00 | 0.01 | 1.10 | 60.60 | 7.81 | 123.00 | 510.00 | 319.00 | 0.14 | 0.01 | 1.13 |
| 10 | 6140.00 | 2.04 | 5.52 | 0.01 | 1.35 | 60.70 | 7.81 | 136.00 | 235.00 | 118.00 | 0.10 | 0.03 | 1.23 |
| 10 | 7240.00 | 4.07 | 19.60 | 0.01 | 0.43 | 64.60 | 33.00 | 137.00 | 283.00 | 142.00 | 1.00 | 0.09 | 1.14 |
| 10 | 6420.00 | 3.47 | 13.30 | 0.01 | 0.36 | 71.10 | 7.81 | 131.00 | 134.00 | 44.50 | 0.44 | 0.00 | 1.01 |
| 10 | 6070.00 | 10.00 | 14.70 | 0.04 | 1.52 | 68.70 | 10.50 | 147.00 | 254.00 | 104.00 | 0.50 | 0.04 | 1.19 |
| 10 | 4800.00 | 0.70 | 3.99 | 0.09 | 1.02 | 61.00 | 2.03 | 199.00 | 149.00 | 75.10 | 0.44 | 0.02 | 1.05 |
| 10 | 4800.00 | 5.92 | 2.50 | 0.01 | 0.36 | 51.80 | 7.81 | 122.00 | 160.00 | 50.00 | 0.38 | 0.03 | 1.12 |
| 24 | 12600.00 | 6.06 | 16.80 | 0.06 | 1.19 | 65.70 | 14.60 | 197.00 | 466.00 | 162.00 | 0.92 | 0.11 | 1.52 |
| 24 | 14500.00 | 2.68 | 14.00 | 0.16 | 1.35 | 73.40 | 2.03 | 221.00 | 44.30 | 9.15 | 0.44 | 0.01 | 1.06 |
| 24 | 8740.00 | 5.65 | 5.52 | 0.06 | 0.36 | 65.10 | 5.09 | 171.00 | 44.30 | 50.00 | 0.84 | 0.02 | 1.14 |
| 24 | 8840.00 | 7.24 | 7.00 | 0.09 | 0.30 | 74.60 | 2.03 | 149.00 | 82.40 | 89.30 | 0.10 | 0.00 | 1.27 |
| 24 | 3690.00 | 7.24 | 1.29 | 0.01 | 0.30 | 77.20 | 2.03 | 171.00 | 17.00 | 22.30 | 0.31 | 0.00 | 1.22 |
| 24 | 7040.00 | 2.68 | 2.50 | 0.02 | 0.07 | 73.00 | 2.03 | 142.00 | 224.00 | 168.00 | 0.31 | 0.04 | 1.21 |
| 24 | 11800.00 | 1.37 | 8.43 | 0.03 | 1.19 | 66.20 | 11.90 | 154.00 | 160.00 | 44.50 | 0.23 | 0.04 | 1.17 |
| 24 | 9740.00 | 0.70 | 9.85 | 0.01 | 0.24 | 84.80 | 10.50 | 146.00 | 105.00 | 25.10 | 0.44 | 0.00 | 0.98 |
| 24 | 12400.00 | 0.67 | 8.43 | 0.06 | 0.87 | 77.30 | 13.20 | 149.00 | 89.90 | 44.50 | 0.10 | 0.07 | 0.87 |
| 24 | 6640.00 | 0.28 | 11.30 | 0.01 | 0.36 | 69.80 | 7.81 | 72.40 | 105.00 | 142.00 | 0.44 | 0.00 | 0.87 |
| 24 | 8840.00 | 3.00 | 14.00 | 0.05 | 0.64 | 75.10 | 34.50 | 130.00 | 348.00 | 202.00 | 0.31 | 0.08 | 1.24 |
| 48 | 8690.00 | 2.52 | 1.29 | 0.07 | 2.68 | 77.90 | 2.03 | 176.00 | 134.00 | 52.80 | 0.14 | 0.02 | 1.16 |
| 48 | 13900.00 | 16.20 | 39.20 | 0.06 | 0.07 | 63.80 | 85.10 | 336.00 | 2200.00 | 363.00 | 1.59 | 0.22 | 1.44 |
| 48 | 8050.00 | 6.79 | 2.50 | 0.01 | 0.50 | 67.70 | 10.50 | 126.00 | 17.00 | 77.90 | 0.14 | 0.00 | 1.14 |
| 48 | 5930.00 | 7.62 | 5.52 | 0.01 | 0.07 | 69.80 | 2.03 | 98.20 | 67.40 | 41.80 | 0.44 | 0.00 | 0.98 |
| 48 | 5840.00 | 3.54 | 13.30 | 0.01 | 0.07 | 65.60 | 5.09 | 87.70 | 17.00 | 92.10 | 0.55 | 0.00 | 0.77 |
| 48 | 6500.00 | 5.72 | 11.90 | 0.02 | 1.10 | 43.60 | 25.80 | 66.00 | 231.00 | 183.00 | 0.70 | 0.02 | 1.14 |
| 48 | 9160.00 | 4.07 | 7.00 | 0.04 | 0.87 | 76.80 | 16.00 | 94.60 | 134.00 | 118.00 | 0.55 | 0.06 | 0.87 |
| 48 | 8840.00 | 3.16 | 3.99 | 0.01 | 0.07 | 70.90 | 2.03 | 144.00 | 74.90 | 104.00 | 0.31 | 0.04 | 0.61 |
| 48 | 10200.00 | 3.39 | 20.90 | 0.01 | 0.07 | 76.90 | 11.90 | 116.00 | 134.00 | 101.00 | 0.55 | 0.02 | 1.19 |
| 48 | 6450.00 | 1.29 | 6.27 | 0.01 | 1.27 | 65.30 | 36.00 | 138.00 | 239.00 | 348.00 | 0.66 | 0.05 | 1.12 |
| 72 | 2920.00 | 1.56 | 4.14 | 0.06 | 0.57 | 59.80 | 7.11 | 139.00 | 93.50 | 151.00 | 0.10 | 0.01 | 0.69 |
| 72 | 2490.00 | 1.94 | 4.43 | 0.11 | 0.07 | 83.70 | 29.60 | 113.00 | 722.00 | 168.00 | 0.29 | 0.00 | 0.94 |
| 72 | 3510.00 | 1.40 | 7.83 | 0.01 | 1.08 | 51.60 | 12.10 | 218.00 | 64.50 | 47.80 | 0.30 | 0.01 | 0.41 |
| 72 | 3310.00 | 1.72 | 2.46 | 0.01 | 0.39 | 88.70 | 2.03 | 146.00 | 17.00 | 71.00 | 0.16 | 0.01 | 0.69 |
| 72 | 7390.00 | 1.87 | 5.47 | 0.01 | 0.22 | 82.20 | 17.60 | 187.00 | 57.30 | 35.90 | 0.44 | 0.00 | 0.67 |
| 72 | 6270.00 | 3.29 | 6.87 | 0.01 | 0.07 | 71.50 | 29.40 | 177.00 | 123.00 | 122.00 | 0.10 | 0.02 | 0.90 |
| 72 | 7560.00 | 17.90 | 30.40 | 0.01 | 0.57 | 74.20 | 127.00 | 161.00 | 3940.00 | 594.00 | 2.21 | 0.62 | 1.26 |
| 72 | 7470.00 | 13.70 | 15.00 | 0.01 | 0.45 | 76.00 | 24.50 | 296.00 | 652.00 | 352.00 | 0.64 | 0.09 | 1.20 |
| 72 | 8900.00 | 1.08 | 7.83 | 0.01 | 0.39 | 78.70 | 28.10 | 199.00 | 86.20 | 169.00 | 0.22 | 0.02 | 0.72 |
| 96 | 5610.00 | 2.18 | 5.47 | 0.03 | 1.21 | 65.80 | 7.11 | 80.70 | 53.70 | 108.00 | 0.10 | 0.02 | 0.67 |
| 96 | 5310.00 | 1.87 | 3.71 | 0.01 | 0.15 | 76.20 | 13.20 | 113.00 | 50.20 | 65.30 | 0.20 | 0.03 | 0.81 |
| 96 | 4240.00 | 1.64 | 7.83 | 0.02 | 0.89 | 69.60 | 9.06 | 154.00 | 17.00 | 82.20 | 0.57 | 0.02 | 0.72 |
| 96 | 6500.00 | 1.08 | 4.14 | 0.01 | 0.07 | 65.80 | 19.80 | 152.00 | 84.50 | 47.80 | 0.30 | 0.00 | 0.85 |
| 96 | 5960.00 | 0.92 | 2.46 | 0.02 | 0.07 | 81.40 | 17.60 | 184.00 | 17.00 | 38.30 | 0.30 | 0.01 | 0.66 |
| 96 | 7800.00 | 23.60 | 32.60 | 0.01 | 0.07 | 65.40 | 166.00 | 66.00 | 5340.00 | 617.00 | 2.25 | 0.82 | 0.87 |
| 96 | 8870.00 | 10.20 | 5.93 | 0.01 | 1.01 | 70.00 | 23.30 | 130.00 | 303.00 | 284.00 | 0.64 | 0.02 | 1.00 |
| 96 | 6680.00 | 4.17 | 7.83 | 0.03 | 0.07 | 74.90 | 19.80 | 181.00 | 123.00 | 71.00 | 0.10 | 0.04 | 0.98 |
| 96 | 6760.00 | 0.22 | 1.29 | 0.01 | 0.95 | 73.30 | 6.17 | 173.00 | 84.50 | 52.70 | 0.30 | 0.00 | 0.57 |
| 96 | 8020.00 | 17.80 | 36.00 | 0.01 | 0.57 | 56.40 | 108.00 | 78.10 | 4580.00 | 549.00 | 2.13 | 0.38 | 1.14 |
| 96 | 8150.00 | 8.33 | 15.00 | 0.04 | 1.34 | 83.50 | 57.90 | 165.00 | 2130.00 | 267.00 | 1.31 | 0.17 | 1.16 |
| 96 | 7830.00 | 27.80 | 145.00 | 0.01 | 0.82 | 54.10 | 199.00 | 65.60 | 5130.00 | 739.00 | 3.08 | 0.77 | 2.25 |
| 96 | 9180.00 | 17.40 | 45.10 | 0.01 | 0.07 | 55.50 | 111.00 | 77.70 | 4300.00 | 601.00 | 2.13 | 0.32 | 1.10 |
| 48 | 4930.00 | 61.80 | 520.00 | 0.01 | 0.87 | 57.30 | 207.00 | 38.70 | 8400.00 | 1710.00 | 3.41 | 0.75 | 1.28 |
| 48 | 6000.00 | 34.10 | 78.50 | 0.01 | 0.30 | 51.90 | 137.00 | 51.10 | 3890.00 | 776.00 | 2.87 | 0.66 | 1.37 |
| 48 | 2010.00 | 49.70 | 141.00 | 0.01 | 0.79 | 48.00 | 201.00 | 64.00 | 8650.00 | 953.00 | 3.35 | 0.77 | 1.38 |
| 48 | 12700.00 | 28.50 | 76.60 | 0.03 | 0.57 | 62.10 | 204.00 | 57.00 | 6070.00 | 853.00 | 3.82 | 0.76 | 1.34 |
| 48 | 333.00 | 18.20 | 125.00 | 0.07 | 2.87 | 29.20 | 159.00 | 15.70 | 5810.00 | 569.00 | 2.23 | 0.52 | 1.57 |
| 48 | 5820.00 | 19.50 | 54.10 | 0.03 | 0.87 | 54.50 | 140.00 | 32.90 | 2900.00 | 517.00 | 1.92 | 0.34 | 1.46 |
| 48 | 11200.00 | 43.60 | 98.00 | 0.07 | 1.62 | 76.80 | 227.00 | 112.00 | 4980.00 | 1120.00 | 3.77 | 0.91 | 1.69 |
| 72 | 227.00 | 24.00 | 356.00 | 0.01 | 1.34 | 31.40 | 151.00 | 14.80 | 5260.00 | 511.00 | 2.00 | 0.41 | 1.74 |
| 48 | 9960.00 | 25.70 | 106.00 | 0.01 | 0.70 | 55.20 | 149.00 | 109.00 | 4010.00 | 791.00 | 2.27 | 0.56 | 1.06 |
| 72 | 3120.00 | 21.40 | 87.50 | 0.03 | 0.45 | 44.10 | 209.00 | 76.20 | 5360.00 | 838.00 | 2.56 | 0.60 | 1.97 |
| 72 | 8790.00 | 37.80 | 120.00 | 0.01 | 1.34 | 72.30 | 204.00 | 108.00 | 5930.00 | 774.00 | 3.11 | 0.84 | 3.90 |
| 72 | 9870.00 | 17.20 | 31.50 | 0.02 | 0.07 | 73.30 | 137.00 | 81.80 | 4770.00 | 643.00 | 2.54 | 0.58 | 1.38 |
| 96 | 6380.00 | 18.60 | 105.00 | 0.06 | 0.70 | 54.20 | 196.00 | 57.20 | 4960.00 | 701.00 | 2.81 | 0.72 | 4.73 |

| hour | IL-1alpha | IL-1beta | IL-2 | IL-3 | IL-4 | IL-5 | IL-6 | IL-7 | Insulin | IP-10 | KC/GROalpha | Leptin | LIF |
|---|---|---|---|---|---|---|---|---|---|---|---|---|---|
| 0 | 1.53 | 0.12 | 6.88 | 1.36 | 11.70 | 0.04 | 7.81 | 0.01 | 0.88 | 6.26 | 0.04 | 2.66 | 39.60 |
| 0 | 63.20 | 0.24 | 17.80 | 1.36 | 11.70 | 0.06 | 7.81 | 0.04 | 3.06 | 20.00 | 0.04 | 2.15 | 141.00 |
| 0 | 1.53 | 0.35 | 6.88 | 10.80 | 11.70 | 0.10 | 7.81 | 0.04 | 3.10 | 42.20 | 0.04 | 2.98 | 116.00 |
| 0 | 45.40 | 0.40 | 7.85 | 1.95 | 11.70 | 0.12 | 12.90 | 0.08 | 2.80 | 38.60 | 0.04 | 2.85 | 53.70 |
| 0 | 75.00 | 0.10 | 46.60 | 2.48 | 37.70 | 0.12 | 9.86 | 0.01 | 2.48 | 20.00 | 0.04 | 1.64 | 116.00 |
| 0 | 10.70 | 0.09 | 46.60 | 1.36 | 82.30 | 0.08 | 7.81 | 0.01 | 0.69 | 33.40 | 0.04 | 1.10 | 70.80 |
| 0 | 2.75 | 0.17 | 6.88 | 1.36 | 11.70 | 0.07 | 7.81 | 0.06 | 1.28 | 26.70 | 0.04 | 0.87 | 84.00 |
| 0 | 1.53 | 0.06 | 6.88 | 1.36 | 11.70 | 0.02 | 7.81 | 0.01 | 0.21 | 13.50 | 0.04 | 1.37 | 50.30 |
| 0 | 28.30 | 0.09 | 17.80 | 2.94 | 11.70 | 0.01 | 7.81 | 0.01 | 0.79 | 20.00 | 0.04 | 0.63 | 103.00 |
| 0 | 30.70 | 0.12 | 46.60 | 7.07 | 86.70 | 0.06 | 7.81 | 0.01 | 3.58 | 40.40 | 0.04 | 2.13 | 80.70 |
| 0 | 1.53 | 0.22 | 72.20 | 6.61 | 48.50 | 0.07 | 14.30 | 0.01 | 2.80 | 54.70 | 0.04 | 0.96 | 77.40 |
| 0 | 8.70 | 0.09 | 17.80 | 1.36 | 11.70 | 0.05 | 11.50 | 0.03 | 0.21 | 26.70 | 0.04 | 1.83 | 50.30 |
| 0 | 1.53 | 0.14 | 6.88 | 1.36 | 11.70 | 0.05 | 7.81 | 0.01 | 2.02 | 30.00 | 0.04 | 0.71 | 87.30 |
| 0 | 18.10 | 0.14 | 6.88 | 2.46 | 58.70 | 0.04 | 7.81 | 0.01 | 1.28 | 26.70 | 0.04 | 0.97 | 50.30 |
| 0 | 5.75 | 0.06 | 6.88 | 1.36 | 37.70 | 0.05 | 7.81 | 0.01 | 0.21 | 40.40 | 0.04 | 0.46 | 64.00 |
| 0 | 6.73 | 0.14 | 6.88 | 1.36 | 11.70 | 0.05 | 7.81 | 0.01 | 0.42 | 12.10 | 0.04 | 0.63 | 36.00 |
| 4 | 52.90 | 0.19 | 17.80 | 1.36 | 19.30 | 0.04 | 199.00 | 0.02 | 0.93 | 258.00 | 1.45 | 0.86 | 97.00 |
| 4 | 94.80 | 0.19 | 72.20 | 4.33 | 19.30 | 0.10 | 133.00 | 0.01 | 1.02 | 185.00 | 1.35 | 2.04 | 116.00 |
| 4 | 17.00 | 0.06 | 72.20 | 1.36 | 31.90 | 0.05 | 109.00 | 0.04 | 0.21 | 78.70 | 0.61 | 2.81 | 80.70 |
| 4 | 52.90 | 0.21 | 96.60 | 23.10 | 25.80 | 0.10 | 644.00 | 0.01 | 0.21 | 596.00 | 1.41 | 0.88 | 57.20 |
| 4 | 65.80 | 0.29 | 46.60 | 2.94 | 19.30 | 0.04 | 105.00 | 0.06 | 1.97 | 106.00 | 2.09 | 1.89 | 103.00 |
| 4 | 124.00 | 0.24 | 32.90 | 4.33 | 58.70 | 0.05 | 142.00 | 0.09 | 0.42 | 78.50 | 2.75 | 3.98 | 103.00 |
| 4 | 34.30 | 0.21 | 6.88 | 7.07 | 11.70 | 0.02 | 160.00 | 0.01 | 0.42 | 463.00 | 1.87 | 0.41 | 24.80 |
| 4 | 73.70 | 0.14 | 72.20 | 24.60 | 25.80 | 0.01 | 469.00 | 0.07 | 0.21 | 435.00 | 7.58 | 0.54 | 20.90 |
| 4 | 28.30 | 0.17 | 25.70 | 14.70 | 58.70 | 0.04 | 245.00 | 0.01 | 1.17 | 300.00 | 4.00 | 0.61 | 64.00 |
| 4 | 65.80 | 0.32 | 65.90 | 18.60 | 11.70 | 0.06 | 199.00 | 0.02 | 0.21 | 214.00 | 7.30 | 0.61 | 103.00 |
| 4 | 46.60 | 0.12 | 46.60 | 12.20 | 48.50 | 0.01 | 176.00 | 0.07 | 0.21 | 155.00 | 5.20 | 1.10 | 28.60 |
| 10 | 88.20 | 0.37 | 6.88 | 12.70 | 48.50 | 0.10 | 251.00 | 0.07 | 0.21 | 533.00 | 4.58 | 2.02 | 103.00 |
| 10 | 26.00 | 0.12 | 17.80 | 9.39 | 37.70 | 0.10 | 160.00 | 0.05 | 0.59 | 110.00 | 5.62 | 1.47 | 64.00 |
| 10 | 72.40 | 0.29 | 59.60 | 33.20 | 37.70 | 0.08 | 668.00 | 0.04 | 0.21 | 689.00 | 11.90 | 1.34 | 57.20 |
| 10 | 185.00 | 0.21 | 84.50 | 37.80 | 25.80 | 0.06 | 206.00 | 0.22 | 0.59 | 334.00 | 8.81 | 0.58 | 43.20 |
| 10 | 42.90 | 0.42 | 59.60 | 13.70 | 31.90 | 0.07 | 251.00 | 0.01 | 1.59 | 438.00 | 2.57 | 0.78 | 97.00 |
| 10 | 33.10 | 0.26 | 72.20 | 28.10 | 48.50 | 0.07 | 582.00 | 0.15 | 0.69 | 151.00 | 3.00 | 1.84 | 57.20 |
| 10 | 52.90 | 0.24 | 6.88 | 14.70 | 11.70 | 0.10 | 502.00 | 0.07 | 3.02 | 95.30 | 1.68 | 1.87 | 50.30 |
| 10 | 46.60 | 0.28 | 7.85 | 26.10 | 68.40 | 0.10 | 491.00 | 0.03 | 1.88 | 56.50 | 5.80 | 0.88 | 50.30 |
| 10 | 35.50 | 0.21 | 6.88 | 7.07 | 31.90 | 0.11 | 109.00 | 0.06 | 5.17 | 322.00 | 0.48 | 3.90 | 135.00 |
| 10 | 78.90 | 0.19 | 25.70 | 15.60 | 77.70 | 0.06 | 563.00 | 0.05 | 1.07 | 65.60 | 5.02 | 2.13 | 77.40 |
| 24 | 104.00 | 0.28 | 84.50 | 46.40 | 86.70 | 0.12 | 538.00 | 0.09 | 1.17 | 329.00 | 2.27 | 0.77 | 64.00 |
| 24 | 21.40 | 0.14 | 6.88 | 10.80 | 19.30 | 0.14 | 67.30 | 0.01 | 2.84 | 114.00 | 0.04 | 1.15 | 64.00 |
| 24 | 1.53 | 0.30 | 65.90 | 9.39 | 37.70 | 0.13 | 41.60 | 0.05 | 2.30 | 23.30 | 1.51 | 1.07 | 116.00 |
| 24 | 26.00 | 0.34 | 6.88 | 9.86 | 31.90 | 0.08 | 225.00 | 0.01 | 0.79 | 80.40 | 1.61 | 0.45 | 77.40 |
| 24 | 196.00 | 0.21 | 6.88 | 7.07 | 11.70 | 0.12 | 11.50 | 0.04 | 1.39 | 40.40 | 0.04 | 1.94 | 36.00 |
| 24 | 37.90 | 0.13 | 32.90 | 22.60 | 73.10 | 0.05 | 236.00 | 0.01 | 0.21 | 140.00 | 3.40 | 0.76 | 60.60 |
| 24 | 14.90 | 0.15 | 7.85 | 7.99 | 25.80 | 0.04 | 166.00 | 0.01 | 1.88 | 76.70 | 0.49 | 1.28 | 70.80 |
| 24 | 31.90 | 0.17 | 6.88 | 11.88 | 53.70 | 0.06 | 104.00 | 0.01 | 0.21 | 229.00 | 0.04 | 1.34 | 64.00 |
| 24 | 30.70 | 0.21 | 72.20 | 12.70 | 48.50 | 0.02 | 119.00 | 0.08 | 1.59 | 40.40 | 0.80 | 0.83 | 32.30 |
| 24 | 1.53 | 0.17 | 6.88 | 12.70 | 86.70 | 0.02 | 28.20 | 0.01 | 1.07 | 65.60 | 0.11 | 1.18 | 12.90 |
| 24 | 42.90 | 0.18 | 109.00 | 38.80 | 116.00 | 0.04 | 254.00 | 0.15 | 1.28 | 254.00 | 4.28 | 1.43 | 87.30 |
| 48 | 30.70 | 0.34 | 84.50 | 19.60 | 48.50 | 0.12 | 97.00 | 0.01 | 3.71 | 47.50 | 1.22 | 1.13 | 97.00 |
| 48 | 402.00 | 0.48 | 155.00 | 147.00 | 127.00 | 0.11 | 4940.00 | 0.27 | 4.97 | 684.00 | 52.70 | 1.77 | 135.00 |
| 48 | 30.70 | 0.17 | 17.80 | 13.20 | 11.70 | 0.08 | 52.70 | 0.01 | 3.50 | 103.00 | 2.22 | 2.09 | 46.70 |
| 48 | 13.80 | 0.28 | 6.88 | 11.80 | 25.80 | 0.07 | 86.10 | 0.02 | 5.09 | 42.20 | 1.56 | 0.92 | 64.00 |
| 48 | 1.53 | 0.07 | 6.88 | 7.53 | 112.00 | 0.05 | 11.50 | 0.01 | 1.59 | 47.50 | 0.27 | 1.02 | 20.90 |
| 48 | 58.10 | 0.30 | 46.60 | 22.10 | 108.00 | 0.07 | 154.00 | 0.12 | 1.28 | 73.00 | 2.84 | 0.41 | 64.00 |
| 48 | 31.90 | 0.19 | 6.88 | 24.60 | 63.60 | 0.10 | 159.00 | 0.01 | 2.62 | 69.30 | 3.42 | 0.87 | 50.30 |
| 48 | 21.40 | 0.20 | 53.10 | 8.92 | 11.70 | 0.05 | 163.00 | 0.01 | 0.79 | 40.40 | 2.56 | 1.80 | 36.00 |
| 48 | 12.80 | 0.28 | 96.60 | 20.60 | 68.40 | 0.07 | 120.00 | 0.06 | 1.69 | 76.70 | 2.81 | 1.15 | 28.60 |
| 48 | 40.40 | 0.14 | 72.20 | 26.10 | 43.20 | 0.07 | 153.00 | 0.06 | 0.36 | 144.00 | 1.20 | 0.54 | 28.60 |
| 72 | 5.83 | 0.18 | 35.90 | 1.36 | 15.10 | 0.07 | 12.10 | 0.02 | 2.68 | 50.30 | 0.04 | 1.34 | 63.40 |
| 72 | 1.53 | 0.32 | 39.90 | 8.16 | 46.20 | 0.12 | 20.40 | 0.08 | 7.68 | 118.00 | 0.04 | 1.41 | 141.00 |
| 72 | 72.80 | 0.15 | 18.90 | 1.36 | 44.20 | 0.08 | 7.81 | 0.01 | 2.27 | 126.00 | 0.04 | 1.39 | 63.40 |
| 72 | 5.83 | 0.14 | 12.70 | 1.36 | 11.70 | 0.07 | 12.10 | 0.01 | 2.74 | 31.90 | 0.04 | 0.90 | 43.60 |
| 72 | 10.30 | 0.13 | 6.88 | 1.36 | 11.70 | 0.08 | 58.60 | 0.01 | 0.21 | 112.00 | 0.97 | 0.47 | 14.90 |
| 72 | 9.20 | 0.16 | 12.70 | 19.20 | 44.20 | 0.07 | 123.00 | 0.01 | 4.91 | 117.00 | 1.32 | 0.41 | 24.10 |
| 72 | 659.00 | 0.97 | 164.00 | 185.00 | 150.00 | 0.17 | 17200.00 | 0.28 | 3.26 | 270.00 | 70.40 | 1.95 | 178.00 |
| 72 | 92.60 | 0.17 | 53.40 | 55.00 | 63.80 | 0.09 | 573.00 | 0.09 | 3.41 | 150.00 | 9.01 | 0.10 | 33.80 |
| 72 | 12.50 | 0.08 | 12.70 | 15.30 | 54.20 | 0.06 | 105.00 | 0.01 | 2.14 | 113.00 | 1.49 | 0.90 | 63.50 |
| 96 | 1.53 | 0.14 | 18.90 | 16.50 | 11.70 | 0.05 | 33.40 | 0.01 | 3.96 | 55.40 | 0.25 | 0.81 | 68.40 |
| 96 | 1.53 | 0.20 | 22.20 | 15.30 | 15.10 | 0.08 | 40.00 | 0.02 | 3.36 | 60.50 | 0.63 | 0.97 | 63.40 |
| 96 | 1.53 | 0.05 | 12.70 | 4.53 | 35.70 | 0.04 | 7.81 | 0.01 | 1.17 | 41.20 | 0.34 | 0.62 | 56.00 |
| 96 | 1.53 | 0.06 | 26.90 | 1.36 | 25.70 | 0.05 | 12.10 | 0.01 | 5.70 | 83.10 | 0.54 | 1.27 | 38.70 |
| 96 | 1.75 | 0.06 | 6.88 | 11.50 | 15.10 | 0.06 | 15.30 | 0.01 | 1.07 | 45.10 | 0.30 | 0.52 | 56.00 |
| 96 | 1660.00 | 0.94 | 239.00 | 203.00 | 143.00 | 0.08 | 18100.00 | 0.28 | 0.21 | 182.00 | 170.00 | 1.19 | 153.00 |
| 96 | 19.20 | 0.12 | 46.90 | 39.00 | 35.70 | 0.08 | 281.00 | 0.01 | 3.96 | 110.00 | 4.70 | 0.51 | 58.50 |
| 96 | 23.40 | 0.25 | 18.90 | 23.70 | 63.80 | 0.07 | 91.80 | 0.01 | 1.88 | 76.80 | 3.17 | 0.64 | 53.50 |
| 96 | 1.53 | 0.16 | 6.88 | 6.24 | 25.70 | 0.04 | 17.70 | 0.01 | 0.21 | 37.20 | 0.36 | 1.04 | 43.60 |
| 96 | 756.00 | 0.25 | 185.00 | 207.00 | 136.00 | 0.12 | 6890.00 | 0.25 | 3.06 | 159.00 | 185.00 | 3.58 | 73.40 |
| 96 | 460.00 | 0.32 | 46.90 | 111.00 | 73.10 | 0.10 | 1700.00 | 0.10 | 0.21 | 138.00 | 17.90 | 0.43 | 28.90 |
| 96 | 978.00 | 0.57 | 280.00 | 249.00 | 193.00 | 0.11 | 48700.00 | 0.39 | 2.95 | 266.00 | 424.00 | 1.55 | 422.00 |
| 96 | 843.00 | 0.30 | 146.00 | 201.00 | 143.00 | 0.06 | 6510.00 | 0.31 | 3.06 | 190.00 | 152.00 | 3.91 | 93.20 |
| 48 | 3480.00 | 1.84 | 360.00 | 315.00 | 142.00 | 0.08 | 181000.00 | 0.54 | 2.62 | 400.00 | 315.00 | 0.66 | 4129.00 |
| 48 | 813.00 | 0.48 | 271.00 | 282.00 | 202.00 | 0.11 | 49000.00 | 0.38 | 2.53 | 310.00 | 232.00 | 0.98 | 670.00 |
| 48 | 1880.00 | 2.62 | 350.00 | 338.00 | 208.00 | 0.10 | 66800.00 | 0.57 | 2.21 | 331.00 | 183.00 | 2.63 | 3320.00 |
| 48 | 1100.00 | 0.46 | 425.00 | 318.00 | 208.00 | 0.07 | 51800.00 | 0.60 | 1.78 | 441.00 | 276.00 | 8.09 | 292.00 |
| 48 | 1810.00 | 3.90 | 209.00 | 263.00 | 183.00 | 0.13 | 17500.00 | 0.51 | 2.97 | 268.00 | 55.80 | 1.53 | 1710.00 |
| 48 | 658.00 | 0.31 | 251.00 | 205.00 | 150.00 | 0.11 | 10400.00 | 0.39 | 6.32 | 223.00 | 159.00 | 11.60 | 189.00 |
| 48 | 911.00 | 0.49 | 303.00 | 292.00 | 215.00 | 0.15 | 41700.00 | 0.48 | 2.38 | 339.00 | 302.00 | 3.46 | 699.00 |
| 72 | 2510.00 | 3.98 | 197.00 | 195.00 | 176.00 | 0.10 | 18100.00 | 0.36 | 4.27 | 192.00 | 74.20 | 0.20 | 4129.00 |
| 48 | 688.00 | 0.36 | 280.00 | 217.00 | 150.00 | 0.10 | 21900.00 | 0.37 | 2.39 | 250.00 | 378.00 | 0.33 | 233.00 |
| 72 | 2250.00 | 1.06 | 296.00 | 210.00 | 176.00 | 0.10 | 29300.00 | 0.37 | 2.68 | 292.00 | 138.00 | 0.14 | 697.00 |
| 72 | 1270.00 | 0.76 | 352.00 | 285.00 | 368.00 | 0.16 | 79500.00 | 0.43 | 4.52 | 394.00 | 496.00 | 2.60 | 792.00 |
| 72 | 997.00 | 1.07 | 185.00 | 198.00 | 107.00 | 0.09 | 12600.00 | 0.25 | 4.52 | 209.00 | 89.60 | 2.77 | 143.00 |
| 96 | 804.00 | 0.51 | 255.00 | 237.00 | 157.00 | 0.09 | 43000.00 | 0.51 | 4.43 | 367.00 | 449.00 | 1.15 | 93.20 |

| | | MCP-1/ | | | | | MIP-1 | MIP-1 | MIP-1 | | MIP-3 | | |
|---|---|---|---|---|---|---|---|---|---|---|---|---|---|
| hour | Lymphotactin | JE | MCP-3 | MCP-5 | M-CSF | MDC | alpha | beta | gamma | MIP-2 | beta | Myoglobin | OSM |
| 0 | 74.00 | 44.30 | 110.00 | 73.20 | 4.96 | 219.00 | 0.10 | 22.70 | 20.70 | 7.31 | 0.12 | 26.10 | 0.02 |
| 0 | 80.00 | 68.70 | 226.00 | 58.80 | 5.28 | 274.00 | 0.15 | 32.80 | 24.20 | 7.31 | 0.41 | 666.00 | 0.02 |
| 0 | 106.00 | 113.00 | 318.00 | 148.00 | 5.55 | 319.00 | 0.14 | 51.30 | 17.30 | 35.10 | 0.43 | 291.00 | 0.02 |
| 0 | 111.00 | 146.00 | 379.00 | 173.00 | 5.82 | 428.00 | 0.10 | 107.00 | 16.50 | 28.90 | 0.36 | 1200.00 | 0.05 |
| 0 | 81.60 | 68.70 | 207.00 | 30.00 | 3.60 | 134.00 | 0.12 | 22.70 | 19.20 | 8.64 | 0.65 | 59.00 | 0.02 |
| 0 | 83.10 | 137.00 | 478.00 | 109.00 | 4.49 | 149.00 | 0.11 | 22.70 | 15.90 | 8.01 | 0.25 | 27.00 | 0.02 |
| 0 | 93.80 | 202.00 | 664.00 | 256.00 | 5.37 | 219.00 | 0.11 | 195.00 | 16.30 | 27.90 | 0.28 | 73.60 | 0.02 |
| 0 | 105.00 | 122.00 | 458.00 | 116.00 | 4.81 | 166.00 | 0.08 | 22.70 | 20.30 | 9.24 | 0.30 | 120.00 | 0.02 |
| 0 | 128.00 | 86.30 | 267.00 | 58.80 | 4.88 | 251.00 | 0.13 | 67.80 | 22.80 | 12.50 | 0.36 | 251.00 | 0.02 |
| 0 | 63.50 | 126.00 | 472.00 | 201.00 | 5.25 | 333.00 | 0.10 | 22.70 | 19.10 | 10.90 | 0.49 | 77.40 | 0.03 |
| 0 | 77.00 | 88.20 | 419.00 | 148.00 | 5.55 | 279.00 | 0.14 | 22.70 | 25.50 | 7.31 | 0.43 | 7.14 | 0.02 |
| 0 | 81.60 | 64.10 | 226.00 | 102.00 | 4.45 | 279.00 | 0.10 | 22.70 | 22.60 | 7.31 | 0.15 | 68.30 | 0.02 |
| 0 | 134.00 | 190.00 | 520.00 | 159.00 | 4.36 | 164.00 | 0.10 | 22.70 | 20.60 | 12.50 | 0.41 | 130.00 | 0.02 |
| 0 | 86.10 | 206.00 | 701.00 | 145.00 | 4.31 | 151.00 | 0.10 | 22.70 | 21.30 | 10.40 | 0.20 | 301.00 | 0.02 |
| 0 | 105.00 | 231.00 | 657.00 | 201.00 | 4.54 | 215.00 | 0.10 | 22.70 | 23.20 | 8.01 | 0.30 | 104.00 | 0.02 |
| 0 | 56.10 | 194.00 | 570.00 | 166.00 | 4.23 | 194.00 | 0.07 | 22.70 | 15.70 | 25.80 | 0.15 | 30.80 | 0.02 |
| 4 | 35.70 | 380.00 | 962.00 | 183.00 | 4.61 | 225.00 | 0.11 | 22.70 | 20.20 | 33.00 | 0.36 | 226.00 | 0.02 |
| 4 | 62.00 | 189.00 | 576.00 | 91.20 | 4.26 | 219.00 | 0.15 | 188.00 | 20.00 | 60.00 | 0.65 | 94.60 | 0.02 |
| 4 | 77.00 | 132.00 | 460.00 | 159.00 | 4.33 | 185.00 | 0.13 | 22.70 | 17.80 | 22.20 | 0.46 | 231.00 | 0.02 |
| 4 | 486.00 | 562.00 | 1410.00 | 420.00 | 5.28 | 473.00 | 0.08 | 75.60 | 55.40 | 41.50 | 0.46 | 118.00 | 0.02 |
| 4 | 89.20 | 632.00 | 1160.00 | 319.00 | 5.26 | 348.00 | 0.10 | 137.00 | 17.20 | 99.20 | 0.33 | 238.00 | 0.02 |
| 4 | 80.00 | 489.00 | 1280.00 | 452.00 | 4.82 | 262.00 | 0.15 | 137.00 | 16.20 | 61.10 | 0.15 | 558.00 | 0.02 |
| 4 | 142.00 | 1310.00 | 2340.00 | 329.00 | 4.12 | 189.00 | 0.10 | 216.00 | 29.10 | 48.50 | 0.12 | 98.40 | 0.02 |
| 4 | 148.00 | 3220.00 | 4110.00 | 642.00 | 4.39 | 200.00 | 0.08 | 766.00 | 24.20 | 405.00 | 0.20 | 73.60 | 0.18 |
| 4 | 148.00 | 1240.00 | 2730.00 | 375.00 | 4.93 | 202.00 | 0.13 | 302.00 | 24.80 | 243.00 | 0.56 | 131.00 | 0.12 |
| 4 | 86.10 | 2310.00 | 3520.00 | 594.00 | 4.14 | 225.00 | 0.14 | 449.00 | 13.90 | 276.00 | 0.25 | 219.00 | 0.24 |
| 4 | 92.20 | 1240.00 | 2670.00 | 464.00 | 4.29 | 172.00 | 0.09 | 115.00 | 22.00 | 194.00 | 0.22 | 36.20 | 0.03 |
| 10 | 206.00 | 2970.00 | 2170.00 | 505.00 | 4.52 | 168.00 | 0.18 | 759.00 | 31.00 | 267.00 | 0.60 | 339.00 | 0.17 |
| 10 | 123.00 | 821.00 | 2000.00 | 666.00 | 4.85 | 234.00 | 0.13 | 152.00 | 29.40 | 87.30 | 0.25 | 37.10 | 0.02 |
| 10 | 242.00 | 3500.00 | 3130.00 | 1040.00 | 5.77 | 350.00 | 0.15 | 1150.00 | 45.20 | 719.00 | 0.65 | 348.00 | 0.24 |
| 10 | 210.00 | 8230.00 | 4150.00 | 1360.00 | 5.82 | 489.00 | 0.12 | 1220.00 | 31.10 | 1840.00 | 0.25 | 1160.00 | 0.63 |
| 10 | 187.00 | 2630.00 | 1550.00 | 517.00 | 5.04 | 283.00 | 0.17 | 862.00 | 43.10 | 307.00 | 0.72 | 48.90 | 0.21 |
| 10 | 136.00 | 733.00 | 1460.00 | 666.00 | 4.54 | 622.00 | 0.16 | 340.00 | 40.00 | 236.00 | 0.30 | 318.00 | 0.02 |
| 10 | 77.00 | 322.00 | 891.00 | 375.00 | 4.57 | 302.00 | 0.12 | 145.00 | 25.70 | 89.00 | 0.30 | 96.80 | 0.02 |
| 10 | 112.00 | 1040.00 | 1900.00 | 618.00 | 4.22 | 424.00 | 0.15 | 407.00 | 22.10 | 494.00 | 0.28 | 132.00 | 0.02 |
| 10 | 89.20 | 942.00 | 902.00 | 433.00 | 4.56 | 289.00 | 0.12 | 230.00 | 28.10 | 50.10 | 0.65 | 605.00 | 0.05 |
| 10 | 80.00 | 452.00 | 1170.00 | 439.00 | 4.78 | 333.00 | 0.16 | 296.00 | 32.00 | 211.00 | 0.33 | 203.00 | 0.02 |
| 24 | 153.00 | 1710.00 | 3050.00 | 992.00 | 4.63 | 903.00 | 0.20 | 572.00 | 54.90 | 199.00 | 0.58 | 124.00 | 0.10 |
| 24 | 89.20 | 296.00 | 1030.00 | 356.00 | 4.08 | 397.00 | 0.10 | 22.70 | 40.60 | 11.50 | 0.77 | 123.00 | 0.02 |
| 24 | 99.90 | 421.00 | 1190.00 | 483.00 | 5.22 | 529.00 | 0.09 | 75.60 | 33.00 | 91.30 | 0.33 | 177.00 | 0.05 |
| 24 | 59.00 | 427.00 | 1000.00 | 352.00 | 4.84 | 463.00 | 0.16 | 22.70 | 45.90 | 184.00 | 0.60 | 40.60 | 0.02 |
| 24 | 105.00 | 225.00 | 675.00 | 239.00 | 4.75 | 407.00 | 0.14 | 22.70 | 35.70 | 21.70 | 0.25 | 727.00 | 0.02 |
| 24 | 156.00 | 2310.00 | 3870.00 | 837.00 | 4.80 | 369.00 | 0.09 | 498.00 | 41.20 | 146.00 | 0.41 | 118.00 | 0.11 |
| 24 | 86.10 | 785.00 | 1990.00 | 471.00 | 4.62 | 325.00 | 0.14 | 22.70 | 40.00 | 56.70 | 0.49 | 65.40 | 0.02 |
| 24 | 114.00 | 830.00 | 1950.00 | 458.00 | 4.37 | 298.00 | 0.11 | 22.70 | 41.50 | 33.00 | 0.41 | 92.40 | 0.02 |
| 24 | 95.30 | 1300.00 | 2760.00 | 452.00 | 4.01 | 249.00 | 0.16 | 22.70 | 28.80 | 26.80 | 0.12 | 140.00 | 0.02 |
| 24 | 105.00 | 1650.00 | 2970.00 | 986.00 | 4.47 | 412.00 | 0.09 | 51.30 | 24.20 | 69.90 | 0.25 | 696.00 | 0.02 |
| 24 | 195.00 | 4810.00 | 6470.00 | 1890.00 | 5.65 | 697.00 | 0.11 | 805.00 | 33.60 | 353.00 | 0.56 | 660.00 | 0.29 |
| 48 | 63.50 | 449.00 | 921.00 | 356.00 | 4.93 | 475.00 | 0.15 | 195.00 | 35.00 | 69.90 | 0.58 | 23.60 | 0.02 |
| 48 | 259.00 | 2530.00 | 5180.00 | 1550.00 | 9.27 | 1410.00 | 0.24 | 3410.00 | 157.00 | 4450.00 | 1.01 | 231.00 | 0.49 |
| 48 | 81.60 | 1140.00 | 1620.00 | 794.00 | 6.20 | 600.00 | 0.12 | 209.00 | 25.10 | 169.00 | 0.20 | 347.00 | 0.02 |
| 48 | 59.00 | 1230.00 | 1260.00 | 733.00 | 5.68 | 643.00 | 0.13 | 425.00 | 20.00 | 422.00 | 0.22 | 599.00 | 0.13 |
| 48 | 105.00 | 660.00 | 659.00 | 375.00 | 5.07 | 436.00 | 0.10 | 137.00 | 14.40 | 198.00 | 0.20 | 646.00 | 0.02 |
| 48 | 77.00 | 2850.00 | 3990.00 | 1350.00 | 4.21 | 430.00 | 0.13 | 460.00 | 18.20 | 604.00 | 0.41 | 1010.00 | 0.28 |
| 48 | 114.00 | 2450.00 | 4260.00 | 1170.00 | 4.80 | 346.00 | 0.13 | 195.00 | 21.90 | 190.00 | 0.08 | 91.70 | 0.10 |
| 48 | 57.50 | 843.00 | 1920.00 | 445.00 | 4.41 | 296.00 | 0.11 | 22.70 | 26.10 | 60.00 | 0.25 | 289.00 | 0.02 |
| 48 | 92.20 | 1820.00 | 3330.00 | 704.00 | 5.12 | 360.00 | 0.13 | 160.00 | 28.20 | 113.00 | 0.36 | 230.00 | 0.06 |
| 48 | 130.00 | 3350.00 | 5370.00 | 1520.00 | 5.25 | 436.00 | 0.13 | 395.00 | 28.70 | 69.90 | 0.15 | 730.00 | 0.14 |
| 72 | 92.40 | 385.00 | 490.00 | 262.00 | 5.50 | 580.00 | 0.10 | 97.90 | 13.90 | 31.60 | 0.30 | 485.00 | 0.07 |
| 72 | 190.00 | 367.00 | 505.00 | 307.00 | 6.18 | 554.00 | 0.24 | 200.00 | 15.70 | 33.10 | 1.12 | 360.00 | 0.02 |
| 72 | 107.00 | 137.00 | 284.00 | 67.80 | 4.01 | 175.00 | 0.06 | 22.70 | 21.70 | 7.31 | 0.37 | 144.00 | 0.02 |
| 72 | 44.50 | 265.00 | 515.00 | 242.00 | 4.29 | 424.00 | 0.13 | 22.70 | 16.50 | 19.20 | 0.23 | 862.00 | 0.02 |
| 72 | 100.00 | 726.00 | 1300.00 | 264.00 | 4.26 | 291.00 | 0.15 | 22.70 | 33.70 | 30.80 | 0.21 | 576.00 | 0.02 |
| 72 | 114.00 | 2290.00 | 3710.00 | 971.00 | 5.69 | 396.00 | 0.14 | 231.00 | 24.40 | 147.00 | 0.32 | 2400.00 | 0.07 |
| 72 | 263.00 | 13200.00 | 13500.00 | 1970.00 | 5.79 | 683.00 | 5.35 | 84600.00 | 37.30 | 11400.00 | 0.16 | 529.00 | 0.77 |
| 72 | 230.00 | 4250.00 | 4800.00 | 1910.00 | 6.12 | 499.00 | 0.26 | 1480.00 | 42.60 | 1330.00 | 0.54 | 250.00 | 0.23 |
| 72 | 80.20 | 1040.00 | 1810.00 | 502.00 | 4.95 | 252.00 | 0.06 | 58.50 | 20.20 | 37.10 | 0.21 | 450.00 | 0.02 |
| 96 | 108.00 | 1220.00 | 1190.00 | 576.00 | 5.40 | 403.00 | 0.14 | 152.00 | 17.90 | 106.00 | 0.32 | 523.00 | 0.02 |
| 96 | 132.00 | 680.00 | 1060.00 | 402.00 | 6.03 | 424.00 | 0.06 | 97.90 | 24.80 | 65.90 | 0.36 | 1200.00 | 0.02 |
| 96 | 138.00 | 357.00 | 612.00 | 276.00 | 4.64 | 298.00 | 0.16 | 84.90 | 18.90 | 44.30 | 0.17 | 363.00 | 0.02 |
| 96 | 124.00 | 360.00 | 503.00 | 286.00 | 5.12 | 301.00 | 0.08 | 49.40 | 20.50 | 30.80 | 0.27 | 52.40 | 0.02 |
| 96 | 100.00 | 368.00 | 609.00 | 188.00 | 5.14 | 308.00 | 0.07 | 71.80 | 23.90 | 23.80 | 0.21 | 272.00 | 0.02 |
| 96 | 240.00 | 17500.00 | 16700.00 | 2730.00 | 3.46 | 751.00 | 4.53 | 61800.00 | 26.00 | 22100.00 | 0.17 | 593.00 | 0.97 |
| 96 | 155.00 | 3210.00 | 3880.00 | 1170.00 | 4.84 | 418.00 | 0.13 | 432.00 | 21.20 | 826.00 | 0.45 | 1060.00 | 0.14 |
| 96 | 103.00 | 1610.00 | 2220.00 | 717.00 | 5.37 | 332.00 | 0.12 | 226.00 | 24.50 | 93.90 | 0.21 | 197.00 | 0.04 |
| 96 | 78.80 | 608.00 | 1220.00 | 295.00 | 4.23 | 163.00 | 0.05 | 22.70 | 17.50 | 7.31 | 0.21 | 550.00 | 0.02 |
| 96 | 228.00 | 11500.00 | 18200.00 | 3280.00 | 3.49 | 464.00 | 3.15 | 22600.00 | 24.60 | 29600.00 | 0.39 | 93.90 | 0.70 |
| 96 | 111.00 | 3050.00 | 3150.00 | 1090.00 | 3.18 | 367.00 | 0.75 | 6370.00 | 46.70 | 2890.00 | 0.48 | 121.00 | 0.25 |
| 96 | 336.00 | 34700.00 | 54200.00 | 4430.00 | 6.36 | 874.00 | 1.25 | 6840.00 | 70.70 | 62000.00 | 0.32 | 526.00 | 1.01 |
| 96 | 259.00 | 10400.00 | 14700.00 | 3740.00 | 3.94 | 589.00 | 3.21 | 25200.00 | 28.90 | 20900.00 | 0.17 | 94.30 | 0.79 |
| 48 | 344.00 | 32900.00 | 36700.00 | 3690.00 | 8.42 | 924.00 | 3.38 | 14200.00 | 60.10 | 70200.00 | 0.36 | 1340.00 | 1.35 |
| 48 | 312.00 | 16300.00 | 26500.00 | 2700.00 | 7.82 | 952.00 | 0.30 | 3020.00 | 74.00 | 36800.00 | 0.41 | 1580.00 | 0.95 |
| 48 | 352.00 | 34500.00 | 30500.00 | 3370.00 | 6.57 | 618.00 | 25.60 | 59300.00 | 39.00 | 105000.00 | 0.25 | 4010.00 | 1.59 |
| 48 | 405.00 | 43600.00 | 65400.00 | 3590.00 | 5.88 | 832.00 | 5.65 | 28900.00 | 100.00 | 33100.00 | 0.51 | 31.70 | 1.31 |
| 48 | 327.00 | 7870.00 | 5260.00 | 1200.00 | 7.25 | 712.00 | 3.93 | 5200.00 | 12.60 | 36600.00 | 0.60 | 1170.00 | 1.11 |
| 48 | 312.00 | 12400.00 | 28300.00 | 1780.00 | 6.72 | 556.00 | 0.25 | 1770.00 | 72.70 | 13800.00 | 0.51 | 454.00 | 0.99 |
| 48 | 406.00 | 23000.00 | 39200.00 | 5170.00 | 9.37 | 962.00 | 0.72 | 5800.00 | 103.00 | 19900.00 | 0.70 | 2360.00 | 1.05 |
| 72 | 286.00 | 17100.00 | 6520.00 | 749.00 | 6.84 | 172.00 | 1.36 | 2300.00 | 13.60 | 37200.00 | 0.42 | 532.00 | 0.80 |
| 48 | 325.00 | 25000.00 | 44700.00 | 3420.00 | 8.09 | 1030.00 | 0.40 | 3800.00 | 74.30 | 32100.00 | 0.39 | 331.00 | 0.85 |
| 72 | 357.00 | 42400.00 | 32000.00 | 4350.00 | 6.43 | 852.00 | 1.85 | 21300.00 | 28.40 | 19900.00 | 0.32 | 442.00 | 1.10 |
| 72 | 393.00 | 23400.00 | 33000.00 | 3290.00 | 7.37 | 940.00 | 2.03 | 11800.00 | 84.80 | 79300.00 | 0.39 | 565.00 | 1.02 |
| 72 | 284.00 | 9090.00 | 11500.00 | 2560.00 | 4.82 | 689.00 | 9.71 | 62800.00 | 34.20 | 16900.00 | 0.29 | 193.00 | 0.80 |
| 96 | 372.00 | 29900.00 | 51500.00 | 5590.00 | 4.99 | 587.00 | 2.42 | 8620.00 | 30.50 | 55700.00 | 0.51 | 105.00 | 1.01 |

| hour | RANTES | SCF | SGOT | TIMP-1 | TF | TNF-alpha | TPO | VCAM-1 | VEGF | vWF |
|---|---|---|---|---|---|---|---|---|---|---|
| 0 | 10.90 | 40.50 | 14.80 | 3.85 | 0.42 | 0.02 | 5.42 | 1630.00 | 107.00 | 21.20 |
| 0 | 12.00 | 38.50 | 15.30 | 2.63 | 1.02 | 0.07 | 8.73 | 1580.00 | 180.00 | 20.30 |
| 0 | 16.50 | 99.50 | 5.76 | 4.57 | 0.89 | 0.02 | 13.10 | 1390.00 | 166.00 | 28.00 |
| 0 | 24.30 | 104.00 | 6.23 | 2.55 | 3.21 | 0.10 | 17.10 | 1510.00 | 150.00 | 8.00 |
| 0 | 14.80 | 17.00 | 15.80 | 1.02 | 0.95 | 0.04 | 8.54 | 1230.00 | 129.00 | 12.50 |
| 0 | 10.90 | 54.70 | 14.20 | 1.13 | 1.47 | 0.13 | 8.17 | 1110.00 | 55.70 | 26.50 |
| 0 | 22.80 | 102.00 | 8.87 | 2.90 | 0.95 | 0.07 | 7.60 | 1120.00 | 145.00 | 33.20 |
| 0 | 10.90 | 50.50 | 12.50 | 1.79 | 0.39 | 0.02 | 5.42 | 1210.00 | 107.00 | 22.20 |
| 0 | 13.90 | 63.20 | 13.80 | 5.20 | 0.45 | 0.06 | 7.60 | 1500.00 | 102.00 | 20.80 |
| 0 | 21.30 | 50.50 | 11.00 | 3.84 | 1.02 | 0.07 | 7.41 | 1620.00 | 139.00 | 25.10 |
| 0 | 21.30 | 54.70 | 12.30 | 6.17 | 0.92 | 0.03 | 7.02 | 1560.00 | 107.00 | 24.10 |
| 0 | 16.50 | 40.50 | 14.80 | 2.31 | 0.63 | 0.02 | 6.23 | 1640.00 | 134.00 | 23.20 |
| 0 | 19.00 | 80.90 | 12.90 | 1.85 | 0.76 | 0.02 | 6.03 | 1230.00 | 118.00 | 34.70 |
| 0 | 25.80 | 61.00 | 14.70 | 1.80 | 1.09 | 0.02 | 7.02 | 1250.00 | 110.00 | 22.70 |
| 0 | 25.80 | 54.70 | 14.40 | 2.06 | 0.34 | 0.15 | 5.42 | 1360.00 | 86.40 | 21.20 |
| 0 | 14.80 | 42.40 | 9.72 | 1.10 | 0.39 | 0.02 | 7.02 | 987.00 | 76.10 | 20.30 |
| 4 | 14.80 | 46.40 | 15.20 | 2.95 | 0.82 | 0.02 | 7.70 | 1390.00 | 118.00 | 20.80 |
| 4 | 35.60 | 54.70 | 15.30 | 4.15 | 1.15 | 0.02 | 12.60 | 1370.00 | 131.00 | 19.30 |
| 4 | 14.80 | 50.50 | 16.40 | 2.67 | 0.57 | 0.07 | 7.41 | 1490.00 | 145.00 | 24.60 |
| 4 | 58.60 | 23.80 | 17.60 | 16.40 | 0.34 | 0.06 | 7.89 | 2160.00 | 177.00 | 17.40 |
| 4 | 47.40 | 80.90 | 6.51 | 4.00 | 1.65 | 0.06 | 12.30 | 1370.00 | 145.00 | 28.50 |
| 4 | 40.20 | 85.50 | 8.79 | 2.89 | 1.15 | 0.15 | 10.90 | 1120.00 | 76.10 | 15.90 |
| 4 | 32.80 | 54.70 | 15.30 | 4.00 | 0.57 | 0.07 | 6.23 | 1240.00 | 129.00 | 15.40 |
| 4 | 71.70 | 119.00 | 15.00 | 5.26 | 0.39 | 0.19 | 6.53 | 1240.00 | 194.00 | 26.50 |
| 4 | 43.50 | 131.00 | 8.16 | 4.44 | 1.05 | 0.10 | 10.00 | 921.00 | 169.00 | 34.70 |
| 4 | 69.40 | 90.10 | 10.10 | 2.82 | 1.02 | 0.19 | 9.65 | 879.00 | 153.00 | 37.50 |
| 4 | 39.60 | 58.90 | 12.40 | 3.13 | 0.63 | 0.06 | 8.64 | 1110.00 | 113.00 | 28.90 |
| 10 | 40.20 | 109.00 | 15.60 | 5.60 | 0.63 | 0.21 | 6.23 | 1250.00 | 221.00 | 21.20 |
| 10 | 46.10 | 54.70 | 11.80 | 4.05 | 0.57 | 0.09 | 7.22 | 1490.00 | 194.00 | 38.00 |
| 10 | 75.20 | 159.00 | 12.50 | 6.84 | 1.15 | 0.25 | 12.60 | 1520.00 | 322.00 | 28.90 |
| 10 | 87.60 | 258.00 | 6.53 | 6.09 | 0.95 | 0.42 | 12.20 | 1540.00 | 361.00 | 29.90 |
| 10 | 60.40 | 124.00 | 17.10 | 5.10 | 1.09 | 0.09 | 8.73 | 1590.00 | 233.00 | 31.80 |
| 10 | 78.60 | 99.50 | 12.90 | 18.00 | 1.79 | 0.18 | 10.80 | 2160.00 | 177.00 | 28.90 |
| 10 | 40.20 | 44.40 | 14.90 | 8.54 | 0.57 | 0.02 | 10.50 | 1530.00 | 156.00 | 21.20 |
| 10 | 54.30 | 107.00 | 9.43 | 10.20 | 1.76 | 0.15 | 15.60 | 1490.00 | 199.00 | 33.70 |
| 10 | 38.20 | 50.50 | 15.20 | 6.38 | 0.69 | 0.04 | 7.98 | 1700.00 | 123.00 | 30.80 |
| 10 | 58.80 | 67.50 | 11.10 | 14.80 | 1.29 | 0.06 | 12.20 | 1650.00 | 183.00 | 21.20 |
| 24 | 113.00 | 124.00 | 12.70 | 33.10 | 2.24 | 0.18 | 13.80 | 1780.00 | 249.00 | 30.80 |
| 24 | 41.50 | 7.79 | 20.30 | 9.54 | 1.29 | 0.02 | 7.02 | 1840.00 | 63.30 | 20.30 |
| 24 | 32.80 | 76.40 | 10.80 | 10.40 | 1.68 | 0.03 | 12.70 | 1620.00 | 150.00 | 45.00 |
| 24 | 62.20 | 32.80 | 18.90 | 11.10 | 1.65 | 0.02 | 13.70 | 1570.00 | 102.00 | 31.30 |
| 24 | 27.20 | 54.70 | 12.20 | 6.45 | 1.58 | 0.02 | 12.60 | 1700.00 | 118.00 | 7.50 |
| 24 | 58.60 | 65.30 | 15.50 | 11.40 | 0.76 | 0.13 | 9.28 | 1380.00 | 227.00 | 27.00 |
| 24 | 44.80 | 34.70 | 18.00 | 8.22 | 0.89 | 0.07 | 10.40 | 1190.00 | 134.00 | 22.20 |
| 24 | 32.10 | 27.30 | 18.40 | 6.97 | 0.45 | 0.02 | 6.83 | 1330.00 | 123.00 | 21.20 |
| 24 | 40.20 | 50.50 | 16.40 | 7.35 | 0.23 | 0.02 | 7.98 | 1050.00 | 123.00 | 27.00 |
| 24 | 57.40 | 80.90 | 6.50 | 5.24 | 0.39 | 0.03 | 7.50 | 1180.00 | 150.00 | 49.30 |
| 24 | 113.00 | 193.00 | 4.97 | 17.30 | 0.76 | 0.19 | 12.70 | 1360.00 | 339.00 | 70.20 |
| 48 | 37.60 | 34.70 | 16.30 | 10.10 | 1.12 | 0.02 | 11.10 | 1410.00 | 134.00 | 36.60 |
| 48 | 203.00 | 389.00 | 5.19 | 32.90 | 1.79 | 0.63 | 19.80 | 2860.00 | 550.00 | 77.60 |
| 48 | 32.80 | 87.80 | 5.74 | 9.21 | 1.51 | 0.04 | 12.50 | 1510.00 | 172.00 | 68.40 |
| 48 | 28.60 | 121.00 | 5.35 | 6.84 | 1.22 | 0.07 | 13.00 | 1350.00 | 134.00 | 78.10 |
| 48 | 39.60 | 76.40 | 6.07 | 3.41 | 0.69 | 0.04 | 10.70 | 1270.00 | 131.00 | 43.20 |
| 48 | 51.10 | 188.00 | 5.86 | 11.20 | 1.87 | 0.20 | 13.50 | 676.00 | 221.00 | 50.70 |
| 48 | 56.10 | 149.00 | 8.67 | 12.30 | 1.15 | 0.10 | 13.30 | 895.00 | 131.00 | 35.60 |
| 48 | 26.50 | 38.50 | 13.60 | 6.32 | 0.76 | 0.13 | 8.45 | 1100.00 | 102.00 | 28.00 |
| 48 | 42.80 | 107.00 | 10.20 | 8.47 | 1.09 | 0.18 | 10.40 | 1090.00 | 172.00 | 40.30 |
| 48 | 64.60 | 94.80 | 11.30 | 11.90 | 0.76 | 0.15 | 7.98 | 1410.00 | 188.00 | 37.50 |
| 72 | 51.30 | 84.30 | 5.13 | 3.48 | 1.54 | 0.06 | 7.63 | 1580.00 | 141.00 | 45.50 |
| 72 | 43.40 | 118.00 | 4.59 | 3.36 | 2.97 | 0.23 | 12.60 | 1420.00 | 219.00 | 97.40 |
| 72 | 10.90 | 6.81 | 17.40 | 2.94 | 0.56 | 0.02 | 5.96 | 1730.00 | 99.50 | 20.10 |
| 72 | 34.80 | 32.90 | 10.80 | 4.36 | 1.14 | 0.02 | 7.41 | 1510.00 | 108.00 | 26.00 |
| 72 | 36.20 | 22.10 | 17.40 | 4.83 | 1.31 | 0.03 | 7.41 | 1520.00 | 126.00 | 17.70 |
| 72 | 52.60 | 127.00 | 9.47 | 7.45 | 1.65 | 0.13 | 9.09 | 1640.00 | 200.00 | 31.50 |
| 72 | 468.00 | 381.00 | 8.08 | 283.00 | 2.30 | 1.10 | 15.60 | 1760.00 | 858.00 | 46.30 |
| 72 | 103.00 | 152.00 | 12.10 | 12.40 | 1.68 | 0.30 | 13.20 | 2110.00 | 302.00 | 21.30 |
| 72 | 37.70 | 55.10 | 14.60 | 7.56 | 1.42 | 0.04 | 7.20 | 1550.00 | 143.00 | 22.90 |
| 96 | 34.80 | 63.60 | 8.96 | 4.96 | 1.25 | 0.09 | 7.84 | 1700.00 | 141.00 | 33.80 |
| 96 | 39.10 | 59.40 | 10.40 | 7.09 | 1.59 | 0.09 | 6.84 | 2650.00 | 136.00 | 18.90 |
| 96 | 24.10 | 53.30 | 13.20 | 3.54 | 1.20 | 0.08 | 5.96 | 2020.00 | 101.00 | 19.30 |
| 96 | 27.30 | 63.60 | 14.20 | 3.13 | 0.59 | 0.04 | 5.05 | 2000.00 | 112.00 | 25.20 |
| 96 | 32.60 | 36.20 | 14.40 | 5.83 | 0.83 | 0.06 | 6.40 | 2110.00 | 146.00 | 20.50 |
| 96 | 470.00 | 397.00 | 10.90 | 282.00 | 1.87 | 1.03 | 16.20 | 1050.00 | 688.00 | 34.20 |
| 96 | 81.90 | 132.00 | 7.85 | 9.11 | 1.45 | 0.18 | 14.00 | 1420.00 | 239.00 | 36.20 |
| 96 | 56.50 | 88.50 | 12.80 | 5.70 | 1.31 | 0.09 | 10.20 | 1620.00 | 170.00 | 29.90 |
| 96 | 28.00 | 39.50 | 18.00 | 4.66 | 1.02 | 0.02 | 5.51 | 1420.00 | 92.60 | 15.70 |
| 96 | 447.00 | 418.00 | 5.25 | 107.00 | 1.34 | 0.87 | 12.70 | 1090.00 | 651.00 | 67.40 |
| 96 | 272.00 | 154.00 | 15.50 | 26.40 | 1.87 | 0.36 | 12.40 | 1270.00 | 307.00 | 21.30 |
| 96 | 435.00 | 628.00 | 2.39 | 98.50 | 2.00 | 1.42 | 17.70 | 1350.00 | 978.00 | 88.80 |
| 96 | 507.00 | 388.00 | 4.37 | 96.90 | 1.57 | 0.97 | 13.50 | 1060.00 | 640.00 | 88.00 |
| 48 | 403.00 | 722.00 | 0.19 | 308.00 | 1.15 | 2.19 | 14.10 | 1070.00 | 2590.00 | 126.00 |
| 48 | 319.00 | 601.00 | 0.26 | 166.00 | 1.72 | 1.36 | 20.40 | 1400.00 | 824.00 | 119.00 |
| 48 | 464.00 | 756.00 | 0.19 | 358.00 | 0.95 | 1.50 | 13.10 | 649.00 | 3410.00 | 53.50 |
| 48 | 547.00 | 785.00 | 5.71 | 140.00 | 2.53 | 1.83 | 20.20 | 1090.00 | 1220.00 | 67.90 |
| 48 | 330.00 | 437.00 | 0.19 | 131.00 | 1.58 | 0.66 | 16.10 | 704.00 | 2370.00 | 15.40 |
| 48 | 257.00 | 486.00 | 0.19 | 66.50 | 2.01 | 1.01 | 19.40 | 886.00 | 452.00 | 139.00 |
| 48 | 472.00 | 781.00 | 2.53 | 164.00 | 2.16 | 2.24 | 20.80 | 1980.00 | 980.00 | 140.00 |
| 72 | 314.00 | 399.00 | 0.19 | 117.00 | 2.00 | 0.75 | 14.80 | 273.00 | 1360.00 | 6.23 |
| 48 | 388.00 | 557.00 | 2.10 | 107.00 | 1.31 | 1.27 | 17.20 | 1590.00 | 735.00 | 89.60 |
| 72 | 476.00 | 598.00 | 3.02 | 154.00 | 1.70 | 1.14 | 11.30 | 1160.00 | 907.00 | 47.90 |
| 72 | 538.00 | 783.00 | 3.39 | 247.00 | 2.14 | 1.84 | 16.00 | 2080.00 | 1570.00 | 67.40 |
| 72 | 455.00 | 418.00 | 5.97 | 297.00 | 1.76 | 1.17 | 14.60 | 1450.00 | 1020.00 | 57.20 |
| 96 | 441.00 | 743.00 | 3.62 | 85.00 | 1.37 | 2.19 | 16.20 | 1500.00 | 1000.00 | 72.20 |

What is claimed is:

1. A method for selecting a panel of biomarkers useful for determining the stage of sepsis in an animal species comprising:
(a) providing a plurality of biological samples taken at a selected timepoint from at least two groups of animals, wherein the first group of animals comprises survived immunocompromised individuals infected by a sepsis-causing pathogen and the second group of animals comprises doomed immunocompromised individuals infected by a sepsis-causing pathogen;
(b) measuring the amount of each of a plurality of analytes in the biological samples from each group and generating a dataset for each group; and
(c) performing a statistical analysis on the data comprising:
(i) conducting a univariate statistical test on the dataset for each analyte, to compare the dataset for biological samples from the first group to the dataset for biological samples from the second group of animals; and
(ii) selecting as biomarkers analytes according to their significance level as determined by the univariate statistical test.

2. The method of claim 1 wherein the univariate statistical test is a T-test.

3. The method of claim 1 further comprising transforming the data for each group to log scale.

4. The method of claim 1, wherein the p value of each of the selected analytes is less than a significance level of 0.05.

5. The method of claim 1 further comprising:
deriving a discrimination function for the selected biomarkers, wherein said deriving comprises performing a principle component analysis and a linear discriminant analysis; and
using the discrimination function to generate a score for each animal.

6. The method of claim 5, wherein the analytes comprise MCP-1/JE, IL-6, MCP-3, IL-3, MIP-1β, and KC-GRO.

7. The method of claim 6 wherein the discrimination function is 19(MCP-1-JE)+27(IL-6)+18(MCP-3)+21(IL-3)+18(MIP-1β)+25(KC-GRO).

8. The method of claim 1, wherein the analytes comprise Apolipoprotein A1, β2 Microglobulin, C Reactive Protein, D-dimer, EGF, Endothelin-1, Eotaxin, Factor VII, FGF-9, FGF-Basic, Fibrinogen, GCP-2, LIX, GM-CSF, Growth Hormone, GST, Haptoglobin, IFN-α, IgA, IL-10, IL-11, IL-12p70, IL-17, IL-18, IL-1α, IL-1β, IL-2, IL-3, IL-4, IL-5, IL-6, IL-7, Insulin, IP-10, KC-GRO, Leptin, LIF, Lymphotactin, MCP-1-JE, MCP-3, MCP-5, M-CSF, MDC, MIP-1α, MIP-1β, MIP-1α, MIP-2, MIP-3β, Myoglobin, OSM, RANTES, SCF, SGOT, TIMP-1, Tissue Factor, TNF-α, TPO, VCAM-1, VEGF, and VWF.

9. The method of claim 1, wherein the animals are mice.

10. The method of claim 8, wherein the timepoint is selected from the group consisting of 4 hours post infection, 10 hours post infection, 22 hours post infection, 24 hours post infection, 48 hours post infection, 72 hours post infection, and 96 hours post infection.

11. The method of claim 1, wherein the species is human.

12. The method of claim 1, wherein the biomarker panel consists of fifteen or fewer biomarkers.

13. The method of claim 1, wherein the biomarker panel consists of ten or fewer biomarkers.

14. The method of claim 1, wherein the biomarker panel consists of five or fewer biomarkers.

15. The method of claim 1, further comprising using data-visualization software to evaluate the ability of the panel biomarkers to predict disease outcome for a subject diagnosed with sepsis.

16. The method of claim 1, wherein the biological samples are serum samples.

17. A method for providing a survival prognosis for an animal diagnosed with sepsis, comprising:
(a) providing a biological sample from an animal suspected of being infected by a sepsis-causing pathogen;
(b) providing a panel of biomarkers useful for determining the stage of sepsis syndrome in the animal species, said panel selected according to the method defined in claim 5;
(c) measuring in the biological sample the amount of each of the biomarkers;
(d) generating a score for the biological sample using the discrimination function; and
(e) comparing the score with at least one score determined using a biological sample from a survived immunocompromised animal and at least one score determined using a biological sample from a doomed immunocompromised animal.

18. The method of claim 17, further comprising confirming that the animal is infected by a sepsis-causing pathogen.

19. The method of claim 17 wherein the animal species is a mammal.

20. The method of claim 17 where the animal is a mouse.

21. The method of claim 17 where the animal is a human.

22. A method for determining the stage of sepsis in an animal comprising:
(a) providing a biological sample from an animal suspected of being infected by a sepsis-causing pathogen;
(b) providing a panel of biomarkers useful for determining the stage of sepsis syndrome in the animal species, said panel selected according to the method defined in claim 5;
(c) measuring in the biological sample the amount of each of the biomarkers;
(d) generating a score for the biological sample using a discrimination function determined for the stage of sepsis syndrome; and
(e) comparing the score for the biological sample with at least one reference score determined using a biological sample from at least one animal in said stage of sepsis syndrome.

23. The method of claim 22 further comprising confirming that the animal is infected by a sepsis-causing pathogen.

24. The method of claim 22 where the animal is a mammal.

25. The method of claim 22 where the animal is a mouse.

26. The method of claim 22 where the animal is a human.

27. A method of evaluating a test compound for treating sepsis syndrome, comprising:
(a) developing experimental animals modeling sepsis syndrome, comprising infecting experimental immunocompromised animals and control immunocompromised animals of the same species with a pathogen species a pathogen species capable of causing sepsis in the animal species, wherein the survival rate of immunocompromised infected animals in the model system is 10-90%;
(b) administering a test compound to the experimental animals;
(c) obtaining biological samples from the experimental and control animals at a selected timepoint following infection;
(d) measuring the amounts of a plurality of analytes in the biological samples; and
(e) determining the scores for the experimental and control animals using a discrimination function for the animal species;
whereby if the test compound is determined to be effective in causing a statistically significant change in the score for the biological sample compared to the score for the control animals, the test compound is a candidate drug for treating sepsis syndrome.

28. The method of claim 27 wherein said test compound is a modulator of vascular endothelial growth factor, monocyte chemoattractant protein 1, or peroxisome proliferator-activated receptor gamma.

29. The method of claim 27, wherein said survival rate of immunocompromised infected animals in the model system is 30-70%.

30. The method of claim 27 wherein the test compound is a toll-like receptor (TLR) inhibitor.

31. The method of claim 27, further comprising administering an antibiotic to the animals.

32. A method of determining a reference score for a group of immunocompromised infected animals in a model system comprising:
(a) providing a model system of sepsis syndrome, said model system comprising immunocompromised survived animals and immunocompromised doomed animals from an animal species and a sepsis-causing pathogen species;
(b) infecting the animals in the model system;
(c) obtaining biological samples from the animals at a selected time after infecting;
(d) measuring the level of a panel of biomarkers selected using the method of claim 5 in each biological sample; and
(e) determining a first reference score for immunocompromised survived animals using a discrimination function, and determining a second reference score for immunocompromised doomed animals using a discrimination function.

33. A method of determining a reference score for a group of sepsis patients comprising:
(a) providing a group of patients having sepsis;
(b) obtaining biological samples from said patients;
(c) measuring the level of a panel of biomarkers selected using the method of claims 5 in each biological sample; and
(d) determining a first reference score for actual doomed patients with sepsis using a discrimination function, and determining a second reference score for actual survived patients using a discrimination function.

34. A method as defined in claim 33, wherein the biomarker panel comprises an MCP-1 analyte.

35. A method as defined in claim 34, wherein the biomarker panel further comprises a VEGF analyte.

36. A model system for septic syndrome comprising:
(a) at least one immunocompromised animal infected with a sepsis-causing pathogen; and
(b) at least one immunocompromised animal not infected with a sepsis-causing pathogen.

37. A method of using the model system of claim 36 to test the effectiveness of a compound active against a sepsis target, comprising:
(a) providing a test compound to said at least one infected animal and to said at least one not infected animal;
(b) determining the survival rate for each said treated animal; and
(c) determining the level of at least one serum analyte in each said treated animal, whereby change in the survival rates and the at least one analyte level reflects the effectiveness of the compound as a treatment for septic syndrome.

38. The method of claim 37, wherein said animals are each a mouse.

39. The method of claim 37, wherein the test compound is an anti-vascular endothelial growth factor (VEGF) antibody or an anti-MCP-1 antibody.

40. The method of claim 37, further comprising administering an antibiotic to the animals.

41. A method for identifying biomarkers involved in the systemic inflammatory response to infection comprising:
(a) providing a plurality of biological samples taken at a selected timepoint from at least two groups of animals wherein the first group comprises survived immunocompromised individuals infected by a sepsis-causing pathogen and the second group comprises doomed immunocompromised individuals infected by a sepsis-causing pathogen;
(b) measuring the amount of each of a plurality of analytes in the biological samples from each group and generating a dataset for each group; and
(c) performing a statistical analysis on the data comprising:
(i) conducting a univariate statistical test on the dataset, for each analyte, to compare the dataset for biological samples from the first group to the dataset for biological samples from the second group of animals; and
(ii) selecting analytes according to their significance level as determined by the univariate statistical test.

42. A method for selecting a panel of biomarkers useful for determining the stage of sepsis in an animal species comprising:
(a) providing a plurality of biological samples taken at a selected timepoint from at least two groups of animals wherein the first group comprises survived immunocompromised individuals infected by a sepsis-causing pathogen and the second group comprises doomed immunocompromised individuals infected by a sepsis-causing pathogen;
(b) measuring the amount of each of a plurality of analytes in the biological samples from each group and generating a dataset for each group; and
(c) selecting analytes according to their ability to discriminate between the groups.

43. A method of treating sepsis, comprising administering to a subject in need of such treatment a therapeutically effective amount of a compound modulating MCP-1 activity.

44. A method as defined in claim 43, wherein said compound is an anti-MCP-1 antibody.
